(19) United States
(12) Patent Application Publication
(10) Pub. No.: US 2022/0381748 A1
(43) Pub. Date: Dec. 1, 2022

(54) METHOD FOR DETERMINING AT LEAST ONE PARAMETER OF A SAMPLE COMPOSITION COMPRISING NUCLEIC ACID, SUCH AS RNA, AND OPTIONALLY PARTICLES

(71) Applicant: BioNTech SE, Mainz (DE)

(72) Inventors: Heinrich HAAS, Mainz (DE); Tijana BACIC, Mainz (DE); Jens SCHUMACHER, Mainz (DE)

(21) Appl. No.: 17/627,066

(22) PCT Filed: Jul. 17, 2020
(86) PCT No.: PCT/EP2020/070344

§ 371 Date: Jan. 13, 2022

(30) Foreign Application Priority Data
Jul. 18, 2019 (EP) PCT/EP2019/069342

(51) Int. Cl. G01N 30/00; G01N 15/02; G01N 30/74

(52) U.S. Cl. CPC G01N 30/0005; G01N 15/0211; G01N 30/74; G01N 2015/0038

(57) ABSTRACT

The present disclosure relates generally to the field of analyzing a nucleic acid, such as RNA, in particular to the determination of at least one parameter of a sample composition comprising a nucleic acid, especially RNA, and optionally particles.

### TECHNICAL FIELD

The present disclosure relates generally to the field of analyzing a nucleic acid, such as RNA, in particular to the determination of at least one parameter of a sample composition comprising a nucleic acid, especially RNA, and optionally particles.

### BACKGROUND

The use of a recombinant nucleic acid (such as DNA or RNA) for delivery of foreign genetic information into target cells is well known. The advantages of using RNA include transient expression and a non-transforming character. RNA does not need to enter the nucleus in order to be expressed and moreover cannot integrate into the host genome, thereby eliminating diverse risks such as oncogenesis.

A recombinant nucleic acid may be administered in naked form to a subject in need thereof; however, usually a recombinant nucleic acid is administered using a pharmaceutical composition. For example, RNA may be delivered by so-called nanoparticle formulations containing RNA and a nanoparticle forming vehicle, e.g., a cationic lipid, a mixture of a cationic lipid and helper lipid, or a cationic polymer.

The fate of such nanoparticle formulations is controlled by diverse key-factors (e.g., integrity and concentration of the nucleic acid in the nanoparticles; amount of free nucleic acid; size, size distribution, quantitative size distribution, and morphology of the nanoparticles; etc.). These factors are, e.g., referred to in the FDA “Liposome Drug Products Guidance” from 2018 as specific attributes which should be analyzed and specified. The limitations to the clinical application of current nanoparticle formulations may lie in the lack of homogeneous, pure and well-characterized nanoparticle formulations. This is also due to the fact that all the existing techniques for determining these factors have some drawbacks.

For example, the current techniques for the determination of integrity and/or concentration of nucleic acid in nanoparticles (such as methods based on a dye, gel electrophoresis, microchannel electrophoresis, or capillary electrophoresis (CE)) are labor-intensive, costly, utilize sample preparation steps causing artefacts, cannot provide adequate information and/or cannot analyze high numbers of samples. In one current technique using a dye (such as a fluorescent dye), the dye by itself can causes differences, which can affect reliability of the measured results. In addition, most of the techniques based on gel electrophoresis require multiple washing steps, the use of special running buffers that increase the length of the procedure, and special precautions due to the use of toxic reagents. For example, the agarose gel technique is affected by multiple parameters (e.g., quality of the agarose, cast of the gel, dye/sensitivity (higher amount of sample is needed), exposure time, processing the raw data and standardized evaluation by densitometry software (28S/18S method)) which make this technique unreliable. The techniques based on microchannel, chip-based electrophoresis or capillary electrophoresis provide faster run times and improved data quality compared to agarose gel electrophoresis, but require hands-on processing for priming and loading of gel, markers, and samples onto the system. CE instruments lack the sensitivity, dynamic range, and separation quality required for adequate RNA quality/quantity analysis.

Furthermore, one key challenge for characterizing nanoparticle formulations lies in the quantitative determination of the size distribution of the particles contained in the formulations. This is particularly the case for particles with a diameter smaller than about 500 nm, i.e., the range which is relevant for most pharmaceutical products. A further unmet need lies in the determination of the size distribution of nanoparticle formulations, where the size distribution is broad or complex (in particular asymmetric). All existing techniques which are available for characterization of nanoparticle formulations have certain drawbacks: e.g., they do not provide direct quantitative information on size or they measure only small, optionally not representative, subsets of the samples, or the sensitivity for particles with different sizes (or other parameters, e.g., refractive index gradients with respect to the bulk phase) is very different, which strongly affects the obtained size distributions.

Regarding the size measurements of particles in the lower submicron range (around 100 nm), several techniques exist, such as dynamic light scattering (DLS), nanoparticle tracking analysis (NTA), electron microscopy (EM), and size-exclusion chromatography (SEC)-UV.

DLS provides information on the diffusion constant of nanoparticles, from which the hydrodynamic radius, Rₕ, is calculated using the Stokes-Einstein equation. However, DLS provides only average data, from which particle sizes are numerically calculated using certain algorithms. In order to obtain quantitatively reliable numbers, nanoparticle formulations should be monomodal and monodisperse, which is not the case for many products, including nanoparticulate pharmaceutical formulations. The algorithm which is most widely used in DLS is the so-called cumulative analysis (D. E. Koppel, J. Chem. Phys. 57 (1972) 4814-4820) which as a premise only assumes monomodal size distributions and provides physically meaningful numbers only if the polydispersity is below a certain threshold. Other algorithms for DLS (cf., e.g., Provencher, S. W., Comput. Phys. Commun. 1982, 27, 229-242) provide size curves which heavily depend on the fitting parameters, and several, very different profiles can correspond to the same data set. Such analysis is hampered by the fact that the light scattering intensity for large particles is much higher than for smaller particles, which makes it difficult to determine fractions of smaller particles in the presence of much larger ones.

NTA is a method which determines the sizes of particles from their diffusion constant by microscopically observing scattered light from very small (diluted) subsets of the samples over time. NTA, in principle, is able to provide quantitative size distribution profiles; however, only very diluted samples can be measured, and the particles must be present in a relatively small size range, i.e., very small particles cannot be determined on a background of much larger ones, due to their much higher scattering intensity. Therefore, NTA is not suitable as a regularly applicable method for determining quantitative size distributions for pharmaceutical formulations. Furthermore, the statistical standard deviation of NTA is high compared to other techniques (e.g., DLS). This is a direct consequence of one to three orders of magnitude lower amount of particles analyzed by NTA. In particular, marginal amounts of particles (e.g., aggregates), which have biological impact, can be underestimated or cannot even be detected by NTA. NTA requires several time-consuming optimization steps (e.g., video capture setting, different sample dilutions, etc.) to identify suitable settings for an accurate measurement. Typically, the samples for the NTA measurement have to be diluted by a factor of 10-1000-fold which can cause problems, especially with concentration depending aggregation or disassembly of particles. Due to all these disadvantages, it is difficult to establish NTA as a quality control method.

EM provides quantitative information on size, shape and morphology of individual particles, but the number of particles which can be analyzed is even lower than for NTA. Therefore, EM has disadvantages similar or identical to those of NTA in the sense that the measured particles may not be representative for the total sample. Additional major drawbacks of this technique are the high costs, complex sample preparation and long turn-around time for analyzing the samples. This is why EM is not commonly used as a GMP method. Another problem of EM is that fixation of the samples can causes artifacts (e.g., shrinking, aggregation, etc.). If samples are not fixed (e.g., in Cryo-EM), the samples may have low contrast and cannot be analyzed.

Other separation techniques like SEC-UV are not applicable, because interaction with the column matrix can causes problems (e.g., absorption or delay of the elution). The nanoparticles cannot adequately dispersed because of the limited size range of the SEC column, or the nanoparticles cannot separated from aggregates. Furthermore, SEC-UV does not provide a quantitative size distribution in the sense that mass or particle numbers are directly correlated to the to the particle size. Other dispersive methods, such as Analytical Ultracentrifugation (AUC), allow only indirect size measurements, for example as based on the sedimentation coefficients, where several assumptions have to be made in order to calculate size profiles. In addition, AUC is costly and time consuming and it is not a common method in regular quality control. Therefore, also AUC is not appropriate for determining quantitative size profiles as a regular quality control method.

In view of the above, to assure reproducible quality of nanoparticle formulations, advanced analytical methods for in-depth particle characterization are needed. In particular, there is a need for an improved method of analyzing nanoparticle formulations containing a nucleic acid (especially RNA), wherein said method preferably (i) provides information on characteristics of the formulation (such as quantitative size distribution of the particles contained in the formulation (in particular with respect to particles having a diameter of less than 500 nm); (ii) provides information on characteristics of the particle composition (e.g., the amount of nucleic acid (especially RNA) contained in the particles, in particular as a function of the particle size, such as the ratio of the amount of nucleic acid (especially RNA) contained in the particles to the amount of particle forming compounds (in particular lipids and/or polymers, e.g., cationic lipid vs. cationic polymer), in particular as a function of the particle size); (iii) is GMP-compatible; (iv) does not depend on the use of a dye; (v) is semi-automatic; and/or (vi) can be used to analyze the effect of altering one or more reaction conditions (e.g., salt concentration; temperature; pH or buffer concentration; light/radiation; oxygen; shear force; pressure; freezing/thawing cycle; drying/reconstitution cycle; addition of excipient(s) (e.g., stabilizer and/or chelating agent); type and/or source of particle forming compounds (in particular lipids and/or polymers); charge ratio; and/or ratio of nucleic acid (such as RNA) to particle forming compounds (in particular lipids and/or polymers)) when preparing and/or storing a composition comprising a nucleic acid (such as RNA) and optionally particles. Preferably, said method provides data regarding one or more of the following parameters: nucleic acid (such as RNA) integrity; the total amount of nucleic acid (such as RNA); the amount of free nucleic acid (such as RNA); the amount of nucleic acid (such as RNA) bound to particles; the size of nucleic acid (such as RNA) containing particles (e.g., based on the radius of gyration (R_{g}) of nucleic acid (such as RNA) containing particles and/or the hydrodynamic radius (Rₕ) of nucleic acid (such as RNA) containing particles); the size distribution of nucleic acid (such as RNA) containing particles (e.g., based on R_{g} or Rₕ values); the quantitative size distribution of nucleic acid (such as RNA) containing particles (e.g., based on R_{g} or Rₕ values); the molecular weight of nucleic acid (such as RNA); and/or the shape (e.g., the shape and/or form factor) of nucleic acid (such as RNA) containing particles. Optionally, additional parameters may include one or more of the following: the amount of surface nucleic acid (such as the amount of surface RNA), the amount of encapsulated nucleic acid (such as the amount of encapsulated RNA), the amount of accessible nucleic acid (such as the amount of accessible RNA), the size of the nucleic acid (especially RNA) (e.g., based on R_{g} or Rₕ values), the size distribution of the nucleic acid (especially RNA) (e.g., based on R_{g} or Rₕ values), the quantitative size distribution of the nucleic acid (especially RNA) (e.g., based on R_{g} or Rₕ values), the nucleic acid (especially RNA) encapsulation efficiency, the ratio of the amount of nucleic acid (such as RNA) bound to particles to the total amount of particle forming compounds (in particular lipids and/or polymers) in the particles, the ratio of the amount of positively charged moieties of particle forming compounds (in particular lipids and/or polymers) in the particles to the amount of nucleic acid (such as RNA) bound to particles, and the charge ratio of the amount of positively charged moieties of particle forming compounds (in particular lipids and/or polymers) in the particles to the amount of negatively charged moieties of nucleic acid (such as RNA) bound to particles (N/P ratio)

The inventors surprisingly found that the methods and uses described herein fulfill the above mentioned requirements.

### SUMMARY

In a first aspect, the present disclosure provides a method for determining one or more parameters of a sample composition, wherein the sample composition comprises a nucleic acid (such as RNA) and optionally particles, the method comprising:

(a) subjecting at least a part of the sample composition to field-flow fractionation, thereby fractioning the components contained in the sample composition by their size so as to produce one or more sample fractions;

(b) measuring at least one signal selected from the group consisting of the UV signal, the fluorescence signal, and the refractory index (RI) signal, and optionally measuring the light scattering (LS) signal, of least one of the one or more sample fractions obtained from step (a); and

(c) calculating from the at least one signal selected from the group consisting of the UV signal, the fluorescence signal, and the RI signal, and optionally from the LS signal, the one or more parameters, wherein the one or more parameters comprise the nucleic acid (such as RNA) integrity, the total amount of nucleic acid (such as RNA), the amount of free nucleic acid (such as RNA), the amount of nucleic acid (such as RNA) bound to particles, the size of nucleic acid (such as RNA) containing particles (in particular, based on the radius of gyration (R_{g}) of nucleic acid (such as RNA) containing particles and/or the hydrodynamic radius (Rₕ) of nucleic acid (especially RNA) containing particles), the size distribution of nucleic acid (such as RNA) containing particles (e.g., based on R_{g} or Rₕ values of nucleic acid (especially RNA) containing particles), and the quantitative size distribution of nucleic acid (such as RNA) containing particles (e.g., based on R_{g} or Rₕ values of nucleic acid (especially RNA) containing particles). Generally, the size distribution and/or quantitative size distribution of nucleic acid (such as RNA) containing particles can be given as the number of the nucleic acid (such as RNA) containing particles, the molar amount of the nucleic acid (such as RNA) containing particles, or the mass of the nucleic acid (such as RNA) containing particles each as a function of their size. Additional optional parameters include the molecular weight of nucleic acid (especially RNA), the amount of surface nucleic acid (such as the amount of surface RNA), the amount of encapsulated nucleic acid (such as the amount of encapsulated RNA), the amount of accessible nucleic acid (such as the amount of accessible RNA), the size of nucleic acid (especially RNA) (in particular, based on R_{g} and/or Rₕ values of nucleic acid (especially RNA)), the size distribution of nucleic acid (especially RNA) (e.g., based on R_{g} or Rₕ values of nucleic acid (especially RNA)), the quantitative size distribution of nucleic acid (especially RNA) (e.g., based on R_{g} or Rₕ values) of nucleic acid (especially RNA)), the shape factor, the form factor, and the nucleic acid (especially RNA) encapsulation efficiency. Generally, the size distribution and/or quantitative size distribution of nucleic acid (especially RNA) can be given as the number of the nucleic acid (especially RNA) molecules, the molar amount of the nucleic acid (especially RNA), or the mass of the nucleic acid (especially RNA) each as a function of their size. Further additional optional parameters include the ratio of the amount of nucleic acid (such as RNA) bound to particles to the total amount of particle forming compounds (in particular lipids and/or polymers) in the particles, wherein said ratio may be given as a function of the particle size; the ratio of the amount of positively charged moieties of particle forming compounds (in particular lipids and/or polymers) in the particles to the amount of nucleic acid (such as RNA) bound to particles, wherein said ratio may be given as a function of the particle size; and the charge ratio of the amount of positively charged moieties of particle forming compounds (in particular lipids and/or polymers) in the particles to the amount of negatively charged moieties of nucleic acid (such as RNA) bound to particles, wherein said charge ratio is usually denoted as N/P ratio and may be given as a function of the particle size.

In a first subgroup of the first aspect, the method comprises:

(a) subjecting at least a part of the sample composition to field-flow fractionation, thereby fractioning the components contained in the sample composition by their size so as to produce one or more sample fractions;

(b) measuring at least the UV signal, and optionally the light scattering (LS) signal, of least one of the one or more sample fractions obtained from step (a); and

(c) calculating from the UV signal, and optionally from the LS signal, the one or more parameters.

In a second and preferred subgroup of the first aspect, the method is for determining one or more parameters of a sample composition, wherein the sample composition comprises RNA and optionally particles, the method comprising:

(a) subjecting at least a part of the sample composition to field-flow fractionation, thereby fractioning the components contained in the sample composition by their size so as to produce one or more sample fractions;

(b) measuring at least one signal selected from the group consisting of the UV signal, the fluorescence signal, and the refractory index (RI) signal, and optionally measuring the light scattering (LS) signal, of least one of the one or more sample fractions obtained from step (a); and

(c) calculating from the at least one signal selected from the group consisting of the UV signal, the fluorescence signal, and the RI signal, and optionally from the LS signal, the one or more parameters.

In a third and more preferred subgroup of the first aspect, the method is for determining one or more parameters of a sample composition, wherein the sample composition comprises RNA and optionally particles, the method comprising:

(a) subjecting at least a part of the sample composition to field-flow fractionation, thereby fractioning the components contained in the sample composition by their size so as to produce one or more sample fractions;

(b) measuring at least the UV signal, and optionally the light scattering (LS) signal, of least one of the one or more sample fractions obtained from step (a); and

(c) calculating from the UV signal, and optionally from the LS signal, the one or more parameters.

In one embodiment of the first aspect (in particular, in one embodiment of the first, second or third subgroup of the first aspect), the size, size distribution, and/or quantitative size distribution of nucleic acid (such as RNA) containing particles is/are calculated based on the R_{g} values of the nucleic acid (such as RNA) containing particles. In another embodiment of the first aspect (in particular, in another embodiment of the first, second or third subgroup of the first aspect), the size, size distribution, and/or quantitative size distribution of nucleic acid (such as RNA) containing particles is/are calculated based on the Rₕ values of the nucleic acid (such as RNA) containing particles. In another embodiment of the first aspect (in particular, in another embodiment of the first, second or third subgroup of the first aspect), the size, size distribution, and/or quantitative size distribution of nucleic acid (such as RNA) containing particles is/are calculated based on the R_{g} values of the nucleic acid (such as RNA) containing particles and separately based on the Rₕ values of nucleic acid (such as RNA) containing particles (i.e., this embodiment results in two data sets for the size, size distribution, and/or quantitative size distribution of nucleic acid (such as RNA) containing particles, one based on the R_{g} values and one based on the Rₕ values).

In one embodiment of the first aspect (in particular, in one embodiment of the first, second or third subgroup of the first aspect), where the one or more parameters comprise the size, size distribution, and/or quantitative size distribution of nucleic acid (such as RNA), the size, size distribution, and/or quantitative size distribution of nucleic acid (such as RNA) is/are calculated based on the R_{g} values of the nucleic acid (such as RNA). In another embodiment of the first aspect (in particular, in another embodiment of the first, second or third subgroup of the first aspect), where the one or more parameters comprise the size, size distribution, and/or quantitative size distribution of nucleic acid (such as RNA), the size, size distribution, and/or quantitative size distribution of nucleic acid (such as RNA) is/are calculated based on the Rₕ values of the nucleic acid (such as RNA). In another embodiment of the first aspect (in particular, in another embodiment of the first, second or third subgroup of the first aspect), where the one or more parameters comprise the size, size distribution, and/or quantitative size distribution of nucleic acid (such as RNA), the size, size distribution, and/or quantitative size distribution of nucleic acid (such as RNA) is/are calculated based on the R_{g} values of the nucleic acid (such as RNA) and separately based on the Rₕ values of nucleic acid (such as RNA) (i.e., this embodiment results in two data sets for the size, size distribution, and/or quantitative size distribution of nucleic acid (such as RNA), one based on the R_{g} values and one based on the Rₕ values).

In one embodiment of the first aspect (in particular, in one embodiment of the first, second or third subgroup of the first aspect), the field-flow fractionation preferably is flow field-flow fractionation, such as asymmetric flow field-flow fractionation (AF4) or hollow fiber flow field-flow fractionation (HF5).

In one embodiment of the first aspect (in particular, in one embodiment of the first, second or third subgroup of the first aspect), step (a) is performed using a membrane having a molecular weight (MW) cut-off suitable to prevent the nucleic acid (especially RNA) from permeating the membrane, preferably a membrane having a MW cut-off in the range of from 2 kDa to 30 kDa, such as a MW cut-off of 10 kDa.

In one embodiment of the first aspect (in particular, in one embodiment of the first, second or third subgroup of the first aspect), step (a) is performed using a polyethersulfon (PES) or regenerated cellulose membrane.

In one embodiment of the first aspect (in particular, in one embodiment of the first, second or third subgroup of the first aspect), step (a) is performed using (I) a cross flow rate of up to 8 mL/min, preferably up to 4 mL/min, more preferably up to 2 mL/min, e.g., a cross flow rate profile; and/or (II) an inject flow in the range of 0.05 to 0.35 mL/min, preferably in the range of 0.10 to 0.30 mL/min, more preferably in the range of 0.15 to 0.25 mL/min; and/or (III) a detector flow in the range of 0.30 to 0.70 mL/min, preferably in the range of 0.40 to 0.60 mL/min, more preferably in the range of 0.45 to 0.55 mL/min.

In one embodiment of the first aspect (in particular, in one embodiment of the first, second or third subgroup of the first aspect), the cross flow rate profile preferably contains a fractioning phase which allows the components contained in the control or sample composition to fraction/separate by their size so as to produce one or more sample fractions. It is preferred that the cross flow rate changes during this fractioning phase (e.g., starting from one value (such as about 1 to about 4 mL/min) and then decreasing to a lower value (such as about 0 to about 0.1 mL/min) or starting from one value (such as about 0 to about 0.1 mL/min) and then increasing to a higher value (such as about 1 to about 4 mL/min), wherein the change can be by any means, e.g., a continuous (such as linear or exponential) change or a stepwise change. Preferably, the cross flow rate profile contains a fractioning phase, wherein the cross flow rate changes continuously (preferably exponentially) starting from one value (such as about 1 to about 4 mL/min) and then decreasing to a lower value (such as about 0 to about 0.1 mL/min). The fractioning phase may have any length suitable to fraction/separate the components contained in the sample composition by their size, e.g., about 5 min to about 60 min, such as about 10 min to about 50 min, about 15 min to about 45 min, about 20 min to about 40 min, or about 25 min to about 35 min, or about 30 min. The cross flow rate profile may contain additional phases (e.g., 1, 2, 3, or 4 phases) which may be before and/or after the fractioning phase (e.g., one before and 1, 2, or 3 after the fractioning phase) and which may serve to separate non-nucleic acid (especially non RNA) components contained in the sample composition (e.g., proteins, polypeptides, mononucleotides, etc.) from the nucleic acid (especially RNA) contained in the sample composition, to focus the nucleic acid (especially RNA) contained in the sample composition and/or to regenerate the field-flow fractionation device (e.g., to remove all components bound to the membrane of the device). Preferably, the cross flow rate of these additional phases is constant for each additional phase and the length of each of the additional phases is independently for each of the additional phases in the range of about 5 min to about 60 min (such as about 10 min to about 50 min, about 15 min to about 45 min, about 20 min to about 40 min, or about 25 min to about 35 min, or about 30 min). For example, the cross flow rate profile may contain (i) a first additional phase which is before the fractioning phase, wherein the cross flow rate of said first additional phase is constant and is the same cross low rate with which the fractioning phase starts (the length of the first additional phase may be in the range of about 5 min to about 60 min, such as about 10 min to about 50 min, about 15 min to about 45 min, about 20 min to about 40 min, or about 25 min to about 35 min, or about 10 min or about 20 min or about 30 min); (ii) a second additional phase which is after the fractioning phase, wherein the cross flow rate of said second additional phase is constant and is the same cross low rate with which the fractioning phase ends (the length of the second additional phase may be in the range of about 5 min to about 60 min, such as about 10 min to about 50 min, about 15 min to about 45 min, about 20 min to about 40 min, or about 25 min to about 35 min, or about 10 min or about 20 min or about 30 min); and optionally (iii) a third additional phase which is after the second additional phase, wherein the cross flow rate of said third additional phase is constant and different from that of the second additional phase (the length of the third additional phase may be in the range of about 5 min to about 60 min, such as about 10 min to about 50 min, about 15 min to about 45 min, about 20 min to about 40 min, or about 25 min to about 35 min, or about 10 min or about 20 min or about 30 min). In the embodiment, where the cross flow rate profile contains a fractioning phase, wherein the cross flow rate changes continuously (preferably exponentially) starting from one value (such as about 1 to about 4 mL/min) and then decreasing to a lower value (such as about 0 to about 0.1 mL/min), it is preferred that the cross flow rate profile further contains (i) a first additional phase which is before the fractioning phase, wherein the cross flow rate of said first additional phase is constant and is the same cross low rate with which the fractioning phase starts (such as about 1 to about 4 mL/min) (the length of the first additional phase may be in the range of about 5 min to about 30 min, such as about 6 min to about 25 min, about 7 min to about 20 min, or about 8 min to about 15 min, or about 10 min to about 12 min, or about 5 min or about 10 min or about 12 min); (ii) a second additional phase which is after the fractioning phase, wherein the cross flow rate of said second additional phase is constant and is the same cross low rate with which the fractioning phase ends (such as about 0.01 to 0.1 mL/min) (the length of the second additional phase may be in the range of about 5 min to about 60 min, such as about 10 min to about 50 min, about 15 min to about 45 min, about 20 min to about 40 min, or about 25 min to about 35 min, or about 30 min); and optionally (iii) a third additional phase which is after the second additional phase, wherein the cross flow rate of said third additional phase is constant and lower than that of the second additional phase (e.g., the cross flow rate of said third additional phase is 0) (the length of the third additional phase may be in the range of about 5 min to about 30 min, such as about 6 min to about 25 min, about 7 min to about 20 min, or about 8 min to about 15 min, or about 10 min to about 12 min, or about 5 min or about 10 min or about 12 min). A preferred example of such a cross flow rate profile is the following: 1.0 to 2.0 mL/min for 10 min, an exponential gradient from 1.0 to 2.0 mL/min to 0.01 to 0.07 mL/min within 30 min; 0.01 to 0.07 mL/min for 30 min; and 0 mL/min for 10 min.

In one embodiment of the first aspect (in particular, in one embodiment of the first, second or third subgroup of the first aspect), the integrity of the nucleic acid (especially RNA) contained in the sample composition is calculated using the integrity of a control nucleic acid (especially RNA).

In a first particular example of this embodiment of the first aspect, the integrity of a control nucleic acid (especially RNA) is determined by the following steps:

(a′) subjecting at least a part of a control composition containing control nucleic acid (especially RNA) to field-flow fractionation, in particular AF4 or HF5, thereby fractioning the components contained in the control composition by their size so as to produce one or more control fractions;

(b′) measuring at least one signal selected from the group consisting of the UV signal, the fluorescence signal, and the refractory index (RI) signal of least one of the one or more control fractions obtained from step (a′);

(c′1) calculating from the at least one signal selected from the group consisting of the UV signal, the fluorescence signal, and the RI signal obtained in step (b′) the area from the maximum height of one UV, fluorescence, or RI peak to the end of the UV, fluorescence, or RI peak, thereby obtaining A_{50%}(control);

(c′2) calculating from the at least one signal selected from the group consisting of the UV signal, the fluorescence signal, and the RI signal obtained in step (b′) the total area of the one peak used in step

(c′1), thereby obtaining A_{100%}(control); and

(c′3) determining the ratio between A_{50%}(control) and A_{100%}(control), thereby obtaining the integrity of the control nucleic acid (especially RNA) (I(control)).

In this first example, the integrity of the nucleic acid (especially RNA) contained in the sample composition may be calculated by the following steps:

(c1) calculating from the at least one signal selected from the group consisting of the UV signal, the fluorescence signal, and the RI signal obtained from step (b) the area from the maximum height of the sample UV, fluorescence, or RI peak corresponding to the control UV, fluorescence, or RI peak used in step (c′1) to the end of the sample UV, fluorescence, or RI peak, thereby obtaining A_{50%}(sample);

(c2) calculating from the sample UV, fluorescence, or RI signal obtained from step (b) the total area of the sample UV, fluorescence, or RI peak used in step (c1), thereby obtaining A_{100%}(sample);

(c3) determining the ratio between A_{50%}(sample) and A_{100%}(sample), thereby obtaining I(sample); and

(c4) determining the ratio between I(sample) and I(control), thereby obtaining the integrity of the nucleic acid (especially RNA) contained in the sample composition.

In a second particular example of this embodiment of the first aspect, the integrity of a control nucleic acid (especially RNA) is determined by the following steps:

(a″) subjecting at least a part of a control composition containing control nucleic acid (especially RNA) to field-flow fractionation, in particular AF4 or HF5, thereby fractioning the components contained in the control composition by their size so as to produce one or more control fractions;

(b″) measuring at least one signal selected from the group consisting of the UV signal, the fluorescence signal, and the RI signal of least one of the one or more control fractions obtained from step (a″); and

(c″) determining from the at least one signal selected from the group consisting of the UV signal, the fluorescence signal, and the RI signal obtained in step (b″) the height of one UV, fluorescence, or RI peak (H(control)), thereby obtaining the integrity of the control nucleic acid (especially RNA).

In this second example, the integrity of the nucleic acid (especially RNA) contained in the sample composition may be calculated by the following steps:

(c1′) determining from the at least one signal selected from the group consisting of the UV signal, the fluorescence signal, and the RI signal obtained in step (b) the height of the sample UV, fluorescence, or RI peak corresponding to the control UV, fluorescence, or RI peak used in step (c″) (H(sample)); and

(c2′) determining the ratio between H(sample) and H(control), thereby obtaining the integrity of the nucleic acid (especially RNA) contained in the sample composition.

In a third particular example of this embodiment of the first aspect (relating to the first subgroup of the first aspect), the integrity of a control nucleic acid (especially RNA) is determined by the following steps:

(a′) subjecting at least a part of a control composition containing control nucleic acid (especially RNA) to field-flow fractionation, in particular AF4 or HF5, thereby fractioning the components contained in the control composition by their size so as to produce one or more control fractions;

(b′) measuring at least the UV signal of least one of the one or more control fractions obtained from step (a′);

(c′1) calculating from the UV signal obtained in step (b′) the area from the maximum height of one UV peak to the end of the UV peak, thereby obtaining A_{50%}(control);

(c′2) calculating from the UV signal obtained in step (b′) the total area of the one peak used in step (c′1), thereby obtaining A_{100%}(control); and

(c′3) determining the ratio between A_{50%}(control) and A_{100%}(control), thereby obtaining the integrity of the control nucleic acid (especially RNA) (I(control)).

In this third example, the integrity of the nucleic acid (especially RNA) contained in the sample composition may be calculated by the following steps:

(c1) calculating from the UV signal obtained from step (b) the area from the maximum height of the sample UV peak corresponding to the control UV peak used in step (c′1) to the end of the sample UV peak, thereby obtaining A_{50%}(sample);

(c2) calculating from the sample UV signal obtained from step (b) the total area of the sample UV peak used in step (c1), thereby obtaining A_{100%}(sample);

(c3) determining the ratio between A_{50%}(sample) and A_{100%}(sample), thereby obtaining I(sample); and

(c4) determining the ratio between I(sample) and I(control), thereby obtaining the integrity of the nucleic acid (especially RNA) contained in the sample composition.

In a fourth particular example of this embodiment of the first aspect (relating to the first subgroup of the first aspect), the integrity of a control nucleic acid (especially RNA) is determined by the following steps:

(a″) subjecting at least a part of a control composition containing control nucleic acid (especially RNA) to field-flow fractionation, in particular AF4 or HF5, thereby fractioning the components contained in the control composition by their size so as to produce one or more control fractions;

(b″) measuring at least the UV signal of least one of the one or more control fractions obtained from step (a″); and

(c″) determining from the UV signal obtained in step (b″) the height of one UV peak (H(control)), thereby obtaining the integrity of the control nucleic acid (especially RNA).

In this fourth example, the integrity of the nucleic acid (especially RNA) contained in the sample composition may be calculated by the following steps:

(c1′) determining from the UV signal obtained in step (b) the height of the sample UV peak corresponding to the control UV peak used in step (c″) (H(sample)); and

(c2′) determining the ratio between H(sample) and H(control), thereby obtaining the integrity of the nucleic acid (especially RNA) contained in the sample composition.

In a fifth particular example of this embodiment of the first aspect (relating to the second subgroup of the first aspect), the integrity of a control RNA is determined by the following steps:

(a′) subjecting at least a part of a control composition containing control RNA to field-flow fractionation, in particular AF4 or HF5, thereby fractioning the components contained in the control composition by their size so as to produce one or more control fractions;

(b′) measuring at least one signal selected from the group consisting of the UV signal, the fluorescence signal, and the RI signal of least one of the one or more control fractions obtained from step (a′);

(c′1) calculating from the at least one signal selected from the group consisting of the UV signal, the fluorescence signal, and the RI signal obtained in step (b′) the area from the maximum height of one UV, fluorescence, or RI peak to the end of the UV, fluorescence, or RI peak, thereby obtaining A_{50%}(control);

(c′2) calculating from the at least one signal selected from the group consisting of the UV signal, the fluorescence signal, and the RI signal obtained in step (b′) the total area of the one peak used in step (c′1), thereby obtaining A_{100%}(control); and

(c′3) determining the ratio between A_{50%}(control) and A_{100%}(control), thereby obtaining the integrity of the control RNA (I(control)).

In this fifth example, the integrity of the RNA contained in the sample composition may be calculated by the following steps:

(c1) calculating from the at least one signal selected from the group consisting of the UV signal, the fluorescence signal, and the RI signal obtained from step (b) the area from the maximum height of the sample UV, fluorescence, or RI peak corresponding to the control UV, fluorescence, or RI peak used in step (el) to the end of the sample UV, fluorescence, or RI peak, thereby obtaining A_{50%}(sample);

(c2) calculating from the sample UV, fluorescence, or RI signal obtained from step (b) the total area of the sample UV, fluorescence, or RI peak used in step (c1), thereby obtaining A_{100%}(sample);

(c3) determining the ratio between A_{50%}(sample) and A_{100%}(sample), thereby obtaining I(sample); and

(c4) determining the ratio between I(sample) and I(control), thereby obtaining the integrity of the RNA contained in the sample composition.

In a sixth particular example of this embodiment of the first aspect (relating to the second subgroup of the first aspect), the integrity of a control RNA is determined by the following steps:

(a″) subjecting at least a part of a control composition containing control RNA to field-flow fractionation, in particular AF4 or HF5, thereby fractioning the components contained in the control composition by their size so as to produce one or more control fractions;

(b″) measuring at least one signal selected from the group consisting of the UV signal, the fluorescence signal, and the RI signal of least one of the one or more control fractions obtained from step (a″); and

(c″) determining from the at least one signal selected from the group consisting of the UV signal, the fluorescence signal, and the RI signal obtained in step (b″) the height of one UV, fluorescence, or RI peak (H(control)), thereby obtaining the integrity of the control RNA.

In this sixth example, the integrity of the RNA contained in the sample composition may be calculated by the following steps:

(c1′) determining from the at least one signal selected from the group consisting of the UV signal, the fluorescence signal, and the RI signal obtained in step (b) the height of the sample UV, fluorescence, or RI peak corresponding to the control UV, fluorescence, or RI peak used in step (c″) (H(sample)); and

(c2′) determining the ratio between H(sample) and H(control), thereby obtaining the integrity of the RNA contained in the sample composition.

In a seventh particular example of this embodiment of the first aspect (relating to the third subgroup of the first aspect), the integrity of a control RNA is determined by the following steps:

(a′) subjecting at least a part of a control composition containing control RNA to field-flow fractionation, in particular AF4 or HF5, thereby fractioning the components contained in the control composition by their size so as to produce one or more control fractions;

(b′) measuring at least the UV signal of least one of the one or more control fractions obtained from step (a′);

(c′1) calculating from the UV signal obtained in step (b′) the area from the maximum height of one UV peak to the end of the UV peak, thereby obtaining A_{50%}(control);

(c′2) calculating from the UV signal obtained in step (b′) the total area of the one peak used in step (c′1), thereby obtaining A_{100%}(control); and

(c′3) determining the ratio between A_{50%}(control) and A_{100%}(control), thereby obtaining the integrity of the control RNA (I(control)).

In this seventh example, the integrity of the RNA contained in the sample composition may be calculated by the following steps:

(c1) calculating from the UV signal obtained from step (b) the area from the maximum height of the sample UV peak corresponding to the control UV peak used in step (c′1) to the end of the sample UV peak, thereby obtaining A_{50%}(sample);

(c2) calculating from the sample UV signal obtained from step (b) the total area of the sample UV peak used in step (c1), thereby obtaining A_{100%}(sample);

(c3) determining the ratio between A_{50%}(sample) and A_{100%}(sample), thereby obtaining I(sample); and

(c4) determining the ratio between I(sample) and I(control), thereby obtaining the integrity of the RNA contained in the sample composition.

In an eighth particular example of this embodiment of the first aspect (relating to the third subgroup of the first aspect), the integrity of a control RNA is determined by the following steps:

(a″) subjecting at least a part of a control composition containing control RNA to field-flow fractionation, in particular AF4 or HF5, thereby fractioning the components contained in the control composition by their size so as to produce one or more control fractions;

(b″) measuring at least the UV signal of least one of the one or more control fractions obtained from step (a″); and

(c″) determining from the UV signal obtained in step (b″) the height of one UV peak (H(control)), thereby obtaining the integrity of the control RNA.

In this eighth example, the integrity of the RNA contained in the sample composition may be calculated by the following steps:

(c1′) determining from the UV signal obtained in step (b) the height of the sample UV peak corresponding to the control UV peak used in step (c″) (H(sample)); and

(c2′) determining the ratio between H(sample) and H(control), thereby obtaining the integrity of the RNA contained in the sample composition.

In one embodiment of the first aspect (in particular, in one embodiment of the second or third subgroup of the first aspect), the amount of nucleic acid (especially RNA) is determined by using (i) a nucleic acid extinction coefficient (especially an RNA extinction coefficient) or (ii) a nucleic acid calibration curve (especially an RNA calibration curve).

In one embodiment of the first aspect (in particular, in one embodiment of the first, second or third subgroup of the first aspect), the sample composition comprises nucleic acid (especially RNA) and particles, such as lipoplex particles and/or lipid nanoparticles and/or polyplex particles and/or lipopolyplex particles and/or virus-like particles, to which nucleic acid (especially RNA) is bound.

In one embodiment of the first aspect (in particular, in one embodiment of the first, second or third subgroup of the first aspect), the amount of total nucleic acid (especially the amount of total RNA) is determined by (i) treating at least a part of the sample composition with a release agent; (ii) performing steps (a) to (c) with at least the part obtained from step (i); and (iii) determining the amount of nucleic acid (especially RNA) as specified herein (e.g., by using (i) a nucleic acid extinction coefficient (especially an RNA extinction coefficient) or (ii) a nucleic acid calibration curve (especially an RNA calibration curve)). In this embodiment, in step (a) of the method of the first aspect, the field-flow-fractionation is preferably performed using a liquid phase containing the release agent.

In one embodiment of the first aspect (in particular, in one embodiment of the first, second or third subgroup of the first aspect), the release agent is (i) a surfactant, such as an anionic surfactant (e.g., sodium dodecylsulfate), a zwitterionic surfactant (e.g., n-tetradecyl-N,N-dimethyl-3-ammonio-1-propanesulfonate (Zwittergent® 3-14)), a cationic surfactant, a non-ionic surfactant, or a mixture thereof; (ii) an alcohol, such as an aliphatic alcohol (e.g., ethanol), or a mixture of alcohols; or (iii) a combination of (i) and (ii).

In one embodiment of the first aspect (in particular, in one embodiment of the first, second or third subgroup of the first aspect), the amount of free nucleic acid (especially RNA) is determined by performing steps (a) to (c) without the addition of a release agent, in particular in the absence of any release agent; and determining the amount of nucleic acid (especially RNA) as specified herein (e.g., using (i) a nucleic acid extinction coefficient (especially an RNA extinction coefficient) or (ii) a nucleic acid calibration curve (especially an RNA calibration curve)).

In one embodiment of the first aspect (in particular, in one embodiment of the first, second or third subgroup of the first aspect), the amount of nucleic acid (especially RNA) bound to particles is determined by subtracting the amount of free nucleic acid (especially RNA) as determined herein (e.g., by performing steps (a) to (c) without the addition of a release agent, in particular in the absence of any release agent; and determining the amount of nucleic acid (especially RNA) as specified herein (e.g., using (i) a nucleic acid extinction coefficient (especially an RNA extinction coefficient) or (ii) a nucleic acid calibration curve (especially an RNA calibration curve))) from the amount of total nucleic acid (especially RNA) as determined herein (e.g., by (i) treating at least a part of the sample composition with a release agent; (ii) performing steps (a) to (c) with at least the part obtained from step (i); and (iii) determining the amount of nucleic acid (especially RNA) as specified herein (e.g., using (i) a nucleic acid extinction coefficient (especially an RNA extinction coefficient) or (ii) a nucleic acid calibration curve (especially an RNA calibration curve))).

In one embodiment of the first aspect (in particular, in one embodiment of the first, second or third subgroup of the first aspect), step (b) further comprises measuring the LS signal, such as the dynamic light scattering (DLS) signal and/or the static light scattering (SLS), e.g., multi-angle light scattering (MALS), signal, of least one of the one or more sample fractions obtained from step (a).

In one embodiment of the first aspect (in particular, in one embodiment of the first, second or third subgroup of the first aspect), the size of nucleic acid (especially RNA) containing particles is determined by calculating from the LS signal obtained from step (b) the radius of gyration (R_{g}) values and/or the hydrodynamic radius (Rₕ) values. In one embodiment of the first aspect (in particular, in one embodiment of the first, second or third subgroup of the first aspect), step (b) comprises measuring the dynamic light scattering (DLS) signal of least one of the one or more sample fractions obtained from step (a), and step (c) comprises calculating the Rₕ values from the DLS signal. In one embodiment of the first aspect (in particular, in one embodiment of the first, second or third subgroup of the first aspect), step (b) comprises measuring the static light scattering (SLS), e.g., MALS, signal of least one of the one or more sample fractions obtained from step (a), and step (c) comprises calculating the R_{g} values from the SLS signal. In one embodiment of the first aspect (in particular, in one embodiment of the first, second or third subgroup of the first aspect), step (b) comprises measuring the dynamic light scattering (DLS) signal and the static light scattering (SLS), e.g., MALS, signal of least one of the one or more sample fractions obtained from step (a), and step (c) comprises calculating the R_{g} and Rₕ values. This latter embodiment results in two data sets for the size of nucleic acid (such as RNA) containing particles, i.e., one based on the R_{g} values and one based on the Rₕ values.

In one embodiment of the first aspect (in particular, in one embodiment of the first, second or third subgroup of the first aspect), the size distribution of nucleic acid (especially RNA) containing particles is determined by plotting the at least one signal selected from the group consisting of the UV signal, the fluorescence signal, and the RI signal obtained from step (b) against the R_{g} or Rₕ values determined as specified herein (e.g., by calculating the R_{g} values from the SLS signal obtained from step (b) or by calculating the Rₕ values from the DLS signal obtained from step (b)). In a first example of this embodiment (relating to the first subgroup of the first aspect), the size distribution of nucleic acid (especially RNA) containing particles is determined by plotting the UV signal obtained from step (b) against the R_{g} or Rₕ values determined as specified herein (e.g., by calculating the R_{g} values from the SLS signal obtained from step (b) or by calculating the Rₕ values from the DLS signal obtained from step (b)). In a second example of this embodiment (relating to the second subgroup of the first aspect), the size distribution of RNA containing particles is determined by plotting the at least one signal selected from the group consisting of the UV signal, the fluorescence signal, and the RI signal obtained from step (b) against the R_{g} or Rₕ values determined as specified herein (e.g., by calculating the R_{g} values from the SLS signal obtained from step (b) or by calculating the Rₕ values from the DLS signal obtained from step (b)). In a third example of this embodiment (relating to the third subgroup of the first aspect), the size distribution of RNA containing particles is determined by plotting the UV signal obtained from step (b) against the R_{g} or Rₕ values determined as specified herein (e.g., by calculating the R_{g} values from the SLS signal obtained from step (b) or by calculating the Rₕ values from the DLS signal obtained from step (b)). In each of the above first, second and third examples, the size distribution of nucleic acid (especially RNA) containing particles can be determined on the basis of the R_{g} values, the Rₕ values or both. If the size distribution of nucleic acid (especially RNA) containing particles is determined on the basis of the R_{g} values and the Rₕ values, this results in two data sets, i.e., one size distribution based on the R_{g} values and one size distribution based on the Rₕ values.

In one embodiment of the first aspect (in particular, in one embodiment of the first, second or third subgroup of the first aspect), the quantitative size distribution of nucleic acid (especially RNA) containing particles is calculated from the plot showing the UV, fluorescence, or RI signal as function of the R_{g} or Rₕ values by transforming the UV, fluorescence, or RI signal into a cumulative weight fraction and plotting the cumulative weight fraction against the R_{g} or Rₕ values. In a first example of this embodiment (relating to the first subgroup of the first aspect), the quantitative size distribution of nucleic acid (especially RNA) containing particles is calculated from the plot showing the UV signal as function of the R_{g} or Rₕ values by transforming the UV signal into a cumulative weight fraction and plotting the cumulative weight fraction against the R_{g} or Rₕ values. In a second example of this embodiment (relating to the second subgroup of the first aspect), the quantitative size distribution of RNA containing particles is calculated from the plot showing the UV, fluorescence, or RI signal as function of the R_{g} or Rₕ values by transforming the UV, fluorescence, or RI signal into a cumulative weight fraction and plotting the cumulative weight fraction against the R_{g} or Rₕ values. In a third example of this embodiment (relating to the third subgroup of the first aspect), the quantitative size distribution of RNA containing particles is calculated from the plot showing the UV signal as function of the R_{g} or Rₕ values by transforming the UV signal into a cumulative weight fraction and plotting the cumulative weight fraction against the R_{g} or Rₕ values. In each of the above first, second and third examples, the quantitative size distribution of nucleic acid (especially RNA) containing particles can be determined on the basis of the R_{g} values, the Rₕ values or both. If the quantitative size distribution of nucleic acid (especially RNA) containing particles is determined on the basis of the R_{g} values and the Rₕ values, this results in two data sets, i.e., one quantitative size distribution based on the R_{g} values and one quantitative size distribution based on the Rₕ values.

In one embodiment of the first aspect (in particular, in one embodiment of the first, second or third subgroup of the first aspect), the quantitative size distribution includes D10, D50, and/or D90 values (e.g., based on R_{g} or Rₕ values). If the quantitative size distribution of nucleic acid (especially RNA) containing particles is determined on the basis of the R_{g} values and the Rₕ values, this results in two data sets, i.e., one set of D10, D50, and/or D90 values based on the R_{g} values and one set of D10, D50, and/or D90 values based on the Rₕ values.

In one embodiment of the first aspect (in particular, in one embodiment of the first, second or third subgroup of the first aspect), the one or more parameters comprise (or are) at least two, preferably at least three, parameters as specified herein (including the additional optional parameters), in particular at least two, preferably at least three, parameters selected from the group consisting of: the amount of free nucleic acid (especially RNA), the amount of nucleic acid (especially RNA) bound to particles, the size distribution of nucleic acid (especially RNA) containing particles (in particular, based on the radius of gyration (R_{g}) of nucleic acid (especially RNA) containing particles and/or the hydrodynamic radius (Rₕ) of nucleic acid (especially RNA) containing particles), and the quantitative size distribution of nucleic acid (especially RNA) containing particles (e.g., based on R_{g} or Rₕ values). If the size distribution of nucleic acid (especially RNA) containing particles is determined on the basis of the R_{g} values and the Rₕ values, this results in two data sets, i.e., one based on the R_{g} values and one based on the Rₕ values. However, according to the present invention, these two data sets for the size distribution of nucleic acid (especially RNA) containing particles are only considered as one parameter (and not as two parameters). In addition, in case the fractogram obtained by the field-flow fractionation shows more than one particle peak, the determination of the size distribution for each of the particle peaks is only considered as one parameter (and not as one parameter for each of the particle peaks). The same applies to the situation where the quantitative size distribution of nucleic acid (especially RNA) containing particles is determined on the basis of the R_{g} values and the Rₕ values.

In one embodiment of the first aspect (in particular, in one embodiment of the first, second or third subgroup of the first aspect, in particular in a preferred embodiment of the third subgroup of the first aspect), the one or more parameters comprise the quantitative size distribution of nucleic acid (especially RNA) containing particles (e.g., based on the radius of gyration (R_{g}) of nucleic acid (especially RNA) containing particles and/or the hydrodynamic radius (Rₕ) of nucleic acid (especially RNA) containing particles) and optionally at least one parameter, such as at least two parameters, of the remaining parameters specified herein (including the additional optional parameters); preferably these remaining parameters are selected from the group consisting of: the amount of free nucleic acid (especially RNA), the amount of nucleic acid (especially RNA) bound to particles, and the size distribution of nucleic acid (especially RNA) containing particles (e.g., based on R_{g} or Rₕ values). In one embodiment of the first aspect (in particular, in one embodiment of the first, second or third subgroup of the first aspect, in particular in a preferred embodiment of the third subgroup of the first aspect), the one or more parameters comprise the quantitative size distribution of nucleic acid (especially RNA) containing particles (e.g., based on R_{g} or Rₕ values) and at least one parameter, such as at least two parameters, selected from the group consisting of: the amount of free nucleic acid (especially RNA), the amount of nucleic acid (especially RNA) bound to particles, and the size distribution of nucleic acid (especially RNA) containing particles (e.g., based on R_{g} or Rₕ values). In one embodiment of the first aspect (in particular, in one embodiment of the first, second or third subgroup of the first aspect, in particular in a preferred embodiment of the third subgroup of the first aspect), the one or more parameters comprise the quantitative size distribution of nucleic acid (especially RNA) containing particles (e.g., based on R_{g} or Rₕ values), the amount of free nucleic acid (especially RNA), and the amount of nucleic acid (especially RNA) bound to particles. If the quantitative size distribution of nucleic acid (especially RNA) containing particles is determined on the basis of the R_{g} values and the Rₕ values, this results in two data sets, i.e., one based on the R_{g} values and one based on the Rₕ values. However, according to the present invention, these two data sets for the quantitative size distribution of nucleic acid (especially RNA) containing particles are only considered as one parameter (and not as two parameters). In addition, in case the fractogram obtained by the field-flow fractionation shows more than one particle peak, the determination of the quantitative size distribution for each of the particle peaks is only considered as one parameter (and not as one parameter for each of the particle peaks). The same applies to the situation where the size distribution of nucleic acid (especially RNA) containing particles is determined on the basis of the R_{g} values and the Rₕ values.

In one embodiment of the first aspect (in particular, in one embodiment of the first, second or third subgroup of the first aspect), the amount of nucleic acid (especially RNA), in particular free nucleic acid (especially RNA), is determined by measuring the UV signal, e.g., at a wavelength in the range of 260 nm to 280 nm, such as at a wavelength of 260 nm or 280 nm, and using the nucleic acid (especially RNA) extinction coefficient at the corresponding wavelength (e.g., 260 nm or 280 nm).

In one embodiment of the first aspect (in particular, in one embodiment of the first, second or third subgroup of the first aspect, in particular in a preferred embodiment of the third subgroup of the first aspect), the size distribution of nucleic acid (especially RNA) containing particles (e.g., based on R_{g} or Rₕ values) and/or the quantitative size distribution of nucleic acid (especially RNA) containing particles (e.g., based on R_{g} or Rₕ values) is/are within the range of 10 to 2000 nm, preferably within the range of 20 to 1500 nm, such as 30 to 1200 nm, 40 to 1100 nm, 50 to 1000, 60 to 900 nm, 70 to 800 nm, 80 to 700 nm, 90 to 600 nm, or 100 to 500 nm, or such as within the range of 10 to 1000 nm, 15 to 500 nm, 20 to 450 nm, 25 to 400 nm, 30 to 350 nm, 40 to 300 nm, or 50 to 250 nm. In a preferred embodiment of the third subgroup of the first aspect, the (quantitative) size distribution of RNA containing particles (e.g., based on R_{g} or Rₕ values) is within the range of 10 to 1000 nm, such as within the range of 15 to 500 nm, 20 to 450 nm, 25 to 400 nm, 30 to 350 nm, 40 to 300 nm, or 50 to 250 nm.

In one embodiment of the first aspect (in particular, in one embodiment of the first, second or third subgroup of the first aspect), the nucleic acid (especially RNA) has a length of 10 to 15,000 nucleotides, such as 40 to 15,000 nucleotides, 100 to 12,000 nucleotides or 200 to 10,000 nucleotides.

In one embodiment of the first aspect (in particular, in one embodiment of the first subgroup of the first aspect), the nucleic acid is RNA. In this embodiment and in the embodiments of the second or third subgroup of the first aspect, the RNA preferably is mRNA or in vitro transcribed RNA, in particular in vitro transcribed mRNA.

In one embodiment of the first aspect (in particular, in one embodiment of the first, second or third subgroup of the first aspect), measuring the at least one signal selected from the group consisting of the UV signal, the fluorescence signal, and the RI signal, optionally the LS signal, such as the SLS, e.g., MALS, signal and/or the DLS signal, is performed on-line and/or step (c) is performed on-line.

In one embodiment of the first aspect (in particular, in one embodiment of the first, second or third subgroup of the first aspect), the one or more parameters are determined in one cycle of steps (a) to (c).

In one embodiment of the first aspect (in particular, in one embodiment of the first, second or third subgroup of the first aspect), before subjecting at least a part of the sample composition to field-flow fractionation, the at least part of the sample composition is diluted with a solvent or solvent mixture, said solvent or solvent mixture being able to prevent the formation of aggregates of the particles. In one embodiment, the solvent mixture is a mixture of water and an organic solvent, e.g., formamide.

In one embodiment of the first aspect (in particular, in one embodiment of the first, second or third subgroup of the first aspect), measuring the UV signal is performed by using circular dichroism (CD) spectroscopy.

In a second aspect, the present disclosure provides a method of analyzing the effect of altering one or more reaction conditions when providing a composition comprising a nucleic acid (such as RNA) and optionally particles, the method comprising:

(A) providing a first composition comprising nucleic acid (such as RNA) and optionally particles;

(B) providing a second composition comprising nucleic acid (such as RNA) and optionally particles, wherein the provision of the second composition differs from the provision of the first composition only in the one or more reaction conditions;

(C) subjecting a part of the first composition to a method of the first aspect, thereby determining one or more parameters of the first composition;

(D) subjecting a corresponding part of the second composition to the method used in step (C), thereby determining one or more parameters of the second composition; and

(E) comparing the one or more parameters of the first composition obtained in step (C) with the corresponding one or more parameters of the second composition obtained in step (D).

In one embodiment of the second aspect, the one or more parameters comprise the nucleic acid (such as RNA) integrity, the total amount of nucleic acid (such as RNA), the amount of free nucleic acid (such as RNA), the amount of nucleic acid (such as RNA) bound to particles, the size of nucleic acid (such as RNA) containing particles (in particular, based on the radius of gyration (R_{g}) of nucleic acid (such as RNA) containing particles and/or the hydrodynamic radius (Rₕ) of nucleic acid (such as RNA) containing particles), the size distribution of nucleic acid (such as RNA) containing particles (e.g., based on R_{g} or Rₕ values of nucleic acid (such as RNA) containing particles), and the quantitative size distribution of nucleic acid (such as RNA) containing particles (e.g., based on R_{g} or Rₕ values of nucleic acid (such as RNA) containing particles). Generally, the size distribution and/or quantitative size distribution of nucleic acid (such as RNA) containing particles can be given as the number of the nucleic acid (such as RNA) containing particles, the molar amount of the nucleic acid (such as RNA) containing particles, or the mass of the nucleic acid (such as RNA) containing particles each as a function of their size. Additional optional parameters include the molecular weight of nucleic acid (especially RNA), the amount of surface nucleic acid (such as the amount of surface RNA), the amount of encapsulated nucleic acid (such as the amount of encapsulated RNA), the amount of accessible nucleic acid (such as the amount of accessible RNA), the size of nucleic acid (especially RNA) (in particular, based on R_{g} and/or Rₕ values of nucleic acid (such as RNA)), the size distribution of nucleic acid (especially RNA) (e.g., based on R_{g} or Rₕ values of nucleic acid (such as RNA)), the quantitative size distribution of nucleic acid (especially RNA) (e.g., based on R_{g} or Rₕ values of nucleic acid (such as RNA)), the shape factor, the form factor, and the nucleic acid (especially RNA) encapsulation efficiency. Generally, the size distribution and/or quantitative size distribution of nucleic acid (especially RNA) can be given as the number of the nucleic acid (especially RNA) molecules, the molar amount of the nucleic acid (especially RNA), or the mass of the nucleic acid (especially RNA) each as a function of their size. Further additional optional parameters include the ratio of the amount of nucleic acid (such as RNA) bound to particles to the total amount of particle forming compounds (in particular lipids and/or polymers) in the particles, wherein said ratio may be given as a function of the particle size; the ratio of the amount of positively charged moieties of particle forming compounds (in particular lipids and/or polymers) in the particles to the amount of nucleic acid (such as RNA) bound to particles, wherein said ratio may be given as a function of the particle size; and the charge ratio of the amount of positively charged moieties of particle forming compounds (in particular lipids and/or polymers) in the particles to the amount of negatively charged moieties of nucleic acid (such as RNA) bound to particles, wherein said charge ratio is usually denoted as N/P ratio and may be given as a function of the particle size.

In one embodiment of the second aspect, the one or more parameters comprise (or are) at least two, preferably at least three, parameters as specified herein (including the additional optional parameters), in particular at least two, preferably at least three, parameters selected from the group consisting of: the amount of free nucleic acid (especially RNA), the amount of nucleic acid (especially RNA) bound to particles, the size distribution of nucleic acid (especially RNA) containing particles (e.g., based on R_{g} or Rₕ values of nucleic acid (such as RNA) containing particles), the quantitative size distribution of nucleic acid (especially RNA) containing particles (e.g., based on R_{g} or Rₕ values of nucleic acid (such as RNA) containing particles), and the molecular weight of nucleic acid (especially RNA). In one embodiment of the second aspect, the one or more parameters comprise (or are) at least two, preferably at least three, parameters selected from the group consisting of: the amount of free nucleic acid (especially RNA), the amount of nucleic acid (especially RNA) bound to particles, the size distribution of nucleic acid (especially RNA) containing particles (e.g., based on R_{g} or Rₕ values of nucleic acid (especially RNA)), and the quantitative size distribution of nucleic acid (especially RNA) containing particles (e.g., based on R_{g} or Rₕ values of nucleic acid (especially RNA)).

In one embodiment of the second aspect, the method of the first aspect used in steps (C) and (D) is a method comprising:

(a) subjecting at least a part of the composition (e.g., the first composition for step (C) or the second composition for step (D)) to field-flow fractionation, thereby fractioning the components contained in the composition by their size so as to produce one or more composition fractions;

(b) measuring at least one signal selected from the group consisting of the UV signal, the fluorescence signal, and the refractory index (RI) signal, and optionally measuring the light scattering (LS) signal, of least one of the one or more composition fractions obtained from step (a); and

(c) calculating from the at least one signal selected from the group consisting of the UV signal, the fluorescence signal, and the RI signal, and optionally from the LS signal, the one or more parameters.

In a first subgroup of the second aspect, the method of the first aspect used in steps (C) and (D) is a method comprising:

(a) subjecting at least a part of the composition (e.g., the first composition for step (C) or the second composition for step (D)) to field-flow fractionation, thereby fractioning the components contained in the composition by their size so as to produce one or more fractions;

(b) measuring at least the UV signal, and optionally the light scattering (LS) signal, of least one of the one or more fractions obtained from step (a); and

(c) calculating from the UV signal, and optionally from the LS signal, the one or more parameters.

In a second and preferred subgroup of the second aspect, the method of the first aspect used in steps (C) and (D) is a method for determining one or more parameters of a sample composition (e.g., the first composition for step (C) or the second composition for step (D)), wherein the sample composition comprises RNA and optionally particles, the method comprising:

(a) subjecting at least a part of the sample composition to field-flow fractionation, thereby fractioning the components contained in the sample composition by their size so as to produce one or more sample fractions;

(b) measuring at least one signal selected from the group consisting of the UV signal, the fluorescence signal, and the refractory index (RI) signal, and optionally measuring the light scattering (LS) signal, of least one of the one or more sample fractions obtained from step (a); and

(c) calculating from the at least one signal selected from the group consisting of the UV signal, the fluorescence signal, and the RI signal, and optionally from the LS signal, the one or more parameters.

In a third and more preferred subgroup of the second aspect, the method of the first aspect used in steps (C) and (D) is a method for determining one or more parameters of a sample composition (e.g., the first composition for step (C) or the second composition for step (D)), wherein the sample composition comprises RNA and optionally particles, the method comprising:

(a) subjecting at least a part of the sample composition to field-flow fractionation, thereby fractioning the components contained in the sample composition by their size so as to produce one or more sample fractions;

(b) measuring at least the UV signal, and optionally the light scattering (LS) signal, of least one of the one or more sample fractions obtained from step (a); and

(c) calculating from the UV signal, and optionally from the LS signal, the one or more parameters.

In one embodiment of the second aspect (in particular, in one embodiment of the first, second or third subgroup of the second aspect), the size, size distribution, and/or quantitative size distribution of nucleic acid (such as RNA) containing particles is/are calculated based on the R_{g} values of the nucleic acid (such as RNA) containing particles. In another embodiment of the second aspect (in particular, in another embodiment of the first, second or third subgroup of the second aspect), the size, size distribution, and/or quantitative size distribution of nucleic acid (such as RNA) containing particles is/are calculated based on the Rₕ values of the nucleic acid (such as RNA) containing particles. In another embodiment of the second aspect (in particular, in another embodiment of the first, second or third subgroup of the second aspect), the size, size distribution, and/or quantitative size distribution of nucleic acid (such as RNA) containing particles is/are calculated based on the R_{g} values of the nucleic acid (such as RNA) containing particles and separately based on the Rₕ values of nucleic acid (such as RNA) containing particles (i.e., this embodiment results in two data sets for the size, size distribution, and/or quantitative size distribution of nucleic acid (such as RNA) containing particles, one based on the R_{g} values and one based on the Rₕ values).

In one embodiment of the second aspect (in particular, in one embodiment of the first, second or third subgroup of the second aspect), where the one or more parameters comprise the size, size distribution, and/or quantitative size distribution of nucleic acid (such as RNA), the size, size distribution, and/or quantitative size distribution of nucleic acid (such as RNA) is/are calculated based on the R_{g} values of the nucleic acid (such as RNA). In another embodiment of the second aspect (in particular, in another embodiment of the first, second or third subgroup of the second aspect), where the one or more parameters comprise the size, size distribution, and/or quantitative size distribution of nucleic acid (such as RNA), the size, size distribution, and/or quantitative size distribution of nucleic acid (such as RNA) is/are calculated based on the Rₕ values of the nucleic acid (such as RNA). In another embodiment of the second aspect (in particular, in another embodiment of the first, second or third subgroup of the second aspect), where the one or more parameters comprise the size, size distribution, and/or quantitative size distribution of nucleic acid (such as RNA), the size, size distribution, and/or quantitative size distribution of nucleic acid (such as RNA) is/are calculated based on the R_{g} values of the nucleic acid (such as RNA) and separately based on the Rₕ values of nucleic acid (such as RNA) (i.e., this embodiment results in two data sets for the size, size distribution, and/or quantitative size distribution of nucleic acid (such as RNA), one based on the R_{g} values and one based on the Rₕ values).

In one embodiment of the second aspect (in particular, in one embodiment of the first, second or third subgroup of the second aspect), the one or more parameters comprise the nucleic acid (especially RNA) integrity, the total amount of nucleic acid (especially RNA), the amount of free nucleic acid (especially RNA), the amount of nucleic acid (especially RNA) bound to particles, the size of nucleic acid (especially RNA) containing particles (in particular, based on the radius of gyration (R_{g}) of nucleic acid (especially RNA) containing particles and/or the hydrodynamic radius (Rₕ) of nucleic acid (especially RNA) containing particles), the size distribution of nucleic acid (especially RNA) containing particles (e.g., based on R_{g} or Rₕ values), and the quantitative size distribution of nucleic acid (especially RNA) containing particles (e.g., based on R_{g} or Rₕ values), and optionally the molecular weight of nucleic acid (especially RNA).

In one embodiment of the second aspect (in particular, in one embodiment of the first, second or third subgroup of the second aspect), the one or more parameters comprise (or are) at least two, preferably at least three, parameters selected from the group consisting of: the amount of free nucleic acid (especially RNA), the amount of nucleic acid (especially RNA) bound to particles, the size distribution of nucleic acid (especially RNA) containing particles (e.g., based on R_{g} or Rₕ values of nucleic acid (especially RNA) containing particles), the quantitative size distribution of nucleic acid (especially RNA) containing particles (e.g., based on R_{g} or Rₕ values of nucleic acid (especially RNA) containing particles), and the molecular weight of nucleic acid (especially RNA). In one embodiment of the first, second or third subgroup of the second aspect, the one or more parameters comprise (or are) at least two, preferably at least three, parameters selected from the group consisting of: the amount of free nucleic acid (especially RNA), the amount of nucleic acid (especially RNA) bound to particles, the size distribution of nucleic acid (especially RNA) containing particles (e.g., based on R_{g} or Rₕ values of nucleic acid (especially RNA) containing particles), and the quantitative size distribution of nucleic acid (especially RNA) containing particles (e.g., based on R_{g} or Rₕ values of nucleic acid (especially RNA) containing particles). If the size distribution of nucleic acid (especially RNA) containing particles is determined on the basis of the R_{g} values and the Rₕ values, this results in two data sets, i.e., one based on the R_{g} values and one based on the Rₕ values. However, according to the present invention, these two data sets for the size distribution of nucleic acid (especially RNA) containing particles are only considered as one parameter (and not as two parameters). In addition, in case the fractogram obtained by the field-flow fractionation shows more than one particle peak, the determination of the size distribution for each of the particle peaks is only considered as one parameter (and not as one parameter for each of the particle peaks). The same applies to the situation where the quantitative size distribution of nucleic acid (especially RNA) containing particles is determined on the basis of the R_{g} values and the Rₕ values.

In one embodiment of the second aspect (in particular, in one embodiment of the first, second or third subgroup of the second aspect, in particular in a preferred embodiment of the third subgroup of the second aspect), the one or more parameters comprise the quantitative size distribution of nucleic acid (especially RNA) containing particles (e.g., based on the radius of gyration (R_{g}) of nucleic acid (especially RNA) containing particles and/or the hydrodynamic radius (Rₕ) of nucleic acid (especially RNA) containing particles) and optionally at least one parameter, such as at least two parameters, of the remaining parameters specified herein (including the additional optional parameters); preferably these remaining parameters are selected from the group consisting of: the amount of free nucleic acid (especially RNA), the amount of nucleic acid (especially RNA) bound to particles, and the size distribution of nucleic acid (especially RNA) containing particles (e.g., based on R_{g} or Rₕ values). In one embodiment of the second aspect (in particular, in one embodiment of the first, second or third subgroup of the second aspect, in particular in a preferred embodiment of the third subgroup of the second aspect), the one or more parameters comprise the quantitative size distribution of nucleic acid (especially RNA) containing particles (e.g., based on R_{g} or Rₕ values) and at least one parameter, such as at least two parameters, selected from the group consisting of: the amount of free nucleic acid (especially RNA), the amount of nucleic acid (especially RNA) bound to particles, and the size distribution of nucleic acid (especially RNA) containing particles (e.g., based on R_{g} or Rₕ values). In one embodiment of the second aspect (in particular, in one embodiment of the first, second or third subgroup of the second aspect, in particular in a preferred embodiment of the third subgroup of the second aspect), the one or more parameters comprise the quantitative size distribution of nucleic acid (especially RNA) containing particles (e.g., based on R_{g} or Rₕ values), the amount of free nucleic acid (especially RNA), and the amount of nucleic acid (especially RNA) bound to particles. If the quantitative size distribution of nucleic acid (especially RNA) containing particles is determined on the basis of the R_{g} values and the Rₕ values, this results in two data sets, i.e., one based on the R_{g} values and one based on the Rₕ values. However, according to the present invention, these two data sets for the quantitative size distribution of nucleic acid (especially RNA) containing particles are only considered as one parameter (and not as two parameters). In addition, in case the fractogram obtained by the field-flow fractionation shows more than one particle peak, the determination of the quantitative size distribution for each of the particle peaks is only considered as one parameter (and not as one parameter for each of the particle peaks). The same applies to the situation where the size distribution of nucleic acid (especially RNA) containing particles is determined on the basis of the R_{g} values and the Rₕ values.

In one embodiment of the second aspect (in particular, in one embodiment of the first, second or third subgroup of the second aspect), the one or more parameters are determined in one cycle of steps (a) to (c).

In one embodiment of the second aspect (in particular, in one embodiment of the first, second, or third subgroup of the second aspect), the one or more reaction conditions comprise any of the following: salt concentration/ionic strength; temperature; pH or buffer concentration; light/radiation; oxygen; shear force; pressure; freezing/thawing cycle; drying/reconstitution cycle; addition of excipient(s) (e.g., stabilizer and/or chelating agent); type and/or source of particle forming compounds (in particular lipids and/or polymers); charge ratio; physical state; and ratio of nucleic acid (especially RNA) to particle forming compounds (in particular lipids and/or polymers constituting the particles). Exemplary salt concentrations include 1, 2, 3, 4, 5, 6, 7, 8, 9, 10, 12, 14, 16, 18, 20, 25, 30, 35, 40, 45, 50, 60, 70, 80, 90, or 100 mM of a salt, such as 1, 2, 3, 4, 5, 6, 7, 8, 9, 10, 12, 14, 16, 18, 20, 25, 30, 35, 40, 45, 50, 60, 70, 80, 90, or 100 mM NaCl. Exemplary temperature conditions include low temperature (such as −20° C.), ambient or room temperature, middle temperature (such as 30° C.) or high temperature (such as 50° C.). Exemplary conditions regarding type and/or source of particle forming compounds are cationic lipid vs. cationic polymer, cationic lipid vs. zwitterionic lipid, or pegylated lipid vs. unpegylated lipid. An exemplary charge ratio of positive charges to negative charges in the nucleic acid (especially RNA) particles is from about 6:1 to about 1:2, such as about 5:1 to about 1.2:2, about 4:1 to about 1.4:2, about 3:1 to about 1.6:2, about 2:1 to about 1.8:2, or about 1.6:1 to about 1:1. An exemplary ratio of nucleic acid (especially RNA) to particle forming compounds (in particular the lipids and/or polymers constituting the particles) include ratios of nucleic acid (especially RNA) to total lipids in the range of from about 1:100 to about 10:1 (w/w).

In one embodiment of the second aspect (in particular, in one embodiment of the first, second or third subgroup of the second aspect), the field-flow fractionation preferably is flow field-flow fractionation, such as asymmetric flow field-flow fractionation (AF4) or hollow fiber flow field-flow fractionation (HF5).

In one embodiment of the second aspect (in particular, in one embodiment of the first, second or third subgroup of the second aspect), step (a) is performed using a membrane having a molecular weight (MW) cut-off suitable to prevent the nucleic acid (especially RNA) from permeating the membrane, preferably a membrane having a MW cut-off in the range of from 2 kDa to 30 kDa, such as a MW cut-off of 10 kDa.

In one embodiment of the second aspect (in particular, in one embodiment of the first, second or third subgroup of the second aspect), step (a) is performed using a polyethersulfon (PES) or regenerated cellulose membrane.

In one embodiment of the second aspect (in particular, in one embodiment of the first, second or third subgroup of the second aspect), step (a) is performed using (I) a cross flow rate of up to 8 mL/min, preferably up to 4 mL/min, more preferably up to 2 mL/min, e.g., a cross flow rate profile; and/or (II) an inject flow in the range of 0.05 to 0.35 mL/min, preferably in the range of 0.10 to 0.30 mL/min, more preferably in the range of 0.15 to 0.25 mL/min; and/or (III) a detector flow in the range of 0.30 to 0.70 mL/min, preferably in the range of 0.40 to 0.60 mL/min, more preferably in the range of 0.45 to 0.55 mL/min.

In one embodiment of the second aspect (in particular, in one embodiment of the first, second or third subgroup of the second aspect), the cross flow rate profile preferably contains a fractioning phase which allows the components contained in the composition (such as control or sample composition, in particular the first composition for step (C) or the second composition for step (D)) to fraction/separate by their size so as to produce one or more composition fractions. It is preferred that the cross flow rate changes during this fractioning phase (e.g., starting from one value (such as about 1 to about 4 mL/min) and then decreasing to a lower value (such as about 0 to about 0.1 mL/min) or starting from one value (such as about 0 to about 0.1 mL/min) and then increasing to a higher value (such as about 1 to about 4 mL/min), wherein the change can be by any means, e.g., a continuous (such as linear or exponential) change or a stepwise change. Preferably, the cross flow rate profile contains a fractioning phase, wherein the cross flow rate changes continuously (preferably exponentially) starting from one value (such as about 1 to about 4 mL/min) and then decreasing to a lower value (such as about 0 to about 0.1 mL/min). The fractioning phase may have any length suitable to fraction/separate the components contained in the composition by their size, e.g., about 5 min to about 60 min, such as about 10 min to about 50 min, about 15 min to about 45 min, about 20 min to about 40 min, or about 25 min to about 35 min, or about 30 min. The cross flow rate profile may contain additional phases (e.g., 1, 2, 3, or 4 phases) which may be before and/or after the fractioning phase (e.g., one before and 1, 2, or 3 after the fractioning phase) and which may serve to separate non-nucleic acid (especially non RNA) components contained in the composition (e.g., proteins, polypeptides, mononucleotides, etc.) from the nucleic acid (especially RNA) contained in the composition, to focus the nucleic acid (especially RNA) contained in the composition and/or to regenerate the field-flow fractionation device (e.g., to remove all components bound to the membrane of the device). Preferably, the cross flow rate of these additional phases is constant for each additional phase and the length of each of the additional phases is independently for each of the additional phases in the range of about 5 min to about 60 min (such as about 10 min to about 50 min, about 15 min to about 45 min, about 20 min to about 40 min, or about 25 min to about 35 min, or about 30 min). For example, the cross flow rate profile may contain (i) a first additional phase which is before the fractioning phase, wherein the cross flow rate of said first additional phase is constant and is the same cross low rate with which the fractioning phase starts (the length of the first additional phase may be in the range of about 5 min to about 60 min, such as about 10 min to about 50 min, about 15 min to about 45 min, about 20 min to about 40 min, or about 25 min to about 35 min, or about 10 min or about 20 min or about 30 min); (ii) a second additional phase which is after the fractioning phase, wherein the cross flow rate of said second additional phase is constant and is the same cross low rate with which the fractioning phase ends (the length of the second additional phase may be in the range of about 5 min to about 60 min, such as about 10 min to about 50 min, about 15 min to about 45 min, about 20 min to about 40 min, or about 25 min to about 35 min, or about 10 min or about 20 min or about 30 min); and optionally (iii) a third additional phase which is after the second additional phase, wherein the cross flow rate of said third additional phase is constant and different from that of the second additional phase (the length of the third additional phase may be in the range of about 5 min to about 60 min, such as about 10 min to about 50 min, about 15 min to about 45 min, about 20 min to about 40 min, or about 25 min to about 35 min, or about 10 min or about 20 min or about 30 min). In the embodiment, where the cross flow rate profile contains a fractioning phase, wherein the cross flow rate changes continuously (preferably exponentially) starting from one value (such as about 1 to about 4 mL/min) and then decreasing to a lower value (such as about 0 to about 0.1 mL/min), it is preferred that the cross flow rate profile further contains (i) a first additional phase which is before the fractioning phase, wherein the cross flow rate of said first additional phase is constant and is the same cross low rate with which the fractioning phase starts (such as about 1 to about 4 mL/min) (the length of the first additional phase may be in the range of about 5 min to about 30 min, such as about 6 min to about 25 min, about 7 min to about 20 min, or about 8 min to about 15 min, or about 10 min to about 12 min, or about 5 min or about 10 min or about 12 min); (ii) a second additional phase which is after the fractioning phase, wherein the cross flow rate of said second additional phase is constant and is the same cross low rate with which the fractioning phase ends (such as about 0.01 to 0.1 mL/min) (the length of the second additional phase may be in the range of about 5 min to about 60 min, such as about 10 min to about 50 min, about 15 min to about 45 min, about 20 min to about 40 min, or about 25 min to about 35 min, or about 30 min); and optionally (iii) a third additional phase which is after the second additional phase, wherein the cross flow rate of said third additional phase is constant and lower than that of the second additional phase (e.g., the cross flow rate of said third additional phase is 0) (the length of the third additional phase may be in the range of about 5 min to about 30 min, such as about 6 min to about 25 min, about 7 min to about 20 min, or about 8 min to about 15 min, or about 10 min to about 12 min, or about 5 min or about 10 min or about 12 min). A preferred example of such a cross flow rate profile is the following: 1.0 to 2.0 mL/min for 10 min, an exponential gradient from 1.0 to 2.0 mL/min to 0.01 to 0.07 mL/min within 30 min; 0.01 to 0.07 mL/min for 30 min; and 0 mL/min for 10 min.

In one embodiment of the second aspect (in particular, in one embodiment of the first, second or third subgroup of the second aspect), the integrity of the nucleic acid (especially RNA) contained in the sample composition (e.g., the first composition for step (C) or the second composition for step (D)) is calculated using the integrity of a control nucleic acid (especially RNA).

In a first particular example of this embodiment of the second aspect, the integrity of a control nucleic acid (especially RNA) is determined by the following steps:

(a′) subjecting at least a part of a control composition containing control nucleic acid (especially RNA) to field-flow fractionation, in particular AF4 or HF5, thereby fractioning the components contained in the control composition by their size so as to produce one or more control fractions;

(b′) measuring at least one signal selected from the group consisting of the UV signal, the fluorescence signal, and the refractory index (RI) signal of least one of the one or more control fractions obtained from step (a′);

(c′1) calculating from the at least one signal selected from the group consisting of the UV signal, the fluorescence signal, and the RI signal obtained in step (b′) the area from the maximum height of one UV, fluorescence, or RI peak to the end of the UV, fluorescence, or RI peak, thereby obtaining A_{50%}(control);

(c′2) calculating from the at least one signal selected from the group consisting of the UV signal, the fluorescence signal, and the RI signal obtained in step (b′) the total area of the one peak used in step (c′1), thereby obtaining A_{100%}(control); and

(c′3) determining the ratio between A_{50%}(control) and A_{100%}(control), thereby obtaining the integrity of the control nucleic acid (especially RNA) (I(control)).

In this first example, the integrity of the nucleic acid (especially RNA) contained in the sample composition (e.g., the first composition for step (C) or the second composition for step (D)) may be calculated by the following steps:

(c1) calculating from the at least one signal selected from the group consisting of the UV signal, the fluorescence signal, and the RI signal obtained from step (b) the area from the maximum height of the sample UV, fluorescence, or RI peak corresponding to the control UV, fluorescence, or RI peak used in step (c′1) to the end of the sample UV, fluorescence, or RI peak, thereby obtaining A_{50%}(sample);

(c2) calculating from the sample UV, fluorescence, or RI signal obtained from step (b) the total area of the sample UV, fluorescence, or RI peak used in step (c1), thereby obtaining A_{100%}(sample);

(c3) determining the ratio between A_{50%}(sample) and A_{100%}(sample), thereby obtaining I(sample); and

(c4) determining the ratio between I(sample) and I(control), thereby obtaining the integrity of the nucleic acid (especially RNA) contained in the sample composition.

Ina second particular example of this embodiment of the second aspect, the integrity of a control nucleic acid (especially RNA) is determined by the following steps:

(a″) subjecting at least a part of a control composition containing control nucleic acid (especially RNA) to field-flow fractionation, in particular AF4 or HF5, thereby fractioning the components contained in the control composition by their size so as to produce one or more control fractions;

(b″) measuring at least one signal selected from the group consisting of the UV signal, the fluorescence signal, and the RI signal of least one of the one or more control fractions obtained from step (e); and

(c″) determining from the at least one signal selected from the group consisting of the UV signal, the fluorescence signal, and the RI signal obtained in step (b″) the height of one UV, fluorescence, or RI peak (H(control)), thereby obtaining the integrity of the control nucleic acid (especially RNA).

In this second example, the integrity of the nucleic acid (especially RNA) contained in the sample composition (e.g., the first composition for step (C) or the second composition for step (D)) may be calculated by the following steps:

(c1′) determining from the at least one signal selected from the group consisting of the UV signal, the fluorescence signal, and the RI signal obtained in step (b) the height of the sample UV, fluorescence, or RI peak corresponding to the control UV, fluorescence, or RI peak used in step (c″) (H(sample)); and

(c2′) determining the ratio between H(sample) and H(control), thereby obtaining the integrity of the nucleic acid (especially RNA) contained in the sample composition.

In a third particular example of this embodiment of the second aspect (relating to the first subgroup of the second aspect), the integrity of a control nucleic acid (especially RNA) is determined by the following steps:

(a′) subjecting at least a part of a control composition containing control nucleic acid (especially RNA) to field-flow fractionation, in particular AF4 or HF5, thereby fractioning the components contained in the control composition by their size so as to produce one or more control fractions;

(b′) measuring at least the UV signal of least one of the one or more control fractions obtained from step (a′);

(c′1) calculating from the UV signal obtained in step (1:0 the area from the maximum height of one UV peak to the end of the UV peak, thereby obtaining A_{50%}(control);

(c′2) calculating from the UV signal obtained in step (b) the total area of the one peak used in step (c′1), thereby obtaining A_{100%}(control); and

(c′3) determining the ratio between A_{50%}(control) and A_{100%}(control), thereby obtaining the integrity of the control nucleic acid (especially RNA) (I(control)).

In this third example, the integrity of the nucleic acid (especially RNA) contained in the sample composition (e.g., the first composition for step (C) or the second composition for step (D)) may be calculated by the following steps:

(c1) calculating from the UV signal obtained from step (b) the area from the maximum height of the sample UV peak corresponding to the control UV peak used in step (c′1) to the end of the sample UV peak, thereby obtaining A_{50%}(sample);

(c2) calculating from the sample UV signal obtained from step (b) the total area of the sample UV peak used in step (c1), thereby obtaining A_{100%}(sample);

(c3) determining the ratio between A_{50%}(sample) and A_{100%}(sample), thereby obtaining I(sample); and

(c4) determining the ratio between I(sample) and I(control), thereby obtaining the integrity of the nucleic acid (especially RNA) contained in the sample composition.

In a fourth particular example of this embodiment of the second aspect (relating to the first subgroup of the second aspect), the integrity of a control nucleic acid (especially RNA) is determined by the following steps:

(a″) subjecting at least a part of a control composition containing control nucleic acid (especially RNA) to field-flow fractionation, in particular AF4 or HF5, thereby fractioning the components contained in the control composition by their size so as to produce one or more control fractions;

(b″) measuring at least the UV signal of least one of the one or more control fractions obtained from step (a″); and

(c″) determining from the UV signal obtained in step (b″) the height of one UV peak (H(control)), thereby obtaining the integrity of the control nucleic acid (especially RNA).

In this fourth example, the integrity of the nucleic acid (especially RNA) contained in the sample composition (e.g., the first composition for step (C) or the second composition for step (D)) may be calculated by the following steps:

(c1′) determining from the UV signal obtained in step (b) the height of the sample UV peak corresponding to the control UV peak used in step (c″) (H(sample)); and

(c2′) determining the ratio between H(sample) and H(control), thereby obtaining the integrity of the nucleic acid (especially RNA) contained in the sample composition.

In a fifth particular example of this embodiment of the second aspect (relating to the second subgroup of the second aspect), the integrity of a control RNA is determined by the following steps:

(a′) subjecting at least a part of a control composition containing control RNA to field-flow fractionation, in particular AF4 or HF5, thereby fractioning the components contained in the control composition by their size so as to produce one or more control fractions;

(b′) measuring at least one signal selected from the group consisting of the UV signal, the fluorescence signal, and the RI signal of least one of the one or more control fractions obtained from step (a′);

(c′1) calculating from the at least one signal selected from the group consisting of the UV signal, the fluorescence signal, and the RI signal obtained in step (b′) the area from the maximum height of one UV, fluorescence, or RI peak to the end of the UV, fluorescence, or RI peak, thereby obtaining A_{50%}(control);

(c′2) calculating from the at least one signal selected from the group consisting of the UV signal, the fluorescence signal, and the RI signal obtained in step (b′) the total area of the one peak used in step (c′1), thereby obtaining A_{100%}(control); and

(c′3) determining the ratio between A_{50%}(control) and A_{100%}(control), thereby obtaining the integrity of the control RNA (I(control)).

In this fifth example, the integrity of the RNA contained in the sample composition (e.g., the first composition for step (C) or the second composition for step (D)) may be calculated by the following steps:

(c1) calculating from the at least one signal selected from the group consisting of the UV signal, the fluorescence signal, and the RI signal obtained from step (b) the area from the maximum height of the sample UV, fluorescence, or RI peak corresponding to the control UV, fluorescence, or RI peak used in step (c′1) to the end of the sample UV, fluorescence, or RI peak, thereby obtaining A_{50%}(sample);

(c2) calculating from the sample UV, fluorescence, or RI signal obtained from step (b) the total area of the sample UV, fluorescence, or RI peak used in step (c1), thereby obtaining A_{100%}(sample);

(c3) determining the ratio between A_{50%}(sample) and A_{100%}(sample), thereby obtaining I(sample); and

(c4) determining the ratio between I(sample) and I(control), thereby obtaining the integrity of the RNA contained in the sample composition.

In a sixth particular example of this embodiment of the second aspect (relating to the second subgroup of the second aspect), the integrity of a control RNA is determined by the following steps:

(a″) subjecting at least a part of a control composition containing control RNA to field-flow fractionation, in particular AF4 or HF5, thereby fractioning the components contained in the control composition by their size so as to produce one or more control fractions;

(b″) measuring at least one signal selected from the group consisting of the UV signal, the fluorescence signal, and the RI signal of least one of the one or more control fractions obtained from step (a″); and

(c″) determining from the at least one signal selected from the group consisting of the UV signal, the fluorescence signal, and the RI signal obtained in step (b″) the height of one UV, fluorescence, or RI peak (H(control)), thereby obtaining the integrity of the control RNA.

In this sixth example, the integrity of the RNA contained in the sample composition (e.g., the first composition for step (C) or the second composition for step (D)) may be calculated by the following steps:

(c1′) determining from the at least one signal selected from the group consisting of the UV signal, the fluorescence signal, and the RI signal obtained in step (b) the height of the sample UV, fluorescence, or RI peak corresponding to the control UV, fluorescence, or RI peak used in step (c″) (H(sample)); and

(c2′) determining the ratio between H(sample) and H(control), thereby obtaining the integrity of the RNA contained in the sample composition.

In a seventh particular example of this embodiment of the second aspect (relating to the third subgroup of the second aspect), the integrity of a control RNA is determined by the following steps:

(a′) subjecting at least a part of a control composition containing control RNA to field-flow fractionation, in particular AF4 or HF5, thereby fractioning the components contained in the control composition by their size so as to produce one or more control fractions;

(b′) measuring at least the UV signal of least one of the one or more control fractions obtained from step (a′);

(c′1) calculating from the UV signal obtained in step (b′) the area from the maximum height of one UV peak to the end of the UV peak, thereby obtaining A_{50%}(control);

(c′2) calculating from the UV signal obtained in step (b′) the total area of the one peak used in step (c′1), thereby obtaining A_{100%}(control); and

(c′3) determining the ratio between A_{50%}(control) and A_{100%}(control), thereby obtaining the integrity of the control RNA (I(control)).

In this seventh example, the integrity of the RNA contained in the sample composition (e.g., the first composition for step (C) or the second composition for step (D)) may be calculated by the following steps:

(c1) calculating from the UV signal obtained from step (b) the area from the maximum height of the sample UV peak corresponding to the control UV peak used in step (c′1) to the end of the sample UV peak, thereby obtaining A_{50%}(sample);

(c2) calculating from the sample UV signal obtained from step (b) the total area of the sample UV peak used in step (c1), thereby obtaining A_{100%}(sample);

(c3) determining the ratio between A_{50%}(sample) and A_{100%}(sample), thereby obtaining I(sample); and

(c4) determining the ratio between I(sample) and I(control), thereby obtaining the integrity of the RNA contained in the sample composition.

In an eighth particular example of this embodiment of the second aspect (relating to the third subgroup of the second aspect), the integrity of a control RNA is determined by the following steps:

(a″) subjecting at least a part of a control composition containing control RNA to field-flow fractionation, in particular AF4 or HF5, thereby fractioning the components contained in the control composition by their size so as to produce one or more control fractions;

(b″) measuring at least the UV signal of least one of the one or more control fractions obtained from step (a″); and

(c″) determining from the UV signal obtained in step (b″) the height of one UV peak (H(control)), thereby obtaining the integrity of the control RNA.

In this eighth example, the integrity of the RNA contained in the sample composition (e.g., the first composition for step (C) or the second composition for step (D)) may be calculated by the following steps:

(c1′) determining from the UV signal obtained in step (b) the height of the sample UV peak corresponding to the control UV peak used in step (c″) (H(sample)); and

(c2′) determining the ratio between H(sample) and H(control), thereby obtaining the integrity of the RNA contained in the sample composition.

In one embodiment of the second aspect (in particular, in one embodiment of the first, second or third subgroup of the second aspect), the amount of nucleic acid (especially RNA) is determined by using (i) a nucleic acid extinction coefficient (especially an RNA extinction coefficient) or (ii) a nucleic acid calibration curve (especially an RNA calibration curve).

In one embodiment of the second aspect (in particular, in one embodiment of the first, second or third subgroup of the second aspect), the sample composition (e.g., the first composition for step (C) or the second composition for step (D)) comprises nucleic acid (especially RNA) and particles, such as lipoplex particles and/or lipid nanoparticles and/or polyplex particles and/or lipopolyplex particles and/or virus-like particles, to which nucleic acid (especially RNA) is bound.

In one embodiment of the second aspect (in particular, in one embodiment of the first, second or third subgroup of the second aspect), the amount of total nucleic acid (especially the amount of total RNA) is determined by (i) treating at least a part of the sample composition (e.g., the first composition for step (C) or the second composition for step (D)) with a release agent; (ii) performing steps (a) to (c) with at least the part obtained from step (i); and (iii) determining the amount of nucleic acid (especially RNA) as specified herein (e.g., using (i) a nucleic acid extinction coefficient (especially an RNA extinction coefficient) or (ii) a nucleic acid calibration curve (especially an RNA calibration curve)). In this embodiment, in step (a) of the method of the second aspect, the field-flow-fractionation is preferably performed using a liquid phase containing the release agent.

In one embodiment of the second aspect (in particular, in one embodiment of the first, second or third subgroup of the second aspect), the release agent is (i) a surfactant, such as an anionic surfactant (e.g., sodium dodecylsulfate), a zwitterionic surfactant (e.g., n-tetradecyl-N,N-dimethyl-3-ammonio-1-propanesulfonate (Zwittergent® 3-14)), a cationic surfactant, a non-ionic surfactant, or a mixture thereof; (ii) an alcohol, such as an aliphatic alcohol (e.g., ethanol), or a mixture of alcohols; or (iii) a combination of (i) and (ii).

In one embodiment of the second aspect (in particular, in one embodiment of the first, second or third subgroup of the second aspect), the amount of free nucleic acid (especially RNA) is determined by performing steps (a) to (c) without the addition of a release agent, in particular in the absence of any release agent; and determining the amount of nucleic acid (especially RNA) as specified herein (e.g., using (i) a nucleic acid extinction coefficient (especially an RNA extinction coefficient) or (ii) a nucleic acid calibration curve (especially an RNA calibration curve)).

In one embodiment of the second aspect (in particular, in one embodiment of the first, second or third subgroup of the second aspect), the amount of nucleic acid (especially RNA) bound to particles is determined by subtracting the amount of free nucleic acid (especially RNA) as determined herein (e.g., by performing steps (a) to (c) without the addition of a release agent, in particular in the absence of any release agent; and determining the amount of nucleic acid (especially RNA) as specified herein (e.g., using (i) a nucleic acid extinction coefficient (especially an RNA extinction coefficient) or (ii) a nucleic acid calibration curve (especially an RNA calibration curve))) from the amount of total nucleic acid (especially RNA) as determined herein (e.g., by (i) treating at least a part of the sample composition (e.g., the first composition for step (C) or the second composition for step (D)) with a release agent; (ii) performing steps (a) to (c) with at least the part obtained from step (i); and (iii) determining the amount of nucleic acid (especially RNA) as specified herein (e.g., using (i) a nucleic acid extinction coefficient (especially an RNA extinction coefficient) or (ii) a nucleic acid calibration curve (especially an RNA calibration curve))).

In one embodiment of the second aspect (in particular, in one embodiment of the second or third subgroup of the second aspect), step (b) further comprises measuring the LS signal, such as the dynamic light scattering (DLS) and/or the static light scattering (SLS), e.g., multi-angle light scattering (MALS), signal, of least one of the one or more sample fractions obtained from step (a).

In one embodiment of the second aspect (in particular, in one embodiment of the second or third subgroup of the second aspect), the size of nucleic acid (especially RNA) containing particles is determined by calculating from the LS signal obtained from step (b) the radius of gyration (R_{g}) values and/or the hydrodynamic radius (Rₕ) values. In one embodiment of the second aspect (in particular, in one embodiment of the first, second or third subgroup of the second aspect), step (b) comprises measuring the dynamic light scattering (DLS) signal of least one of the one or more sample fractions obtained from step (a) and step (c) comprises calculating the Rₕ values from the DLS signal. In one embodiment of the second aspect (in particular, in one embodiment of the first, second or third subgroup of the second aspect), step (b) comprises measuring the static light scattering (SLS), e.g., MALS, signal of least one of the one or more sample fractions obtained from step (a), and step (c) comprises calculating the R_{g} values from the SLS signal. In one embodiment of the second aspect (in particular, in one embodiment of the first, second or third subgroup of the second aspect), step (b) comprises measuring the dynamic light scattering (DLS) signal and the static light scattering (SLS), e.g., MALS, signal of least one of the one or more sample fractions obtained from step (a) and step (c) comprises calculating the R_{g} and Rₕ values. This latter embodiment results in two data sets for the size of nucleic acid (such as RNA) containing particles, i.e., one based on the R_{g} values and one based on the Rₕ values.

In one embodiment of the second aspect (in particular, in one embodiment of the first, second or third subgroup of the second aspect), the size distribution of nucleic acid (especially RNA) containing particles is determined by plotting the at least one signal selected from the group consisting of the UV signal, the fluorescence signal, and the RI signal obtained from step (b) against the R_{g} or Rₕ values determined as specified herein (e.g., by calculating the R_{g} values from the SLS signal obtained from step (b) or by calculating the Rₕ values from the DLS signal obtained from step (b)). In a first example of this embodiment (relating to the first subgroup of the second aspect), the size distribution of nucleic acid (especially RNA) containing particles is determined by plotting the UV signal obtained from step (b) against the R_{g} or Rₕ values determined as specified herein (e.g., by calculating the R_{g} values from the SLS signal obtained from step (b) or by calculating the Rₕ values from the DLS signal obtained from step (b)). In a second example of this embodiment (relating to the second subgroup of the second aspect), the size distribution of RNA containing particles is determined by plotting the at least one signal selected from the group consisting of the UV signal, the fluorescence signal, and the RI signal obtained from step (b) against the R_{g} or Rₕ values determined as specified herein (e.g., by calculating the R_{g} values from the SLS signal obtained from step (b) or by calculating the Rₕ values from the DLS signal obtained from step (b)). In a third example of this embodiment (relating to the third subgroup of the second aspect), the size distribution of RNA containing particles is determined by plotting the UV signal obtained from step (b) against the R_{g} or Rₕ values determined as specified herein (e.g., by calculating the R_{g} values from the SLS signal obtained from step (b) or by calculating the Rₕ values from the DLS signal obtained from step (b)). In each of the above first, second and third examples, the size distribution of nucleic acid (especially RNA) containing particles can be determined on the basis of the R_{g} values, the Rₕ values or both. If the size distribution of nucleic acid (especially RNA) containing particles is determined on the basis of the R_{g} values and the Rₕ values, this results in two data sets, i.e., one size distribution based on the R_{g} values and one size distribution based on the Rₕ values.

In one embodiment of the second aspect (in particular, in one embodiment of the first, second or third subgroup of the second aspect), the quantitative size distribution of nucleic acid (especially RNA) containing particles is calculated from the plot showing the UV, fluorescence, or RI signal as function of the R_{g} or Rₕ values by transforming the UV, fluorescence, or RI signal into a cumulative weight fraction and plotting the cumulative weight fraction against the R_{g} or Rₕ values. In a first example of this embodiment (relating to the first subgroup of the second aspect), the quantitative size distribution of nucleic acid (especially RNA) containing particles is calculated from the plot showing the UV signal as function of the R_{g} or Rₕ values by transforming the UV signal into a cumulative weight fraction and plotting the cumulative weight fraction against the R_{g} or Rₕ values. In a second example of this embodiment (relating to the second subgroup of the second aspect), the quantitative size distribution of RNA containing particles is calculated from the plot showing the UV, fluorescence, or RI signal as function of the R_{g} or Rₕ values by transforming the UV, fluorescence, or RI signal into a cumulative weight fraction and plotting the cumulative weight fraction against the R_{g} or Rₕ values. In a third example of this embodiment (relating to the third subgroup of the second aspect), the quantitative size distribution of RNA containing particles is calculated from the plot showing the UV signal as function of the R_{g} or Rₕ values by transforming the UV signal into a cumulative weight fraction and plotting the cumulative weight fraction against the R_{g} or Rₕ values. In each of the above first, second and third examples, the quantitative size distribution of nucleic acid (especially RNA) containing particles can be determined on the basis of the R_{g} values, the Rₕ values or both. If the quantitative size distribution of nucleic acid (especially RNA) containing particles is determined on the basis of the R_{g} values and the Rₕ values, this results in two data sets, i.e., one quantitative size distribution based on the R_{g} values and one quantitative size distribution based on the Rₕ values.

In one embodiment of the second aspect (in particular, in one embodiment of the first, second or third subgroup of the second aspect), the quantitative size distribution includes D10, D50, and/or D90 values. If the quantitative size distribution of nucleic acid (especially RNA) containing particles is determined on the basis of the R_{g} values and the Rₕ values, this results in two data sets, i.e., one set of D10, D50, and/or D90 values based on the R_{g} values and one set of D10, D50, and/or D90 values based on the Rₕ values.

In one embodiment of the second aspect (in particular, in one embodiment of the first, second or third subgroup of the second aspect), the amount of nucleic acid (especially RNA), in particular free nucleic acid (especially RNA), is determined by measuring the UV signal, e.g., at a wavelength in the range of 260 nm to 280 nm, such as at a wavelength of 260 nm or 280 nm, and using the nucleic acid (especially RNA) extinction coefficient at the corresponding wavelength (e.g., 260 nm or 280 nm).

In one embodiment of the second aspect (in particular, in one embodiment of the first, second or third subgroup of the second aspect, in particular in a preferred embodiment of the third subgroup of the second aspect), the size distribution of nucleic acid (especially RNA) containing particles (e.g., based on the R_{g} or Rₕ values) and/or the quantitative size distribution of nucleic acid (especially RNA) containing particles (e.g., based on the R_{g} or Rₕ values) is/are within the range of 10 to 2000 nm, preferably within the range of 20 to 1500 nm, such as 30 to 1200 nm, 40 to 1100 nm, 50 to 1000, 60 to 900 nm, 70 to 800 nm, 80 to 700 nm, 90 to 600 nm, or 100 to 500 nm, or such as within the range of 10 to 1000 nm, 15 to 500 nm, 20 to 450 nm, 25 to 400 nm, 30 to 350 nm, 40 to 300 nm, or 50 to 250 nm. In a preferred embodiment of the third subgroup of the second aspect, the (quantitative) size distribution of RNA containing particles (e.g., based on R_{g} or Rₕ values) is within the range of 10 to 1000 nm, such as within the range of 15 to 500 nm, 20 to 450 nm, 25 to 400 nm, 30 to 350 nm, 40 to 300 nm, or 50 to 250 nm.

In one embodiment of the second aspect (in particular, in one embodiment of the first, second or third subgroup of the second aspect), the nucleic acid (especially RNA) has a length of 10 to 15,000 nucleotides, such as 40 to 15,000 nucleotides, 100 to 12,000 nucleotides or 200 to 10,000 nucleotides.

In one embodiment of the second aspect (in particular, in one embodiment of the first subgroup of the second aspect), the nucleic acid is RNA. In this embodiment and in the embodiments of the second or third subgroup of the second aspect, the RNA preferably is mRNA or in vitro transcribed RNA, in particular in vitro transcribed mRNA.

In one embodiment of the second aspect (in particular, in one embodiment of the first, second or third subgroup of the second aspect), measuring the at least one signal selected from the group consisting of the UV signal, the fluorescence signal, and the RI signal, optionally the LS signal, such as the SLS, e.g., MALS, signal and/or the DLS signal, is performed on-line and/or step (c) is performed on-line.

In one embodiment of the second aspect (in particular, in one embodiment of the first, second or third subgroup of the second aspect), before subjecting at least a part of the sample composition (e.g., the first composition for step (C) or the second composition for step (D)) to field-flow fractionation, the at least part of the sample composition is diluted with a solvent or solvent mixture, said solvent or solvent mixture being able to prevent the formation of aggregates of the particles. In one embodiment, the solvent mixture is a mixture of water and an organic solvent, e.g., formamide.

In one embodiment of the second aspect (in particular, in one embodiment of the first, second or third subgroup of the second aspect), measuring the UV signal is performed by using circular dichroism (CD) spectroscopy.

It is understood that any embodiment described herein in the context of the first aspect may also apply to any embodiment of the second aspect.

In a third aspect, the present disclosure provides the use of field-flow-fractionation for determining one or more parameters of a sample composition comprising nucleic acid (such as RNA) and optionally particles, wherein the one or more parameters comprise the nucleic acid (such as RNA) integrity, the total amount of nucleic acid (such as RNA), the amount of free nucleic acid (such as RNA), the amount of nucleic acid (such as RNA) bound to particles, the size of nucleic acid (such as RNA) containing particles (in particular, based on the radius of gyration (R_{g}) of nucleic acid (such as RNA) containing particles and/or the hydrodynamic radius (Rₕ) of nucleic acid (such as RNA) containing particles), the size distribution of nucleic acid (such as RNA) containing particles (e.g., based on R_{g} or Rₕ values of nucleic acid (such as RNA) containing particles), and the quantitative size distribution of nucleic acid (such as RNA) containing particles (e.g., based on R_{g} or Rₕ values of nucleic acid (such as RNA) containing particles). Generally, the size distribution and/or quantitative size distribution of nucleic acid (such as RNA) containing particles can be given as the number of the nucleic acid (such as RNA) containing particles, the molar amount of the nucleic acid (such as RNA) containing particles, or the mass of the nucleic acid (such as RNA) containing particles each as a function of their size. Additional optional parameters include the molecular weight of nucleic acid (such as RNA), the amount of surface nucleic acid (such as the amount of surface RNA), the amount of encapsulated nucleic acid (such as the amount of encapsulated RNA), the amount of accessible nucleic acid (such as the amount of accessible RNA), the size of nucleic acid (especially RNA) (in particular, based on R_{g} and/or Rₕ values of nucleic acid (such as RNA) containing particles), the size distribution of nucleic acid (especially RNA) (e.g., based on R_{g} or Rₕ values of nucleic acid (such as RNA)), the quantitative size distribution of nucleic acid (especially RNA) (e.g., based on R_{g} or Rₕ values of nucleic acid (such as RNA)), the shape factor, the form factor, and the nucleic acid (especially RNA) encapsulation efficiency. Generally, the size distribution and/or quantitative size distribution of nucleic acid (especially RNA) can be given as the number of the nucleic acid (especially RNA) molecules, the molar amount of the nucleic acid (especially RNA), or the mass of the nucleic acid (especially RNA) each as a function of their size. Further additional optional parameters include the ratio of the amount of nucleic acid (such as RNA) bound to particles to the total amount of particle forming compounds (in particular lipids and/or polymers) in the particles, wherein said ratio may be given as a function of the particle size; the ratio of the amount of positively charged moieties of particle forming compounds (in particular lipids and/or polymers) in the particles to the amount of nucleic acid (such as RNA) bound to particles, wherein said ratio may be given as a function of the particle size; and the charge ratio of the amount of positively charged moieties of particle forming compounds (in particular lipids and/or polymers) in the particles to the amount of negatively charged moieties of nucleic acid (such as RNA) bound to particles, wherein said charge ratio is usually denoted as N/P ratio and may be given as a function of the particle size.

In one embodiment of the third aspect, the field-flow fractionation comprises:

(a) subjecting at least a part of the sample composition to field-flow fractionation, thereby fractioning the components contained in the sample composition by their size so as to produce one or more sample fractions;

(b) measuring at least one signal selected from the group consisting of the UV signal, the fluorescence signal, and the refractory index (RI) signal, and optionally the light scattering (LS) signal, of least one of the one or more sample fractions obtained from step (a); and

(c) calculating from the at least one signal selected from the group consisting of the UV signal, the fluorescence signal, and the RI signal, and optionally from the LS signal, the one or more parameters.

In a first subgroup of the third aspect, the field-flow fractionation comprises:

(a) subjecting at least a part of the sample composition to field-flow fractionation, thereby fractioning the components contained in the sample composition by their size so as to produce one or more sample fractions;

(b) measuring at least the UV signal, and optionally the light scattering (LS) signal, of least one of the one or more sample fractions obtained from step (a); and

(c) calculating from the UV signal, and optionally from the LS signal, the one or more parameters.

In a second and preferred subgroup of the third aspect, the use is for determining one or more parameters of a sample composition, wherein the sample composition comprises RNA and optionally particles, the field-flow fractionation comprising:

(a) subjecting at least a part of the sample composition to field-flow fractionation, thereby fractioning the components contained in the sample composition by their size so as to produce one or more sample fractions;

(b) measuring at least one signal selected from the group consisting of the UV signal, the fluorescence signal, and the refractory index (RI) signal, and optionally measuring the light scattering (LS) signal, of least one of the one or more sample fractions obtained from step (a); and

(c) calculating from the at least one signal selected from the group consisting of the UV signal, the fluorescence signal, and the RI signal, and optionally from the LS signal, the one or more parameters.

In a third and more preferred subgroup of the third aspect, the use is for determining one or more parameters of a sample composition, wherein the sample composition comprises RNA and optionally particles, the field-flow fractionation comprising:

(a) subjecting at least a part of the sample composition to field-flow fractionation, thereby fractioning the components contained in the sample composition by their size so as to produce one or more sample fractions;

(b) measuring at least the UV signal, and optionally the light scattering (LS) signal, of least one of the one or more sample fractions obtained from step (a); and

(c) calculating from the UV signal, and optionally from the LS signal, the one or more parameters.

In one embodiment of the third aspect (in particular, in one embodiment of the first, second or third subgroup of the third aspect), the size, size distribution, and/or quantitative size distribution of nucleic acid (such as RNA) containing particles is/are calculated based on the R_{g} values of the nucleic acid (such as RNA) containing particles. In another embodiment of the third aspect (in particular, in another embodiment of the first, second or third subgroup of the third aspect), the size, size distribution, and/or quantitative size distribution of nucleic acid (such as RNA) containing particles is/are calculated based on the Rₕ values of the nucleic acid (such as RNA) containing particles. In another embodiment of the third aspect (in particular, in another embodiment of the first, second or third subgroup of the third aspect), the size, size distribution, and/or quantitative size distribution of nucleic acid (such as RNA) containing particles is/are calculated based on the R_{g} values of the nucleic acid (such as RNA) containing particles and separately based on the Rₕ values of nucleic acid (such as RNA) containing particles (i.e., this embodiment results in two data sets for the size, size distribution, and/or quantitative size distribution of nucleic acid (such as RNA) containing particles, one based on the R_{g} values and one based on the Rₕ values).

In one embodiment of the third aspect (in particular, in one embodiment of the first, second or third subgroup of the third aspect), where the one or more parameters comprise the size, size distribution, and/or quantitative size distribution of nucleic acid (such as RNA), the size, size distribution, and/or quantitative size distribution of nucleic acid (such as RNA) is/are calculated based on the R_{g} values of the nucleic acid (such as RNA). In another embodiment of the third aspect (in particular, in another embodiment of the first, second or third subgroup of the third aspect), where the one or more parameters comprise the size, size distribution, and/or quantitative size distribution of nucleic acid (such as RNA), the size, size distribution, and/or quantitative size distribution of nucleic acid (such as RNA) is/are calculated based on the Rₕ values of the nucleic acid (such as RNA). In another embodiment of the third aspect (in particular, in another embodiment of the first, second or third subgroup of the third aspect), where the one or more parameters comprise the size, size distribution, and/or quantitative size distribution of nucleic acid (such as RNA), the size, size distribution, and/or quantitative size distribution of nucleic acid (such as RNA) is/are calculated based on the R_{g} values of the nucleic acid (such as RNA) and separately based on the Rₕ values of nucleic acid (such as RNA) (i.e., this embodiment results in two data sets for the size, size distribution, and/or quantitative size distribution of nucleic acid (such as RNA), one based on the R_{g} values and one based on the Rₕ values).

In one embodiment of the third aspect (in particular, in one embodiment of the first, second or third subgroup of the third aspect), the field-flow fractionation is flow field-flow fractionation, such as asymmetric flow field-flow fractionation (AF4) or hollow fiber flow field-flow fractionation (HF5).

In one embodiment of the third aspect (in particular, in one embodiment of the first, second or third subgroup of the third aspect), the field-flow-fractionation uses a membrane having a molecular weight (MW) cut-off suitable to prevent nucleic acid (especially RNA) from permeating the membrane, preferably a membrane having a MW cut-off in the range of from 2 kDa to 30 kDa, such as a MW cut-off of 10 kDa.

In one embodiment of the third aspect (in particular, in one embodiment of the first, second or third subgroup of the third aspect), the field-flow-fractionation uses a polyethersulfon (PES) or regenerated cellulose membrane.

In one embodiment of the third aspect (in particular, in one embodiment of the first, second or third subgroup of the third aspect), step (a) is performed using (I) a cross flow rate of up to 8 mL/min, preferably up to 4 mL/min, more preferably up to 2 mL/min, e.g., a cross flow rate profile; and/or (II) an inject flow in the range of 0.05 to 0.35 mL/min, preferably in the range of 0.10 to 0.30 mL/min, more preferably in the range of 0.15 to 0.25 mL/min; and/or (III) a detector flow in the range of 0.30 to 0.70 mL/min, preferably in the range of 0.40 to 0.60 mL/min, more preferably in the range of 0.45 to 0.55 mL/min.

In one embodiment of the third aspect (in particular, in one embodiment of the first, second or third subgroup of the third aspect), the cross flow rate profile preferably contains a fractioning phase which allows the components contained in the control or sample composition to fraction/separate by their size so as to produce one or more sample fractions. It is preferred that the cross flow rate changes during this fractioning phase (e.g., starting from one value (such as about 1 to about 4 mL/min) and then decreasing to a lower value (such as about 0 to about 0.1 mL/min) or starting from one value (such as about 0 to about 0.1 mL/min) and then increasing to a higher value (such as about 1 to about 4 mL/min), wherein the change can be by any means, e.g., a continuous (such as linear or exponential) change or a stepwise change. Preferably, the cross flow rate profile contains a fractioning phase, wherein the cross flow rate changes continuously (preferably exponentially) starting from one value (such as about 1 to about 4 mL/min) and then decreasing to a lower value (such as about 0 to about 0.1 mL/min). The fractioning phase may have any length suitable to fraction/separate the components contained in the sample composition by their size, e.g., about 5 min to about 60 min, such as about 10 min to about 50 min, about 15 min to about 45 min, about 20 min to about 40 min, or about 25 min to about 35 min, or about 30 min. The cross flow rate profile may contain additional phases (e.g., 1, 2, 3, or 4 phases) which may be before and/or after the fractioning phase (e.g., one before and 1, 2, or 3 after the fractioning phase) and which may serve to separate non-nucleic acid (especially non RNA) components contained in the sample composition (e.g., proteins, polypeptides, mononucleotides, etc.) from the nucleic acid (especially RNA) contained in the sample composition, to focus the nucleic acid (especially RNA) contained in the sample composition and/or to regenerate the field-flow fractionation device (e.g., to remove all components bound to the membrane of the device). Preferably, the cross flow rate of these additional phases is constant for each additional phase and the length of each of the additional phases is independently for each of the additional phases in the range of about 5 min to about 60 min (such as about 10 min to about 50 min, about 15 min to about 45 min, about 20 min to about 40 min, or about 25 min to about 35 min, or about 30 min). For example, the cross flow rate profile may contain (i) a first additional phase which is before the fractioning phase, wherein the cross flow rate of said first additional phase is constant and is the same cross low rate with which the fractioning phase starts (the length of the first additional phase may be in the range of about 5 min to about 60 min, such as about 10 min to about 50 min, about 15 min to about 45 min, about 20 min to about 40 min, or about 25 min to about 35 min, or about 10 min or about 20 min or about 30 min); (ii) a second additional phase which is after the fractioning phase, wherein the cross flow rate of said second additional phase is constant and is the same cross low rate with which the fractioning phase ends (the length of the second additional phase may be in the range of about 5 min to about 60 min, such as about 10 min to about 50 min, about 15 min to about 45 min, about 20 min to about 40 min, or about 25 min to about 35 min, or about 10 min or about 20 min or about 30 min); and optionally (iii) a third additional phase which is after the second additional phase, wherein the cross flow rate of said third additional phase is constant and different from that of the second additional phase (the length of the third additional phase may be in the range of about 5 min to about 60 min, such as about 10 min to about 50 min, about 15 min to about 45 min, about 20 min to about 40 min, or about 25 min to about 35 min, or about 10 min or about 20 min or about 30 min). In the embodiment, where the cross flow rate profile contains a fractioning phase, wherein the cross flow rate changes continuously (preferably exponentially) starting from one value (such as about 1 to about 4 mL/min) and then decreasing to a lower value (such as about 0 to about 0.1 mL/min), it is preferred that the cross flow rate profile further contains (i) a first additional phase which is before the fractioning phase, wherein the cross flow rate of said first additional phase is constant and is the same cross low rate with which the fractioning phase starts (such as about 1 to about 4 mL/min) (the length of the first additional phase may be in the range of about 5 min to about 30 min, such as about 6 min to about 25 min, about 7 min to about 20 min, or about 8 min to about 15 min, or about 10 min to about 12 min, or about 5 min or about 10 min or about 12 min); (ii) a second additional phase which is after the fractioning phase, wherein the cross flow rate of said second additional phase is constant and is the same cross low rate with which the fractioning phase ends (such as about 0.01 to 0.1 mL/min) (the length of the second additional phase may be in the range of about 5 min to about 60 min, such as about 10 min to about 50 min, about 15 min to about 45 min, about 20 min to about 40 min, or about 25 min to about 35 min, or about 30 min); and optionally (iii) a third additional phase which is after the second additional phase, wherein the cross flow rate of said third additional phase is constant and lower than that of the second additional phase (e.g., the cross flow rate of said third additional phase is 0) (the length of the third additional phase may be in the range of about 5 min to about 30 min, such as about 6 min to about 25 min, about 7 min to about 20 min, or about 8 min to about 15 min, or about 10 min to about 12 min, or about 5 min or about 10 min or about 12 min). A preferred example of such a cross flow rate profile is the following: 1.0 to 2.0 mL/min for 10 min, an exponential gradient from 1.0 to 2.0 mL/min to 0.01 to 0.07 mL/min within 30 min; 0.01 to 0.07 mL/min for 30 min; and 0 mL/min for 10 min.

In one embodiment of the third aspect (in particular, in one embodiment of the first, second or third subgroup of the third aspect), the integrity of the nucleic acid (especially RNA) contained in the sample composition is determined using the integrity of a control nucleic acid (especially RNA).

In a first particular example of this embodiment of the third aspect, the integrity of a control nucleic acid (especially RNA) is determined by the following steps:

(a′) subjecting at least a part of a control composition containing control nucleic acid (especially RNA) to field-flow fractionation, in particular AF4 or HF5, thereby fractioning the components contained in the control composition by their size so as to produce one or more control fractions;

(b′) measuring at least one signal selected from the group consisting of the UV signal, the fluorescence signal, and the refractory index (RI) signal of least one of the one or more control fractions obtained from step (a′);

(c′1) calculating from the at least one signal selected from the group consisting of the UV signal, the fluorescence signal, and the RI signal obtained in step (b′) the area from the maximum height of one UV, fluorescence, or RI peak to the end of the UV, fluorescence, or RI peak, thereby obtaining A_{50%}(control);

(c′2) calculating from the at least one signal selected from the group consisting of the UV signal, the fluorescence signal, and the RI signal obtained in step (b′) the total area of the one peak used in step (c′1), thereby obtaining A_{100%}(control); and

(c′3) determining the ratio between A_{50%}(control) and A_{100%}(control), thereby obtaining the integrity of the control nucleic acid (especially RNA) (I(control)).

In this first example, the integrity of the nucleic acid (especially RNA) contained in the sample composition may be calculated by the following steps:

(c1) calculating from the at least one signal selected from the group consisting of the UV signal, the fluorescence signal, and the RI signal obtained from step (b) the area from the maximum height of the sample UV, fluorescence, or RI peak corresponding to the control UV, fluorescence, or RI peak used in step (el) to the end of the sample UV, fluorescence, or RI peak, thereby obtaining A_{50%}(sample);

(c2) calculating from the sample UV, fluorescence, or RI signal obtained from step (b) the total area of the sample UV, fluorescence, or RI peak used in step (c1), thereby obtaining A_{100%}(sample);

(c3) determining the ratio between A_{50%}(sample) and A_{100%}(sample), thereby obtaining I(sample); and

(c4) determining the ratio between I(sample) and I(control), thereby obtaining the integrity of the nucleic acid (especially RNA) contained in the sample composition.

In a second particular example of this embodiment of the third aspect, the integrity of a control nucleic acid (especially RNA) is determined by the following steps:

(a″) subjecting at least a part of a control composition containing control nucleic acid (especially RNA) to field-flow fractionation, in particular AF4 or HF5, thereby fractioning the components contained in the control composition by their size so as to produce one or more control fractions;

(b″) measuring at least one signal selected from the group consisting of the UV signal, the fluorescence signal, and the RI signal of least one of the one or more control fractions obtained from step (e); and

(c″) determining from the at least one signal selected from the group consisting of the UV signal, the fluorescence signal, and the RI signal obtained in step (b″) the height of one UV, fluorescence, or RI peak (H(control)), thereby obtaining the integrity of the control nucleic acid (especially RNA).

In this second example, the integrity of the nucleic acid (especially RNA) contained in the sample composition may be calculated by the following steps:

(c1′) determining from the at least one signal selected from the group consisting of the UV signal, the fluorescence signal, and the RI signal obtained in step (b) the height of the sample UV, fluorescence, or RI peak corresponding to the control UV, fluorescence, or RI peak used in step (c″) (H(sample)); and

(c2′) determining the ratio between H(sample) and H(control), thereby obtaining the integrity of the nucleic acid (especially RNA) contained in the sample composition.

In a third particular example of this embodiment of the third aspect (relating to the first subgroup of the third aspect), the integrity of a control nucleic acid (especially RNA) is determined by the following steps:

(a′) subjecting at least a part of a control composition containing control nucleic acid (especially RNA) to field-flow fractionation, in particular AF4 or HF5, thereby fractioning the components contained in the control composition by their size so as to produce one or more control fractions;

(b′) measuring at least the UV signal of least one of the one or more control fractions obtained from step (a′);

(c′1) calculating from the UV signal obtained in step (b′) the area from the maximum height of one UV peak to the end of the UV peak, thereby obtaining A_{50%}(control);

(c′2) calculating from the UV signal obtained in step (b′) the total area of the one peak used in step (c′1), thereby obtaining A_{100%}(control); and

(c′3) determining the ratio between A_{50%}(control) and A_{100%}(control), thereby obtaining the integrity of the control nucleic acid (especially RNA) (I(control)).

In this third example, the integrity of the nucleic acid (especially RNA) contained in the sample composition may be calculated by the following steps:

(c1) calculating from the UV signal obtained from step (b) the area from the maximum height of the sample UV peak corresponding to the control UV peak used in step (c′1) to the end of the sample UV peak, thereby obtaining A_{50%}(sample);

(c2) calculating from the sample UV signal obtained from step (b) the total area of the sample UV peak used in step (c1), thereby obtaining A_{100%}(sample);

(c3) determining the ratio between A_{50%}(sample) and A_{100%}(sample), thereby obtaining I(sample); and

(c4) determining the ratio between I(sample) and I(control), thereby obtaining the integrity of the nucleic acid (especially RNA) contained in the sample composition.

In a fourth particular example of this embodiment of the third aspect (relating to the first subgroup of the third aspect), the integrity of a control nucleic acid (especially RNA) is determined by the following steps:

(a″) subjecting at least a part of a control composition containing control nucleic acid (especially RNA) to field-flow fractionation, in particular AF4 or HF5, thereby fractioning the components contained in the control composition by their size so as to produce one or more control fractions;

(b″) measuring at least the UV signal of least one of the one or more control fractions obtained from step (a″); and

(c″) determining from the UV signal obtained in step (b″) the height of one UV peak (H(control)), thereby obtaining the integrity of the control nucleic acid (especially RNA).

In this fourth example, the integrity of the nucleic acid (especially RNA) contained in the sample composition may be calculated by the following steps:

(c1′) determining from the UV signal obtained in step (b) the height of the sample UV peak corresponding to the control UV peak used in step (c″) (H(sample)); and

(c2′) determining the ratio between H(sample) and H(control), thereby obtaining the integrity of the nucleic acid (especially RNA) contained in the sample composition.

In a fifth particular example of this embodiment of the third aspect (relating to the second subgroup of the third aspect), the integrity of a control RNA is determined by the following steps:

(a′) subjecting at least a part of a control composition containing control RNA to field-flow fractionation, in particular AF4 or HF5, thereby fractioning the components contained in the control composition by their size so as to produce one or more control fractions;

(b′) measuring at least one signal selected from the group consisting of the UV signal, the fluorescence signal, and the RI signal of least one of the one or more control fractions obtained from step (a′);

(c′1) calculating from the at least one signal selected from the group consisting of the UV signal, the fluorescence signal, and the RI signal obtained in step (b′) the area from the maximum height of one UV, fluorescence, or RI peak to the end of the UV, fluorescence, or RI peak, thereby obtaining A_{50%}(control);

(c′2) calculating from the at least one signal selected from the group consisting of the UV signal, the fluorescence signal, and the RI signal obtained in step (b′) the total area of the one peak used in step (c′1), thereby obtaining A_{100%}(control); and

(c′3) determining the ratio between A_{50%}(control) and A_{100%}(control), thereby obtaining the integrity of the control RNA (I(control)).

In this fifth example, the integrity of the RNA contained in the sample composition may be calculated by the following steps:

(c1) calculating from the at least one signal selected from the group consisting of the UV signal, the fluorescence signal, and the RI signal obtained from step (b) the area from the maximum height of the sample UV, fluorescence, or RI peak corresponding to the control UV, fluorescence, or RI peak used in step (c′1) to the end of the sample UV, fluorescence, or RI peak, thereby obtaining A_{50%}(sample);

(c2) calculating from the sample UV, fluorescence, or RI signal obtained from step (b) the total area of the sample UV, fluorescence, or RI peak used in step (c1), thereby obtaining A_{100%}(sample);

(c3) determining the ratio between A_{50%}(sample) and A_{100%}(sample), thereby obtaining I(sample); and

(c4) determining the ratio between I(sample) and I(control), thereby obtaining the integrity of the RNA contained in the sample composition.

In a sixth particular example of this embodiment of the third aspect (relating to the second subgroup of the third aspect), the integrity of a control RNA is determined by the following steps:

(a″) subjecting at least a part of a control composition containing control RNA to field-flow fractionation, in particular AF4 or HF5, thereby fractioning the components contained in the control composition by their size so as to produce one or more control fractions;

(b″) measuring at least one signal selected from the group consisting of the UV signal, the fluorescence signal, and the RI signal of least one of the one or more control fractions obtained from step (a″); and

(c″) determining from the at least one signal selected from the group consisting of the UV signal, the fluorescence signal, and the RI signal obtained in step (b″) the height of one UV, fluorescence, or RI peak (H(control)), thereby obtaining the integrity of the control RNA.

In this sixth example, the integrity of the RNA contained in the sample composition may be calculated by the following steps:

(c1′) determining from the at least one signal selected from the group consisting of the UV signal, the fluorescence signal, and the RI signal obtained in step (b) the height of the sample UV, fluorescence, or RI peak corresponding to the control UV, fluorescence, or RI peak used in step (c″) (H(sample)); and

(c2′) determining the ratio between H(sample) and H(control), thereby obtaining the integrity of the RNA contained in the sample composition.

In a seventh particular example of this embodiment of the third aspect (relating to the third subgroup of the third aspect), the integrity of a control RNA is determined by the following steps:

(a′) subjecting at least a part of a control composition containing control RNA to field-flow fractionation, in particular AF4 or HF5, thereby fractioning the components contained in the control composition by their size so as to produce one or more control fractions;

(b′) measuring at least the UV signal of least one of the one or more control fractions obtained from step (a′);

(c′1) calculating from the UV signal obtained in step (b′) the area from the maximum height of one UV peak to the end of the UV peak, thereby obtaining A_{50%}(control);

(c′2) calculating from the UV signal obtained in step (b′) the total area of the one peak used in step (c′1), thereby obtaining A_{100%}(control); and

(c′3) determining the ratio between A_{50%}(control) and A_{100%}(control), thereby obtaining the integrity of the control RNA (I(control)).

In this seventh example, the integrity of the RNA contained in the sample composition may be calculated by the following steps:

(c1) calculating from the UV signal obtained from step (b) the area from the maximum height of the sample UV peak corresponding to the control UV peak used in step (c′1) to the end of the sample UV peak, thereby obtaining A_{50%}(sample);

(c2) calculating from the sample UV signal obtained from step (b) the total area of the sample UV peak used in step (c1), thereby obtaining A_{100%}(sample);

(c3) determining the ratio between A_{50%}(sample) and A_{100%}(sample), thereby obtaining I(sample); and

(c4) determining the ratio between I(sample) and I(control), thereby obtaining the integrity of the RNA contained in the sample composition.

In an eighth particular example of this embodiment of the third aspect (relating to the third subgroup of the third aspect), the integrity of a control RNA is determined by the following steps:

(a″) subjecting at least a part of a control composition containing control RNA to field-flow fractionation, in particular AF4 or HF5, thereby fractioning the components contained in the control composition by their size so as to produce one or more control fractions;

(b″) measuring at least the UV signal of least one of the one or more control fractions obtained from step (a″); and

(c″) determining from the UV signal obtained in step (b″) the height of one UV peak (H(control)), thereby obtaining the integrity of the control RNA.

In this eighth example, the integrity of the RNA contained in the sample composition may be calculated by the following steps:

(c1′) determining from the UV signal obtained in step (b) the height of the sample UV peak corresponding to the control UV peak used in step (c″) (H(sample)); and

(c2′) determining the ratio between H(sample) and H(control), thereby obtaining the integrity of the RNA contained in the sample composition.

In one embodiment of the third aspect (in particular, in one embodiment of the first, second or third subgroup of the third aspect), the amount of nucleic acid (especially RNA) is determined by using (i) a nucleic acid extinction coefficient (especially an RNA extinction coefficient) or (ii) a nucleic acid calibration curve (especially an RNA calibration curve).

In one embodiment of the third aspect (in particular, in one embodiment of the first, second or third subgroup of the third aspect), the sample composition comprises nucleic acid (especially RNA) and particles, such as lipoplex particles and/or lipid nanoparticles and/or polyplex particles and/or lipopolyplex particles and/or virus-like particles, to which nucleic acid (especially RNA) is bound.

In one embodiment of the third aspect (in particular, in one embodiment of the first, second or third subgroup of the third aspect), the amount of total nucleic acid (especially RNA) is determined by (i) treating at least a part of the sample composition with a release agent; (ii) performing steps (a) to (c) with at least the part obtained from step (i); and (iii) determining the amount of nucleic acid (especially RNA) as specified herein (e.g., by using (i) a nucleic acid extinction coefficient (especially an RNA extinction coefficient) or (ii) a nucleic acid calibration curve (especially an RNA calibration curve)). In this embodiment, in step (a) of the method of the first aspect, the field-flow-fractionation is preferably performed using a liquid phase containing the release agent.

In one embodiment of the third aspect (in particular, in one embodiment of the first, second or third subgroup of the third aspect), the release agent is (i) a surfactant, such as an anionic surfactant (e.g., sodium dodecylsulfate), a zwitterionic surfactant (e.g., n-tetradecyl-N,N-dimethyl-3-ammonio-1-propanesulfonate (Zwittergent® 3-14)), a cationic surfactant, a non-ionic surfactant, or a mixture thereof; (ii) an alcohol, such as an aliphatic alcohol (e.g., ethanol), or a mixture of alcohols; or (iii) a combination of (i) and (ii).

In one embodiment of the third aspect (in particular, in one embodiment of the first, second or third subgroup of the third aspect), the amount of free nucleic acid (especially RNA) is determined by performing steps (a) to (c) without the addition of a release agent, in particular in the absence of any release agent; and determining the amount of nucleic acid (especially RNA) as specified herein (e.g., using (i) a nucleic acid extinction coefficient (especially an RNA extinction coefficient) or (ii) a nucleic acid calibration curve (especially an RNA calibration curve)).

In one embodiment of the third aspect (in particular, in one embodiment of the first, second or third subgroup of the third aspect), the amount of nucleic acid (especially RNA) bound to particles is determined by subtracting the amount of free nucleic acid (especially RNA) as determined herein (e.g., by performing steps (a) to (c) without the addition of a release agent, in particular in the absence of any release agent; and determining the amount of nucleic acid (especially RNA) as specified herein (e.g., using (i) a nucleic acid extinction coefficient (especially an RNA extinction coefficient) or (ii) a nucleic acid calibration curve (especially an RNA calibration curve))) from the amount of total nucleic acid (especially RNA) as determined herein (e.g., by (i) treating at least a part of the sample composition with a release agent; (ii) performing steps (a) to (c) with at least the part obtained from step (i); and (iii) determining the amount of nucleic acid (especially RNA) as specified herein (e.g., using (i) a nucleic acid extinction coefficient (especially an RNA extinction coefficient) or (ii) a nucleic acid calibration curve (especially an RNA calibration curve))).

In one embodiment of the third aspect (in particular, in one embodiment of the first, second or third subgroup of the third aspect), step (b) further comprises measuring the LS signal, such as the dynamic light scattering (DLS) signal and/or the static light scattering (SLS), e.g., multi-angle light scattering (MALS), signal, of least one of the one or more sample fractions obtained from step (a).

In one embodiment of the third aspect (in particular, in one embodiment of the first, second or third subgroup of the third aspect), the size of nucleic acid (especially RNA) containing particles is determined by calculating from the LS signal obtained from step (b) the radius of gyration (R_{g}) values and/or the hydrodynamic radius (Rₕ) values. In one embodiment of the third aspect (in particular, in one embodiment of the first, second or third subgroup of the third aspect), step (b) comprises measuring the dynamic light scattering (DLS) signal of least one of the one or more sample fractions obtained from step (a) and step (c) comprises calculating the Rₕ values from the DLS signal. In one embodiment of the third aspect (in particular, in one embodiment of the first, second or third subgroup of the third aspect), step (b) comprises measuring the static light scattering (SLS), e.g., MALS, signal of least one of the one or more sample fractions obtained from step (a), and step (c) comprises calculating the R_{g} values from the SLS signal. In one embodiment of the third aspect (in particular, in one embodiment of the first, second or third subgroup of the third aspect), step (b) comprises measuring the dynamic light scattering (DLS) signal and the static light scattering (SLS), e.g., MALS, signal of least one of the one or more sample fractions obtained from step (a) and step (c) comprises calculating the R_{g} and Rₕ values. This latter embodiment results in two data sets for the size of nucleic acid (such as RNA) containing particles, i.e., one based on the R_{g} values and one based on the Rₕ values.

In one embodiment of the third aspect (in particular, in one embodiment of the first, second or third subgroup of the third aspect), the size distribution of nucleic acid (especially RNA) containing particles is determined by plotting the at least one signal selected from the group consisting of the UV signal, the fluorescence signal, and the RI signal obtained from step (b) against the R_{g} or Rₕ values determined as specified herein (e.g., by calculating the R_{g} values from the SLS signal obtained from step (b) or by calculating the Rₕ values from the DLS signal obtained from step (b)). In a first example of this embodiment (relating to the first subgroup of the third aspect), the size distribution of nucleic acid (especially RNA) containing particles is determined by plotting the UV signal obtained from step (b) against the R_{g} or Rₕ values determined as specified herein (e.g., by calculating the R_{g} values from the SLS signal obtained from step (b) or by calculating the Rₕ values from the DLS signal obtained from step (b)). In a second example of this embodiment (relating to the second subgroup of the third aspect), the size distribution of RNA containing particles is determined by plotting the at least one signal selected from the group consisting of the UV signal, the fluorescence signal, and the RI signal obtained from step (b) against the R_{g} or Rₕ values determined as specified herein (e.g., by calculating the R_{g} values from the SLS signal obtained from step (b) or by calculating the Rₕ values from the DLS signal obtained from step (b)). In a third example of this embodiment (relating to the third subgroup of the third aspect), the size distribution of RNA containing particles is determined by plotting the UV signal obtained from step (b) against the R_{g} or Rₕ values determined as specified herein (e.g., by calculating the R_{g} values from the SLS signal obtained from step (b) or by calculating the Rₕ values from the DLS signal obtained from step (b)). In each of the above first, second and third examples, the size distribution of nucleic acid (especially RNA) containing particles can be determined on the basis of the R_{g} values, the Rₕ values or both. If the size distribution of nucleic acid (especially RNA) containing particles is determined on the basis of the R_{g} values and the Rₕ values, this results in two data sets, i.e., one size distribution based on the R_{g} values and one size distribution based on the Rₕ values.

In one embodiment of the third aspect (in particular, in one embodiment of the first, second or third subgroup of the third aspect), the quantitative size distribution of nucleic acid (especially RNA) containing particles is calculated from the plot showing the UV, fluorescence, or RI signal as function of the R_{g} or Rₕ values by transforming the UV, fluorescence, or RI signal into a cumulative weight fraction and plotting the cumulative weight fraction against the R_{g} or Rₕ values. In a first example of this embodiment (relating to the first subgroup of the third aspect), the quantitative size distribution of nucleic acid (especially RNA) containing particles is calculated from the plot showing the UV signal as function of the R_{g} or Rₕ values by transforming the UV signal into a cumulative weight fraction and plotting the cumulative weight fraction against the R_{g} or Rₕ values. In a second example of this embodiment (relating to the second subgroup of the third aspect), the quantitative size distribution of RNA containing particles is calculated from the plot showing the UV, fluorescence, or RI signal as function of the R_{g} or Rₕ values by transforming the UV, fluorescence, or RI signal into a cumulative weight fraction and plotting the cumulative weight fraction against the R_{g} or Rₕ values. In a third example of this embodiment (relating to the third subgroup of the third aspect), the quantitative size distribution of RNA containing particles is calculated from the plot showing the UV signal as function of the R_{g} or Rₕ values by transforming the UV signal into a cumulative weight fraction and plotting the cumulative weight fraction against the R_{g} or Rₕ values. In each of the above first, second and third examples, the quantitative size distribution of nucleic acid (especially RNA) containing particles can be determined on the basis of the R_{g} values, the Rₕ values or both. If the quantitative size distribution of nucleic acid (especially RNA) containing particles is determined on the basis of the R_{g} values and the Rₕ values, this results in two data sets, i.e., one quantitative size distribution based on the R_{g} values and one quantitative size distribution based on the Rₕ values.

In one embodiment of the third aspect (in particular, in one embodiment of the first, second or third subgroup of the third aspect), the quantitative size distribution includes D10, D50, and/or D90 values. If the quantitative size distribution of nucleic acid (especially RNA) containing particles is determined on the basis of the R_{g} values and the Rₕ values, this results in two data sets, i.e., one set of D10, D50, and/or D90 values based on the R_{g} values and one set of D10, D50, and/or D90 values based on the Rₕ values.

In one embodiment of the third aspect (in particular, in one embodiment of the first, second or third subgroup of the third aspect), the one or more parameters comprise (or are) at least two, preferably at least three, parameters as specified herein (including the additional optional parameters), in particular at least two, preferably at least three, parameters selected from the group consisting of: the amount of free nucleic acid (especially RNA), the amount of nucleic acid (especially RNA) bound to particles, the size distribution of nucleic acid (especially RNA) containing particles (in particular, based on the radius of gyration (R_{g}) of nucleic acid (especially RNA) containing particles and/or the hydrodynamic radius (Rₕ) of nucleic acid (especially RNA) containing particles), and the quantitative size distribution of nucleic acid (especially RNA) containing particles (e.g., based on R_{g} or Rₕ values). If the size distribution of nucleic acid (especially RNA) containing particles is determined on the basis of the R_{g} values and the Rₕ values, this results in two data sets, i.e., one based on the R_{g} values and one based on the Rₕ values. However, according to the present invention, these two data sets for the size distribution of nucleic acid (especially RNA) containing particles are only considered as one parameter (and not as two parameters). In addition, in case the fractogram obtained by the field-flow fractionation shows more than one particle peak, the determination of the size distribution for each of the particle peaks is only considered as one parameter (and not as one parameter for each of the particle peaks). The same applies to the situation where the quantitative size distribution of nucleic acid (especially RNA) containing particles is determined on the basis of the R_{g} values and the Rₕ values.

In one embodiment of the third aspect (in particular, in one embodiment of the first, second or third subgroup of the third aspect, in particular in a preferred embodiment of the third subgroup of the third aspect), the one or more parameters comprise the quantitative size distribution of nucleic acid (especially RNA) containing particles (e.g., based on the radius of gyration (R_{g}) of nucleic acid (especially RNA) containing particles and/or the hydrodynamic radius (Rₕ) of nucleic acid (especially RNA) containing particles) and optionally at least one parameter, such as at least two parameters, of the remaining parameters specified herein (including the additional optional parameters); preferably these remaining parameters are selected from the group consisting of: the amount of free nucleic acid (especially RNA), the amount of nucleic acid (especially RNA) bound to particles, and the size distribution of nucleic acid (especially RNA) containing particles (e.g., based on R_{g} or Rₕ values). In one embodiment of the third aspect (in particular, in one embodiment of the first, second or third subgroup of the third aspect, in particular in a preferred embodiment of the third subgroup of the third aspect), the one or more parameters comprise the quantitative size distribution of nucleic acid (especially RNA) containing particles (e.g., based on R_{g} or Rₕ values) and at least one parameter, such as at least two parameters, selected from the group consisting of: the amount of free nucleic acid (especially RNA), the amount of nucleic acid (especially RNA) bound to particles, and the size distribution of nucleic acid (especially RNA) containing particles (e.g., based on R_{g} or Rₕ values). In one embodiment of the third aspect (in particular, in one embodiment of the first, second or third subgroup of the third aspect, in particular in a preferred embodiment of the third subgroup of the third aspect), the one or more parameters comprise the quantitative size distribution of nucleic acid (especially RNA) containing particles (e.g., based on R_{g} or Rₕ values), the amount of free nucleic acid (especially RNA), and the amount of nucleic acid (especially RNA) bound to particles. If the quantitative size distribution of nucleic acid (especially RNA) containing particles is determined on the basis of the R_{g} values and the Rₕ values, this results in two data sets, i.e., one based on the R_{g} values and one based on the Rₕ values. However, according to the present invention, these two data sets for the quantitative size distribution of nucleic acid (especially RNA) containing particles are only considered as one parameter (and not as two parameters). In addition, in case the fractogram obtained by the field-flow fractionation shows more than one particle peak, the determination of the quantitative size distribution for each of the particle peaks is only considered as one parameter (and not as one parameter for each of the particle peaks). The same applies to the situation where the size distribution of nucleic acid (especially RNA) containing particles is determined on the basis of the R_{g} values and the Rₕ values.

In one embodiment of the third aspect (in particular, in one embodiment of the first, second or third subgroup of the third aspect), the one or more parameters are determined in one cycle of steps (a) to (c).

In one embodiment of the third aspect (in particular, in one embodiment of the first, second or third subgroup of the third aspect), the amount of nucleic acid (especially RNA), in particular free nucleic acid (especially RNA), is determined by measuring the UV signal, e.g., at a wavelength in the range of 260 nm to 280 nm, such as at a wavelength of 260 nm or 280 nm, and using the nucleic acid (especially RNA) extinction coefficient at the corresponding wavelength (e.g., 260 nm or 280 nm).

In one embodiment of the third aspect (in particular, in one embodiment of the first, second or third subgroup of the third aspect, in particular in a preferred embodiment of the third subgroup of the third aspect), the size distribution of nucleic acid (especially RNA) containing particles (e.g., based on the R_{g} or Rₕ values) and/or the quantitative size distribution of nucleic acid (especially RNA) containing particles (e.g., based on the R_{g} or Rₕ values) is/are within the range of 10 to 2000 nm, preferably within the range of 20 to 1500 nm, such as 30 to 1200 nm, 40 to 1100 nm, 50 to 1000, 60 to 900 nm, 70 to 800 nm, 80 to 700 nm, 90 to 600 nm, or 100 to 500 nm, or such as within the range of 10 to 1000 nm, 15 to 500 nm, 20 to 450 nm, 25 to 400 nm, 30 to 350 nm, 40 to 300 nm, or 50 to 250 nm. In a preferred embodiment of the third subgroup of the third aspect, the (quantitative) size distribution of RNA containing particles (e.g., based on R_{g} or Rₕ values) is within the range of 10 to 1000 nm, such as within the range of 15 to 500 nm, 20 to 450 nm, 25 to 400 nm, 30 to 350 nm, 40 to 300 nm, or 50 to 250 nm.

In one embodiment of the third aspect (in particular, in one embodiment of the first, second or third subgroup of the third aspect), the nucleic acid (especially RNA) has a length of 10 to 15,000 nucleotides, such as 40 to 15,000 nucleotides, 100 to 12,000 nucleotides or 200 to 10,000 nucleotides.

In one embodiment of the third aspect (in particular, in one embodiment of the first subgroup of the third aspect), the nucleic acid is RNA. In this embodiment and in the embodiments of the second or third subgroup of the third aspect, the RNA preferably is mRNA or in vitro transcribed RNA, in particular in vitro transcribed mRNA.

In one embodiment of the third aspect (in particular, in one embodiment of the first, second or third subgroup of the third aspect), measuring the at least one signal selected from the group consisting of the UV signal, the fluorescence signal, and the RI signal, optionally the LS signal, such as the SLS, e.g., MALS, signal and/or the DLS signal, is performed on-line and/or step (c) is performed on-line.

In one embodiment of the third aspect (in particular, in one embodiment of the first, second or third subgroup of the third aspect), before subjecting at least a part of the sample composition to field-flow fractionation, the at least part of the sample composition is diluted with a solvent or solvent mixture, said solvent or solvent mixture being able to prevent the formation of aggregates of the particles. In one embodiment, the solvent mixture is a mixture of water and an organic solvent, e.g., formamide.

In one embodiment of the third aspect (in particular, in one embodiment of the first, second or third subgroup of the third aspect), measuring the UV signal is performed by using circular dichroism (CD) spectroscopy.

It is understood that any embodiment described herein in the context of the first or second aspect may also apply to any embodiment of the third aspect.

Further embodiments are as follows:
1. A method for determining one or more parameters of a sample composition, wherein the sample composition comprises RNA and optionally particles, the method comprising:
   (a) subjecting at least a part of the sample composition to field-flow fractionation, thereby fractioning the components contained in the sample composition by their size so as to produce one or more sample fractions;
   (b) measuring at least the UV signal, and optionally the light scattering (LS) signal, of least one of the one or more sample fractions obtained from step (a); and
   (c) calculating from the UV signal, and optionally from the LS signal, the one or more parameters,
   wherein the one or more parameters comprise the RNA integrity, the total amount of RNA, the amount of free RNA, the amount of RNA bound to particles, the size of RNA containing particles, the size distribution of RNA containing particles, and the quantitative size distribution of RNA containing particles.
2. The method of item 1, wherein the field-flow fractionation is flow field-flow fractionation, such as asymmetric flow field-flow fractionation (AF4) or hollow fiber flow field-flow fractionation (HF5).
3. The method of item 1 or 2, wherein step (a) is performed using a membrane having a molecular weight (MW) cut-off suitable to prevent RNA from permeating the membrane, preferably a membrane having a MW cut-off in the range of from 2 kDa to 30 kDa, such as a MW cut-off of 10 kDa.
4. The method of any one of items 1 to 3, wherein step (a) is performed using a polyethersulfon (PES) or regenerated cellulose membrane.
5. The method of any one of items 1 to 4, wherein step (a) is performed using a cross flow rate of up to 8 mL/min, preferably up to 4 mL/min, more preferably up to 2 mL/min.
6. The method of any one of items 1 to 5, wherein step (a) is performed using the following cross flow rate profile: 1.0 to 2.0 mL/min for 10 min, an exponential gradient from 1.0 to 2.0 mL/min to 0.01 to 0.07 mL/min within 30 min; 0.01 to 0.07 mL/min for 30 min; and 0 mL/min for 10 min.
7. The method of any one of items 1 to 6, wherein step (a) is performed using an inject flow in the range of 0.05 to 0.35 mL/min, preferably in the range of 0.10 to 0.30 mL/min, more preferably in the range of 0.15 to 0.25 mL/min.
8. The method of any one of items 1 to 7, wherein step (a) is performed using a detector flow in the range of 0.30 to 0.70 mL/min, preferably in the range of 0.40 to 0.60 mL/min, more preferably in the range of 0.45 to 0.55 mL/min.
9. The method of any one of items 1 to 8, wherein the integrity of the RNA contained in the sample composition is calculated using the integrity of a control RNA.
10. The method of item 9, wherein the integrity of a control RNA is determined by the following steps:
   (a′) subjecting at least a part of a control composition containing control RNA to field-flow fractionation, in particular AF4 or HF5, thereby fractioning the components contained in the control composition by their size so as to produce one or more control fractions;
   (b′) measuring at least the UV signal of least one of the one or more control fractions obtained from step (a′);
   (c′1) calculating from the UV signal obtained in step (b′) the area from the maximum height of one UV peak to the end of the UV peak, thereby obtaining A_{50%}(control);
   (c′2) calculating from the UV signal obtained in step (b′) the total area of the one peak used in step (c′1), thereby obtaining A_{100%}(control); and
   (c′3) determining the ratio between A_{50%}(control) and A_{100%}(control), thereby obtaining the integrity of the control RNA (I(control)).
11. The method of item 10, wherein the integrity of the RNA contained in the sample composition is calculated by the following steps:
   (c1) calculating from the sample UV signal obtained from step (b) the area from the maximum height of the sample UV peak corresponding to the control UV peak used in step (c′1) to the end of the sample UV peak, thereby obtaining A_{50%}(sample);
   (c2) calculating from the sample UV signal obtained from step (b) the total area of the sample UV peak used in step (c1), thereby obtaining A_{100%}(sample);
   (c3) determining the ratio between A_{50%}(sample) and A_{100%}(sample), thereby obtaining I(sample); and
   (c4) determining the ratio between I(sample) and I(control), thereby obtaining the integrity of the RNA contained in the sample composition.
12. The method of item 9, wherein calculating the integrity of a control RNA is determined by the following steps:
   (a″) subjecting at least a part of a control composition containing control RNA to field-flow fractionation, in particular AF4 or HF5, thereby fractioning the components contained in the control composition by their size so as to produce one or more control fractions;
   (b″) measuring at least the UV signal of least one of the one or more control fractions obtained from step (a″); and
   (c″) determining from the UV signal obtained in step (b″) the height of one UV peak (H(control)), thereby obtaining the integrity of the control RNA.
13. The method of item 12, wherein the integrity of the RNA contained in the sample composition is calculated by the following steps:
   (c1′) determining from the UV signal obtained in step (b) the height of the sample UV peak corresponding to the control UV peak used in step (c″) (H(sample)); and
   (c2′) determining the ratio between H(sample) and H(control), thereby obtaining the integrity of the RNA contained in the sample composition.
14. The method of any one of items 1 to 13, wherein the amount of RNA is determined by using (i) an RNA extinction coefficient or (ii) an RNA calibration curve.
15. The method of any one of items 1 to 14, wherein the sample composition comprises RNA and particles, such as lipoplex particles and/or lipid nanoparticles and/or polyplex particles and/or lipopolyplex particles and/or virus-like particles, to which RNA is bound.
16. The method of item 15, wherein the amount of total RNA is determined by (i) treating at least a part of the sample composition with a release agent; (ii) performing steps (a) to (c) with at least the part obtained from step (i); and (iii) determining the amount of RNA as specified in item 14.
17. The method of item 16, wherein in step (a) the field-flow-fractionation is performed using a liquid phase containing the release agent.
18. The method of item 16 or 17, wherein the release agent is (i) a surfactant, such as an anionic surfactant (e.g., sodium dodecylsulfate), a zwitterionic surfactant (e.g., n-tetradecyl-N,N-dimethyl-3-ammonio-1-propanesulfonate (Zwittergent® 3-14)), a cationic surfactant, a non-ionic surfactant, or a mixture thereof; (ii) an alcohol, such as an aliphatic alcohol (e.g., ethanol), or a mixture of alcohols; or (iii) a combination of (i) and (ii).
19. The method of any one of items 15 to 18, wherein the amount of free RNA is determined by performing steps (a) to (c) without the addition of a release agent, in particular in the absence of any release agent; and determining the amount of RNA as specified in item 14.
20. The method of any one of items 15 to 19, wherein the amount of RNA bound to particles is determined by subtracting the amount of free RNA as determined by item 19 from the amount of total RNA as determined by any one of items 16 to 18.
21. The method of any one of items 15 to 20, wherein step (b) further comprises measuring the LS signal, such as the dynamic light scattering (DLS) signal and/or the static light scattering (SLS), e.g., multi-angle light scattering (MALS), signal, of least one of the one or more sample fractions obtained from step (a).
22. The method of item 21, wherein the size of RNA containing particles is determined by calculating from the LS signal obtained from step (b) the radius of gyration (R_{g}) values and/or the hydrodynamic radius (Rₕ) values.
23. The method of item 21, wherein the experimentally determined R_{g} and/or Rₕ values are smoothed, preferably by fitting the experimentally determined or calculated R_{g} or Rₕ values to a polynomial or linear function and recalculating the R_{g} or Rₕ values based on the polynomial or linear fit.
24. The method of any one of items 21 to 23, wherein the size distribution of RNA containing particles is determined by plotting the UV signal obtained from step (b) against the R_{g} or Rₕ values determined as specified in item 22.
25. The method of any one of items 21 to 24, wherein the quantitative size distribution of RNA containing particles is calculated from the plot showing the UV signal as function of the R_{g} values by transforming the UV signal into a cumulative weight fraction and plotting the cumulative weight fraction against the R_{g} or Rₕ values.
26. The method of item 25, wherein the quantitative size distribution includes D10, D50, and/or D90 values.
27. The method of any one of items 22 to 26, wherein step (b) comprises measuring the dynamic light scattering (DLS) signal of least one of the one or more sample fractions obtained from step (a) and step (c) comprises calculating the Rₕ values from the DLS signal.
28. The method of any one of items 15 to 27, wherein the one or more parameters comprise (or are) at least two, preferably at least three, parameters selected from the group consisting of: the amount of free RNA, the amount of RNA bound to particles, the size distribution of RNA containing particles, and the quantitative size distribution of RNA containing particles.
29. The method of any one of items 15 to 28, wherein the amount of RNA, in particular free RNA, is determined by measuring the UV signal at 260 nm and using the RNA extinction coefficient at 260 nm or by measuring the UV signal at 280 nm and using the RNA extinction coefficient at 280 nm.
30. The method of any one of items 1 to 29, wherein the size distribution of RNA containing particles and/or the quantitative size distribution of RNA containing particles is/are within the range of 20 to 1500 nm, such as 30 to 1200 nm, 40 to 1100 nm, 50 to 1000, 60 to 900 nm, 70 to 800 nm, 80 to 700 nm, 90 to 600 nm, or 100 to 500 nm, such as within the range of 10 to 1000 nm, 15 to 500 nm, 20 to 450 nm, 25 to 400 nm, 30 to 350 nm, 40 to 300 nm, or 50 to 250 nm.
31. The method of any one of items 1 to 30, wherein the RNA has a length of 10 to 15,000 nucleotides, such as 40 to 15,000 nucleotides, 100 to 12,000 nucleotides or 200 to 10,000 nucleotides.
32. The method of any one of items 1 to 31, wherein the RNA is in vitro transcribed RNA, in particular in vitro transcribed mRNA.
33. The method of any one of items 1 to 32, wherein measuring the UV signal, optionally the LS signal, such as the SLS, e.g., MALS, signal and/or the DLS signal, is performed on-line and/or step (c) is performed on-line.
34. The method of any one of items 15 to 33, wherein before subjecting at least a part of the sample composition to field-flow fractionation, the at least part of the sample composition is diluted with a solvent or solvent mixture, said solvent or solvent mixture being able to prevent the formation of aggregates of the particles.
35. The method of item 34, wherein the solvent mixture is a mixture of water and an organic solvent, e.g., formamide.
35a. The method of any one of items 1 to 35, wherein measuring the UV signal is performed by using circular dichroism (CD) spectroscopy.
36. A method of analyzing the effect of altering one or more reaction conditions when providing a composition comprising RNA and optionally particles, the method comprising:
   (A) providing a first composition comprising RNA and optionally particles;
   (B) providing a second composition comprising RNA and optionally particles, wherein the provision of the second composition differs from the provision of the first composition only in the one or more reaction conditions;
   (C) subjecting a part of the first composition to a method of any one of items 1 to 35 and 35a, thereby determining one or more parameters of the first composition;
   (D) subjecting a corresponding part of the second composition to the method used in step (C), thereby determining one or more parameters of the second composition; and
   (E) comparing the one or more parameters of the first composition obtained in step (C) with the corresponding one or more parameters of the second composition obtained in step (D).
37. The method of item 36, wherein the one or more reaction conditions comprise any of the following: salt concentration/ionic strength (e.g., 2 mM NaCl or 100 mM NaCl); temperature (e.g., low temperature (such as −20° C.) or high temperature (such as 50° C.)); pH or buffer concentration; light/radiation; oxygen; shear force; pressure; freezing/thawing cycle; drying/reconstitution cycle; addition of excipient(s) (e.g., stabilizer and/or chelating agent); type and/or source of particle forming compounds (in particular lipids and/or polymers, e.g., cationic lipid vs. cationic polymer, cationic lipid vs. zwitterionic lipid, or pegylated lipid vs. unpegylated lipid); charge ratio; physical state; and ratio of RNA to particle forming compounds (in particular lipids and/or polymers).
38. Use of field-flow-fractionation for determining one or more parameters of a sample composition comprising RNA and optionally particles, wherein the one or more parameters comprise the RNA integrity, the total amount of RNA, the amount of free RNA, the amount of RNA bound to particles, the size of RNA containing particles (such as the hydrodynamic radius of RNA containing particles), the size distribution of RNA containing particles, and the quantitative size distribution of RNA containing particles.
39. The use of item 38, wherein the field-flow fractionation comprises:
   (a) subjecting at least a part of the sample composition to field-flow fractionation, thereby fractioning the components contained in the sample composition by their size so as to produce one or more sample fractions;
   (b) measuring at least the UV signal, and optionally the light scattering (LS) signal, of least one of the one or more sample fractions obtained from step (a); and
   (c) calculating from the UV signal, and optionally from the LS signal, the one or more parameters.
40. The use of item 38 or 39, wherein the field-flow fractionation is flow field-flow fractionation, such as asymmetric flow field-flow fractionation (AF4) or hollow fiber flow field-flow fractionation (HF5).
41. The use of any one of items 38 to 40, wherein the field-flow-fractionation uses a membrane having a molecular weight (MW) cut-off suitable to prevent RNA from permeating the membrane, preferably a membrane having a MW cut-off in the range of from 2 kDa to 30 kDa, such as a MW cut-off of 10 kDa.
42. The use of any one of items 38 to 41, wherein the field-flow-fractionation uses a polyethersulfon (PES) or regenerated cellulose membrane.
43. The use of any one of items 39 to 42, wherein step (a) is performed using
   (I) a cross flow rate of up to 8 mL/min, preferably up to 4 mL/min, more preferably up to 2 mL/min, such as the following cross flow rate profile: 1.0 to 2.0 mL/min for 10 min, an exponential gradient from 1.0 to 2.0 mL/min to 0.01 to 0.07 mL/min within 30 min; 0.01 to 0.07 mL/min for 30 min; and 0 mL/min for 10 min; and/or
   (II) an inject flow in the range of 0.05 to 0.35 mL/min, preferably in the range of 0.10 to 0.30 mL/min, more preferably in the range of 0.15 to 0.25 mL/min; and/or
   (III) a detector flow in the range of 0.30 to 0.70 mL/min, preferably in the range of 0.40 to 0.60 mL/min, more preferably in the range of 0.45 to 0.55 mL/min.
44. The use of any one of items 38 to 43, wherein the integrity of the RNA contained in the sample composition is determined using the integrity of a control RNA.
45. The use of item 44, wherein the integrity of a control RNA is determined by the following steps:
   (a′) subjecting at least a part of a control composition containing control RNA to field-flow fractionation, in particular AF4 or HF5, thereby fractioning the components contained in the control composition by their size so as to produce one or more control fractions;
   (b′) measuring at least the UV signal of least one of the one or more control fractions obtained from step (a′);
   (c′1) calculating from the UV signal obtained in step (b′) the area from the maximum height of one UV peak to the end of the UV peak, thereby obtaining A_{50%}(control);
   (c′2) calculating from the UV signal obtained in step (b′) the total area of the one peak used in step (c′1), thereby obtaining A_{100%}(control); and
   (c′3) determining the ratio between A_{50%}(control) and A_{100%}(control), thereby obtaining the integrity of the control RNA (I(control)).
46. The use of item 45, wherein the integrity of the RNA contained in the sample composition is calculated by the following steps:
   (c1) calculating from the sample UV signal obtained from step (b) the area from the maximum height of the sample UV peak corresponding to the control UV peak used in step (c′1) to the end of the sample UV peak, thereby obtaining A_{50%}(sample);
   (c2) calculating from the sample UV signal obtained from step (b) the total area of the sample UV peak used in step (c1), thereby obtaining A_{100%}(sample);
   (c3) determining the ratio between A_{50%}(sample) and A_{100%}(sample), thereby obtaining I(sample); and
   (c4) determining the ratio between I(sample) and I(control), thereby obtaining the integrity of the RNA contained in the sample composition.
47. The use of item 44, wherein calculating the integrity of a control RNA is determined by the following steps:
   (a″) subjecting at least a part of a control composition containing control RNA to field-flow fractionation, in particular AF4 or HF5, thereby fractioning the components contained in the control composition by their size so as to produce one or more control fractions;
   (b″) measuring at least the UV signal of least one of the one or more control fractions obtained from step (a″); and
   (c″) determining from the UV signal obtained in step (b″) the height of one UV peak (H(control)), thereby obtaining the integrity of the control RNA.
48. The use of item 47, wherein the integrity of the RNA contained in the sample composition is calculated by the following steps:
   (c1′) determining from the UV signal obtained in step (b) the height of the sample UV peak corresponding to the control UV peak used in step (c″) (H(sample)); and
   (c2′) determining the ratio between H(sample) and H(control), thereby obtaining the integrity of the RNA contained in the sample composition.
49. The use of any one of items 38 to 48, wherein the amount of RNA is determined by using (i) an RNA extinction coefficient or (ii) an RNA calibration curve.
50. The use of any one of items 39 to 49, wherein the sample composition comprises RNA and particles, such as lipoplex particles and/or lipid nanoparticles and/or polyplex particles and/or lipopolyplex particles and/or virus-like particles, to which RNA is bound and/or within which RNA is contained.
51. The use of item 50, wherein the amount of total RNA is determined by (i) treating at least a part of the sample composition with a release agent; (ii) performing steps (a) to (c) with at least the part obtained from step (i); and (iii) determining the amount of RNA as specified in item 49.
52. The use of item 51, wherein in step (a) the field-flow-fractionation is performed using a liquid phase containing the release agent.
53. The use of item 51 or 52, wherein the release agent is (i) a surfactant, such as an anionic surfactant (e.g., sodium dodecylsulfate), a zwitterionic surfactant (e.g., n-tetradecyl-N,N-dimethyl-3-ammonio-1-propanesulfonate (Zwittergent® 3-14)), a cationic surfactant, a non-ionic surfactant, or a mixture thereof; (ii) an alcohol, such as an aliphatic alcohol (e.g., ethanol), or a mixture of alcohols; or (iii) a combination of (i) and (ii).
54. The use of any one of items 50 to 53, wherein the amount of free RNA is determined by performing steps (a) to (c) without the addition of a release agent, in particular in the absence of any release agent; and determining the amount of RNA as specified in item 49.
55. The use of any one of items 50 to 54, wherein the amount of RNA bound to particles is determined by subtracting the amount of free RNA as determined by item 53 from the amount of total RNA as determined by any one of items 51 to 53.
56. The use of any one of items 50 to 55, wherein step (b) further comprises measuring the LS signal, such as the dynamic light scattering (DLS) signal and/or the static light scattering (SLS), e.g., multi-angle light scattering (MALS), signal, of least one of the one or more sample fractions obtained from step (a).
57. The use of item 56, wherein the size of RNA containing particles is determined by calculating from the LS signal obtained from step (b) the radius of gyration (R_{g}) values and/or the hydrodynamic radius (Rₕ) values.
58. The use of item 57, wherein the experimentally determined R_{g} and/or Rₕ values are smoothed, preferably by fitting the experimentally determined or calculated R_{g} or Rₕ values to a polynomial or linear function and recalculating the R_{g} or Rₕ values based on the polynomial or linear fit.
59. The use of any one of items 56 to 58, wherein the size distribution of RNA containing particles is determined by plotting the UV signal obtained from step (b) against the R_{g} or Rₕ values determined as specified in item 57.
60. The use of any one of items 56 to 59, wherein the quantitative size distribution of RNA containing particles is calculated from the plot showing the UV signal as function of the R_{g} or Rₕ values by transforming the UV signal into a cumulative weight fraction and plotting the cumulative weight fraction against the R_{g} or Rₕ values.
61. The use of item 60, wherein the quantitative size distribution includes D10, D50, and/or D90 values.
62. The use of any one of items 57 to 61, wherein step (b) further comprises measuring the dynamic light scattering (DLS) signal of least one of the one or more sample fractions obtained from step (a) and step (c) comprises calculating the Rₕ values from the DLS signal.
63. The use of any one of items 50 to 62, wherein the one or more parameters comprise (or are) at least two, preferably at least three, parameters selected from the group consisting of: the amount of free RNA, the amount of RNA bound to particles, the size distribution of RNA containing particles, and the quantitative size distribution of RNA containing particles.
64. The use of any one of items 50 to 63, wherein the amount of RNA, in particular free RNA, is determined by measuring the UV signal at 260 nm and using the RNA extinction coefficient at 260 nm or by measuring the UV signal at 280 nm and using the RNA extinction coefficient at 280 nm.
65. The use of any one of items 38 to 64, wherein the size distribution of RNA containing particles and/or the quantitative size distribution of RNA containing particles is/are within the range of 20 to 1500 nm, such as 30 to 1200 nm, 40 to 1100 nm, 50 to 1000, 60 to 900 nm, 70 to 800 nm, 80 to 700 nm, 90 to 600 nm, or 100 to 500 nm, such as within the range of 10 to 1000 nm, 15 to 500 nm, 20 to 450 nm, 25 to 400 nm, 30 to 350 nm, 40 to 300 nm, or 50 to 250 nm.
66. The use of any one of items 38 to 64, wherein the RNA has a length of 10 to 15,000 nucleotides, such as 40 to 15,000 nucleotides, 100 to 12,000 nucleotides or 200 to 10,000 nucleotides.
67. The use of any one of items 38 to 65, wherein the RNA is in vitro transcribed RNA, in particular in vitro transcribed mRNA.
68. The use of any one of items 39 to 67, wherein measuring the UV signal, optionally the LS signal, such as the SLS, e.g., MALS, signal and/or the DLS signal, is performed on-line and/or step (c) is performed on-line.
69. The use of any one of items 39 to 68, wherein before subjecting at least a part of the sample composition to field-flow fractionation, the at least part of the sample composition is diluted with a solvent or solvent mixture, said solvent or solvent mixture being able to prevent the formation of aggregates of the particles.
70. The use of item 69, wherein the solvent mixture is a mixture of water and an organic solvent, e.g., formamide.
70a. The use of any one of items 39 to 70, wherein measuring the UV signal is performed by using circular dichroism (CD) spectroscopy.

In a fourth aspect, the present disclosure provides a data-processing apparatus/system comprising means for carrying out any of the methods of the present disclosure, in particular the method of the first aspect (e.g., the methods as defined in any one of items 1 to 35 and 35a) and/or the method of the second aspect (e.g., the method as defined in item 36 or 37).

In a fifth aspect, the present disclosure provides a computer program adapted to perform any of the methods of the present disclosure, in particular the method of the first aspect (e.g., the methods as defined in any one of items 1 to 35 and 35a) and/or the method of the second aspect (e.g., the method as defined in item 36 or 37).

In a sixth aspect, the present disclosure provides a computer-readable storage medium or data carrier comprising the program of the fifth aspect of the present disclosure.

Further aspects of the present disclosure are disclosed herein.

### BRIEF DESCRIPTION OF THE FIGURES

FIG. 1 shows a time-flow profile of an asymmetric flow field-flow fractionation (AF4) separation, where detector flow (Vd) was 0.5 mL/min and cross flow (Vx) start point 1.5 mL/min and was exponentially decreased to 0.04 mL/min.

FIG. 2 shows an overview of preferred calculation procedures for the estimation of the relative RNA integrity. Examples of AF4 fractograms are shown with UV Signal at 260 nm after separating the RNA. A) Limits for the calculation of the control RNA. B) Limits for the calculation of the total RNA peak area. C) Limits for the calculation of a slightly degraded RNA. D) Limits for the calculation of the total slightly degraded RNA peak area.

FIG. 3 shows a quantification of RNA without using a standard: A) Different injection volumes of a RNA stock solution were analyzed by AF4-UV-RI. The peak areas under the curve (UV full line; RI dashed line) were plotted against the injected volumes and a linear regression was fitted. B) Serial dilutions of an RNA were measured with the identical injection volumes by AF4-UV-RI and analyzed as in A).

FIG. 4 shows a quantification of degraded RNAs using AF4-UV-RI and without using a standard: A) Representative AF4 fractograms of different heat-degraded RNAs and untreated RNA are depicted (the curves represent UV signals at 260 nm). B) The UV signal of different degraded RNA is directly correlated to the concentration, applying Lambert-Beer's law.

FIG. 5 shows a representative fractogram obtained from sample particle compositions (containing lipid and RNA in a molar ratio of 1.3/2) separated by the AF4 method disclosed herein. The solid line represents the light scattering (LS) signal at an angle of 90° and indicates the particle peak (t=˜35 min), whereas the dashed line represents the UV signal (recorded at 260 nm) and reflects bound (t=˜38 min) and unbound RNA (t=˜20 min).

FIG. 6 shows quantitative RNA integrity measurements of non-formulated RNAs: A) Representative AF4 fractograms of different heat-degraded RNAs (n=3; the curves represent UV signals at 260 nm). B) Overview of the mean calculated relative integrity of four heat-degraded RNAs differing in their lengths (RNA #1-4; size: 986 to 1688 nt). Error bars represent the standard deviation (n=3). C) Representative AF4 fractograms obtained from RNA #2 using different ratios (untreated, completely heat-degraded and a 50:50 mixture of untreated with completely heat-degraded). D) Verification experiments: different RNAs (RNA #1-3, 986 to 1688 nt) were heat-degraded, mixed in a defined manner (for AF4 fractograms of mixture 4, see FIG. 6C) and analyzed by AF4-UV measurements. Bar diagrams represent the relative RNA integrities determined with the AF4 method disclosed herein (dark, middle and light gray bars) in comparison to the theoretical calculated values (black bars).

FIG. 7 demonstrates the suitability of the UV signal for quantifying RNA (proof of concept) in comparison to the quantification of RNA using a fluorescent dye. A) UV peaks as well as fluorescence (FS) integrals of sample compositions (comprising RNA and fluorescently labeled particles) were correlated to corresponding total RNA amount in the sample compositions. B) Calculated ratios of UV to FS peak area of the sample compositions were found to be constant over a wide mass range (1-15 μg total RNA in the sample compositions).

FIG. 8 shows the UV ratio as a parameter for RNA sample compositions. A) UV peak integrals of free RNA as well as RNA bound to the particles are correlated to the corresponding nominal total RNA amount contained in the sample composition. B) Calculation of the UV ratio of free RNA (peak) to bound RNA (peak).

FIG. 9 shows the proof of concept for the quantification of particle size distribution by AF4-UV-MALS. A) Representative AF4 fractograms of sample compositions (RNA and Atto594-labeled particles): the dashed line represents the UV traces recorded at 260 nm and the solid line represents the fluorescence signal (FS) emitted at 624 nm. B) The UV/FS ratio (dashed line) is calculated and plotted against the radius of gyration (R_{g}) and the recorded UV signal (highlighted grey peak) from the particle peak fraction (elution time: 22-60 min). The R_{g} area which has a variation below 50% of the UV/FS ratio is highlighted (boxes). In the R_{g} range between 50 and 300 nm the variation of the UV/FS ratio is small and gives reliable size values. Smaller R_{g} values are affected by the RNA signal. Larger R_{g} values are affected by scattering. In total these affected R_{g} values are below 10% of the total signal quantities. C) Calculation of quantitative quality parameter (D10, D50, D90) based on a cumulative weight fraction analysis using fluorescence emission at 624 nm and UV signal at 260 nm.

FIG. 10 shows a representative AF4 fractogram of sample compositions (RNA and particles) with LS signal at 90° and UV detection at 260 nm. Calculated radius of gyration (R_{g}) values (gray squares) are derived from multi angle light scattering (MALS) using Berry plot and hydrodynamic radius (Rₕ) values are derived from on-line dynamic light scattering (DLS; gray circles).

FIG. 11 shows the quantification of particle size distribution in complex sample compositions by using AF4-UV-MALS. A) AF4-UV-MALS elution profiles of sample compositions (RNA and particles), UV signal at 260 nm (dashed line) for RNA detection and light scattering signal at 90° (solid line) are depicted. Corresponding radius of gyration (R_{g}) values from the MALS signals are shown as black dots. B) The experimentally determined RMS values of the particle peak (elution time: 26-55 min) are fitted to a polynomial equation (light gray line). C) UV signal (solid line) is plotted as a function of the polynomial fitted R_{g} values (see FIG. 11B) and the corresponding cumulative weight fraction is plotted as a function of the UV signal (dashed line).

FIG. 12 shows the separation and qualitative analysis of different sample compositions (prepared by mixing lipid and RNA at different lipid/RNA ratios (0.1-0.9) with 100 mM NaCl) using the AF4 method disclosed herein. A) For each of the different sample compositions, the UV signal (at 260 nm), the light scattering signal (at 90°), and the corresponding radius of gyration (R_{g}) value, calculated using Berry plot, are shown overlaid. B) R_{g} values, calculated from the MALS signals, are plotted versus the appropriate cumulative weight fraction analysis, followed by calculation of the corresponding D90 values. C) R_{g}(D90) values, derived from the cumulative weight fraction analysis, are plotted as a function of lipid/RNA ratio with 100 mM NaCl (black dots) or without NaCl (open dots)).

FIG. 13 shows an estimation of the “shape factor” by correlating of hydrodynamic radius (Rₕ) values against R_{g} values. The values fit the linear regression and the resulting slope provides the information on the particle shape.

FIG. 14 shows the separation and characterization of diverse particle compositions (LPX, LNP, polyplex particles (PLX), liposomes, VLPs+LPX) by the AF4 method disclosed herein. Shown is the AF4-UV-MALS-DLS separation/detection. LS at 90° angle is depicted as solid lines and indicates the particle peaks. Dashed lines represent the UV signal (for the RNA detection) recorded at 260 nm. Radius of gyration (R_{g}) values (dark dots) are derived from multi angle light scattering (MALS) signals using Zimm plot. Dynamic light scattering (DLS; gray dots) provides hydrodynamic radius (Rₕ). The individual particle peak fractions are highlighted by gray bars. A) Representative fractogram of an LPX sample containing lipid and RNA in a molar ratio of 1.3/2 after AF4-UV-MALS-DLS separation/detection. B) Representative fractogram of a composition comprising two types of particles (short RNA-LPX:VLP, 1:1 mixture). C) Representative fractogram of a liposome sample (positively charged liposomes, composed of DOTMA and DOPE in a molar ratio of 2/1). D) Representative fractogram of a LPX sample (positively charged LPX, containing DOTMA and cholesterol, and RNA in a molar ratio of 4/1). E) Representative fractogram of lipid nanoparticle (LNPs) samples, composed of DODMA, cholesterol, DOPE, PEG (in a molar ratio of 1.2/1.44/0.3/0.06) and RNA in a molar ratio of 3/1. F) Representative fractogram of particles, containing JetPEI polymer and IVT-RNA or saRNA in a particle to RNA ratio of 12/1.

FIG. 15 shows an analysis of the RNA behavior in the presence of ions (sodium chloride). Exemplary AF4 fractograms (light scattering signals at 90° are shown) from non-formulated RNA in different sodium chloride concentrations (0-50 mM) are depicted. Radius of gyration (R_{g}) values are derived from multi-angle light scattering (MALS) using Zimm plot.

FIG. 16 shows the characterization of RNA after treatment with sodium chloride. A) The R_{g}(D50) values, derived from the cumulative weight fraction analysis, for different sodium chloride concentrations (0-50 mM) are shown. B) The RNA R_{g}(D50) values (from FIG. 16A) were plotted against the sodium chloride concentration and the ratios (mM sodium chloride vs. nm R_{g}) were calculated. Linear fitting of the ratio from 0 to 10 mM NaCl values are represented by bold lines, whereas dotted lines represent the fitting from 10 to 50 mM NaCl. Gray and black lines represent examples of measurements with two different RNA concentrations.

FIG. 17 shows the quantification of the free/unbound RNA in complex sample compositions. A) Using the AF4 method disclosed herein different amounts of free RNA (1-15 μg) were detected by the UV absorption at 260 nm in composition without particles. The RNA amounts were plotted versus the respective UV peak area under the curve (AUC*min) to generate a linear calibration curve. B) Varying amounts of particle compositions (containing 1-15 μg total RNA) were analyzed by the AF4 method. Overlaid AF4 fractograms show UV signals at 260 nm. The first peak (elution time: ˜20 min) corresponds to the free RNA, whereas the second peak (elution time: ˜38 min) corresponds to the particles (bound RNA). The amount of free, unbound RNA in particle compositions can be calculated in the relation to the reference RNA (=100%) (see FIG. 17A). C) To show linearity of the method, the UV peak integrals of the free RNA (see FIG. 17B) as well as the reference, naked RNA (see FIG. 17A) are plotted as a function of different RNA amounts (1-15 μg). D) As a second, preferred procedure (direct method) for the quantification of the free RNA, the unbound RNA peak is defined and the RNA amount can be directly calculated using the specific extinction coefficient of RNA.

FIG. 18 shows the analysis of the free RNA amount in sample compositions with different physicochemical behavior. A) AF4-UV fractograms of particle compositions ((DOTMA/DOPE 2/1)/RNA complexes mixed at variable charge ratios (0.1-0.9)) without NaCl or B) particle compositions with 100 mM NaCl are depicted. C) Plot of percentage (mol/mol) of the calculated, unbound RNA with 100 mM NaCl (black circles) and without NaCl (open circles) using the AF4-UV-detection at 260 nm. All mixtures were prepared in duplicates and measured at least in duplicates. Error bars represents standard deviation. D) Plot of unbound RNA concentration (μg/mL) with 100 mM NaCl (black circles) and without NaCl (open circles) calculated by using the extinction coefficient of RNA at 260 nm.

FIG. 19 shows the quantification of total RNA in particle compositions. A) AF4 fractogram of Zwittergent treated, naked RNA separated by the AF4 method disclosed herein. The UV signal at 260 nm is represented by the black line and the LS signal at 90° is represented by the dashed line. B) Representative fractograms of particle compositions with UV detection (solid line), with free RNA (highlighted in grey) and bound RNA (second peak), LS signal at 90° angle (dashed line). C) Corresponding AF4 fractogram of an RNA composition, in which the particles have been dissolved using a release agent (the liquid phase contained 0.1% Zwittergent), with UV detection (solid line) and light scattering at 90° (dashed line). D) Direct quantification of the naked RNA and total RNA after treatment with the release agent (Zwittergent).

FIG. 20 shows the integrity of free RNA and total RNA in sample compositions containing RNA and particles. A) UV traces of separated particles with RNAs differing in the RNA integrity using the AF4 method disclosed herein (untreated RNA: black solid line; partially heat-degraded RNA: dotted line; mixture (mixed in a defined manner 50% of untreated and 50% of completely degraded): dashed line; completely degraded RNA in particles: solid grey line). B) Quantification of intact free RNA (dark grey) as well as of total (black) and completely degraded (light gray) free RNA in particles. C) UV traces of dissolved particles after AF4 separation (using a release agent in the liquid phase). D) Determined integrities analyzed by AF4-UV measurements of free and total RNA in particles. Bar diagrams represent the relative RNA integrities of free RNA (gray bars) in comparison to the determined integrities of total RNA values in particles (black bars).

FIG. 21 shows a scheme how the different fractions of RNA (total, bound, encapsulated, accessible, surface, and unbound RNA) can be determined by the AF4 method disclosed herein. For example, the AF4 method can be used for quantification of the accessible RNA and/or surface RNA using fluorescence emission signal of an intercalating dye (e.g., GelRED). The combination of quantification of the free (unbound), total and accessible RNA can be used to calculate the encapsulated, bound and surface RNA. The fluorescence emission of GelRED at 600 nm is enhanced by intercalation into RNA.

FIG. 22 shows (A) the linearity of fluorescence detection using the AF4 method disclosed herein; (B) bar diagrams showing the relative amounts of accessible (black bars) and encapsulated (grey bars) RNA; and (C) a comparison of the relative amounts of free RNA in particle compositions, wherein the amounts have been determined using different RNA detections: UV absorption at 260 nm (black bars) and fluorescence emission signal at 600 nm (FS) (grey bars).

FIG. 23 shows an analysis of RNA integrity with the AF4 method disclosed herein without using a reference RNA. A) Shown is an exemplary AF4 fractogram of a long saRNA with the LS signal at 90° (dotted line) and UV signal at 260 nm (solid line). The bold dark line represents the molecular weight curve derived from the MALS signal. B) For better overview, only the molecular weight curve from (A) is shown as solid line in the upper panel of FIG. 23B. The limits for the total RNA peak (peak 1) are set based on the total UV peak signal (i.e., from t=10 min to t=40 min). Here, the limits for the “intact” RNA peak (peak 2) are set by the first derivative from the molecular weight curve (derived form MALS) as follows. The first derivative from the molecular weight curve is calculated (dotted line in the lower panel of FIG. 23B). The more horizontal part of the molecular weight curve reflects the retention time, where the fraction of undegraded RNA is present. On this basis, integration limits can be selected, and the amount of undegraded RNA in the sample can be calculated.

FIG. 24 shows a quantitative analysis of free and bound RNA using UV for the determination of the particle size distribution, in particular the cumulative RNA weight fraction, the RNA mass in the RNA lipoplex (LPX) fractions, and the RNA copies per LPX fraction. A) Shown is a representative AF4 fractogram for an RNA LPX sample composition with the LS signal at 90° (solid line) and the UV signal at 260 nm (dashed line). The UV signal shows two peaks, wherein the first peak represents the amount of free, unbound RNA and the second peak results from the LPX nanoparticles comprising RNA. The UV signal is directly representative for the RNA amount in the different fractions, as a function of elution time. The radius of gyration (R_{g}; bold line) is derived from the MALS signal. B) Shown are the UV signal at 260 nm (dashed line) from FIG. 24A and, as solid line, the cumulative weight fraction based on the area under the UV signal. C) Shown is the RNA amount bound in the RNA LPX sample composition by using the absorption at 260 nm in the different R_{g} fractions (Δt=1 min) including particles of a certain size. For the calculation of the RNA amount of different R_{g} fractions only the LPX peak (i.e., the second peak of FIGS. 24A and 24B starting at t=˜24 min and ending at t=˜60 min) was used. D) Shown is the number of calculated RNA copies per R_{g} fraction (bars, left y-axis) calculated from the results presented in FIG. 24C. The calculated particle number per R_{g} fraction is represented by a corresponding dot-line curve (second right y-axis).

FIG. 25 shows the feasibility of using circular dichroism (CD) spectroscopy in the AF4 method disclosed herein. A) Shown is a representative AF4 fractogram for an RNA lipoplex (LPX) formulation with the LS signal at 90° angle (solid line) and the CD signal recorded at 260 nm (dotted line), wherein the latter represents the unbound RNA (first peak; t=18 min) and the bound RNA (second peak; t=35 min). B) Calibration curves of naked RNA were generated using UV detection at 260 nm as well as CD detection at 260 nm in parallel. The peak areas under the curve (CD: filled squares and solid line; UV: filled triangles and dotted line) are plotted against the injected RNA amount. The ratio of the peak areas of CD and UV signals is shown as dots (second right y-axis). C) Different amounts of RNA LPX sample (2 to 15 μg) were analyzed using the AF4 method. The area under the curve (AUC) of the CD signal from the appropriate naked RNA was correlated to the appropriate total AUC CD signal, wherein the respective CD peak AUC values were plotted against the amounts of RNA, resulting in a linearly fitting (R²=0.998). The relative amount (%) of unbound RNA (unfilled squares) and bound RNA (unfilled circles) in the RNA LPX sample composition was determined by correlating the amount of unbound RNA and bound RNA with respect to the total RNA amount.

### DETAILED DESCRIPTION OF THE INVENTION

Although the present disclosure is further described in more detail below, it is to be understood that this disclosure is not limited to the particular methodologies, protocols and reagents described herein as these may vary. It is also to be understood that the terminology used herein is for the purpose of describing particular embodiments only, and is not intended to limit the scope of the present disclosure which will be limited only by the appended claims. Unless defined otherwise, all technical and scientific terms used herein have the same meanings as commonly understood by one of ordinary skill in the art.

In the following, the elements of the present disclosure will be described in more detail. These elements are listed with specific embodiments, however, it should be understood that they may be combined in any manner and in any number to create additional embodiments. The variously described examples and preferred embodiments should not be construed to limit the present disclosure to only the explicitly described embodiments. This description should be understood to support and encompass embodiments which combine the explicitly described embodiments with any number of the disclosed and/or preferred elements. Furthermore, any permutations and combinations of all described elements in this application should be considered disclosed by the description of the present application unless the context indicates otherwise. For example, if in a preferred embodiment of the method of the present disclosure AF4 is used as the field-flow fractionation and in another preferred embodiment of the method of the present disclosure the nucleic acid (such as RNA) is in vitro transcribed RNA, then in a further preferred embodiment of the method of the present disclosure, AF4 is used as the field-flow fractionation and the nucleic acid (such as RNA) is in vitro transcribed RNA.

Preferably, the terms used herein are defined as described in “A multilingual glossary of biotechnological terms: (IUPAC Recommendations)”, H. G. W. Leuenberger, B. Nagel, and H. Kolbl, Eds., Helvetica Chimica Acta, CH-4010 Basel, Switzerland, (1995).

The practice of the present disclosure will employ, unless otherwise indicated, conventional chemistry, biochemistry, cell biology, immunology, and recombinant DNA techniques which are explained in the literature in the field (cf., e.g., Organikum, Deutscher Verlag der Wissenschaften, Berlin 1990; Streitwieser/Heathcook, “Organische Chemie”, VCH, 1990; Beyer/Walter, “Lehrbuch der Organischen Chemie”, S. Hirzel Verlag Stuttgart, 1988; Carey/Sundberg, “Organische Chemie”, VCH, 1995; March, “Advanced Organic Chemistry”, John Wiley & Sons, 1985; Rompp Chemie Lexikon, Falbe/Regitz (Hrsg.), Georg Thieme Verlag Stuttgart, N.Y., 1989; Molecular Cloning: A Laboratory Manual, 2nd Edition, J. Sambrook et al. eds., Cold Spring Harbor Laboratory Press, Cold Spring Harbor 1989.

Throughout this specification and the claims which follow, unless the context requires otherwise, the word “comprise”, and variations such as “comprises” and “comprising”, will be understood to imply the inclusion of a stated member, integer or step or group of members, integers or steps but not the exclusion of any other member, integer or step or group of members, integers or steps. The term “consisting essentially of” means excluding other members, integers or steps of any essential significance. The term “comprising” encompasses the term “consisting essentially of” which, in turn, encompasses the term “consisting of”. Thus, at each occurrence in the present application, the term “comprising” may be replaced with the term “consisting essentially of” or “consisting of”. Likewise, at each occurrence in the present application, the term “consisting essentially of” may be replaced with the term “consisting of”.

The terms “a”, “an” and “the” and similar references used in the context of describing the present disclosure (especially in the context of the claims) are to be construed to cover both the singular and the plural, unless otherwise indicated herein or clearly contradicted by the context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by the context. The use of any and all examples, or exemplary language (e.g., “such as”), provided herein is intended merely to better illustrate the present disclosure and does not pose a limitation on the scope of the present disclosure otherwise claimed. No language in the specification should be construed as indicating any non-claimed element essential to the practice of the present disclosure.

Where used herein, “and/or” is to be taken as specific disclosure of each of the two specified features or components with or without the other. For example, “X and/or Y” is to be taken as specific disclosure of each of (i) X, (ii) Y, and (iii) X and Y, just as if each is set out individually herein.

In the context of the present disclosure, the term “about” denotes an interval of accuracy that the person of ordinary skill will understand to still ensure the technical effect of the feature in question. The term typically indicates deviation from the indicated numerical value by ±5%, ±4%, ±3%, ±2%, ±1%, ±0.9%, ±0.8%, ±0.7%, ±0.6%, ±0.5%, ±0.4%, ±0.3%, ±0.2%, ±0.1%, ±0.05%, and for example ±0.01%. As will be appreciated by the person of ordinary skill, the specific such deviation for a numerical value for a given technical effect will depend on the nature of the technical effect. For example, a natural or biological technical effect may generally have a larger such deviation than one for a man-made or engineering technical effect.

Recitation of ranges of values herein is merely intended to serve as a shorthand method of referring individually to each separate value falling within the range. Unless otherwise indicated herein, each individual value is incorporated into the specification as if it were individually recited herein.

The use of any and all examples, or exemplary language (e.g., “such as”), provided herein is intended merely to better illustrate the invention and does not pose a limitation on the scope of the invention otherwise claimed. No language in the specification should be construed as indicating any non-claimed element essential to the practice of the invention.

Several documents are cited throughout the text of this specification. Each of the documents cited herein (including all patents, patent applications, scientific publications, manufacturer's specifications, instructions, etc.), whether supra or infra, are hereby incorporated by reference in their entirety. Nothing herein is to be construed as an admission that the invention is not entitled to antedate such disclosure by virtue of prior invention.

### Definitions

In the following, definitions will be provided which apply to all aspects of the present disclosure. The following terms have the following meanings unless otherwise indicated. Any undefined terms have their art recognized meanings.

Terms such as “reduce” or “inhibit” as used herein means the ability to cause an overall decrease, for example, of about 5% or greater, about 10% or greater, about 15% or greater, about 20% or greater, about 25% or greater, about 30% or greater, about 40% or greater, about 50% or greater, or about 75% or greater, in the level. The term “inhibit” or similar phrases includes a complete or essentially complete inhibition, i.e. a reduction to zero or essentially to zero.

Terms such as “increase” or “enhance” in one embodiment relate to an increase or enhancement by at least about 10%, at least about 20%, at least about 30%, at least about 40%, at least about 50%, at least about 80%, or at least about 100%.

“Physiological pH” as used herein refers to a pH of about 7.5.

As used in the present disclosure, “% w/v” refers to weight by volume percent, which is a unit of concentration measuring the amount of solute in grams (g) expressed as a percent of the total volume of solution in milliliters (mL).

The term “ionic strength” refers to the mathematical relationship between the number of different kinds of ionic species in a particular solution and their respective charges. Thus, ionic strength I_{S} is represented mathematically by the formula

$${I}_{S} = \frac{1}{2} \cdot {\sum }_{i} {z}_{i}^{2} \cdot {c}_{i}$$

in which c is the molar concentration of a particular ionic species and z the absolute value of its charge. The sum Σ is taken over all the different kinds of ions (i) in solution.

According to the disclosure, the term “ionic strength” in one embodiment relates to the presence of monovalent ions. Regarding the presence of divalent ions, in particular divalent cations, their concentration or effective concentration (presence of free ions) due to the presence of chelating agents is in one embodiment sufficiently low so as to prevent degradation of the RNA. In one embodiment, the concentration or effective concentration of divalent ions is below the catalytic level for hydrolysis of the phosphodiester bonds between RNA nucleotides. In one embodiment, the concentration of free divalent ions is 20 μM or less. In one embodiment, there are no or essentially no free divalent ions.

“Osmolality” refers to the concentration of a particular solute expressed as the number of osmoles of solute per kilogram of solvent.

The term “freezing” relates to the solidification of a liquid, usually with the removal of heat.

The term “lyophilizing” or “lyophilization” refers to the freeze-drying of a substance by freezing it and then reducing the surrounding pressure to allow the frozen medium in the substance to sublimate directly from the solid phase to the gas phase.

The term “spray-drying” refers to spray-drying a substance by mixing (heated) gas with a fluid that is atomized (sprayed) within a vessel (spray dryer), where the solvent from the formed droplets evaporates, leading to a dry powder.

The term “reconstitute” relates to adding a solvent such as water to a dried product to return it to a liquid state such as its original liquid state.

The term “recombinant” in the context of the present disclosure means “made through genetic engineering”. In one embodiment, a “recombinant object” in the context of the present disclosure is not occurring naturally.

The term “naturally occurring” as used herein refers to the fact that an object can be found in nature. For example, a peptide or nucleic acid that is present in an organism (including viruses) and can be isolated from a source in nature and which has not been intentionally modified by man in the laboratory is naturally occurring. The term “found in nature” means “present in nature” and includes known objects as well as objects that have not yet been discovered and/or isolated from nature, but that may be discovered and/or isolated in the future from a natural source.

As used herein, the terms “room temperature” and “ambient temperature” are used interchangeably herein and refer to temperatures from at least about 15° C., preferably from about 15° C. to about 35° C., from about 15° C. to about 30° C., from about 15° C. to about 25° C., or from about 17° C. to about 22° C. Such temperatures will include 15° C., 16° C., 17° C., 18° C., 19° C., 20° C., 21° C. and 22° C.

The term “ethanol injection technique” refers to a process, in which an ethanol solution comprising lipids is rapidly injected into an aqueous solution through a needle. This action disperses the lipids throughout the solution and promotes lipid structure formation, for example lipid vesicle formation such as liposome formation. Generally, the nucleic acid (especially RNA) lipoplex particles described herein are obtainable by adding nucleic acid (especially RNA) to a colloidal liposome dispersion. Using the ethanol injection technique, such colloidal liposome dispersion is, in one embodiment, formed as follows: an ethanol solution comprising lipids, such as cationic lipids like DOTMA and additional lipids, is injected into an aqueous solution under stirring. In one embodiment, the nucleic acid (especially RNA) lipoplex particles described herein are obtainable without a step of extrusion.

The term EDTA refers to ethylenediaminetetraacetic acid disodium salt. All concentrations are given with respect to the EDTA disodium salt.

The term “alkyl” refers to a monoradical of a saturated straight or branched hydrocarbon. Preferably, the alkyl group comprises from 1 to 12 (such as 1 to 10) carbon atoms, i.e., 1, 2, 3, 4, 5, 6, 7, 8, 9, 10, 11, or 12 carbon atoms (such as 1, 2, 3, 4, 5, 6, 7, 8, 9, or 10 carbon atoms), more preferably 1 to 8 carbon atoms, such as 1 to 6 or 1 to 4 carbon atoms. Exemplary alkyl groups include methyl, ethyl, propyl, iso-propyl (also called 2-propyl or 1-methylethyl), butyl, iso-butyl, tert-butyl, n-pentyl, iso-pentyl, sec-pentyl, neo-pentyl, 1,2-dimethyl-propyl, iso-amyl, n-hexyl, iso-hexyl, sec-hexyl, n-heptyl, iso-heptyl, n-octyl, 2-ethyl-hexyl, n-nonyl, n-decyl, n-undecyl, n-dodecyl, and the like.

According to the present disclosure, the term “peptide” comprises oligo- and polypeptides and refers to substances which comprise about two or more, about 3 or more, about 4 or more, about 6 or more, about 8 or more, about 10 or more, about 13 or more, about 16 or more, about 20 or more, and up to about 50, about 100 or about 150, consecutive amino acids linked to one another via peptide bonds. The term “protein” refers to large peptides, in particular peptides having at least about 151 amino acids, but the terms “peptide” and “protein” are used herein usually as synonyms.

According to the present disclosure, it is preferred that a nucleic acid such as RNA (preferably mRNA) encoding a peptide or protein once taken up by or introduced, i.e. transfected or transduced, into a cell which cell may be present in vitro or in a subject results in expression of said peptide or protein. The cell may express the encoded peptide or protein intracellularly (e.g. in the cytoplasm and/or in the nucleus), may secrete the encoded peptide or protein, or may express it on the surface.

According to the present disclosure, terms such as “nucleic acid expressing” and “nucleic acid encoding” or similar terms are used interchangeably herein and with respect to a particular peptide or polypeptide mean that the nucleic acid, if present in the appropriate environment, preferably within a cell, can be expressed to produce said peptide or polypeptide.

According to the present disclosure, a part or fragment of a peptide or protein preferably has at least one functional property of the peptide or protein from which it has been derived. Such functional properties comprise a pharmacological activity, the interaction with other peptides or proteins, an enzymatic activity, the interaction with antibodies, and the selective binding of nucleic acids. E.g., a pharmacological active fragment of a peptide or protein has at least one of the pharmacological activities of the peptide or protein from which the fragment has been derived. A part or fragment of a peptide or protein preferably comprises a sequence of at least 6, in particular at least 8, at least 10, at least 12, at least 15, at least 20, at least 30 or at least 50, consecutive amino acids of the peptide or protein. A part or fragment of a peptide or protein preferably comprises a sequence of up to 8, in particular up to 10, up to 12, up to 15, up to 20, up to 30 or up to 55, consecutive amino acids of the peptide or protein.

According to the present disclosure, an analog of a peptide or protein is a modified form of said peptide or protein from which it has been derived and has at least one functional property of said peptide or protein. E.g., a pharmacological active analog of a peptide or protein has at least one of the pharmacological activities of the peptide or protein from which the analog has been derived. Such modifications include any chemical modification and comprise single or multiple substitutions, deletions and/or additions of any molecules associated with the protein or peptide, such as carbohydrates, lipids and/or proteins or peptides. In one embodiment, “analogs” of proteins or peptides include those modified forms resulting from glycosylation, acetylation, phosphorylation, amidation, palmitoylation, myristoylation, isoprenylation, lipidation, alkylation, derivatization, introduction of protective/blocking groups, proteolytic cleavage or binding to an antibody or to another cellular ligand. The term “analog” also extends to all functional chemical equivalents of said proteins and peptides.

An “antigen” according to the present disclosure covers any substance that will elicit an immune response and/or any substance against which an immune response or an immune mechanism such as a cellular response is directed. This also includes situations wherein the antigen is processed into antigen peptides and an immune response or an immune mechanism is directed against one or more antigen peptides, in particular if presented in the context of MHC molecules. In particular, an “antigen” relates to any substance, preferably a peptide or protein, that reacts specifically with antibodies or T-lymphocytes (T-cells). According to the present invention, the term “antigen” comprises any molecule which comprises at least one epitope, such as a T cell epitope. Preferably, an antigen in the context of the present disclosure is a molecule which, optionally after processing, induces an immune reaction, which is preferably specific for the antigen (including cells expressing the antigen). In one embodiment, an antigen is a disease-associated antigen, such as a tumor antigen, a viral antigen, or a bacterial antigen, or an epitope derived from such antigen.

According to the present disclosure, any suitable antigen may be used, which is a candidate for an immune response, wherein the immune response may be both a humoral as well as a cellular immune response. In the context of some embodiments of the present disclosure, the antigen is preferably presented by a cell, preferably by an antigen presenting cell, in the context of MHC molecules, which results in an immune response against the antigen. An antigen is preferably a product which corresponds to or is derived from a naturally occurring antigen. Such naturally occurring antigens may include or may be derived from allergens, viruses, bacteria, fungi, parasites and other infectious agents and pathogens or an antigen may also be a tumor antigen. According to the present invention, an antigen may correspond to a naturally occurring product, for example, a viral protein, or a part thereof.

In a preferred embodiment, the antigen is a tumor antigen, i.e., a part of a tumor cell, in particular those which primarily occur intracellularly or as surface antigens of tumor cells. In another embodiment, the antigen is a pathogen-associated antigen, i.e., an antigen derived from a pathogen, e.g., from a virus, bacterium, unicellular organism, or parasite, for example a viral antigen such as viral ribonucleoprotein or coat protein. In particular, the antigen should be presented by MHC molecules which results in modulation, in particular activation of cells of the immune system, preferably CD4+ and CD8+ lymphocytes, in particular via the modulation of the activity of a T-cell receptor.

The term “disease-associated antigen” is used in its broadest sense to refer to any antigen associated with a disease. A disease-associated antigen is a molecule which contains epitopes that will stimulate a host's immune system to make a cellular antigen-specific immune response and/or a humoral antibody response against the disease. Disease-associated antigens include pathogen-associated antigens, i.e., antigens which are associated with infection by microbes, typically microbial antigens (such as bacterial or viral antigens), or antigens associated with cancer, typically tumors, such as tumor antigens.

The term “tumor antigen” refers to a constituent of cancer cells which may be derived from the cytoplasm, the cell surface or the cell nucleus. In particular, it refers to those antigens which are produced intracellularly or as surface antigens on tumor cells. For example, tumor antigens include the carcinoembryonal antigen, α1-fetoprotein, isoferritin, and fetal sulphoglycoprotein, α2-H-ferroprotein and γ-fetoprotein, as well as various virus tumor antigens. According to the present disclosure, a tumor antigen preferably comprises any antigen which is characteristic for tumors or cancers as well as for tumor or cancer cells with respect to type and/or expression level.

The term “viral antigen” refers to any viral component having antigenic properties, i.e., being able to provoke an immune response in an individual. The viral antigen may be a viral ribonucleoprotein or an envelope protein.

The term “bacterial antigen” refers to any bacterial component having antigenic properties, i.e. being able to provoke an immune response in an individual. The bacterial antigen may be derived from the cell wall or cytoplasm membrane of the bacterium.

The term “epitope” refers to an antigenic determinant in a molecule such as an antigen, i.e., to a part in or fragment of the molecule that is recognized by the immune system, for example, that is recognized by antibodies T cells or B cells, in particular when presented in the context of MHC molecules. An epitope of a protein preferably comprises a continuous or discontinuous portion of said protein and is preferably between about 5 and about 100, preferably between about 5 and about 50, more preferably between about 8 and about 0, most preferably between about 10 and about 25 amino acids in length, for example, the epitope may be preferably 9, 10, 11, 12, 13, 14, 15, 16, 17, 18, 19, 20, 21, 22, 23, 24, or 25 amino acids in length. It is particularly preferred that the epitope in the context of the present invention is a T cell epitope.

Terms such as “epitope”, “fragment of an antigen”, “immunogenic peptide” and “antigen peptide” are used interchangeably herein and preferably relate to an incomplete representation of an antigen which is preferably capable of eliciting an immune response against the antigen or a cell expressing or comprising and preferably presenting the antigen. Preferably, the terms relate to an immunogenic portion of an antigen. Preferably, it is a portion of an antigen that is recognized (i.e., specifically bound) by a T cell receptor, in particular if presented in the context of MHC molecules. Certain preferred immunogenic portions bind to an MHC class I or class II molecule.

The term “T cell epitope” refers to a part or fragment of a protein that is recognized by a T cell when presented in the context of MHC molecules. The term “major histocompatibility complex” and the abbreviation “MHC” includes MHC class I and MHC class II molecules and relates to a complex of genes which is present in all vertebrates. MHC proteins or molecules are important for signaling between lymphocytes and antigen presenting cells or diseased cells in immune reactions, wherein the MHC proteins or molecules bind peptide epitopes and present them for recognition by T cell receptors on T cells. The proteins encoded by the MHC are expressed on the surface of cells, and display both self-antigens (peptide fragments from the cell itself) and non-self-antigens (e.g., fragments of invading microorganisms) to a T cell. In the case of class I MHC/peptide complexes, the binding peptides are typically about 8 to about 10 amino acids long although longer or shorter peptides may be effective. In the case of class II MHC/peptide complexes, the binding peptides are typically about 10 to about 25 amino acids long and are in particular about 13 to about 18 amino acids long, whereas longer and shorter peptides may be effective.

The term “target” shall mean an agent such as a cell or tissue which is a target for an immune response such as a cellular immune response. Targets include cells that present an antigen or an antigen epitope, i.e. a peptide fragment derived from an antigen. In one embodiment, the target cell is a cell expressing an antigen and preferably presenting said antigen with class I MHC.

The term “portion” refers to a fraction. With respect to a particular structure such as an amino acid sequence or protein the term “portion” thereof may designate a continuous or a discontinuous fraction of said structure.

The terms “part” and “fragment” are used interchangeably herein and refer to a continuous element. For example, a part of a structure such as an amino acid sequence or protein refers to a continuous element of said structure. When used in context of a composition, the term “part” means a portion of the composition. For example, a part of a composition may any portion from 0.1% to 99.9% (such as 0.1%, 0.5%, 1%, 5%, 10%, 50%, 90%, or 99%) of said composition.

“Antigen processing” refers to the degradation of an antigen into processing products which are fragments of said antigen (e.g., the degradation of a protein into peptides) and the association of one or more of these fragments (e.g., via binding) with MHC molecules for presentation by cells, preferably antigen-presenting cells to specific T-cells.

By “antigen-responsive CTL” is meant a CD8⁺ T-cell that is responsive to an antigen or a peptide derived from said antigen, which is presented with class I MHC on the surface of antigen presenting cells.

According to the invention, CTL responsiveness may include sustained calcium flux, cell division, production of cytokines such as IFN-γ and TNF-α, up-regulation of activation markers such as CD44 and CD69, and specific cytolytic killing of tumor antigen expressing target cells. CTL responsiveness may also be determined using an artificial reporter that accurately indicates CTL responsiveness.

The terms “immune response” and “immune reaction” are used herein interchangeably in their conventional meaning and refer to an integrated bodily response to an antigen and preferably refers to a cellular immune response, a humoral immune response, or both. According to the invention, the term “immune response to” or “immune response against” with respect to an agent such as an antigen, cell or tissue, relates to an immune response such as a cellular response directed against the agent. An immune response may comprise one or more reactions selected from the group consisting of developing antibodies against one or more antigens and expansion of antigen-specific T-lymphocytes, preferably CD4⁺ and CD8⁺ T-lymphocytes, more preferably CD8⁺ T-lymphocytes, which may be detected in various proliferation or cytokine production tests in vitro.

The terms “inducing an immune response” and “eliciting an immune response” and similar terms in the context of the present invention refer to the induction of an immune response, preferably the induction of a cellular immune response, a humoral immune response, or both. The immune response may be protective/preventive/prophylactic and/or therapeutic. The immune response may be directed against any immunogen or antigen or antigen peptide, preferably against a tumor-associated antigen or a pathogen-associated antigen (e.g., an antigen of a virus (such as influenza virus (A, B, or C), CMV or RSV)). “Inducing” in this context may mean that there was no immune response against a particular antigen or pathogen before induction, but it may also mean that there was a certain level of immune response against a particular antigen or pathogen before induction and after induction said immune response is enhanced. Thus, “inducing the immune response” in this context also includes “enhancing the immune response”. Preferably, after inducing an immune response in an individual, said individual is protected from developing a disease such as an infectious disease or a cancerous disease or the disease condition is ameliorated by inducing an immune response.

The terms “cellular immune response”, “cellular response”, “cell-mediated immunity” or similar terms are meant to include a cellular response directed to cells characterized by expression of an antigen and/or presentation of an antigen with class I or class II MHC. The cellular response relates to cells called T cells or T lymphocytes which act as either “helpers” or “killers”. The helper T cells (also termed CD4⁺ T cells) play a central role by regulating the immune response and the killer cells (also termed cytotoxic T cells, cytolytic T cells, CD8⁺ T cells or CTLs) kill cells such as diseased cells.

The term “humoral immune response” refers to a process in living organisms wherein antibodies are produced in response to agents and organisms, which they ultimately neutralize and/or eliminate. The specificity of the antibody response is mediated by T and/or B cells through membrane-associated receptors that bind antigen of a single specificity. Following binding of an appropriate antigen and receipt of various other activating signals, B lymphocytes divide, which produces memory B cells as well as antibody secreting plasma cell clones, each producing antibodies that recognize the identical antigenic epitope as was recognized by its antigen receptor. Memory B lymphocytes remain dormant until they are subsequently activated by their specific antigen. These lymphocytes provide the cellular basis of memory and the resulting escalation in antibody response when re-exposed to a specific antigen.

The term “antibody” as used herein, refers to an immunoglobulin molecule, which is able to specifically bind to an epitope on an antigen. In particular, the term “antibody” refers to a glycoprotein comprising at least two heavy (H) chains and two light (L) chains inter-connected by disulfide bonds. The term “antibody” includes monoclonal antibodies, recombinant antibodies, human antibodies, humanized antibodies, chimeric antibodies and combinations of any of the foregoing. Each heavy chain is comprised of a heavy chain variable region (VH) and a heavy chain constant region (CH). Each light chain is comprised of a light chain variable region (VL) and a light chain constant region (CL). The variable regions and constant regions are also referred to herein as variable domains and constant domains, respectively. The VH and VL regions can be further subdivided into regions of hypervariability, termed complementarity determining regions (CDRs), interspersed with regions that are more conserved, termed framework regions (FRs). Each VH and VL is composed of three CDRs and four FRs, arranged from amino-terminus to carboxy-terminus in the following order: FR1, CDR1, FR2, CDR2, FR3, CDR3, FR4. The CDRs of a VH are termed HCDR1, HCDR2 and HCDR3, the CDRs of a VL are termed LCDR1, LCDR2 and LCDR3. The variable regions of the heavy and light chains contain a binding domain that interacts with an antigen. The constant regions of an antibody comprise the heavy chain constant region (CH) and the light chain constant region (CL), wherein CH can be further subdivided into constant domain CH1, a hinge region, and constant domains CH2 and CH3 (arranged from amino-terminus to carboxy-terminus in the following order: CH1, CH2, CH3). The constant regions of the antibodies may mediate the binding of the immunoglobulin to host tissues or factors, including various cells of the immune system (e.g., effector cells) and the first component (Cl q) of the classical complement system. Antibodies can be intact immunoglobulins derived from natural sources or from recombinant sources and can be immunoactive portions of intact immunoglobulins. Antibodies are typically tetramers of immunoglobulin molecules. Antibodies may exist in a variety of forms including, for example, polyclonal antibodies, monoclonal antibodies, Fv, Fab and F(ab)₂, as well as single chain antibodies and humanized antibodies.

The term “immunoglobulin” relates to proteins of the immunoglobulin superfamily, preferably to antigen receptors such as antibodies or the B cell receptor (BCR). The immunoglobulins are characterized by a structural domain, i.e., the immunoglobulin domain, having a characteristic immunoglobulin (Ig) fold. The term encompasses membrane bound immunoglobulins as well as soluble immunoglobulins. Membrane bound immunoglobulins are also termed surface immunoglobulins or membrane immunoglobulins, which are generally part of the BCR. Soluble immunoglobulins are generally termed antibodies Immunoglobulins generally comprise several chains, typically two identical heavy chains and two identical light chains which are linked via disulfide bonds. These chains are primarily composed of immunoglobulin domains, such as the V_{L} (variable light chain) domain, CL (constant light chain) domain, V_{H} (variable heavy chain) domain, and the CH (constant heavy chain) domains C_{H}1, C_{H}2, C_{H}3, and C_{H}4. There are five types of mammalian immunoglobulin heavy chains, i.e., α, δ, ε, γ, and μ which account for the different classes of antibodies, i.e., IgA, IgD, IgE, IgG, and IgM. As opposed to the heavy chains of soluble immunoglobulins, the heavy chains of membrane or surface immunoglobulins comprise a transmembrane domain and a short cytoplasmic domain at their carboxy-terminus. In mammals there are two types of light chains, i.e., lambda and kappa. The immunoglobulin chains comprise a variable region and a constant region. The constant region is essentially conserved within the different isotypes of the immunoglobulins, wherein the variable part is highly divers and accounts for antigen recognition.

The terms “vaccination” and “immunization” describe the process of treating an individual for therapeutic or prophylactic reasons and relate to the procedure of administering one or more immunogen(s) or antigen(s) or derivatives thereof, in particular in the form of RNA coding therefor, as described herein to an individual and stimulating an immune response against said one or more immunogen(s) or antigen(s) or cells characterized by presentation of said one or more immunogen(s) or antigen(s).

By “cell characterized by presentation of an antigen” or “cell presenting an antigen” or “MHC molecules which present an antigen on the surface of an antigen presenting cell” or similar expressions is meant a cell such as a diseased cell, in particular a tumor cell, or an antigen presenting cell presenting the antigen or an antigen peptide, either directly or following processing, in the context of MHC molecules, preferably MHC class I and/or MHC class II molecules, most preferably MHC class I molecules.

In the context of the present disclosure, the term “transcription” relates to a process, wherein the genetic code in a DNA sequence is transcribed into RNA. Subsequently, the RNA may be translated into peptide or protein.

With respect to RNA, the term “expression” or “translation” relates to the process in the ribosomes of a cell by which a strand of mRNA directs the assembly of a sequence of amino acids to make a peptide or protein

The term “optional” or “optionally” as used herein means that the subsequently described event, circumstance or condition may or may not occur, and that the description includes instances where said event, circumstance, or condition occurs and instances in which it does not occur.

The “radius of gyration” (abbreviated herein as R_{g}) of a particle about an axis of rotation is the radial distance of a point from the axis of rotation at which, if the whole mass of the particle is assumed to be concentrated, its moment of inertia about the given axis would be the same as with its actual distribution of mass. Mathematically, R_{g} is the root mean square distance of the particle's components from either its center of mass or a given axis. For example, for a macromolecule composed of n mass elements, of masses mᵢ (i=1, 2, 3, . . . , n), located at fixed distances sᵢ from the center of mass, R_{g} is the square-root of the mass average of sᵢ² over all mass elements and can be calculated as follows:

$${R}_{g} = {( {\sum }_{i = 1}^{n} {m}_{i} \cdot {s}_{i}^{2} / {\sum }_{i = 1}^{n} {m}_{i} )}^{1 / 2}$$

The radius of gyration can be determined or calculated experimentally, e.g., by using light scattering. In particular, for small scattering vectors \vec{q} the structure function S is defined as follows:

$$S ( \vec{q} ) \approx N \cdot ( 1 - \frac{{q}^{2} \cdot {R}_{g}^{2}}{3} )$$

wherein N is the number of components (Guinier's law).

The “D10 value”, in particular regarding a quantitative size distribution of particles, is the diameter at which 10% of the particles have a diameter less than this value. The D10 value is a means to describe the proportion of the smallest particles within a population of particles (such as within a particle peak obtained from a field-flow fractionation).

“D50 value”, in particular regarding a quantitative size distribution of particles, is the diameter at which 50% of the particles have a diameter less than this value. The D50 value is a means to describe the mean particle size of a population of particles (such as within a particle peak obtained from a field-flow fractionation).

The “D90” value, in particular regarding a quantitative size distribution of particles, is the diameter at which 90% of the particles have a diameter less than this value. The “D95”, “D99”, and “D100” values have corresponding meanings. The D90, D95, D99, and D100 values are means to describe the proportion of the larger particles within a population of particles (such as within a particle peak obtained from a field-flow fractionation).

The “hydrodynamic radius” (which is sometimes called “Stokes radius” or “Stokes-Einstein radius”) of a particle is the radius of a hypothetical hard sphere that diffuses at the same rate as said particle. The hydrodynamic radius is related to the mobility of the particle, taking into account not only size but also solvent effects. For example, a smaller charged particle with stronger hydration may have a greater hydrodynamic radius than a larger charged particle with weaker hydration. This is because the smaller particle drags a greater number of water molecules with it as it moves through the solution. Since the actual dimensions of the particle in a solvent are not directly measurable, the hydrodynamic radius may be defined by the Stokes-Einstein equation:

$${R}_{h} = \frac{{k}_{B} \cdot T}{6 \cdot π \cdot η \cdot D}$$

wherein k_{B} is the Boltzmann constant; T is the temperature; η is the viscosity of the solvent; and D is the diffusion coefficient. The diffusion coefficient can be determined experimentally, e.g., by using dynamic light scattering (DLS). Thus, one procedure to determine the hydrodynamic radius of a particle or a population of particles (such as the hydrodynamic radius of particles contained in a sample or control composition as disclosed herein or the hydrodynamic radius of a particle peak obtained from subjecting such a sample or control composition to field-flow fractionation) is to measure the DLS signal of said particle or population of particles (such as DLS signal of particles contained in a sample or control composition as disclosed herein or the DLS signal of a particle peak obtained from subjecting such a sample or control composition to field-flow fractionation).

The term “shape factor” as used herein means the ratio of R_{g} values (such as recalculated R_{g} values) to hydrodynamic radius (Rₕ) values. It can be determined or calculated by plotting the R_{g} values (such as recalculated R_{g} values) against the hydrodynamic radius (Rₕ) values and fitting the data points to a function (e.g. a linear function).

The term “form factor” as used herein means the ratio of hydrodynamic radius (Rₕ) values to R_{g} values (such as recalculated R_{g} values). It can be determined or calculated by plotting the hydrodynamic radius (Rₕ) values against the R_{g} values (such as recalculated R_{g} values) and fitting the data points to a function (e.g. a linear function).

The expression “nucleic acid encapsulation efficiency” as used herein means the ratio of the amount of encapsulated nucleic acid contained in a sample or control composition comprising nucleic acid and particles to the total amount of nucleic acid contained in the sample or control composition. For example, in case the nucleic acid is RNA, the expression “RNA encapsulation efficiency” as used herein means the ratio of the amount of encapsulated RNA contained in a sample or control composition comprising RNA and particles to the total amount of RNA contained in the sample or control composition.

The term “membrane” as used herein refers to a size-selective barrier which allows molecules under a certain size which is called “cut-off” (such as molecular weight (MW) cut-off) to pass through but stops molecules above said certain size (i.e., cut-off, such as MW cut-off). Preferably, the membrane is synthetic. Examples of membranes suitable for the methods and/or uses of the present disclosure include ultrafiltration membranes, polyethersulfon (PES) membranes, regenerated cellulose membranes, polyvinylidene fluoride (PVDF) membranes, and other ultrafiltration membranes.

The term “aggregate” as used herein relates to a cluster of particles, wherein the particles are identical or very similar and adhere to each other in a non-covalently manner (e.g., via ionic interactions, H bridge interactions, dipole interactions, and/or van der Waals interactions).

The expression “light scattering” as used herein refers to the physical process where light is forced to deviate from a straight trajectory by one or more paths due to localized non-uniformities in the medium through which the light passes.

The term “UV” means ultraviolet and designates a band of the electromagnetic spectrum with a wavelength from 10 nm to 400 nm, i.e., shorter than that of visible light but longer than X-rays.

The term “circular dichroism spectroscopy” or “CD spectroscopy” as used herein refers to spectroscopy using circularly polarized light. Preferably, CD spectroscopy involves the differential absorption of left- and right-handed light.

The term “UV CD light” or “UV CD signal” means circularly polarized light having a wavelength from 10 nm to 400 nm, i.e., shorter than that of visible light but longer than X-rays.

The expression “multi-angle light scattering” or “MALS” as used herein relates to a technique for measuring the light scattered by a sample into a plurality of angles. “Multi-angle” means in this respect that scattered light can be detected at different discrete angles as measured, for example, by a single detector moved over a range including the specific angles selected or an array of detectors fixed at specific angular locations. In one preferred embodiment, the light source used in MALS is a laser source (MALLS: multi-angle laser light scattering). Based on the MALS signal of a composition comprising particles and by using an appropriate formalism (e.g., Zimm plot, Berry plot, or Debye plot), it is possible to determine the radius of gyration (R_{g}) and, thus, the size of said particles. Preferably, the Zimm plot is a graphical presentation using the following equation:

$$\frac{{R}_{θ}}{{K}^{*} c} = {M}_{w} P ( θ ) - 2 {A}_{2} c {M}_{w}^{2} {P}^{2} ( θ )$$

wherein c is the mass concentration of the particles in the solvent (g/mL); A₂ is the second virial coefficient (mol·mL/g²); P(θ) is a form factor relating to the dependence of scattered light intensity on angle; R_{θ} is the excess Rayleigh ratio (cm⁻¹); and K* is an optical constant that is equal to 4π²ηₒ (dn/dc)²λ₀⁻⁴N_{A}⁻¹, where ηₒ is the refractive index of the solvent at the incident radiation (vacuum) wavelength, λ₀ is the incident radiation (vacuum) wavelength (nm), N_{A} is Avogadro's number (mol⁻¹), and dn/dc is the differential refractive index increment (mL/g) (cf., e.g., Buchholz et al. (Electrophoresis 22 (2001), 4118-4128); B. H. Zimm (J. Chem. Phys. 13 (1945), 141; P. Debye (J. Appl. Phys. 15 (1944): 338; and W. Burchard (Anal. Chem. 75 (2003), 4279-4291). Preferably, the Berry plot is calculated the following term:

$$\sqrt{\frac{{R}_{θ}}{{K}^{*} c}}$$

wherein c, R_{θ} and K* are as defined above. Preferably, the Debye plot is calculated the following term:

$$\frac{{K}^{*} c}{{R}_{θ}}$$

wherein c, R_{θ} and K* are as defined above. Although nucleic acid (especially RNA) as such is not a particle in the sense of the definition provided above, the size of the nucleic acid (especially RNA) can also be determined using any of the above formalisms (e.g., Zimm plot, Berry plot, or Debye plot), assuming that the nucleic acid (especially RNA) is in the form of a random coil. Therefore, in one embodiment of the methods and/or uses of the present disclosure, the size, size distribution, and/or quantitative size distribution of nucleic acid (such as RNA) is/are calculated based on the R_{g} values of the nucleic acid (such as RNA). In another embodiment of the methods and/or uses of the present disclosure, the size, size distribution, and/or quantitative size distribution of nucleic acid (such as RNA) is/are calculated based on the Rₕ values of the nucleic acid (such as RNA). In another embodiment of the methods and/or uses of the present disclosure, the size, size distribution, and/or quantitative size distribution of nucleic acid (such as RNA) is/are calculated based on the R_{g} values of the nucleic acid (such as RNA) and separately based on the Rₕ values of nucleic acid (such as RNA) (i.e., this embodiment results in two data sets for the size, size distribution, and/or quantitative size distribution of nucleic acid (such as RNA), one based on the R_{g} values and one based on the Rₕ values).

The expression “dynamic light scattering” or “DLS” as used herein refers to a technique to determine the size and size distribution profile of particles, in particular with respect to the hydrodynamic radius of the particles. A monochromatic light source, usually a laser, is shot through a polarizer and into a sample. The scattered light then goes through a second polarizer where it is detected and the resulting image is projected onto a screen. The particles in the solution are being hit with the light and diffract the light in all directions. The diffracted light from the particles can either interfere constructively (light regions) or destructively (dark regions). This process is repeated at short time intervals and the resulting set of speckle patterns are analyzed by an autocorrelator that compares the intensity of light at each spot over time.

The expression “static light scattering” or “SLS” as used herein refers to a technique to determine the size and size distribution profile of particles, in particular with respect to the radius of gyration of the particles, and/or the molar mass of particles. A high-intensity monochromatic light, usually a laser, is launched in a solution containing the particles. One or many detectors are used to measure the scattering intensity at one or many angles. The angular dependence is needed to obtain accurate measurements of both molar mass and size for all macromolecules of radius. Hence simultaneous measurements at several angles relative to the direction of incident light, known as multi-angle light scattering (MALS) or multi-angle laser light scattering (MALLS), is generally regarded as the standard implementation of static light scattering.

The expressions “elution time” and “retention time” are used interchangeable herein and relate to the time period it takes for a particular analyte to pass through the system (e.g., from the injection point of the field-flow fractionation device to the detector) under set conditions.

The expression “continuous change” means that the change from one value to a different value is performed steadily, i.e., without any jumps. Examples of a continuous change are a linear change or an exponential change (such as a linear gradient or an exponential gradient).

The expression “stepwise change” means that the change from one value to a different value is not continuous but jumps from a first specific value to a second specific value thereby leaving out at least one of the values between the first and second values. An example of a stepwise change is a flow rate profile starting from a first value (e.g., 10 mL/min) and ending at a second value (e.g., 0 mL/min), wherein during this profile the flow rate can only be an integer (e.g., 10, 9, 8, 7, 6, 5, 4, 3, 2, 1, or 0 mL/min) thereby leaving out the values between these integers.

The expression “providing a composition comprising a nucleic acid (such as RNA) and optionally particles” as used herein means that such a composition is provided by any means, e.g., it may be prepared, processed (such as purified and/or dried) and/or stored.

Nucleic Acid

According to the present disclosure, the term “nucleic acid” comprises deoxyribonucleic acid (DNA), ribonucleic acid (RNA), combinations thereof, and modified forms thereof. The term comprises genomic DNA, cDNA, mRNA, recombinantly produced and chemically synthesized molecules. According to the present disclosure, a nucleic acid may be present as a single-stranded or double-stranded and linear or covalently circularly closed molecule. A nucleic acid can, according to the present disclosure, be isolated. The term “isolated nucleic acid” means, according to the present disclosure, that the nucleic acid (i) was amplified in vitro, for example via polymerase chain reaction (PCR) for DNA or in vitro transcription (using e.g. an RNA polymerase) for RNA, (ii) was produced recombinantly by cloning, (iii) was purified, for example, by cleavage and separation by gel electrophoresis, or (iv) was synthesized, for example, by chemical synthesis.

The term “nucleoside” (abbreviated herein as “N”) relates to compounds which can be thought of as nucleotides without a phosphate group. While a nucleoside is a nucleobase linked to a sugar (e.g., ribose or deoxyribose), a nucleotide is composed of a nucleoside and one or more phosphate groups. Examples of nucleosides include cytidine, uridine, pseudouridine, adenosine, and guanosine.

The five standard nucleosides which usually make up naturally occurring nucleic acids are uridine, adenosine, thymidine, cytidine and guanosine. The five nucleosides are commonly abbreviated to their one letter codes U, A, T, C and G, respectively. However, thymidine is more commonly written as “dT” (“d” represents “deoxy”) as it contains a 2′-deoxyribofuranose moiety rather than the ribofuranose ring found in uridine. This is because thymidine is found in deoxyribonucleic acid (DNA) and not ribonucleic acid (RNA). Conversely, uridine is found in RNA and not DNA. The remaining three nucleosides may be found in both RNA and DNA. In RNA, they would be represented as A, C and G, whereas in DNA they would be represented as dA, dC and dG.

A modified purine (A or G) or pyrimidine (C, T, or U) base moiety is preferably modified by one or more alkyl groups, more preferably one or more C₁₋₄ alkyl groups, even more preferably one or more methyl groups. Particular examples of modified purine or pyrimidine base moieties include N⁷-alkyl-guanine, N⁶-alkyl-adenine, 5-alkyl-cytosine, 5-alkyl-uracil, and N(1)-alkyl-uracil, such as N⁷-C₁₋₄ alkyl-guanine, N⁶—C₁₋₄ alkyl-adenine, 5-C₁₋₄ alkyl-cytosine, 5-C₁₋₄ alkyl-uracil, and N(1)-C₁₋₄ alkyl-uracil, preferably N⁷-methyl-guanine, N⁶-methyl-adenine, 5-methyl-cytosine, 5-methyl-uracil, and N(1)-methyl-uracil.

In the present disclosure, the term “DNA” relates to a nucleic acid molecule which includes deoxyribonucleotide residues. In preferred embodiments, the DNA contains all or a majority of deoxyribonucleotide residues. As used herein, “deoxyribonucleotide” refers to a nucleotide which lacks a hydroxyl group at the 2′-position of a β-D-ribofuranosyl group. DNA encompasses without limitation, double stranded DNA, single stranded DNA, isolated DNA such as partially purified DNA, essentially pure DNA, synthetic DNA, recombinantly produced DNA, as well as modified DNA that differs from naturally occurring DNA by the addition, deletion, substitution and/or alteration of one or more nucleotides. Such alterations may refer to addition of non-nucleotide material to internal DNA nucleotides or to the end(s) of DNA. It is also contemplated herein that nucleotides in DNA may be non-standard nucleotides, such as chemically synthesized nucleotides or ribonucleotides. For the present disclosure, these altered DNAs are considered analogs of naturally-occurring DNA. A molecule contains “a majority of deoxyribonucleotide residues” if the content of deoxyribonucleotide residues in the molecule is more than 50% (such as at least 55%, at least 60%, at least 65%, at least 70%, at least 75%, at least 80%, at least 85%, at least 90%, at least 95%, at least 96%, at least 97%, at least 98%, at least 99%), based on the total number of nucleotide residues in the molecule. The total number of nucleotide residues in a molecule is the sum of all nucleotide residues (irrespective of whether the nucleotide residues are standard (i.e., naturally occurring) nucleotide residues or analogs thereof).

In one embodiment, DNA is recombinant DNA and may be obtained by cloning of a nucleic acid, in particular cDNA. The cDNA may be obtained by reverse transcription of RNA.

In the present disclosure, the term “RNA” relates to a nucleic acid molecule which includes ribonucleotide residues. In preferred embodiments, the RNA contains all or a majority of ribonucleotide residues. As used herein, “ribonucleotide” refers to a nucleotide with a hydroxyl group at the 2′-position of a β-D-ribofuranosyl group. RNA encompasses without limitation, double stranded RNA, single stranded RNA, isolated RNA such as partially purified RNA, essentially pure RNA, synthetic RNA, recombinantly produced RNA, as well as modified RNA that differs from naturally occurring RNA by the addition, deletion, substitution and/or alteration of one or more nucleotides. Such alterations may refer to addition of non-nucleotide material to internal RNA nucleotides or to the end(s) of RNA. It is also contemplated herein that nucleotides in RNA may be non-standard nucleotides, such as chemically synthesized nucleotides or deoxynucleotides. For the present disclosure, these altered/modified nucleotides can be referred to as analogs of naturally occurring nucleotides, and the corresponding RNAs containing such altered/modified nucleotides (i.e., altered/modified RNAs) can be referred to as analogs of naturally occurring RNAs. A molecule contains “a majority of ribonucleotide residues” if the content of ribonucleotide residues in the molecule is more than 50% (such as at least 55%, at least 60%, at least 65%, at least 70%, at least 75%, at least 80%, at least 85%, at least 90%, at least 95%, at least 96%, at least 97%, at least 98%, at least 99%), based on the total number of nucleotide residues in the molecule. The total number of nucleotide residues in a molecule is the sum of all nucleotide residues (irrespective of whether the nucleotide residues are standard (i.e., naturally occurring) nucleotide residues or analogs thereof).

According to the present disclosure, “RNA” includes mRNA, tRNA, ribosomal RNA (rRNA), small nuclear RNA (snRNA), self-amplifying RNA (saRNA), single-stranded RNA (ssRNA), dsRNA, inhibitory RNA (such as antisense ssRNA, small interfering RNA (siRNA), or microRNA (miRNA)), activating RNA (such as small activating RNA) and immunostimulatory RNA (isRNA).

The term “in vitro transcription” or “IVT” as used herein means that the transcription (i.e., the generation of RNA) is conducted in a cell-free manner I.e., IVT does not use living/cultured cells but rather the transcription machinery extracted from cells (e.g., cell lysates or the isolated components thereof, including an RNA polymerase (preferably T7, T3 or SP6 polymerase)).

According to the present disclosure, the term “mRNA” means “messenger-RNA” and relates to a “transcript” which may be generated by using a DNA template and may encode a peptide or protein. Typically, an mRNA comprises a 5′-UTR, a peptide/protein coding region, and a 3′-UTR. In the context of the present disclosure, mRNA is preferably generated by in vitro transcription (IVT) from a DNA template. As set forth above, the in vitro transcription methodology is known to the skilled person, and a variety of in vitro transcription kits is commercially available.

mRNA is single-stranded but may contain self-complementary sequences that allow parts of the mRNA to fold and pair with itself to form double helices.

According to the present disclosure, “dsRNA” means double-stranded RNA and is RNA with two partially or completely complementary strands.

The length of the RNA may vary from 10 nucleotides to 15,000, such as 40 to 15,000, 100 to 12,000 or 200 to 10,000 nucleotides. In one embodiment, the RNA is an inhibitory RNA and has a length of 10 100 nucleotides (such as at most 90 nucleotides, at most 80 nucleotides, at most 70 nucleotides, at most 60 nucleotides, at most 50 nucleotides, at most 45 nucleotides, at most 40 nucleotides, at most 35 nucleotides, at most 30 nucleotides, at most 25 nucleotides, or at most 20 nucleotides). In one embodiment, the RNA encodes a peptide or protein and has a length of at least 45 nucleotides (such as at least 60, at least 90, at least 100, at least 200, at least 300, at least 400, at least 500, at least 600, at least 700, at least 800, at least 900, at least 1,000, at least 1,500, at least 2,000, at least 2,500, at least 3,000, at least 3,500, at least 4,000, at least 4,500, at least 5,000, at least 6,000, at least 7,000, at least 8,000, at least 9,000 nucleotides), preferably up to 15,000, such as up to 14,000, up to 13,000, up to 12,000 nucleotides, up to 11,000 nucleotides or up to 10,000 nucleotides.

In certain embodiments of the present disclosure, the RNA is mRNA that relates to a RNA transcript which encodes a peptide or protein. As established in the art, mRNA generally contains a 5′ untranslated region (5′-UTR), a peptide coding region and a 3′ untranslated region (3′-UTR). In some embodiments, the RNA is produced by in vitro transcription or chemical synthesis. In one embodiment, the mRNA is produced by in vitro transcription using a DNA template. The in vitro transcription methodology is known to the skilled person; cf., e.g., Molecular Cloning: A Laboratory Manual, 2 Edition, J. Sambrook et al. eds., Cold Spring Harbor Laboratory Press, Cold Spring Harbor 1989. Furthermore, a variety of in vitro transcription kits is commercially available, e.g., from Thermo Fisher Scientific (such as TranscriptAid™ T7 kit, MEGAscript® T7 kit, MAXIscript®), New England BioLabs Inc. (such as HiScribe™ T7 kit, HiScribe™ T7 ARCA mRNA kit), Promega (such as RiboMAX™, HeLaScribe®, Riboprobe® systems), Jena Bioscience (such as SP6 or T7 transcription kits), and Epicentre (such as AmpliScribe™). For providing modified RNA, correspondingly modified nucleotides, such as modified naturally occurring nucleotides, non-naturally occurring nucleotides and/or modified non-naturally occurring nucleotides, can be incorporated during synthesis (preferably in vitro transcription), or modifications can be effected in and/or added to the RNA after transcription.

In one embodiment, RNA is in vitro transcribed RNA (IVT-RNA) and may be obtained by in vitro transcription of an appropriate DNA template. The promoter for controlling transcription can be any promoter for any RNA polymerase. A DNA template for in vitro transcription may be obtained by cloning of a nucleic acid, in particular cDNA, and introducing it into an appropriate vector for in vitro transcription. The cDNA may be obtained by reverse transcription of RNA.

In the context of the present disclosure, the RNA, preferably the mRNA, contains one or more modifications, e.g., in order to increase its stability and/or increase translation efficiency and/or decrease immunogenicity and/or decrease cytotoxicity. For example, in order to increase expression of the RNA (especially mRNA), it may be modified within the coding region, i.e., the sequence encoding the expressed peptide or protein, preferably without altering the sequence of the expressed peptide or protein. Such modifications are described, for example, in WO 2007/036366 and PCT/EP2019/056502, and include the following: a 5′-cap structure; an extension or truncation of the naturally occurring poly(A) tail; an alteration of the 5′- and/or 3′-untranslated regions (UTR) such as introduction of a UTR which is not related to the coding region of said RNA; the replacement of one or more naturally occurring nucleotides with synthetic nucleotides; and codon optimization (e.g., to alter, preferably increase, the GC content of the RNA). The term “modification” in the context of modified RNA (preferably mRNA) according to the present disclosure preferably relates to any modification of an RNA (preferably mRNA) which is not naturally present in said RNA.

In some embodiments, the RNA (preferably mRNA) according to the present disclosure comprises a 5′-cap structure. In one embodiment, the RNA (preferably mRNA) does not have uncapped 5′-triphosphates. In one embodiment, the RNA (preferably mRNA) may comprise a conventional 5′-cap and/or a 5′-cap analog. The term “conventional 5′-cap” refers to a cap structure found on the 5′-end of an mRNA molecule and generally consists of a guanosine 5′-triphosphate (Gppp) which is connected via its triphosphate moiety to the 5′-end of the next nucleotide of the mRNA (i.e., the guanosine is connected via a 5′ to 5′ triphosphate linkage to the rest of the mRNA). The guanosine may be methylated at position N⁷ (resulting in the cap structure m⁷Gppp). The term “5′-cap analog” refers to a 5′-cap which is based on a conventional 5′-cap but which has been modified at either the 2′- or 3′-position of the m⁷guanosine structure in order to avoid an integration of the 5′-cap analog in the reverse orientation (such 5′-cap analogs are also called anti-reverse cap analogs (ARCAs)). Particularly preferred 5′-cap analogs are those having one or more substitutions at the bridging and non-bridging oxygen in the phosphate bridge, such as phosphorothioate modified 5′-cap analogs at the β-phosphate (such as m₂^{7,2′O}G(5′)ppSp(5′G (referred to as beta-S-ARCA or β-S-ARCA)), as described in PCT/EP2019/056502, the entire disclosure of which is incorporated herein by reference. Providing an RNA (preferably mRNA) with a 5′-cap structure as described herein may be achieved by in vitro transcription of a DNA template in presence of a corresponding 5′-cap compound, wherein said 5′-cap structure is co-transcriptionally incorporated into the generated RNA strand, or the RNA (preferably mRNA) may be generated, for example, by in vitro transcription, and the 5′-cap structure may be attached to the RNA post-transcriptionally using capping enzymes, for example, capping enzymes of vaccinia virus.

In some embodiments, the RNA (preferably mRNA) according to the present disclosure comprises a 5′-cap structure selected from the group consisting of m₂^{7,2′O}G(5′)ppSp(5′)G (in particular its D1 diastereomer), m₂^{7,3′O}G(5′)ppp(5′)G, and m₂^{7,3′-O}Gppp(m₁^{2′-O})ApG. In one

In some embodiments, the RNA (preferably mRNA) comprises a cap0, cap1, or cap2, preferably cap1 or cap2. According to the present disclosure, the term “cap0” means the structure “m⁷GpppN”, wherein N is any nucleoside bearing an OH moiety at position 2′. According to the present disclosure, the term “cap1” means the structure “m⁷GpppNm”, wherein Nm is any nucleoside bearing an OCH₃ moiety at position 2′. According to the present disclosure, the term “cap2” means the structure “m⁷GpppNmNm”, wherein each Nm is independently any nucleoside bearing an OCH₃ moiety at position 2′.

The D1 diastereomer of beta-S-ARCA (β-S-ARCA) has the following structure:

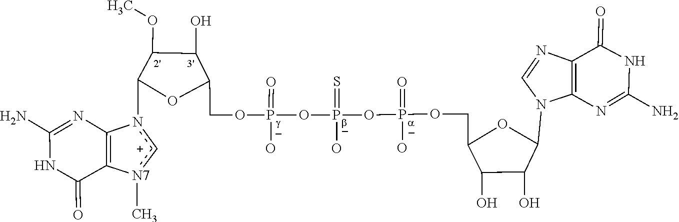

The “D1 diastereomer of beta-S-ARCA” or “beta-S-ARCA(D1)” is the diastereomer of beta-S-ARCA which elutes first on an HPLC column compared to the D2 diastereomer of beta-S-ARCA (beta-S-ARCA(D2)) and thus exhibits a shorter retention time. The HPLC preferably is an analytical HPLC. In one embodiment, a Supelcosil LC-18-T RP column, preferably of the format: 5 μm, 4.6×250 mm is used for separation, whereby a flow rate of 1.3 ml/min can be applied. In one embodiment, a gradient of methanol in ammonium acetate, for example, a 0-25% linear gradient of methanol in 0.05 M ammonium acetate, pH=5.9, within 15 min is used. UV-detection (VWD) can be performed at 260 nm and fluorescence detection (FLD) can be performed with excitation at 280 nm and detection at 337 nm.

The 5′-cap analog)m₂^{7,3′-O}Gppp(m₁^{2′-O})ApG (also referred to as m₂^{7,3′O}G(5′)ppp(5′)m^{2′-O}ApG) which is a building block of a cap1 has the following structure:

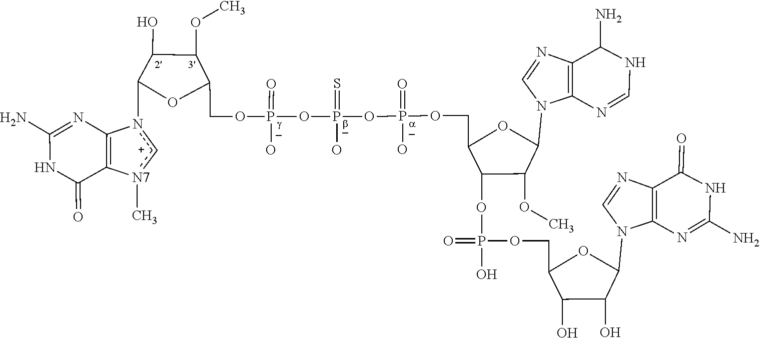

An exemplary cap0 RNA comprising β-S-ARCA and RNA has the following structure:

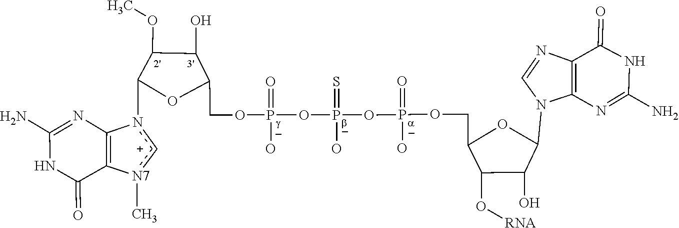

An exemplary cap0 RNA comprising m₂^{7,3′O}G(5′)ppp(5′)G and RNA has the following structure:

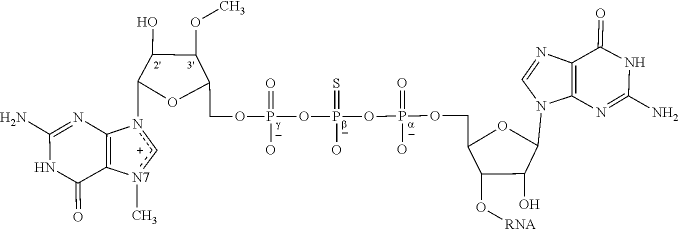

An exemplary cap1 RNA comprising)m₂^{7,3′-O}Gppp(m₁^{2′-O})ApG and RNA has the following structure:

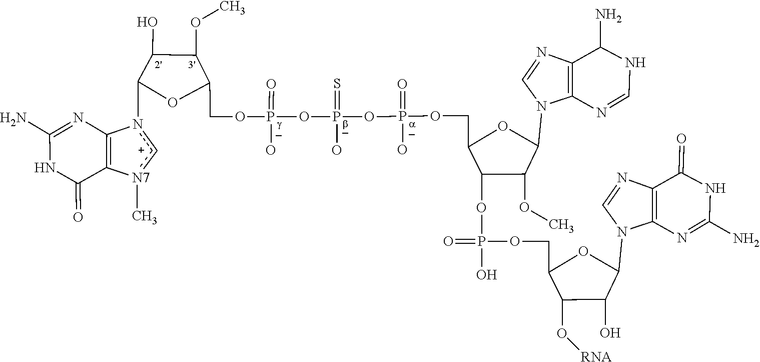

As used herein, the term “poly-A tail” or “poly-A sequence” refers to an uninterrupted or interrupted sequence of adenylate residues which is typically located at the 3′-end of an RNA molecule. Poly-A tails or poly-A sequences are known to those of skill in the art and may follow the 3′-UTR in the RNAs described herein. An uninterrupted poly-A tail is characterized by consecutive adenylate residues. In nature, an uninterrupted poly-A tail is typical. RNAs disclosed herein can have a poly-A tail attached to the free 3′-end of the RNA by a template-independent RNA polymerase after transcription or a poly-A tail encoded by DNA and transcribed by a template-dependent RNA polymerase.

It has been demonstrated that a poly-A tail of about 120 A nucleotides has a beneficial influence on the levels of RNA in transfected eukaryotic cells, as well as on the levels of protein that is translated from an open reading frame that is present upstream (5′) of the poly-A tail (Holtkamp et al., 2006, Blood, vol. 108, pp. 4009-4017).

The poly-A tail may be of any length. In some embodiments, a poly-A tail comprises, essentially consists of, or consists of at least 20, at least 30, at least 40, at least 80, or at least 100 and up to 500, up to 400, up to 300, up to 200, or up to 150 A nucleotides, and, in particular, about 120 A nucleotides. In this context, “essentially consists of” means that most nucleotides in the poly-A tail, typically at least 75%, at least 80%, at least 85%, at least 90%, at least 95%, at least 96%, at least 97%, at least 98%, or at least 99% by number of nucleotides in the poly-A tail are A nucleotides, but permits that remaining nucleotides are nucleotides other than A nucleotides, such as U nucleotides (uridylate), G nucleotides (guanylate), or C nucleotides (cytidylate). In this context, “consists of” means that all nucleotides in the poly-A tail, i.e., 100% by number of nucleotides in the poly-A tail, are A nucleotides. The term “A nucleotide” or “A” refers to adenylate.

In some embodiments, a poly-A tail is attached during RNA transcription, e.g., during preparation of in vitro transcribed RNA, based on a DNA template comprising repeated dT nucleotides (deoxythymidylate) in the strand complementary to the coding strand. The DNA sequence encoding a poly-A tail (coding strand) is referred to as poly(A) cassette.

In some embodiments, the poly(A) cassette present in the coding strand of DNA essentially consists of dA nucleotides, but is interrupted by a random sequence of the four nucleotides (dA, dC, dG, and dT). Such random sequence may be 5 to 50, 10 to 30, or 10 to 20 nucleotides in length. Such a cassette is disclosed in WO 2016/005324 A1, hereby incorporated by reference. Any poly(A) cassette disclosed in WO 2016/005324 A1 may be used in the present invention. A poly(A) cassette that essentially consists of dA nucleotides, but is interrupted by a random sequence having an equal distribution of the four nucleotides (dA, dC, dG, dT) and having a length of e.g., 5 to 50 nucleotides shows, on DNA level, constant propagation of plasmid DNA in E. coli and is still associated, on RNA level, with the beneficial properties with respect to supporting RNA stability and translational efficiency is encompassed. Consequently, in some embodiments, the poly-A tail contained in an RNA molecule described herein essentially consists of A nucleotides, but is interrupted by a random sequence of the four nucleotides (A, C, G, U). Such random sequence may be 5 to 50, 10 to 30, or 10 to 20 nucleotides in length.

In some embodiments, no nucleotides other than A nucleotides flank a poly-A tail at its 3′-end, i.e., the poly-A tail is not masked or followed at its 3′-end by a nucleotide other than A.

In some embodiments, RNA according to the present disclosure comprises a 5′-UTR and/or a 3′-UTR. The term “untranslated region” or “UTR” relates to a region in a DNA molecule which is transcribed but is not translated into an amino acid sequence, or to the corresponding region in an RNA molecule, such as an mRNA molecule. An untranslated region (UTR) can be present 5′ (upstream) of an open reading frame (5′-UTR) and/or 3′ (downstream) of an open reading frame (3′-UTR). A 5′-UTR, if present, is located at the 5′-end, upstream of the start codon of a protein-encoding region. A 5′-UTR is downstream of the 5′-cap (if present), e.g., directly adjacent to the 5′-cap. A 3′-UTR, if present, is located at the 3′-end, downstream of the termination codon of a protein-encoding region, but the term “3′-UTR” does preferably not include the poly-A sequence. Thus, the 3′-UTR is upstream of the poly-A sequence (if present), e.g., directly adjacent to the poly-A sequence. Incorporation of a 3′-UTR into the 3′-non translated region of an RNA (preferably mRNA) molecule can result in an enhancement in translation efficiency. A synergistic effect may be achieved by incorporating two or more of such 3′-UTRs (which are preferably arranged in a head-to-tail orientation; cf., e.g., Holtkamp et al., Blood 108, 4009-4017 (2006)). The 3′-UTRs may be autologous or heterologous to the RNA (preferably mRNA) into which they are introduced. In one particular embodiment the 3′-UTR is derived from a globin gene or mRNA, such as a gene or mRNA of alpha2-globin, alpha1-globin, or beta-globin, preferably beta-globin, more preferably human beta-globin. For example, the RNA (preferably mRNA) may be modified by the replacement of the existing 3′-UTR with or the insertion of one or more, preferably two copies of a 3′-UTR derived from a globin gene, such as alpha2-globin, alpha1-globin, beta-globin, preferably beta-globin, more preferably human beta-globin.

The RNA (preferably mRNA) may have modified ribonucleotides in order to increase its stability and/or decrease immunogenicity and/or decrease cytotoxicity. For example, in one embodiment, uridine in the RNA described herein is replaced (partially or completely, preferably completely) by a modified nucleoside. In some embodiments, the modified nucleoside is a modified uridine.

In some embodiments, the modified uridine replacing uridine is selected from the group consisting of pseudouridine (ψ), N1-methyl-pseudouridine (m1ψ), 5-methyl-uridine (m5U), and combinations thereof.

In some embodiments, the modified nucleoside replacing (partially or completely, preferably completely) uridine in the RNA may be any one or more of 3-methyl-uridine (m3U), 5-methoxy-uridine (mo5U), 5-aza-uridine, 6-aza-uridine, 2-thio-5-aza-uridine, 2-thio-uridine (s2U), 4-thio-uridine (s4U), 4-thio-pseudouridine, 2-thio-pseudouridine, 5-hydroxy-uridine (ho5U), 5-aminoallyl-uridine, 5-halo-uridine (e.g., 5-iodo-uridineor 5-bromo-uridine), uridine 5-oxyacetic acid (cmo5U), uridine 5-oxyacetic acid methyl ester (mcmo5U), 5-carboxymethyl-uridine (cm5U), 1-carboxymethyl-pseudouridine, 5-carboxyhydroxymethyl-uridine (chm5U), 5-carboxyhydroxymethyl-uridine methyl ester (mchm5U), 5-methoxycarbonylmethyl-uridine (mcm5U), 5-methoxycarbonylmethyl-2-thio-uridine (mcm5s2U), 5-aminomethyl-2-thio-uridine (nm5s2U), 5-methylaminomethyl-uridine (mnm5U), 1-ethyl-pseudouridine, 5-methylaminomethyl-2-thio-uridine (mnm5s2U), 5-methylaminomethyl-2-seleno-uridine (mnm5se2U), 5-carbamoylmethyl-uridine (ncm5U), 5-carboxymethylaminomethyl-uridine (cmnm5U), 5-carboxymethylaminomethyl-2-thio-uridine (cmnm5 s2U), 5-propynyl-uridine, 1-propynyl-pseudouridine, 5-taurinomethyl-uridine (τm5U), 1-taurinomethyl-pseudouridine, 5-taurinomethyl-2-thio-uridine (τm5 s2U), 1-taurinomethyl-4-thio-pseudouridine), 5-methyl-2-thio-uridine (m5s2U), 1-methyl-4-thio-pseudouridine (m1s4ψ), 4-thio-1-methyl-pseudouridine, 3-methyl-pseudouridine (m3ψ), 2-thio-1-methyl-pseudouridine, 1-methyl-1-deaza-pseudouridine, 2-thio-1-methyl-1-deaza-pseudouridine, dihydrouridine (D), dihydropseudouridine, 5,6-dihydrouridine, 5-methyl-dihydrouridine (m5D), 2-thio-dihydrouridine, 2-thio-dihydropseudouridine, 2-methoxy-uridine, 2-methoxy-4-thio-uridine, 4-methoxy-pseudouridine, 4-methoxy-2-thio-pseudouridine, N1-methyl-pseudouridine, 3-(3-amino-3-carboxypropyl)uridine (acp3U), 1-methyl-3-(3-amino-3-carboxypropyl)pseudouridine (acp3 ψ), 5-(isopentenylaminomethyl)uridine (inm5U), 5-(isopentenylaminomethyl)-2-thio-uridine (inm5s2U), α-thio-uridine, 2′-O-methyl-uridine (Um), 5,2′-O-dimethyl-uridine (m5Um), 2′-O-methyl-pseudouridine (ψvm), 2-thio-2′-O-methyl-uridine (s2Um), 5-methoxycarbonylmethyl-2′-O-methyl-uridine (mcm5Um), 5-carbamoylmethyl-2′-O-methyl-uridine (ncm5Um), 5-carboxymethylaminomethyl-2′-O-methyl-uridine (cmnm5Um), 3,2′-O-dimethyl-uridine (m3Um), 5-(isopentenylaminomethyl)-2′-O-methyl-uridine (inm5Um), 1-thio-uridine, deoxythymidine, 2′-F-ara-uridine, 2′-F-uridine, 2′-OH-ara-uridine, 5-(2-carbomethoxyvinyl) uridine, 5-[3-(1-E-propenylamino)uridine, or any other modified uridine known in the art.

An RNA (preferably mRNA) which is modified by pseudouridine (replacing partially or completely, preferably completely, uridine) is referred to herein as “Ψ-modified”, whereas the term “m1Ψ-modified” means that the RNA (preferably mRNA) contains N(1)-methylpseudouridine (replacing partially or completely, preferably completely, uridine). Furthermore, the term “m5U-modified” means that the RNA (preferably mRNA) contains 5-methyluridine (replacing partially or completely, preferably completely, uridine). Such or Ψ- or m1Ψ- or m5U-modified RNAs usually exhibit decreased immunogenicity compared to their unmodified forms and, thus, are preferred in applications where the induction of an immune response is to be avoided or minimized.

The codons of the RNA (preferably mRNA) of the present disclosure may further be optimized, e.g., to increase the GC content of the RNA and/or to replace codons which are rare in the cell (or subject) in which the peptide or protein of interest is to be expressed by codons which are synonymous frequent codons in said cell (or subject).

A combination of the above described modifications, i.e., incorporation of a 5′-cap structure, incorporation of a poly-A sequence, unmasking of a poly-A sequence, alteration of the 5′- and/or 3′-UTR (such as incorporation of one or more 3′-UTRs), replacing one or more naturally occurring nucleotides with synthetic nucleotides (e.g., 5-methylcytidine for cytidine and/or pseudouridine (Ψ) or N(1)-methylpseudouridine (m1Ψ) or 5-methyluridine (m5U) for uridine), and codon optimization, has a synergistic influence on the stability of RNA (preferably mRNA) and increase in translation efficiency. Thus, in a preferred embodiment, the RNA (preferably mRNA) according to the present disclosure contains a combination of at least two, at least three, at least four or all five of the above-mentioned modifications, i.e., (i) incorporation of a 5′-cap structure, (ii) incorporation of a poly-A sequence, unmasking of a poly-A sequence; (iii) alteration of the 5′- and/or 3′-UTR (such as incorporation of one or more 3′-UTRs); (iv) replacing one or more naturally occurring nucleotides with synthetic nucleotides (e.g., 5-methylcytidine for cytidine and/or pseudouridine (Ψ) or N(1)-methylpseudouridine (m1Ψ) or 5-methyluridine (m5U) for uridine), and (v) codon optimization.

In one embodiment, RNA according to the present disclosure comprises a nucleic acid sequence encoding a peptide or protein, preferably a pharmaceutically active peptide or protein.

In a preferred embodiment, RNA according to the present disclosure comprises a nucleic acid sequence encoding a peptide or protein, preferably a pharmaceutically active peptide or protein, and is capable of expressing said peptide or protein, in particular if transferred into a cell or subject. Thus, the RNA according to the present invention preferably contains a coding region (open reading frame (ORF)) encoding a peptide or protein, preferably encoding a pharmaceutically active peptide or protein. In this respect, an “open reading frame” or “ORF” is a continuous stretch of codons beginning with a start codon and ending with a stop codon.

According to the present disclosure, the term “pharmaceutically active peptide or protein” means a peptide or protein that can be used in the treatment of an individual where the expression of a peptide or protein would be of benefit, e.g., in ameliorating the symptoms of a disease or disorder. Preferably, a pharmaceutically active peptide or protein has curative or palliative properties and may be administered to ameliorate, relieve, alleviate, reverse, delay onset of or lessen the severity of one or more symptoms of a disease or disorder. Preferably, a pharmaceutically active peptide or protein has a positive or advantageous effect on the condition or disease state of an individual when administered to the individual in a therapeutically effective amount. A pharmaceutically active peptide or protein may have prophylactic properties and may be used to delay the onset of a disease or disorder or to lessen the severity of such disease or disorder. The term “pharmaceutically active peptide or protein” includes entire proteins or polypeptides, and can also refer to pharmaceutically active fragments thereof. It can also include pharmaceutically active analogs of a peptide or protein.

Specific examples of pharmaceutically active peptides and proteins include, but are not limited to, cytokines, hormones, adhesion molecules, immunoglobulins, immunologically active compounds, growth factors, protease inhibitors, enzymes, receptors, apoptosis regulators, transcription factors, tumor suppressor proteins, structural proteins, reprogramming factors, genomic engineering proteins, and blood proteins.

The term “cytokines” relates to proteins which have a molecular weight of about 5 to 20 kDa and which participate in cell signaling (e.g., paracrine, endocrine, and/or autocrine signaling) In particular, when released, cytokines exert an effect on the behavior of cells around the place of their release. Examples of cytokines include lymphokines, interleukins, chemokines, interferons, and tumor necrosis factors (TNFs). According to the present disclosure, cytokines do not include hormones or growth factors. Cytokines differ from hormones in that (i) they usually act at much more variable concentrations than hormones and (ii) generally are made by a broad range of cells (nearly all nucleated cells can produce cytokines). Interferons are usually characterized by antiviral, antiproliferative and immunomodulatory activities. Interferons are proteins that alter and regulate the transcription of genes within a cell by binding to interferon receptors on the regulated cell's surface, thereby preventing viral replication within the cells. The interferons can be grouped into two types. IFN-gamma is the sole type II interferon; all others are type I interferons. Particular examples of cytokines include erythropoietin (EPO), colony stimulating factor (CSF), granulocyte colony stimulating factor (G-CSF), granulocyte-macrophage colony stimulating factor (GM-CSF), tumor necrosis factor (TNF), bone morphogenetic protein (BMP), interferon alfa (IFNα), interferon beta (IFNβ), interferon gamma (INFγ), interleukin 2 (IL-2), interleukin 4 (IL-4), interleukin 10 (IL-10), and interleukin 11 (IL-11).

The term “hormones” relates to a class of signaling molecules produced by glands, wherein signaling usually includes the following steps: (i) synthesis of a hormone in a particular tissue; (ii) storage and secretion; (iii) transport of the hormone to its target; (iv) binding of the hormone by a receptor; (v) relay and amplification of the signal; and (vi) breakdown of the hormone. Hormones differ from cytokines in that (1) hormones usually act in less variable concentrations and (2) generally are made by specific kinds of cells. In one embodiment, a “hormone” is a peptide or protein hormone, such as insulin, vasopressin, prolactin, adrenocorticotropic hormone (ACTH), thyroid hormone, growth hormones (such as human grown hormone or bovine somatotropin), oxytocin, atrial-natriuretic peptide (ANP), glucagon, somatostatin, cholecystokinin, gastrin, and leptins.

The term “adhesion molecules” relates to proteins which are located on the surface of a cell and which are involved in binding of the cell with other cells or with the extracellular matrix (ECM). Adhesion molecules are typically transmembrane receptors and can be classified as calcium-independent (e.g., integrins, immunoglobulin superfamily, lymphocyte homing receptors) and calcium-dependent (cadherins and selectins). Particular examples of adhesion molecules are integrins, lymphocyte homing receptors, selectins (e.g., P-selectin), and addressins.

Integrins are also involved in signal transduction. In particular, upon ligand binding, integrins modulate cell signaling pathways, e.g., pathways of transmembrane protein kinases such as receptor tyrosine kinases (RTK). Such regulation can lead to cellular growth, division, survival, or differentiation or to apoptosis. Particular examples of integrins include: α₁β1, α₂β1, α₃β1, α₄β1, α₅β1, α₆β1, α₇β1, α_{L}β2, α_{M}β2, α_{IIb}β3, αᵥβ1, αᵥβ3, αᵥβ5, αᵥβ6, αᵥβ8, and α₆β4.

The term “immunoglobulins” or “immunoglobulin superfamily” refers to molecules which are involved in the recognition, binding, and/or adhesion processes of cells. Molecules belonging to this superfamily share the feature that they contain a region known as immunoglobulin domain or fold. Members of the immunoglobulin superfamily include antibodies (e.g., IgG), T cell receptors (TCRs), major histocompatibility complex (MHC) molecules, co-receptors (e.g., CD4, CD8, CD19), antigen receptor accessory molecules (e.g., CD-3γ, CD3-δ, CD-3ε, CD79a, CD79b), co-stimulatory or inhibitory molecules (e.g., CD28, CD80, CD86), and other.

The term “immunologically active compound” relates to any compound altering an immune response, preferably by inducing and/or suppressing maturation of immune cells, inducing and/or suppressing cytokine biosynthesis, and/or altering humoral immunity by stimulating antibody production by B cells. Immunologically active compounds possess potent immunostimulating activity including, but not limited to, antiviral and antitumor activity, and can also down-regulate other aspects of the immune response, for example shifting the immune response away from a TH2 immune response, which is useful for treating a wide range of TH2 mediated diseases Immunologically active compounds can be useful as vaccine adjuvants. Particular examples of immunologically active compounds include interleukins, colony stimulating factor (CSF), granulocyte colony stimulating factor (G-CSF), granulocyte-macrophage colony stimulating factor (GM-CSF), erythropoietin, tumor necrosis factor (TNF), interferons, integrins, addressins, selectins, homing receptors, and antigens, in particular tumor-associated antigens, pathogen-associated antigens (such as bacterial, parasitic, or viral antigens), allergens, and autoantigens.

The term “autoantigen” or “self-antigen” refers to an antigen which originates from within the body of a subject (i.e., the autoantigen can also be called “autologous antigen”) and which produces an abnormally vigorous immune response against this normal part of the body. Such vigorous immune reactions against autoantigens may be the cause of “autoimmune diseases”.

The term “allergen” refers to a kind of antigen which originates from outside the body of a subject (i.e., the allergen can also be called “heterologous antigen”) and which produces an abnormally vigorous immune response in which the immune system of the subject fights off a perceived threat that would otherwise be harmless to the subject. “Allergies” are the diseases caused by such vigorous immune reactions against allergens. An allergen usually is an antigen which is able to stimulate a type-I hypersensitivity reaction in atopic individuals through immunoglobulin E (IgE) responses. Particular examples of allergens include allergens derived from peanut proteins (e.g., Ara h 2.02), ovalbumin, grass pollen proteins (e.g., Ph1 p 5), and proteins of dust mites (e.g., Der p 2).

The term “growth factors” refers to molecules which are able to stimulate cellular growth, proliferation, healing, and/or cellular differentiation. Typically, growth factors act as signaling molecules between cells. The term “growth factors” include particular cytokines and hormones which bind to specific receptors on the surface of their target cells. Examples of growth factors include bone morphogenetic proteins (BMPs), fibroblast growth factors (FGFs), vascular endothelial growth factors (VEGFs), such as VEGFA, epidermal growth factor (EGF), insulin-like growth factor, ephrins, macrophage colony-stimulating factor, granulocyte colony-stimulating factor, granulocyte macrophage colony-stimulating factor, neuregulins, neurotrophins (e.g., brain-derived neurotrophic factor (BDNF), nerve growth factor (NGF)), placental growth factor (PGF), platelet-derived growth factor (PDGF), renalase (RNLS) (anti-apoptotic survival factor), T-cell growth factor (TCGF), thrombopoietin (TPO), transforming growth factors (transforming growth factor alpha (TGF-α), transforming growth factor beta (TGF-β)), and tumor necrosis factor-alpha (TNF-α). In one embodiment, a “growth factor” is a peptide or protein growth factor.

The term “protease inhibitors” refers to molecules, in particular peptides or proteins, which inhibit the function of proteases. Protease inhibitors can be classified by the protease which is inhibited (e.g., aspartic protease inhibitors) or by their mechanism of action (e.g., suicide inhibitors, such as serpins). Particular examples of protease inhibitors include serpins, such as alpha 1-antitrypsin, aprotinin, and bestatin.

The term “enzymes” refers to macromolecular biological catalysts which accelerate chemical reactions. Like any catalyst, enzymes are not consumed in the reaction they catalyze and do not alter the equilibrium of said reaction. Unlike many other catalysts, enzymes are much more specific. In one embodiment, an enzyme is essential for homeostasis of a subject, e.g., any malfunction (in particular, decreased activity which may be caused by any of mutation, deletion or decreased production) of the enzyme results in a disease. Examples of enzymes include herpes simplex virus type 1 thymidine kinase (HSV1-TK), hexosaminidase, phenylalanine hydroxylase, pseudocholinesterase, and lactase.

The term “receptors” refers to protein molecules which receive signals (in particular chemical signals called ligands) from outside a cell. The binding of a signal (e.g., ligand) to a receptor causes some kind of response of the cell, e.g., the intracellular activation of a kinase. Receptors include transmembrane receptors (such as ion channel-linked (ionotropic) receptors, G protein-linked (metabotropic) receptors, and enzyme-linked receptors) and intracellular receptors (such as cytoplasmic receptors and nuclear receptors). Particular examples of receptors include steroid hormone receptors, growth factor receptors, and peptide receptors (i.e., receptors whose ligands are peptides), such as P-selectin glycoprotein ligand-1 (PSGL-1). The term “growth factor receptors” refers to receptors which bind to growth factors.

The term “apoptosis regulators” refers to molecules, in particular peptides or proteins, which modulate apoptosis, i.e., which either activate or inhibit apoptosis. Apoptosis regulators can be grouped into two broad classes: those which modulate mitochondrial function and those which regulate caspases. The first class includes proteins (e.g., BCL-2, BCL-xL) which act to preserve mitochondrial integrity by preventing loss of mitochondrial membrane potential and/or release of pro-apoptotic proteins such as cytochrome C into the cytosol. Also to this first class belong proapoptotic proteins (e.g., BAX, BAK, BIM) which promote release of cytochrome C. The second class includes proteins such as the inhibitors of apoptosis proteins (e.g., XIAP) or FLIP which block the activation of caspases.

The term “transcription factors” relates to proteins which regulate the rate of transcription of genetic information from DNA to messenger RNA, in particular by binding to a specific DNA sequence. Transcription factors may regulate cell division, cell growth, and cell death throughout life; cell migration and organization during embryonic development; and/or in response to signals from outside the cell, such as a hormone. Transcription factors contain at least one DNA-binding domain which binds to a specific DNA sequence, usually adjacent to the genes which are regulated by the transcription factors. Particular examples of transcription factors include MECP2, FOXP2, FOXP3, the STAT protein family, and the HOX protein family.

The term “tumor suppressor proteins” relates to molecules, in particular peptides or proteins, which protect a cell from one step on the path to cancer. Tumor-suppressor proteins (usually encoded by corresponding tumor-suppressor genes) exhibit a weakening or repressive effect on the regulation of the cell cycle and/or promote apoptosis. Their functions may be one or more of the following: repression of genes essential for the continuing of the cell cycle; coupling the cell cycle to DNA damage (as long as damaged DNA is present in a cell, no cell division should take place); initiation of apoptosis, if the damaged DNA cannot be repaired; metastasis suppression (e.g., preventing tumor cells from dispersing, blocking loss of contact inhibition, and inhibiting metastasis); and DNA repair. Particular examples of tumor-suppressor proteins include p53, phosphatase and tensin homolog (PTEN), SWI/SNF (SWItch/Sucrose Non-Fermentable), von Hippel-Lindau tumor suppressor (pVHL), adenomatous polyposis coli (APC), CD95, suppression of tumorigenicity 5 (ST5), suppression of tumorigenicity 5 (ST5), suppression of tumorigenicity 14 (ST14), and Yippee-like 3 (YPEL3).

The term “structural proteins” refers to proteins which confer stiffness and rigidity to otherwise-fluid biological components. Structural proteins are mostly fibrous (such as collagen and elastin) but may also be globular (such as actin and tubulin). Usually, globular proteins are soluble as monomers, but polymerize to form long, fibers which, for example, may make up the cytoskeleton. Other structural proteins are motor proteins (such as myosin, kinesin, and dynein) which are capable of generating mechanical forces, and surfactant proteins. Particular examples of structural proteins include collagen, surfactant protein A, surfactant protein B, surfactant protein C, surfactant protein D, elastin, tubulin, actin, and myosin.

The term “reprogramming factors” or “reprogramming transcription factors” relates to molecules, in particular peptides or proteins, which, when expressed in somatic cells optionally together with further agents such as further reprogramming factors, lead to reprogramming or de-differentiation of said somatic cells to cells having stem cell characteristics, in particular pluripotency. Particular examples of reprogramming factors include OCT4, SOX2, c-MYC, KLF4, LIN28, and NANOG.

The term “genomic engineering proteins” relates to proteins which are able to insert, delete or replace DNA in the genome of a subject. Particular examples of genomic engineering proteins include meganucleases, zinc finger nucleases (ZFNs), transcription activator-like effector nucleases (TALENs), and clustered regularly spaced short palindromic repeat-CRISPR-associated protein 9 (CRISPR-Cas9).

The term “blood proteins” relates to peptides or proteins which are present in blood plasma of a subject, in particular blood plasma of a healthy subject. Blood proteins have diverse functions such as transport (e.g., albumin, transferrin), enzymatic activity (e.g., thrombin or ceruloplasmin), blood clotting (e.g., fibrinogen), defense against pathogens (e.g., complement components and immunoglobulins), protease inhibitors (e.g., alpha 1-antitrypsin), etc. Particular examples of blood proteins include thrombin, serum albumin, Factor VII, Factor VIII, insulin, Factor IX, Factor X, tissue plasminogen activator, protein C, von Willebrand factor, antithrombin III, glucocerebrosidase, erythropoietin, granulocyte colony stimulating factor (G-CSF), modified Factor VIII, and anticoagulants.

Thus, in one embodiment, the pharmaceutically active peptide or protein is (i) a cytokine, preferably selected from the group consisting of erythropoietin (EPO), interleukin 4 (IL-2), and interleukin 10 (IL-11), more preferably EPO; (ii) an adhesion molecule, in particular an integrin; (iii) an immunoglobulin, in particular an antibody; (iv) an immunologically active compound, in particular an antigen; (v) a hormone, in particular vasopressin, insulin or growth hormone; (vi) a growth factor, in particular VEGFA; (vii) a protease inhibitor, in particular alpha 1-antitrypsin; (viii) an enzyme, preferably selected from the group consisting of herpes simplex virus type 1 thymidine kinase (HSV1-TK), hexosaminidase, phenylalanine hydroxylase, pseudocholinesterase, pancreatic enzymes, and lactase; (ix) a receptor, in particular growth factor receptors; (x) an apoptosis regulator, in particular BAX; (xi) a transcription factor, in particular FOXP3; (xii) a tumor suppressor protein, in particular p53; (xiii) a structural protein, in particular surfactant protein B; (xiv) a reprogramming factor, e.g., selected from the group consisting of OCT4, SOX2, c-MYC, KLF4, LIN28 and NANOG; (xv) a genomic engineering protein, in particular clustered regularly spaced short palindromic repeat-CRISPR-associated protein 9 (CRISPR-Cas9); and (xvi) a blood protein, in particular fibrinogen.

In one embodiment, a pharmaceutically active peptide or protein comprises one or more antigens or one or more epitopes, i.e., administration of the peptide or protein to a subject elicits an immune response against the one or more antigens or one or more epitopes in a subject which may be therapeutic or partially or fully protective.

In certain embodiments, the RNA encodes at least one epitope. In certain embodiments, the epitope is derived from a tumor antigen. The tumor antigen may be a “standard” antigen, which is generally known to be expressed in various cancers. The tumor antigen may also be a “neo-antigen”, which is specific to an individual's tumor and has not been previously recognized by the immune system. A neo-antigen or neo-epitope may result from one or more cancer-specific mutations in the genome of cancer cells resulting in amino acid changes. Examples of tumor antigens include, without limitation, p53, ART-4, BAGE, beta-catenin/m, Bcr-abL CAMEL, CAP-1, CASP-8, CDC27/m, CDK4/m, CEA, the cell surface proteins of the claudin family, such as CLAUD FN-6, CLAUDIN-18.2 and CLAUDIN-12, c-MYC, CT, Cyp-B, DAM, ELF2M, ETV6-AML1, G250, GAGE, GnT-V, Gap 100, HAGE, HER-2/neu, HPV-E7, HPV-E6, HAST-2, hTERT (or hTRT), LAGE, LDLR/FUT, MAGE-A, preferably MAGE-A1, MAGE-A2, MAGE-A3, MAGE-A4, MAGE-A5, MAGE-A6, MAGE-A7, MAGE-A8, MAGE-A9, MAGE-A 10, MAGE-A11, or MAGE-A12, MAGE-B, MAGE-C, MART-1/Melan-A, MC1R, Myosin/m, MUC1, MUM-1, MUM-2, MUM-3, NA88-A, NF1, NY-ESO-1, NY-BR-1, p190 minor BCR-abL, Pm1/RARa, PRAME, proteinase 3, PSA, PSM, RAGE, RU1 or RU2, SAGE, SART-1 or SART-3, SCGB3A2, SCP1, SCP2, SCP3, SSX, SURVIVIN, TEL/AML1, TPI/m, TRP-1, TRP-2, TRP-2/INT2, TPTE, WT, and WT-1.

Cancer mutations vary with each individual. Thus, cancer mutations that encode novel epitopes (neo-epitopes) represent attractive targets in the development of vaccine compositions and immunotherapies. The efficacy of tumor immunotherapy relies on the selection of cancer-specific antigens and epitopes capable of inducing a potent immune response within a host. RNA can be used to deliver patient-specific tumor epitopes to a patient. Dendritic cells (DCs) residing in the spleen represent antigen-presenting cells of particular interest for RNA expression of immunogenic epitopes or antigens such as tumor epitopes. The use of multiple epitopes has been shown to promote therapeutic efficacy in tumor vaccine compositions. Rapid sequencing of the tumor mutanome may provide multiple epitopes for individualized vaccines which can be encoded by RNA described herein, e.g., as a single polypeptide wherein the epitopes are optionally separated by linkers. In certain embodiments of the present disclosure, the RNA encodes at least one epitope, at least two epitopes, at least three epitopes, at least four epitopes, at least five epitopes, at least six epitopes, at least seven epitopes, at least eight epitopes, at least nine epitopes, or at least ten epitopes. Exemplary embodiments include RNA that encodes at least five epitopes (termed a “pentatope”) and RNA that encodes at least ten epitopes (termed a “decatope”).

Particles

In the context of the present disclosure, the term “particle” relates to a structured entity formed by molecules or molecule complexes, in particular particle forming compounds. Preferably, the particle contains an envelope (e.g., one or more layers or lamellas) made of one or more types of amphiphilic substances (e.g., amphiphilic lipids, amphiphilic polymers, and/or amphiphilic proteins/polypeptides). In this context, the expression “amphiphilic substance” means that the substance possesses both hydrophilic and lipophilic properties. The envelope may also comprise additional substances (e.g., additional lipids and/or additional polymers) which do not have to be amphiphilic. Thus, in one embodiment the particle is a monolamellar or multilamellar structure, wherein the substances constituting the one or more layers or lamellas comprise one or more types of amphiphilic substances (in particular selected from the group consisting of amphiphilic lipids, amphiphilic polymers, and/or amphiphilic proteins/polypeptides) optionally in combination with additional substances (e.g., additional lipids and/or additional polymers) which do not have to be amphiphilic. In one embodiment, the term “particle” relates to a micro- or nano-sized structure, such as a micro- or nano-sized compact structure. In this respect, the term “micro-sized” means that all three external dimensions of the particle are in the microscale, i.e., between 1 and 5 μm. According to the present disclosure, the term “particle” includes lipoplex particles (LPXs), lipid nanoparticles (LNPs), polyplex particles, lipopolyplex particles, virus-like particles (VLPs), and mixtures thereof (e.g., a mixture of two or more of particle types, such as a mixture of LPXs and VLPs or a mixture of LNPs and VLPs).

As used in the present disclosure, “nanoparticle” refers to a particle comprising nucleic acid (especially RNA) as described herein and at least one cationic lipid, wherein all three external dimensions of the particle are in the nanoscale, i.e., at least about 1 nm and below about 1000 nm (preferably, between 10 and 990 nm, such as between 15 and 900 nm, between 20 and 800 nm, between 30 and 700 nm, between 40 and 600 nm, or between 50 and 500 nm). Preferably, the longest and shortest axes do not differ significantly. Preferably, the size of a particle is its diameter.

In the context of the present disclosure, the term “lipoplex particle” relates to a particle that contains an amphiphilic lipid, in particular cationic amphiphilic lipid, and nucleic acid (especially RNA) as described herein. Electrostatic interactions between positively charged liposomes (made from one or more amphiphilic lipids, in particular cationic amphiphilic lipids) and negatively charged nucleic acid (especially RNA) results in complexation and spontaneous formation of nucleic acid lipoplex particles. Positively charged liposomes may be generally synthesized using a cationic amphiphilic lipid, such as DOTMA, and additional lipids, such as DOPE. In one embodiment, a nucleic acid (especially RNA) lipoplex particle is a nanoparticle.

The term “lipid nanoparticle” relates to a nano-sized lipoplex particle.

In the context of the present disclosure, the term “polyplex particle” relates to a particle that contains an amphiphilic polymer, in particular a cationic amphiphilic polymer, and nucleic acid (especially RNA) as described herein. Electrostatic interactions between positively charged cationic amphiphilic polymers and negatively charged nucleic acid (especially RNA) results in complexation and spontaneous formation of nucleic acid polyplex particles. Positively charged amphiphilic polymers suitable for the preparation of polyplex particle include protamine, polyethyleneimine, poly-L-lysine, poly-L-arginine and histone. In one embodiment, a nucleic acid (especially RNA) polyplex particle is a nanoparticle.

The term “lipopolyplex particle” relates to particle that contains amphiphilic lipid (in particular cationic amphiphilic lipid) as described herein, amphiphilic polymer (in particular cationic amphiphilic polymer) as described herein, and nucleic acid (especially RNA) as described herein. In one embodiment, a nucleic acid (especially RNA) lipopolyplex particle is a nanoparticle.

The term “virus-like particle” (abbreviated herein as VLP) refers to a molecule that closely resembles a virus, but which does not contain any genetic material of said virus and, thus, is non-infectious. Preferably, VLPs contain nucleic acid (preferably RNA) as described herein, said nucleic acid (preferably RNA) being heterologous to the virus(es) from which the VLPs are derived. VLPs can be synthesized through the individual expression of viral structural proteins, which can then self-assemble into the virus-like structure. In one embodiment, combinations of structural capsid proteins from different viruses can be used to create recombinant VLPs. VLPs can be produced from components of a wide variety of virus families including Hepatitis B virus (HBV) (small HBV derived surface antigen (HBsAg)), Parvoviridae (e.g., adeno-associated virus), Papillomaviridae (e.g., HPV), Retroviridae (e.g., HIV), Flaviviridae (e.g., Hepatitis C virus) and bacteriophages (e.g. Qβ, AP205).

The term “nucleic acid containing particle” relates to particle as described herein to which nucleic acid (especially RNA) is bound. In this respect, the nucleic acid (especially RNA) may be adhered to the outer surface of the particle (surface nucleic acid (especially surface RNA)) and/or may be contained in the particle (encapsulated nucleic acid (especially encapsulated RNA)).

In one embodiment, the particles utilized in the methods and uses of the present disclosure have a size (preferably a diameter, i.e., double the radius such as double the radius of gyration (R_{g}) value or double the hydrodynamic radius) in the range of about 10 to about 2000 nm, such as at least about 15 nm (preferably at least about 20 nm, at least about 25 nm, at least about 30 nm, at least about 35 nm, at least about 40 nm, at least about 45 nm, at least about 50 nm, at least about 55 nm, at least about 60 nm, at least about 65 nm, at least about 70 nm, at least about 75 nm, at least about 80 nm, at least about 85 nm, at least about 90 nm, at least about 95 nm, or at least about 100 nm) and/or at most 1900 nm (preferably at most about 1900 nm, at most about 1800 nm, at most about 1700 nm, at most about 1600 nm, at most about 1500 nm, at most about 1400 nm, at most about 1300 nm, at most about 1200 nm, at most about 1100 nm, at most about 1000 nm, at most about 950 nm, at most about 900 nm, at most about 850 nm, at most about 800 nm, at most about 750 nm, at most about 700 nm, at most about 650 nm, at most about 600 nm, at most about 550 nm, or at most about 500 nm), preferably in the range of about 20 to about 1500 nm, such as about 30 to about 1200 nm, about 40 to about 1100 nm, about 50 to about 1000, about 60 to about 900 nm, about 70 to 800 nm, about 80 to 700 nm, about 90 to 600 nm, or about 100 to 500 nm, such as in the range of 10 to 1000 nm, 15 to 500 nm, 20 to 450 nm, 25 to 400 nm, 30 to 350 nm, 40 to 300 nm, or 50 to 250 nm.

In one embodiment, the nucleic acid (especially RNA) when in free form (i.e., not bound or adhered to particles contained in a sample or control composition comprising nucleic acid (especially RNA) and particles) or when in unformulated form (i.e., in a composition lacking particles as specified herein, such as lacking particle forming compounds (e.g., components constituting liposomes (in particular cationic lipid(s)) and/or virus-like particles)) has a size (preferably a diameter, i.e., double the radius such as double the radius of gyration (R_{g}) value or double the hydrodynamic radius) in the range of about 10 to about 200 nm, such as about 15 to about 190 nm, about 20 to about 180 nm, about 25 to about 170 nm, or about 30 to about 160 nm.

Sample Composition

According to the present disclosure, a sample composition comprises nucleic acid (especially RNA) as disclosed herein and optionally particles as disclosed herein. In one embodiment, the sample composition comprises RNA as disclosed herein. In one embodiment, the sample composition comprises RNA as disclosed herein and particles as disclosed herein. In one embodiment, the sample composition comprises RNA and a mixture of particles as disclosed herein, e.g., a mixture of two or more of types of particles, such as a mixture of LPXs and VLPs or a mixture of LNPs and VLPs or a mixture of LPXs, VLPs, and VLPs.

The sample compositions may be provided (e.g., prepared) using procedures known to the skilled person. For example, a sample composition comprising RNA as disclosed herein may be provided (e.g., prepared) by in vitro transcription or chemical synthesis, as known to the skilled person or disclosed herein. Such a composition comprising RNA can then be used to produce a sample composition comprising RNA and particles. For example, such a sample composition can be prepared by providing a liposome composition containing one or more suitable lipids and mixing the composition comprising RNA with the liposome composition. The liposome composition is preferably prepared by using the ethanol injection technique. In an alternative embodiment, the liposome composition is preferably prepared by using Microfluidic Hydrodynamic Focusing (MHF) (cf. Zizzari et al., Materials, 10 (2017), 1411, the entire disclosure of which is incorporated herein by reference), or a similar procedure.

Several reaction conditions under which a sample composition (e.g. a first composition as referred to in steps (A) and (C) in the methods of the second aspect or a second composition as referred in steps (B) and (D) in the methods of the second aspect) is provided (e.g., prepared, processed (such as purified and/or dried) and/or stored) may have an impact on one or more parameters of said sample composition, wherein the one or more parameters comprise the nucleic acid integrity (especially RNA integrity), the total amount of nucleic acid (especially RNA), the amount of free nucleic acid (especially RNA), the amount of nucleic acid (especially RNA) bound to particles, the size of nucleic acid (especially RNA) containing particles (in particular, based on the radius of gyration (R_{g}) of nucleic acid (such as RNA) containing particles and/or the hydrodynamic radius (Rₕ) of nucleic acid (especially RNA) containing particles), the size distribution of nucleic acid (especially RNA) containing particles (e.g., based on R_{g} or Rₕ values of nucleic acid (especially RNA) containing particles), and the quantitative size distribution of nucleic acid (especially RNA) containing particles (e.g., based on R_{g} or Rₕ values of nucleic acid (especially RNA) containing particles) (additional optional parameters include the molecular weight of nucleic acid (especially RNA), the amount of surface nucleic acid (such as the amount of surface RNA), the amount of encapsulated nucleic acid (such as the amount of encapsulated RNA), the amount of accessible nucleic acid (such as the amount of accessible RNA), the size of nucleic acid (especially RNA) (in particular, based on R_{g} and/or Rₕ values of nucleic acid (especially RNA)), the size distribution of nucleic acid (especially RNA) (e.g., based on R_{g} or Rₕ values of nucleic acid (especially RNA)), the quantitative size distribution of nucleic acid (especially RNA) (e.g., based on R_{g} or Rₕ values) of nucleic acid (especially RNA)), the shape factor, the form factor, and the nucleic acid (especially RNA) encapsulation efficiency; further additional optional parameters include the ratio of the amount of nucleic acid (such as RNA) bound to particles to the total amount of particle forming compounds (in particular lipids and/or polymers) in the particles, wherein said ratio may be given as a function of the particle size; the ratio of the amount of positively charged moieties of particle forming compounds (in particular lipids and/or polymers) in the particles to the amount of nucleic acid (such as RNA) bound to particles, wherein said ratio may be given as a function of the particle size; and the charge ratio of the amount of positively charged moieties of particle forming compounds (in particular lipids and/or polymers) in the particles to the amount of negatively charged moieties of nucleic acid (such as RNA) bound to particles, wherein said charge ratio is usually denoted as N/P ratio and may be given as a function of the particle size). Those reaction conditions include, but are not limited to, salt concentration/ionic strength; temperature (e.g., for drying and/or storage); pH or buffer concentration; light/radiation; oxygen; shear force; pressure; freezing/thawing cycle; drying/reconstitution cycle; addition of excipient(s) (e.g., a stabilizer and/or a chelating agent); type and/or source of particle forming compounds (in particular lipids (e.g., cationic amphiphilic lipids) and/or polymers (e.g., cationic amphiphilic polymers)); ratio of nucleic acid (especially RNA) to particle forming compounds (in particular lipids (e.g., cationic amphiphilic lipids) and/or polymers (e.g., cationic amphiphilic polymers)); charge ratio; and physical state.

A) Salt and Ionic Strength

According to the present disclosure, the sample compositions described herein may comprise salts such as sodium chloride. Without wishing to be bound by theory, sodium chloride functions as an ionic osmolality agent for preconditioning nucleic acid (especially RNA) prior to mixing with the at least one cationic lipid. Certain embodiments contemplate alternative organic or inorganic salts to sodium chloride in the present disclosure. Alternative salts include, without limitation, potassium chloride, dipotassium phosphate, monopotassium phosphate, potassium acetate, potassium bicarbonate, potassium sulfate, potassium acetate, disodium phosphate, monosodium phosphate, sodium acetate, sodium bicarbonate, sodium sulfate, sodium acetate, lithium chloride, magnesium chloride, magnesium phosphate, calcium chloride, and sodium salts of ethylenediaminetetraacetic acid (EDTA).

Generally, sample compositions comprising nucleic acid (especially RNA) particles described herein may comprise sodium chloride at a concentration that preferably ranges from 0 mM to about 500 mM, from about 2 mM to about 400 mM, from about 4 mM to about 300 mM, from about 6 mM to about 200 mM, or from about 10 mM to about 100 mM. Exemplary salt concentrations include 1, 2, 3, 4, 5, 6, 7, 8, 9, 10, 12, 14, 16, 18, 20, 25, 30, 35, 40, 45, 50, 60, 70, 80, 90, or 100 mM of a salt, such as 1, 2, 3, 4, 5, 6, 7, 8, 9, 10, 12, 14, 16, 18, 20, 25, 30, 35, 40, 45, 50, 60, 70, 80, 90, or 100 mM NaCl. In one embodiment, compositions comprising nucleic acid (especially RNA) particles comprise an ionic strength corresponding to such sodium chloride concentrations.

Generally, sample compositions for and resulting from forming nucleic acid (especially RNA) particles from nucleic acid (especially RNA) and liposomes such as those described herein may comprise high sodium chloride concentrations, or may comprise a high ionic strength. In one embodiment, the sodium chloride is at a concentration of at least 45 mM, such as from about 45 mM to about 300 mM, or from about 50 mM to about 150 mM. In one embodiment, the sample compositions comprise an ionic strength corresponding to such sodium chloride concentrations.

Generally, compositions for storing nucleic acid (especially RNA) particles such as for freezing of nucleic acid (especially RNA) particles such as those described herein may comprise low sodium chloride concentrations, or may comprise a low ionic strength. In one embodiment, the sodium chloride is at a concentration from 0 mM to about 50 mM, from 2 mM to about 40 mM, or from about 10 mM to about 50 mM. In one embodiment, the compositions comprise an ionic strength corresponding to such sodium chloride concentrations.

Generally, sample compositions resulting from thawing frozen nucleic acid (especially RNA) particle compositions and optionally adjusting the osmolality and ionic strength by adding an aqueous liquid may comprise high sodium chloride concentrations, or may comprise a high ionic strength. In one embodiment, the sodium chloride is at a concentration of about 50 mM to about 300 mM, or from about 80 mM to about 150 mM. In one embodiment, the compositions comprise an ionic strength corresponding to such sodium chloride concentrations.

B) Temperature

Generally, the sample compositions described herein are prepared at a temperature suitable for the stability of the nucleic acid (especially RNA) and, if present, for the stability of the nucleic acid (especially RNA) particles. However, for example, during synthesis, it might be necessary to apply low temperature (e.g., below 0° C., such as −20° C.) or high temperature (e.g., about 50° C. or more, such as about 60° C. or about 80° C.). Furthermore, during processing (e.g., drying) and/or storage a sample composition may be subjected temperatures other than room temperature. Thus, it might be necessary to analyze how these temperatures other than room temperature (e.g., stress temperatures) may effect one or more parameters of the sample composition. Exemplary temperature conditions include low temperature (such as below about 0° C. (such as below about −5° C., e.g., about −20° C., or between 5° C. and 15° C.), ambient or room temperature, middle temperature (such as between 35° C. and 45° C.) or high temperature (such as above 45° C., e.g., at about 50° C. or more, about 60° C., about 80° C., or about 98° C.).

C) pH and Buffer

According to the present disclosure, the sample compositions described herein may have a pH suitable for the stability of the nucleic acid (especially RNA) and, if present, for the stability of the nucleic acid (especially RNA) particles. However, for example, for the administration into a subject, it might be necessary, to adjust the pH (e.g., to a physiological pH) and/or the type and/or amount of the buffer(s) used in the sample composition to pH values and/or type and/or amount of the buffer(s) which are not optimal for the stability of the nucleic acid (especially RNA) and, if present, for the stability of the nucleic acid (especially RNA) particles. Thus, it might be necessary to analyze how these stress conditions (i.e., altered pH and/or buffer conditions) may effect one or more parameters of the sample composition.

In one embodiment, the sample compositions described herein have a pH from about 5.7 to about 6.7. In specific embodiments, the compositions have a pH of about 5.7, about 5.8, about 5.9, about 6.0, about 6.1, about 6.2, about 6.3, about 6.4, about 6.5, about 6.6, or about 6.7.

According to the present disclosure, sample compositions that include buffer are provided. Without wishing to be bound by theory, the use of buffer maintains the pH of the sample composition during manufacturing, storage and use of the sample composition. In certain embodiments of the present disclosure, the buffer may be sodium bicarbonate, monosodium phosphate, disodium phosphate, monopotassium phosphate, dipotassium phosphate, [tris(hydroxymethyl)methylamino]propanesulfonic acid (TAPS), 2-(Bis(2-hydroxyethyl)amino)acetic acid (Bicine), 2-Amino-2-(hydroxymethyl)propane-1,3-diol (Tris), N-(2-Hydroxy-1,1-bis(hydroxymethyl)ethyl)glycine (Tricine), 3-[[1,3-dihydroxy-2-(hydroxymethyl)propan-2-yl]amino]-2-hydroxypropane-1-sulfonic acid (TAPSO), 2-[4-(2-hydroxyethyl)piperazin-1-yl]ethanesulfonic acid (HEPES), 2-[[1,3-dihydroxy-2-(hydroxymethyl)propan-2-yl]amino]ethanesulfonic acid (TES), 1,4-piperazinediethanesulfonic acid (PIPES), dimethylarsinic acid, 2-morpholin-4-ylethanesulfonic acid (MES), 3-morpholino-2-hydroxypropanesulfonic acid (MOPSO), or phosphate buffered saline (PBS). Other suitable buffers may be acetic acid in a salt, citric acid in a salt, boric acid in a salt and phosphoric acid in a salt.

In some embodiments, the buffer has a pH from about 5.7 to about 6.7. In specific embodiments, the buffer has a pH of about 5.7, about 5.8, about 5.9, about 6.0, about 6.1, about 6.2, about 6.3, about 6.4, about 6.5, about 6.6, or about 6.7. In one embodiment, the buffer is HEPES. In a preferred embodiment, the HEPES has a pH from about 5.7 to about 6.7. In specific embodiments, the HEPES has a pH of about 5.7, about 5.8, about 5.9, about 6.0, about 6.1, about 6.2, about 6.3, about 6.4, about 6.5, about 6.6, or about 6.7. In an exemplary embodiment, the HEPES has a pH of about 6.2.

In still another embodiment, the buffer has a concentration from about 2.5 mM to about 10 mM. In specific embodiments where HEPES is the buffer, the concentration of HEPES is about 2.5 mM, about 2.75 mM, 3.0 mM, about 3.25 mM, about 3.5 mM, about 3.75 mM, about 4.0 mM, about 4.25 mM, about 4.5 mM, about 4.75 mM, about 5.0 mM, about 5.25 mM, about 5.5 mM, about 5.75 mM, about 6.0 mM, about 6.25 mM, about 6.5 mM, about 6.75 mM, about 7.0 mM, about 7.25 mM, about 7.5 mM, about 7.75 mM, about 8.0 mM, about 8.25 mM, about 8.5 mM, about 8.75 mM, about 9.0 mM, about 9.25 mM, about 9.5 mM, about 9.75 mM, or about 10.0 mM. In a preferred embodiment, the HEPES is at a concentration of about 7.5 mM.

D) Light, Radiation, Oxygen, Shear Force, and/or Pressure

Generally, the sample compositions described herein may be prepared at conditions selected from light, radiation, oxygen, shear force, and/or pressure suitable for the stability of the nucleic acid (especially RNA) and, if present, for the stability of the nucleic acid (especially RNA) particles. However, for example, during synthesis, processing, and/or storage of a sample composition, it might be necessary to apply light, radiation, oxygen, shear force, and/or pressure which are not optimal for the stability of the nucleic acid (especially RNA) and, if present, for the stability of the nucleic acid (especially RNA) particles. Thus, it might be necessary to analyze how these stress conditions (i.e., light, radiation, oxygen, shear force, and/or pressure, which are not optimal for the stability of the nucleic acid (especially RNA) and, if present, for the stability of the nucleic acid (especially RNA) particles) may effect one or more parameters of the sample composition.

In some embodiments, the sample compositions described herein are prepared in the absence of light, i.e., in the dark.

In some embodiments, the sample compositions described herein are prepared in the absence of radiation. In alternative embodiments, the sample compositions described herein are prepared using radiation, e.g., microwave radiation.

In some embodiments, the sample compositions described herein are prepared at ambient air (i.e., air containing oxygen). In alternative embodiments, the sample compositions described herein are prepared under an inert gas (such as nitrogen or a noble gas), i.e., in the absence of oxygen. In this way one could analyze whether the presence of oxygen has an effect on the stability of the nucleic acid (especially RNA) and, if present, for the stability of the nucleic acid (especially RNA) particles (in particular on the stability of lipids as components of the particles), e.g. during storage of a sample composition, and a stability profile over time could be established.

In some embodiments, the sample compositions described herein are prepared under high shear force (e.g., using the ethanol injection technique or Microfluidic Hydrodynamic Focusing (MHF) (cf. Zizzari et al., Materials, 10 (2017), 1411)). In alternative embodiments, the sample compositions described herein are prepared under low shear force (e.g., by mixing composition comprising RNA as described herein with a liposome composition as described herein using a pipette). In this way one could analyze whether the application of different shear forces has an effect on the stability of the nucleic acid (especially RNA) and, if present, for the stability of the nucleic acid (especially RNA) particles.

In some embodiments, the sample compositions described herein are prepared under ambient pressure. In alternative embodiments, the sample compositions described herein are prepared under pressure lower than ambient pressure or higher than ambient pressure. In this way one could analyze whether the application of different pressures has an effect on the stability of the nucleic acid (especially RNA) and, if present, for the stability of the nucleic acid (especially RNA) particles.

E) Freezing/Thawing Cycle

In one embodiment, the sample composition may be stored at a temperature below −10° C. (e.g., from about −15° C. to about −40° C.) and then thawed to a temperature from about 4° C. to about 25° C. (ambient temperature). In another embodiment, the sample composition may be subjected multiple freeze-thaw cycles (e.g., freezing at a temperature below −10° C. (e.g., from about −15° C. to about −40° C.) and thawing to a temperature from about 4° C. to about 25° C. (ambient temperature)). In this way one could analyze whether the application of one or more freeze-thaw cycles has an effect on the stability of the nucleic acid (especially RNA) and, if present, for the stability of the nucleic acid (especially RNA) particles.

In one embodiment, the sample composition may be stored at a temperature below −10° C. (e.g., from about −15° C. to about −40° C.). In an alternative embodiment, the sample composition may be stored without freezing. In this way one could analyze whether freezing has an effect on the stability of the nucleic acid (especially RNA) and, if present, for the stability of the nucleic acid (especially RNA) particles.

F) Drying/Reconstitution Cycle

In one embodiment, the sample composition may be stored in dry form and then reconstituted using an appropriate solvent or solvent mixture (e.g., an aqueous solvent). The dry form may be achieved by spray-drying, lyophilizing or freezing a sample preparation. In an alternative embodiment, this drying/reconstitution cycle may be repeated one or more times. In this way one could analyze whether the application of multiple drying/reconstitution cycles has an effect on the stability of the nucleic acid (especially RNA) and, if present, for the stability of the nucleic acid (especially RNA) particles.

G) Excipients

The sample compositions described herein may comprise one or more excipients. Such excipients include, but are not limited to, stabilizers, chelating agents, carriers, binders, diluents, lubricants, thickeners, surface active agents, preservatives, emulsifiers, buffers, flavoring agents, or colorants. In an alternative embodiment, the sample composition described herein does not comprise an excipient. In this way one could analyze whether the presence of a particular excipient (e.g., a stabilizer or chelating agent) has an effect on the stability of the nucleic acid (especially RNA) and, if present, for the stability of the nucleic acid (especially RNA) particles.

For example, the sample compositions described herein may comprise a stabilizer to avoid substantial loss of the product quality and, in particular, substantial loss of nucleic acid (especially RNA) activity during freezing, lyophilization or spray-drying and storage of the frozen, lyophilized or spray-dried composition. Typically, the stabilizer is present prior to the freezing, lyophilization or spray-drying process and persists in the resulting frozen, lyophilized or freeze-dried preparation. It can be used to protect nucleic acid (especially RNA) particles during freezing, lyophilization or spray-drying and storage of the frozen, lyophilized or freeze-dried preparation, for example to reduce or prevent aggregation, particle collapse, nucleic acid (especially RNA) degradation and/or other types of damage.

In an embodiment, the stabilizer is a carbohydrate. The term “carbohydrate”, as used herein refers to and encompasses monosaccharides, disaccharides, trisaccharides, oligosaccharides and polysaccharides.

In an embodiment, the stabilizer is a monosaccharide. The term “monosaccharide”, as used herein refers to a single carbohydrate unit (e.g., a simple sugar) that cannot be hydrolyzed to simpler carbohydrate units. Exemplary monosaccharide stabilizers include glucose, fructose, galactose, xylose, ribose and the like.

In an embodiment, the stabilizer is a disaccharide. The term “disaccharide”, as used herein refers to a compound or a chemical moiety formed by 2 monosaccharide units that are bonded together through a glycosidic linkage, for example through 1-4 linkages or 1-6 linkages. A disaccharide may be hydrolyzed into two monosaccharides. Exemplary disaccharide stabilizers include sucrose, trehalose, lactose, maltose and the like.

The term “trisaccharide” means three sugars linked together to form one molecule. Examples of a trisaccharides include raffinose and melezitose.

In an embodiment, the stabilizer is an oligosaccharide. The term “oligosaccharide”, as used herein refers to a compound or a chemical moiety formed by 3 to about 15, preferably 3 to about 10 monosaccharide units that are bonded together through glycosidic linkages, for example through 1-4 linkages or 1-6 linkages, to form a linear, branched or cyclic structure. Exemplary oligosaccharide stabilizers include cyclodextrins, raffinose, melezitose, maltotriose, stachyose, acarbose, and the like. An oligosaccharide can be oxidized or reduced.

In an embodiment, the stabilizer is a cyclic oligosaccharide. The term “cyclic oligosaccharide”, as used herein refers to a compound or a chemical moiety formed by 3 to about 15, preferably 6, 7, 8, 9, or 10 monosaccharide units that are bonded together through glycosidic linkages, for example through 1-4 linkages or 1-6 linkages, to form a cyclic structure. Exemplary cyclic oligosaccharide stabilizers include cyclic oligosaccharides that are discrete compounds, such as α cyclodextrin, β cyclodextrin, or γ cyclodextrin.

Other exemplary cyclic oligosaccharide stabilizers include compounds which include a cyclodextrin moiety in a larger molecular structure, such as a polymer that contains a cyclic oligosaccharide moiety. A cyclic oligosaccharide can be oxidized or reduced, for example, oxidized to dicarbonyl forms. The term “cyclodextrin moiety”, as used herein refers to cyclodextrin (e.g., an α, β, or γ cyclodextrin) radical that is incorporated into, or a part of, a larger molecular structure, such as a polymer. A cyclodextrin moiety can be bonded to one or more other moieties directly, or through an optional linker. A cyclodextrin moiety can be oxidized or reduced, for example, oxidized to dicarbonyl forms.

Carbohydrate stabilizers, e.g., cyclic oligosaccharide stabilizers, can be derivatized carbohydrates. For example, in an embodiment, the stabilizer is a derivatized cyclic oligosaccharide, e.g., a derivatized cyclodextrin, e.g., 2-hydroxypropyl-β-cyclodextrin, e.g., partially etherified cyclodextrins (e.g., partially etherified β cyclodextrins).

An exemplary stabilizer is a polysaccharide. The term “polysaccharide”, as used herein refers to a compound or a chemical moiety formed by at least 16 monosaccharide units that are bonded together through glycosidic linkages, for example through 1-4 linkages or 1-6 linkages, to form a linear, branched or cyclic structure, and includes polymers that comprise polysaccharides as part of their backbone structure. In backbones, the polysaccharide can be linear or cyclic. Exemplary polysaccharide stabilizers include glycogen, amylase, cellulose, dextran, maltodextrin and the like.

In an embodiment, the stabilizer is a sugar alcohol. As used herein, the term “sugar alcohol” refers to reduction products of “sugars” and indicates that all oxygen atoms in a simple sugar alcohol molecule are present in the form of hydroxyl groups. The sugar alcohols are “polyols”. This term refers to chemical compounds containing three or more hydroxyl groups, and is synonymous with another customary term, polyhydric alcohol. Examples of sugar alcohols include, but are not limited to, sorbitol, mannitol, maltitol, lactitol, erythritol, glycerin, xylitol, or inositol.

In one embodiment, sample compositions may include sucrose as a stabilizer. Without wishing to be bound by theory, sucrose functions to promote cryoprotection of the sample composition, thereby preventing nucleic acid (especially RNA) particle aggregation and maintaining chemical and physical stability of the composition. Certain embodiments contemplate alternative stabilizers to sucrose in the present disclosure. Alternative stabilizers include, without limitation, trehalose, glucose, fructose, arginin, glycerin, mannitol, prolin, sorbitol, glycine betaine and dextran. In a specific embodiment, an alternative stabilizer to sucrose is trehalose.

In one embodiment, the stabilizer is at a concentration from about 5% (w/v) to about 35% (w/v), such as from about 10% (w/v) to about 25% (w/v), from about 15% (w/v) to about 25% (w/v), or from about 20% (w/v) to about 25% (w/v).

In one embodiment, the sample compositions described herein comprise a chelating agent. Chelating agents refer to chemical compounds that are capable of forming at least two coordinate covalent bonds with a metal ion, thereby generating a stable, water-soluble complex. Without wishing to be bound by theory, chelating agents reduce the concentration of free divalent ions, which may otherwise induce accelerated degradation of nucleic acid (especially RNA) in the sample compositions. Examples of suitable chelating agents include, without limitation, ethylenediaminetetraacetic acid (EDTA), a salt of EDTA, desferrioxamine B, deferoxamine, dithiocarb sodium, penicillamine, pentetate calcium, a sodium salt of pentetic acid, succimer, trientine, nitrilotriacetic acid, trans-diaminocyclohexanetetraacetic acid (DCTA), diethylenetriaminepentaacetic acid (DTPA), bis(aminoethyl)glycolether-N,N,N′,N′-tetraacetic acid, iminodiacetic acid, citric acid, tartaric acid, fumaric acid, or a salt thereof. In certain embodiments, the chelating agent is EDTA or a salt of EDTA. In an exemplary embodiment, the chelating agent is EDTA disodium dihydrate.

In some embodiments, the EDTA is contained in the sample compositions at a concentration from about 0.25 mM to about 5 mM, such as from about 0.3 mM to about 4.5 mM, from about 0.5 mM to about 4.0 mM, from about 1.0 mM to about 3.5 mM, or from about 1.5 mM to about 2.5 mM. In a preferred embodiment, the EDTA is contained in the sample compositions at a concentration of about 2.5 mM.

H) Particle Forming Compounds

The amount and/or type and/or source (e.g., natural, semi-synthetic, or synthetic origin) of particle forming compounds, i.e., compounds of which the nucleic acid (especially RNA) containing particles of a sample composition are mainly composed (in particular lipids (e.g., cationic amphiphilic lipids) and/or polymers (e.g., cationic amphiphilic polymers)) may have an effect on one or more parameters of said sample composition. The effect may be analyzed by applying the methods and/or uses of the present disclosure on different sample compositions thereby determining the one or more one or more parameters of said different sample compositions, and comparing the one or more one or more parameters determined for one of the different sample compositions with the one or more one or more parameters determined for another of the different sample compositions. These different sample compositions may be provided using different conditions, including, but not being limited to, different concentrations of nucleic acid (especially RNA), different source of lipids and/or polymers (e.g., natural, semi-synthetic, or synthetic origin), presence or absence of lipids other than cationic amphiphilic lipids, presence or absence of polymers other than cationic amphiphilic lipids, different concentration of total lipids, different concentration of total polymers, different concentration of total amount of lipids and polymers, and different ratio of nucleic acid (especially RNA) to the particle forming compounds (in particular lipids and/or polymers). Although nucleic acid and particle forming compounds are both components of nucleic acid (especially RNA) containing particles, the expression “particle forming compounds” as used in the present disclosure does not encompass any nucleic acid.

Generally, the concentration of nucleic acid in the sample compositions described herein may be from about 0.01 mg/mL to about 2 mg/mL, such as from about 0.05 mg/mL to about 1 mg/mL or from about 0.1 mg/mL to about 0.5 mg/mL. Thus, in certain embodiments of the present disclosure, the concentration of RNA in the sample compositions described herein is from about 0.01 mg/mL to about 2 mg/mL, such as from about 0.05 mg/mL to about 1 mg/mL or from about 0.1 mg/mL to about 0.5 mg/mL.

In one embodiment, the lipid solutions, liposomes and nucleic acid (especially RNA) particles described herein include a cationic amphiphilic lipid. As used herein, a “cationic amphiphilic lipid” refers to an amphiphilic lipid having a net positive charge. Cationic amphiphilic lipids bind negatively charged nucleic acid (especially RNA) by electrostatic interaction to the lipid matrix. Generally, cationic amphiphilic lipids possess a lipophilic moiety, such as a sterol, an acyl or diacyl chain, and the head group of the lipid typically carries the positive charge. Examples of cationic amphiphilic lipids include, but are not limited to 1,2-di-O-octadecenyl-3-trimethylammonium propane (DOTMA), dimethyldioctadecylammonium (DDAB); 1,2-dioleoyl-3-trimethylammonium propane (DOTAP); 1,2-dioleoyl-3-dimethylammonium-propane (DODAP); 1,2-diacyloxy-3-dimethylammonium propanes; 1,2-dialkyloxy-3-dimethylammonium propanes; dioctadecyldimethyl ammonium chloride (DODAC), 2,3-di(tetradecoxy)propyl-(2-hydroxyethyl)-dimethylazanium (DMRIE), 1,2-dimyristoyl-sn-glycero-3-ethylphosphocholine (DMEPC), 1,2-dimyristoyl-3-trimethylammonium propane (DMTAP), 1,2-dioleyloxypropyl-3-dimethyl-hydroxyethyl ammonium bromide (DORIE), and 2,3-dioleoyloxy-N-[2(spermine carboxamide)ethyl]-N,N-dimethyl-1-propanamium trifluoroacetate (DOSPA). Preferred are DOTMA, DOTAP, DODAC, and DOSPA. In specific embodiments, the at least one cationic amphiphilic lipid is DOTMA and/or DOTAP. In one embodiment, the at least one cationic amphiphilic lipid is DOTMA, in particular (R)-DOTMA.

An additional lipid may be incorporated to adjust the overall positive to negative charge ratio and physical stability of the nucleic acid (especially RNA) particles. In certain embodiments, the additional lipid is a neutral lipid. As used herein, a “neutral lipid” refers to a lipid having a net charge of zero. Examples of neutral lipids include, but are not limited to, 1,2-di-(9Z-octadecenoyl)-sn-glycero-3-phosphoethanolamine (DOPE), 1,2-dioleoyl-sn-glycero-3-phosphocholine (DOPC), diacylphosphatidyl choline, diacylphosphatidyl ethanol amine, ceramide, pegylated ceramides (e.g., N-octanoyl-sphingosine-1-{succinyl[methoxy(PEG)]} and N-palmitoyl-sphingosine-1-{succinyl[methoxy (PEG)]}, wherein PEG is (polyethylene glycol)750, (polyethylene glycol)2000 or (polyethylene glycol)5000), sphingoemyelin, cephalin, cholesterol, pegylated cholesterol (such as cholesterol-(polyethylene glycol)600), pegylated diacylglycerides (such as distearoyl-rac-glycerol-PEG2000, 1,2-dimyristoyl-rac-glycero-3-methoxypolyethylene glycol-2000, 1,3-dimyristoyl-rac-glycero-3-methoxypolyethylene glycol-2000, or a mixture of 1,2-dimyristoyl-rac-glycero-3-methoxypolyethylene glycol-2000 and 1,3-dimyristoyl-rac-glycero-3-methoxypolyethylene glycol-2000) and cerebroside. In specific embodiments, the second lipid is DOPE, cholesterol and/or DOPC.

In certain embodiments, the nucleic acid (especially RNA) particles include both a cationic amphiphilic lipid and an additional lipid. In an exemplary embodiment, the cationic amphiphilic lipid is DOTMA and the additional lipid is DOPE. Without wishing to be bound by theory, the amount of the at least one cationic amphiphilic lipid compared to the amount of the at least one additional lipid may affect important nucleic acid (especially RNA) particle characteristics, such as charge, particle size, stability, tissue selectivity, and bioactivity of the nucleic acid (especially RNA). Accordingly, in some embodiments, the molar ratio of the at least one cationic amphiphilic lipid to the at least one additional lipid is from about 10:0 to about 1:9, about 4:1 to about 1:2, or about 3:1 to about 1:1. In specific embodiments, the molar ratio may be about 3:1, about 2.75:1, about 2.5:1, about 2.25:1, about 2:1, about 1.75:1, about 1.5:1, about 1.25:1, or about 1:1. In an exemplary embodiment, the molar ratio of the at least one cationic amphiphilic lipid to the at least one additional lipid is about 2:1.

Generally, the concentration of total lipids in the sample compositions described herein may be from about 0.1 to about 100 mg/ml, such as from about 0.5 to about 90 mg/ml, from about 1 to about 80 mg/ml, from about 2 to about 70 mg/ml, from about 4 to about 60 mg/ml, from about 6 to about 50 mg/ml, from about 8 to about 40 mg/ml, or from about 10 to about 20 mg/ml.

Also the ratio of nucleic acid (especially RNA) to particle forming compounds (in particular lipids and/or polymers) may have an impact on one or more parameters of said sample composition, wherein the one or more parameters comprise the nucleic acid integrity (especially RNA integrity), the total amount of nucleic acid (especially RNA), the amount of free nucleic acid (especially RNA), the amount of nucleic acid (especially RNA) bound to particles, the size of nucleic acid (especially RNA) containing particles (in particular, based on the radius of gyration (R_{g}) of nucleic acid (such as RNA) containing particles and/or the hydrodynamic radius (Rₕ) of nucleic acid (especially RNA) containing particles), the size distribution of nucleic acid (especially RNA) containing particles (e.g., based on R_{g} or Rₕ values of nucleic acid (especially RNA) containing particles), and the quantitative size distribution of nucleic acid (especially RNA) containing particles (e.g., based on R_{g} or Rₕ values of nucleic acid (especially RNA) containing particles) (additional optional parameters include the molecular weight of nucleic acid (especially RNA), the amount of surface nucleic acid (such as the amount of surface RNA), the amount of encapsulated nucleic acid (such as the amount of encapsulated RNA), the amount of accessible nucleic acid (such as the amount of accessible RNA), the size of nucleic acid (especially RNA) (in particular, based on R_{g} and/or Rₕ values of nucleic acid (especially RNA)), the size distribution of nucleic acid (especially RNA) (e.g., based on R_{g} or Rₕ values of nucleic acid (especially RNA)), the quantitative size distribution of nucleic acid (especially RNA) (e.g., based on R_{g} or Rₕ values) of nucleic acid (especially RNA)), the shape factor, the form factor, and the nucleic acid (especially RNA) encapsulation efficiency) as well as the ratio of the amount of nucleic acid (such as RNA) bound to particles to the total amount of particle forming compounds (in particular lipids and/or polymers) in the particles, wherein said ratio may be given as a function of the particle size; the ratio of the amount of positively charged moieties of particle forming compounds (in particular lipids and/or polymers) in the particles to the amount of nucleic acid (such as RNA) bound to particles, wherein said ratio may be given as a function of the particle size; and the charge ratio of the amount of positively charged moieties of particle forming compounds (in particular lipids and/or polymers) in the particles to the amount of negatively charged moieties of nucleic acid (such as RNA) bound to particles, wherein said charge ratio is usually denoted as N/P ratio). For example, the charge ratio (see below) may have an impact on one or more of these parameters. Additionally, also the ratio of neutral lipid(s) to cationic amphiphilic lipid(s) may have an impact on one or more of these parameters.

Generally, the ratio of nucleic acid (especially RNA) to the particle forming compounds (in particular lipids and/or polymers) may be from about 1:100 to about 10:1 (w/w), such as about 1:90 to about 5:1 (w/w), about 1:80 to about 1:2 (w/w), about 1:70 to about 1:1 (w/w), about 1:60 to about 1:2 (w/w), about 1:55 to about 1:5, about 1:50 to about 1:10, about 1:45 to about 1:15, about 1:40 to about 1:20, or about 1:35 to about 1:25 (w/w).

I) Charge Ratio

The electric charge of the nucleic acid (especially RNA) particles of the present disclosure is the sum of the electric charges present in the at least one cationic lipid and the electric charges present in the nucleic acid (especially RNA). The charge ratio is the ratio of the positive charges present in the at least one cationic amphiphilic lipid (or cationic amphiphilic polymer) to the negative charges present in the nucleic acid (especially RNA). The charge ratio of the positive charges present in the at least one cationic amphiphilic lipid (or cationic amphiphilic polymer) to the negative charges present in the nucleic acid (especially RNA) is calculated by the following equation: charge ratio=[(cationic amphiphilic lipid or polymer concentration (mol))*(the total number of positive charges in the cationic amphiphilic lipid or polymer)]/[(nucleic acid (especially RNA) concentration (mol))*(the total number of negative charges in nucleic acid (especially RNA))]. The concentration of nucleic acid (especially RNA) and the at least one cationic amphiphilic lipid or polymer amount can be determined using routine methods by one skilled in the art.

The charge ratio may have an effect on one or more parameters of a sample composition as described herein. The effect may be analyzed by applying the methods and/or uses of the present disclosure on at least two sample compositions which have been provided with different charge ratios, thereby determining the one or more one or more parameters of said different sample compositions, and comparing the one or more one or more parameters determined for one of the at least two different sample compositions with the one or more one or more parameters determined for another of the at least two different sample compositions.

Generally, at physiological pH the charge ratio of positive charges to negative charges in the nucleic acid (especially RNA) particles is from about 6:1 to about 1:2, such as about 5:1 to about 1.2:2, about 4:1 to about 1.4:2, about 3:1 to about 1.6:2, about 2:1 to about 1.8:2, or about 1.6:1 to about 1:1.

In a first embodiment, at physiological pH the charge ratio of positive charges to negative charges in the nucleic acid (especially RNA) particles is from about 1.9:2 to about 1:2. In specific embodiments, the charge ratio of positive charges to negative charges in the nucleic acid (especially RNA) particles at physiological pH is about 1.9:2.0, about 1.8:2.0, about 1.7:2.0, about 1.6:2.0, about 1.5:2.0, about 1.4:2.0, about 1.3:2.0, about 1.2:2.0, about 1.1:2.0, or about 1:2.0. In one embodiment, the charge ratio of positive charges to negative charges in the nucleic acid (especially RNA) particles at physiological pH is 1.3:2.0. In another embodiment, the nucleic acid (especially RNA) particles described herein may have an equal number of positive and negative charges at physiological pH, yielding nucleic acid (especially RNA) particles with a net neutral charge ratio. Nucleic acid (especially RNA) particles having a charge ratio according to the first embodiment preferentially target spleen tissue or spleen cells such as antigen-presenting cells, in particular dendritic cells.

In a second embodiment, at physiological pH the charge ratio of positive charges to negative charges in the nucleic acid (especially RNA) particles is from about 6:1 to about 1.5:1. In specific embodiments, the charge ratio of positive charges to negative charges in the nucleic acid (especially RNA) particles at physiological pH is about 6.0:1.0, about 5.8:1.0, about 5.6:1.0, about 5.4:1.0, about 5.2:1.0, about 5.0:1.0, about 4.8:1.0, about 4.6:1.0, about 4.4:1.0, about 4.2:1.0, about 4.0:1.0, about 3.8:1.0, about 3.6:1.0, about 3.4:1.0, about 3.2:1.0, about 3.0:1.0, about 2.8:1.0, about 2.6:1.0, about 2.4:1.0, about 2.2:1.0, about 2.0:1.0, about 1.8:1.0, about 1.6:1.0, or about 1.5:1.0. Nucleic acid (especially RNA) particles having a charge ratio according to the second embodiment preferentially target lung tissue or lung cells.

J) Physical State

The physical state (i.e., liquid or solid) of a sample composition as described herein may have an effect on one or more parameters of said sample composition. Non-limiting examples of a solid include a frozen form or a lyophilized form. Non-limiting examples of a liquid form include a solution or suspension. The solid form may be achieved by spray-drying, lyophilizing or freezing a sample preparation. In one embodiment, the sample composition may be in solid form. In an alternative embodiment, the sample composition may be in liquid form (e.g., as solution or suspension).

The effect of the physical state of the sample composition may be analyzed by applying the methods and/or uses of the present disclosure on at least two sample compositions which have been provided in different physical states, thereby determining the one or more one or more parameters of said different sample compositions, and comparing the one or more one or more parameters determined for one of different sample compositions with the one or more one or more parameters determined for another of the different sample compositions.

Parameters of Sample Compositions of the Present Disclosure

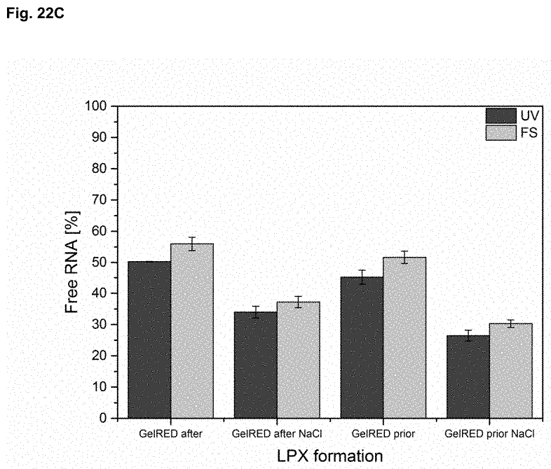

If a sample or control composition comprises nucleic acid (especially RNA) and particles, the nucleic acid (especially RNA) may be contained in the sample or control composition in free form (i.e., not bound/adhered to the particles) and/or in bound form (i.e., bound/adhered to the particles). The total amount of nucleic acid (especially RNA) is the sum of free nucleic acid (especially RNA) (i.e., unbound nucleic acid (such as unbound RNA)) and bound nucleic acid (especially RNA). The bound nucleic acid (especially RNA) is composed of nucleic acid (especially RNA) bound/adhered to the outer surface of the particles (also designated herein as “surface nucleic acid” (such as “surface RNA”)) and nucleic acid (especially RNA) contained/encapsulated within the particles (also designated herein as “encapsulated nucleic acid” (such as “encapsulated RNA”)). The sum of surface nucleic acid” (such as “surface RNA”) and free nucleic acid (such as “free RNA”) is also called herein “accessible nucleic acid (such as “accessible RNA”)). Thus, besides the total amount of nucleic acid (such as the total amount of RNA) and the amount of free nucleic acid (such as the amount of free RNA), additional parameters of a sample or control composition comprising nucleic acid (especially RNA) and particles are the amount of surface nucleic acid (such as the amount of surface RNA), the amount of encapsulated nucleic acid (such as the amount of encapsulated RNA), and the amount of accessible nucleic acid (such as the amount of accessible RNA). FIG. 21 illustrates the above-mentioned forms of nucleic acid contained in a sample or control composition nucleic acid and particles, wherein the nucleic acid is RNA.

Furthermore, when the nucleic acid (especially RNA) is in free form (i.e., not bound or adhered to particles contained in a sample or control composition comprising nucleic acid (especially RNA) and particles) or in unformulated form (i.e., in a composition lacking particles as specified herein, such as lacking components constituting liposomes (in particular cationic amphiphilic lipid(s) and/or cationic amphiphilic polymer(s)) and/or virus-like particles) the size, the size distribution and/or the quantitative size distribution of the nucleic acid (especially RNA) (e.g., based on the radius of gyration (R_{g}) of nucleic acid (such as RNA) and/or the hydrodynamic radius (Rₕ) of nucleic acid (such as RNA)) can also be determined or analyzed. Thus, additional parameters of a sample or control composition comprising nucleic acid (especially RNA) in free or unformulated form are the size, the size distribution and/or the quantitative size distribution of the nucleic acid (especially RNA) (each based, e.g., on R_{g} or Rₕ values).

Further parameters include, e.g., those derived from one or more of the above parameters, such as the shape factor, the form factor, the nucleic acid (especially RNA) encapsulation efficiency, the ratio of the amount of nucleic acid (such as RNA) bound to particles to the total amount of particle forming compounds (in particular lipids and/or polymers) in the particles, the ratio of the amount of positively charged moieties of particle forming compounds (in particular lipids and/or polymers) in the particles to the amount of nucleic acid (such as RNA) bound to particles, and the charge ratio of the amount of positively charged moieties of particle forming compounds (in particular lipids and/or polymers) in the particles to the amount of negatively charged moieties of nucleic acid (such as RNA) bound to particles (N/P ratio).

Therefore, in some embodiments, the one or more parameters determined or analyzed by the methods and/or uses of the present disclosure comprise at least one, preferably at least two (such as at least 3, at least 4, at least 5, or at least 6, e.g., 1, 2, 3, 4, 5, 6, or all) of the following: the nucleic acid integrity (especially RNA integrity), the total amount of nucleic acid (especially RNA), the amount of free nucleic acid (especially RNA), the amount of nucleic acid (especially RNA) bound to particles, the size of nucleic acid (especially RNA) containing particles (e.g., based on the radius of gyration (R_{g}) of nucleic acid (such as RNA) containing particles and/or the hydrodynamic radius (Rₕ) of nucleic acid (such as RNA) containing particles), the size distribution of nucleic acid (especially RNA) containing particles (e.g., based on R_{g} or Rₕ values), the quantitative size distribution of nucleic acid (especially RNA) containing particles (e.g., based on R_{g} or Rₕ values), the molecular weight of nucleic acid (especially RNA), the amount of surface nucleic acid (such as the amount of surface RNA), the amount of encapsulated nucleic acid (such as the amount of encapsulated RNA), the amount of accessible nucleic acid (such as the amount of accessible RNA), the size of the nucleic acid (especially RNA) (e.g., based on R_{g} or Rₕ values), the size distribution of the nucleic acid (especially RNA) (e.g., based on R_{g} or Rₕ values), the quantitative size distribution of the nucleic acid (especially RNA) (e.g., based on R_{g} or Rₕ values), the shape factor, the form factor, the nucleic acid (especially RNA) encapsulation efficiency, the ratio of the amount of nucleic acid (such as RNA) bound to particles to the total amount of particle forming compounds (in particular lipids and/or polymers) in the particles, the ratio of the amount of positively charged moieties of particle forming compounds (in particular lipids and/or polymers) in the particles to the amount of nucleic acid (such as RNA) bound to particles, and the charge ratio of the amount of positively charged moieties of particle forming compounds (in particular lipids and/or polymers) in the particles to the amount of negatively charged moieties of nucleic acid (such as RNA) bound to particles (N/P ratio). In some embodiments, the one or more parameters determined or analyzed by the methods and/or uses of the present disclosure comprise at least one, preferably at least two (such as at least 3, at least 4, at least 5, or at least 6, e.g., 1, 2, 3, 4, 5, 6, or all) of the following: the nucleic acid integrity (especially RNA integrity), the total amount of nucleic acid (especially RNA), the amount of free nucleic acid (especially RNA), the amount of nucleic acid (especially RNA) bound to particles, the size of nucleic acid (especially RNA) containing particles (e.g., based on the radius of gyration (R_{g}) of nucleic acid (such as RNA) containing particles and/or the hydrodynamic radius (Rₕ) of nucleic acid (such as RNA) containing particles), the size distribution of nucleic acid (especially RNA) containing particles (e.g., based on R_{g} or Rₕ values), the quantitative size distribution of nucleic acid (especially RNA) containing particles (e.g., based on R_{g} or Rₕ values), the amount of surface nucleic acid (such as the amount of surface RNA), the amount of encapsulated nucleic acid (such as the amount of encapsulated RNA), the amount of accessible nucleic acid (such as the amount of accessible RNA), the size of the nucleic acid (especially RNA) (e.g., based on R_{g} or Rₕ values), the size distribution of the nucleic acid (especially RNA) (e.g., based on R_{g} or Rₕ values), the quantitative size distribution of the nucleic acid (especially RNA) (e.g., based on R_{g} or Rₕ values), the shape factor, the form factor, the nucleic acid (especially RNA) encapsulation efficiency, the ratio of the amount of nucleic acid (such as RNA) bound to particles to the total amount of particle forming compounds (in particular lipids and/or polymers) in the particles, the ratio of the amount of positively charged moieties of particle forming compounds (in particular lipids and/or polymers) in the particles to the amount of nucleic acid (such as RNA) bound to particles, and the charge ratio of the amount of positively charged moieties of particle forming compounds (in particular lipids and/or polymers) in the particles to the amount of negatively charged moieties of nucleic acid (such as RNA) bound to particles (N/P ratio). In some embodiments, the one or more parameters determined or analyzed by the methods and/or uses of the present disclosure comprise at least one, preferably at least two (such as at least 3, at least 4, at least 5, or at least 6, e.g., 1, 2, 3, 4, 5, 6, or all) of the following: the nucleic acid integrity (especially RNA integrity), the total amount of nucleic acid (especially RNA), the amount of free nucleic acid (especially RNA), the amount of nucleic acid (especially RNA) bound to particles, the size of nucleic acid (especially RNA) containing particles (e.g., based on the radius of gyration (R_{g}) of nucleic acid (such as RNA) containing particles and/or the hydrodynamic radius (Rₕ) of nucleic acid (such as RNA) containing particles), the size distribution of nucleic acid (especially RNA) containing particles (e.g., based on R_{g} or Rₕ values), the quantitative size distribution of nucleic acid (especially RNA) containing particles (e.g., based on R_{g} or Rₕ values), the amount of surface nucleic acid (such as the amount of surface RNA), the amount of encapsulated nucleic acid (such as the amount of encapsulated RNA), the amount of accessible nucleic acid (such as the amount of accessible RNA), the size of the nucleic acid (especially RNA) (e.g., based on R_{g} or Rₕ values), the size distribution of the nucleic acid (especially RNA) (e.g., based on R_{g} or Rₕ values), the quantitative size distribution of the nucleic acid (especially RNA) (e.g., based on R_{g} or Rₕ values), the shape factor, the form factor, and the nucleic acid (especially RNA) encapsulation efficiency. In some embodiments, the one or more parameters determined or analyzed by the methods and/or uses of the present disclosure comprise at least one, preferably at least two (such as at least 3, at least 4, at least 5, or at least 6, e.g., 1, 2, 3, 4, 5, 6, or all) of the following: the nucleic acid integrity (especially RNA integrity), the total amount of nucleic acid (especially RNA), the amount of free nucleic acid (especially RNA), the amount of nucleic acid (especially RNA) bound to particles, the size of nucleic acid (especially RNA) containing particles (e.g., based on the radius of gyration (R_{g}) of nucleic acid (such as RNA) containing particles and/or the hydrodynamic radius (Rₕ) of nucleic acid (such as RNA) containing particles), the size distribution of nucleic acid (especially RNA) containing particles (e.g., based on R_{g} or Rₕ values), the quantitative size distribution of nucleic acid (especially RNA) containing particles (e.g., based on R_{g} or Rₕ values), the amount of surface nucleic acid (such as the amount of surface RNA), the amount of encapsulated nucleic acid (such as the amount of encapsulated RNA), the amount of accessible nucleic acid (such as the amount of accessible RNA), the size of the nucleic acid (especially RNA) (e.g., based on R_{g} or Rₕ values), the size distribution of the nucleic acid (especially RNA) (e.g., based on R_{g} or Rₕ values), the quantitative size distribution of the nucleic acid (especially RNA) (e.g., based on R_{g} or Rₕ values), and the nucleic acid (especially RNA) encapsulation efficiency. In some embodiments, the one or more parameters determined or analyzed by the methods and/or uses of the present disclosure comprise at least one, preferably at least two (such as at least 3, at least 4, at least 5, or at least 6, e.g., 1, 2, 3, 4, 5, 6, or all) of the following: the nucleic acid integrity (especially RNA integrity), the total amount of nucleic acid (especially RNA), the amount of free nucleic acid (especially RNA), the amount of nucleic acid (especially RNA) bound to particles, the size distribution of nucleic acid (especially RNA) containing particles (e.g., based on R_{g} or Rₕ values), the quantitative size distribution of nucleic acid (especially RNA) containing particles (e.g., based on R_{g} or Rₕ values), the amount of surface nucleic acid (such as the amount of surface RNA), the amount of encapsulated nucleic acid (such as the amount of encapsulated RNA), the amount of accessible nucleic acid (such as the amount of accessible RNA), the size of the nucleic acid (especially RNA) (e.g., based on R_{g} or Rₕ values), the size distribution of the nucleic acid (especially RNA) (e.g., based on R_{g} or Rₕ values), the quantitative size distribution of the nucleic acid (especially RNA) (e.g., based on R_{g} or Rₕ values), and the nucleic acid (especially RNA) encapsulation efficiency. In some embodiments, the one or more parameters determined or analyzed by the methods and/or uses of the present disclosure comprise at least one, preferably at least two (such as at least 3, at least 4, or at least 5, e.g., 1, 2, 3, 4, 5, or 6) of the following: the nucleic acid integrity (especially RNA integrity), the total amount of nucleic acid (especially RNA), the amount of free nucleic acid (especially RNA), the amount of nucleic acid (especially RNA) bound to particles, the size distribution of nucleic acid (especially RNA) containing particles (e.g., based on R_{g} or Rₕ values), and the quantitative size distribution of nucleic acid (especially RNA) containing particles (e.g., based on R_{g} or Rₕ values). In some embodiments, the one or more parameters determined or analyzed by the methods and/or uses of the present disclosure comprise at least one, preferably at least two (such as at least 3 or at least 4, e.g., 1, 2, 3, 4, or 5) of the following: the total amount of nucleic acid (especially RNA), the amount of free nucleic acid (especially RNA), the amount of nucleic acid (especially RNA) bound to particles, the size distribution of nucleic acid (especially RNA) containing particles (e.g., based on R_{g} or Rₕ values), and the quantitative size distribution of nucleic acid (especially RNA) containing particles (e.g., based on R_{g} or Rₕ values). In some embodiments, the one or more parameters determined or analyzed by the methods and/or uses of the present disclosure comprise at least one, preferably at least two (such as at least 3, e.g., 1, 2, 3, or 4) of the following: the amount of free nucleic acid (especially RNA), the amount of nucleic acid (especially RNA) bound to particles, the size distribution of nucleic acid (especially RNA) containing particles (e.g., based on R_{g} or Rₕ values), and the quantitative size distribution of nucleic acid (especially RNA) containing particles (e.g., based on R_{g} or Rₕ values).

In some embodiments of the methods and/or uses of the present disclosure (in particular those, where a composition (such as a sample or control composition) comprises RNA and particles), the one or more parameters comprise the quantitative size distribution of nucleic acid (especially RNA) containing particles (e.g., based on the radius of gyration (R_{g}) of nucleic acid (especially RNA) containing particles and/or the hydrodynamic radius (Rₕ) of nucleic acid (especially RNA) containing particles) and optionally at least one parameter, such as at least two parameters, of the remaining parameters specified herein (including the additional optional parameters); preferably these remaining parameters are selected from the group consisting of: the amount of free nucleic acid (especially RNA), the amount of nucleic acid (especially RNA) bound to particles, and the size distribution of nucleic acid (especially RNA) containing particles (e.g., based on R_{g} or Rₕ values). In some embodiments of the methods and/or uses of the present disclosure (in particular those, where a composition (such as a sample or control composition) comprises RNA and particles), the one or more parameters comprise the quantitative size distribution of nucleic acid (especially RNA) containing particles (e.g., based on R_{g} or Rₕ values) and at least one parameter, such as at least two parameters, selected from the group consisting of: the amount of free nucleic acid (especially RNA), the amount of nucleic acid (especially RNA) bound to particles, and the size distribution of nucleic acid (especially RNA) containing particles (e.g., based on R_{g} or Rₕ values). In some embodiments of the methods and/or uses of the present disclosure (in particular those, where a composition (such as a sample or control composition) comprises RNA and particles), the one or more parameters comprise the quantitative size distribution of nucleic acid (especially RNA) containing particles (e.g., based on R_{g} or Rₕ values), the amount of free nucleic acid (especially RNA), and the amount of nucleic acid (especially RNA) bound to particles. If the quantitative size distribution of nucleic acid (especially RNA) containing particles is determined on the basis of the R_{g} values and the Rₕ values, this results in two data sets, i.e., one based on the R_{g} values and one based on the Rₕ values. However, according to the present invention, these two data sets for the quantitative size distribution of nucleic acid (especially RNA) containing particles are only considered as one parameter (and not as two parameters). In addition, in case the fractogram obtained by the field-flow fractionation shows more than one particle peak, the determination of the quantitative size distribution for each of the particle peaks is only considered as one parameter (and not as one parameter for each of the particle peaks). The same applies to the situation where the size distribution of nucleic acid (especially RNA) containing particles is determined on the basis of the R_{g} values and the Rₕ values.

In some embodiments, the one or more parameters to be determined or analyzed by the methods and/or uses of the present disclosure are determined or analyzed in at least one (e.g., 1 to 10) cycle of steps (a) to (c). In one preferred embodiment, the one or more parameters to be determined or analyzed by the methods and/or uses of the present disclosure are determined or analyzed in one cycle of steps (a) to (c).

Generally, parameters (e.g., the amount of nucleic acid (especially RNA)) of a sample composition are to be determined or analyzed by the methods and/or uses of the present disclosure. Thus, in some embodiments, one or more parameters (e.g., the amount of free nucleic acid (especially RNA)) of a sample composition are not known before the methods of the present disclosure are performed or the uses of the present disclosure are applied. However, in some embodiments, one or more parameters (e.g., the amount of free nucleic acid (especially RNA)) of a sample composition are known at a first point in time and the methods and/or uses of the present disclosure are utilized to determine or analyze the one or more parameters (e.g., the amount of free nucleic acid (especially RNA)) of a sample composition at least at a second, later point in time (e.g., at least once (such as at least two time, at least three times, at least four times, at least five times, at least 6 times, at least 8 times, at least 10 times) every hour (such as every day, every week, every month, or every year), over a certain time period (such as one or more hours, one or more days, one or more weeks, one or more months, or one or more years). Thus, in one embodiment, the methods and/or uses of the present disclosure may be utilized to monitor the one or more parameters of a sample composition over a certain period of time (such as one or more hours, one or more days, one or more weeks, one or more months, or one or more years), e.g., during storage of the sample composition, in order to determine a profile of the one or more parameters over time.

In an alternative embodiment, the methods and/or uses of the present disclosure may be utilized to compare the same one or more parameters (e.g., the amount of free nucleic acid (especially RNA)) of at least two sample compositions, where the at least two sample compositions only differ in one or more reactions conditions under which the at least two sample compositions have been provided. In this embodiment, it is possible to analyze the effect of different reaction conditions on the one or more parameters of the sample compositions. These reaction conditions include, but are not limited to, synthesis conditions, processing conditions (e.g., purification and/or drying conditions) and storage conditions.

A. Nucleic Acid Integrity (Especially RNA Integrity)

According to the present disclosure, nucleic acid integrity (especially RNA integrity) is a parameter representing the grade of degradation of the nucleic acid (especially RNA) contained in the sample composition. For example, for a nucleic acid (especially RNA) which is not degraded, all molecules of said nucleic acid have the same length. Thus, when separated according to their size or hydrodynamic mobility (e.g., diffusion coefficient) using field-flow fractionation, undegraded nucleic acid (especially RNA) should give a sharp peak. In contrast, degradation of nucleic acid (especially RNA) results in a mixture of molecules differing in their length. Consequently, when separated according to their size or hydrodynamic mobility using field-flow fractionation, degraded nucleic acid (especially RNA) is detected at a different retention time, in particular at an earlier retention time, compared to the undegraded nucleic acid (especially RNA)) and the peak for the undegraded nucleic acid (especially RNA) is broader and smaller compared to the situation where only undegraded nucleic acid (especially RNA) is present. The higher the degree of degradation, the broader and higher is the peak for the degraded nucleic acid (especially RNA) and the broader and smaller is the peak for undegraded nucleic acid (especially RNA). One of skill in the art would be able to detect nucleic acid (especially RNA) using routine laboratory techniques and instrumentation. For example, after separation via field-flow fractionation nucleic acid (especially RNA) may be detected by measuring at least one signal selected from the group consisting of the UV signal, the fluorescence signal, and the refractory index (RI) signal. Since nucleic acid (especially RNA) has a characteristic extinction coefficient in the UV range (e.g., at 260 nm or 280 nm), it is preferred that the detection of said nucleic acid (especially RNA) is done by measuring the UV signal (preferably at a wavelength in the range of 260 nm to 280 nm, such as at a wavelength of 260 nm or 280 nm).

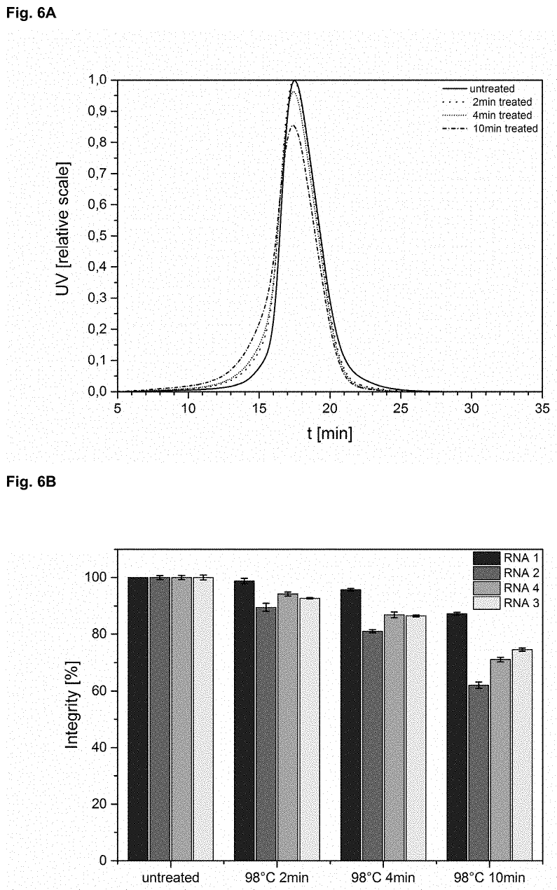

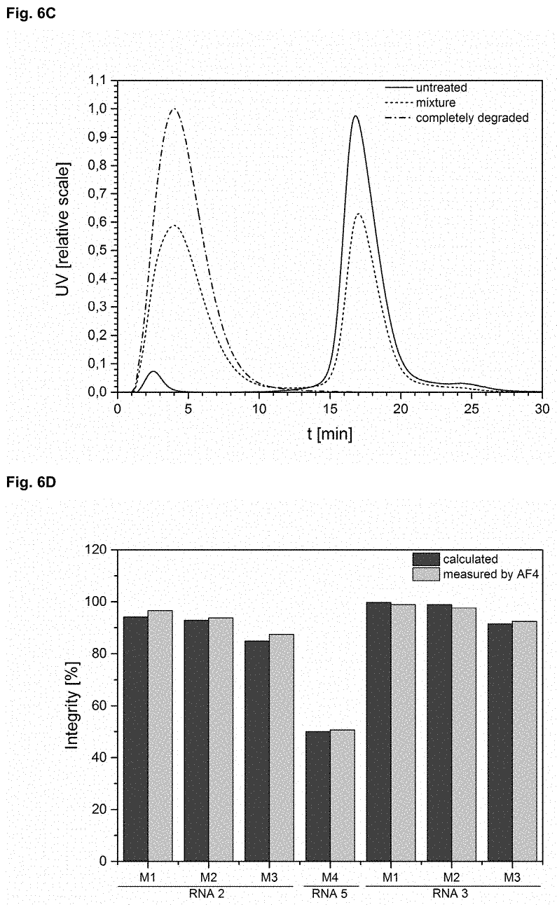

For example, FIG. 6C shows the UV signal for three sample compositions comprising either untreated RNA, completely degraded RNA or a mixture of untreated and degraded RNA. As can be seen in FIG. 6C, the untreated (i.e. undegraded) RNA gives a single peak at a retention time of about 17 min, the completely degraded RNA gives a peak at a retention time of about 4 min, and a mixture of undegraded and degraded RNA gives two peaks (at a retention time of about 4 and about 17 min, respectively) which are smaller than the peak obtained for the completely undegraded RNA or the peak obtained for the completely degraded RNA.

It is preferred that the nucleic acid integrity (especially RNA integrity) of a sample composition as disclosed herein is determined or calculated using the integrity of a control nucleic acid (especially control RNA). This control nucleic acid (especially control RNA) is usually contained in a control composition, wherein the control composition and the sample composition are identical with the exception of (i) the condition applied to the sample composition whose effect on one or more parameters of the sample is to be determined or analyzed and/or (ii) the presence or absence of the component in the sample composition whose effect on one or more parameters of the sample is to be determined or analyzed. For example, if the condition applied to the sample composition is, e.g., a high temperature of about 98° C. (applied for a certain period of time (e.g., 2, 4, or 10 min)), the respective control composition is identical to the sample composition (i.e., has the same components (in particular the same nucleic acid (especially RNA), etc.) in the same amount as the sample composition) but has not been subjected to high temperature. Furthermore, if, for example, the sample composition additionally comprises an excipient (e.g., a stabilizer or chelating agent) the respective control composition is identical to the sample composition and has been subjected to the same conditions as the sample composition, with the exception that the control composition does not contain the excipient. In addition, if one or more parameters of a sample composition are to be monitored over a period of time (e.g., in order to obtain a stability profile upon storage), the control composition may be the initial sample composition, i.e., the sample composition at the start of the monitoring.

Generally, if the nucleic acid integrity (especially RNA integrity) of a sample composition as disclosed herein is determined or calculated using the integrity of a control nucleic acid (especially control RNA), it is preferred that the integrity value determined or calculated for the sample composition is correlated with the integrity value determined or calculated for the control composition. Thus, usually the integrity value (IV) determined or calculated for the sample composition is normalized to the integrity value determined or calculated for the control composition, e.g., the integrity value determined or calculated for the sample composition (IV_{S}) is divided by the integrity value determined or calculated for the control composition (IV_{C}) resulting in the normalized integrity of the sample composition (I_{S norm}) according to the following equation:

$${I}_{S norm .} = \frac{{IV}_{S}}{{IV}_{C}} \cdot 100 \% ) ,$$

wherein the result is presented as percentage (so that the integrity determined or calculated for the control composition is 100%).

In this respect, the integrity values may be determined or calculated as known to the skilled person, using, e.g., the area and/or height of the peak representing the undegraded nucleic acid (especially undegraded RNA) in the fractogram obtained from the field-flow fractionation of the control or sample composition.

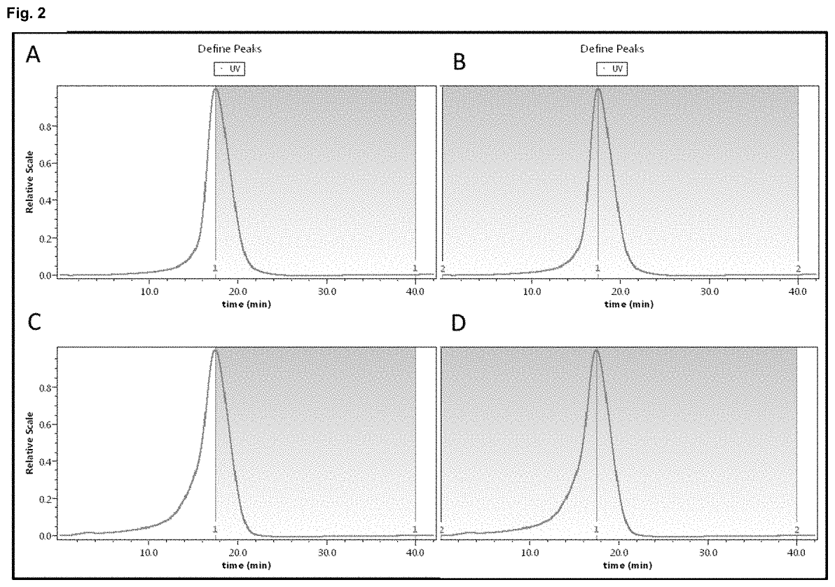

In one preferred embodiment, the integrity values are determined or calculated on basis of the area of the peak (UV, fluorescence or RI peak) representing the undegraded nucleic acid (especially undegraded RNA). In particular, the integrity values are determined or calculated as the ratio of (i) the area from the maximum height of said peak to the end of said peak (A_{50%}) and (ii) the total area of said peak (A_{100%}). For example, FIG. 2 illustrates the determination or calculation of the A_{50%} and A_{100%} values. In particular, FIG. 2A shows the determination or calculation of the A_{50%} value for a control RNA composition (limits for the determination or calculation of the A_{50%} value are indicated with the numerical “1”), whereas FIG. 2B shows the determination or calculation of the A_{100%} value for the control RNA composition (limits for the determination or calculation of the A_{100%} value are indicated with the numerical “2”). FIGS. 2C and 2D show the determination or calculation of the A_{50%} (FIG. 2C) and A_{100%} (FIG. 2D) values for a sample RNA composition which has been subjected to heat treatment (thus, the peak in FIGS. 2C and 2D is broader due to the presence of degraded RNA).

In an alternative preferred embodiment, the integrity values are determined or calculated without a reference sample. In this embodiment, the integrity value for the sample composition preferably is the ratio of (i) 2·A_{50%}, i.e., the twofold value of the peak area from the maximum height of said peak to the end of said peak and (ii) A_{100%}, i.e., the total area of said peak. Thus, the integrity of the nucleic acid (especially RNA) in the sample composition would be determined or calculated according to the following equation:

$${I}_{S} = \frac{2 \cdot {A}_{50 \%}}{{A}_{100 \%}} .$$

Other routines to determine the nucleic acid (especially RNA) integrity are possible (e.g. the limits of a peak can be defined by the slope of the peak). To verify that the peak maxima contains the “intact”/undegraded nucleic acid (especially RNA), the molecular weight of the nucleic acid (especially RNA) can be determined or calculated from the LS data and compared to the theoretical calculated molecular weight (based on the nucleic acid sequence and optional additional substances (e.g., one or more dyes) covalently or non-covalently attached to the nucleic acid) of the sample. To avoid higher molecular structures of the nucleic acid (especially RNA), the sample should be diluted with a solvent or solvent mixture which is able to prevent the formation of aggregates of the particles. For example, the solvent mixture may be a mixture of water and an organic solvent, e.g., formamide (such as 60% (v/v)). Preferably, such dilution is performed immediately prior to the analysis (e.g., 5 min prior to the analysis) and/or at elevated temperature (e.g., in the range of 40° C. to 80° C., such as 50° C. to 70° C. or 55° C. to 65° C., or at about 60° C.). Samples with a low tendency to form higher molecular structures can be analyzed without the dilution with a solvent or solvent mixture which is able to prevent the formation of aggregates of the particles.

In a further alternative embodiment, the integrity values are determined or calculated on basis of the height of the peak (UV, fluorescence or RI peak) representing the undegraded nucleic acid (especially undegraded RNA). In this embodiment, the integrity value for the sample composition is the height of said peak in the fractogram obtained for the sample composition (H_{S}) and integrity value for the control composition is the height of said peak in the fractogram obtained for the control composition (H_{C}). Thus, the normalized integrity of the nucleic acid (especially RNA) in the sample composition would be determined or calculated according to the following equation:

$${I}_{S norm .} = \frac{{H}_{S}}{{H}_{C}} \cdot 100 \% .$$

It is noted that this kind of determination or calculation of the normalized integrity of the nucleic acid (especially RNA) in a sample composition is less sensitive (compared to the above-identified embodiment based on the area, in particular the ratio of A_{50%} to A_{100%}). Thus, this alternative embodiment for the determination or calculation of the normalized integrity of the nucleic acid (especially RNA) in a sample composition based on the height of the peak representing the undegraded nucleic acid (especially undegraded RNA) is less preferred.

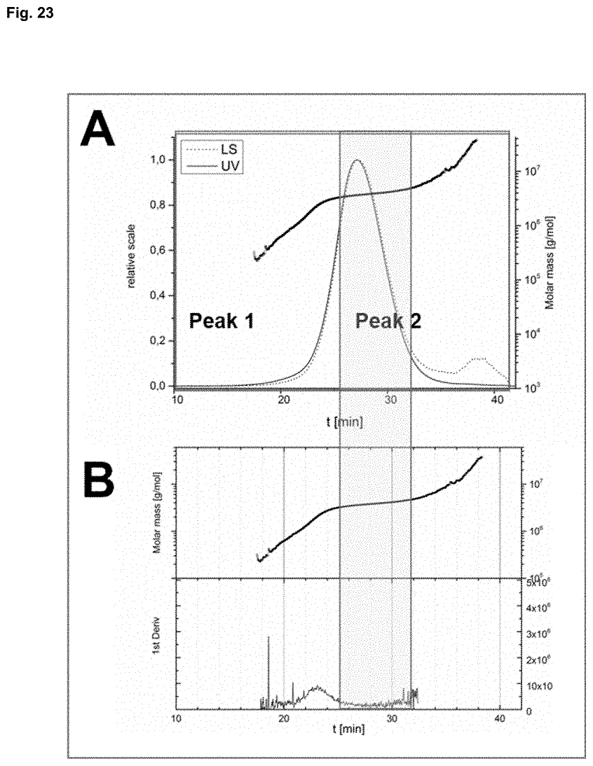

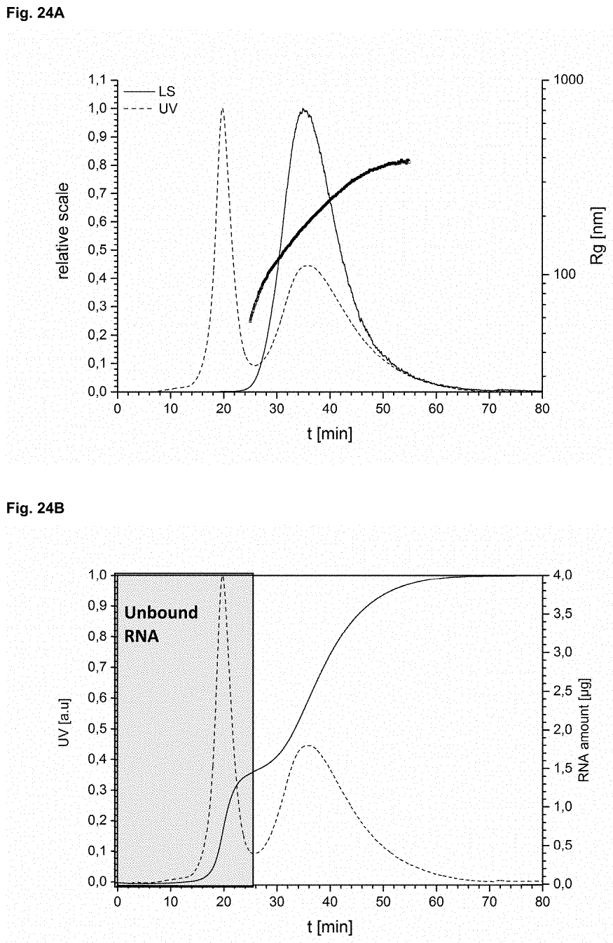

In a further alternative embodiment, in particular when the nucleic acid (especially RNA) has a length of more than 10,000 nucleotides (such as up to 15,000 nucleotides, or up to 12,000 nucleotides), the integrity value for a sample composition may be determined or calculated on basis of both (a) the at least one signal selected from the group consisting of the UV signal, the fluorescence signal, and the refractory index (RI) signal, and (b) the LS signal (e.g., MALS signal). This further alternative embodiment can be used without relying on a reference nucleic acid (especially RNA). As indicated above, undegraded nucleic acid (especially RNA) should give a sharp peak, whereas degradation of nucleic acid (especially RNA) results in a mixture of molecules differing in their length. Consequently, the molecular weight curve calculated from the LS signal (such as the MALS signal) representing undegraded nucleic acid (especially RNA) should be a (nearly) horizontal line, i.e., a continuous curve section having a slope of about 0. In contrast, the molecular weight curve calculated from the LS signal (such as the MALS signal) representing a mixture of partially degraded nucleic acid (especially RNA) (i.e., a mixture of nucleic acids (especially RNAs) having different (preferably decreasing) molecular weights) has different sections with different slopes, wherein the (preferably continuous) section having a slope of nearly 0 ideally represents the portion of intact/undegraded nucleic acid (especially RNA). Thus, those retention times, where the (nearly) horizontal section of the molecular weight curve begins and ends (i.e., t_{b} and tₑ), respectively, can be taken as the limitations for the peak (UV, fluorescence or RI peak) representing “intact”/undegraded nucleic acid (especially RNA). To determine these retentions times, where the (nearly) horizontal section of the molecular weight curve begins and ends, respectively, the first derivate from the molecular weight curve may be calculated. Then, the start and end points of the (preferably continuous) section, where the first derivate is about 0, represent the desired retentions times. Consequently, in this further alternative embodiment, the integrity value for a sample composition is preferably determined or calculated as the ratio of (i) the area of the peak (UV, fluorescence or RI peak) between these retentions times and (ii) the total area of said peak. Thus, in this further alternative embodiment, the integrity (I) of the nucleic acid (especially RNA) in the sample composition can be calculated using the following equation:

$$I ( \% ) = \frac{{A}_{Peak 2}}{{A}_{Peak 1}} \cdot 100 \% ,$$

wherein A_{Peak1} is the area of the total peak (UV, fluorescence or RI peak) and A_{Peak2} is the area of the peak (UV, fluorescence or RI peak) between t_{b} and tₑ. To verify that the peak maxima contains the “intact”/undegraded nucleic acid (especially RNA), the molecular weight of the nucleic acid (especially RNA) can be determined or calculated from the LS data (such as the MALS data) and compared to the theoretical calculated molecular weight (based on the nucleic acid sequence and optional additional substances (e.g., one or more dyes) covalently or non-covalently attached to the nucleic acid) of the sample. To avoid higher molecular structures of the nucleic acid (especially RNA), the sample should be diluted with a solvent or solvent mixture which is able to prevent the formation of aggregates of the particles. For example, the solvent mixture may be a mixture of water and an organic solvent, e.g., formamide (such as 60% (v/v)). Preferably, such dilution is performed immediately prior to the analysis (e.g., 5 min prior to the analysis) and/or at elevated temperature (e.g., in the range of 40° C. to 80° C., such as 50° C. to 70° C. or 55° C. to 65° C., or at about 60° C.). Samples with a low tendency to form higher molecular structures can be analyzed without the dilution with a solvent or solvent mixture which is able to prevent the formation of aggregates of the particles. For example, FIG. 23 illustrates the above further alternative embodiment for the determination or calculation of the nucleic acid integrity without using a reference nucleic acid. In particular, FIG. 23A shows an AF4 fractogram of an saRNA (having a length of 11,917 nucleotides) with LS signal at 90° (dotted line) and UV signal at 260 nm (solid line). The bold dark line represents the molecular weight derived from the MALS signal. In order to determine the limits for the undegraded/intact RNA peak (peak 2), the molecular weight curve derived from the MALS signal (also shown the upper panel of FIG. 23B) is differentiated to calculate its first derivative (shown in the lower panel of FIG. 23B). According to the data presented in FIG. 23B, the continuous section of the first derivative being about 0 starts at t=˜15 min (=t_{b}) and ends at t=˜31.8 min (=tₑ).

As disclosed herein, in step (b) of the methods and/or uses of the present disclosure at least one signal selected from the group consisting of the UV signal, the fluorescence signal, and the refractory index (RI) signal of least one of the one or more sample fractions is measured, from which the amount of nucleic acid (especially RNA) contained in the (sample) composition can be determined. Since nucleic acid (especially RNA) has a characteristic extinction coefficient in the UV range (e.g., at 260 nm or 280 nm), the amount of said nucleic acid (especially RNA) can determined by measuring the UV signal. In case the nucleic acid (especially RNA) is fluorescent (e.g., because the nucleic acid is covalently or non-covalently labeled with a fluorescent dye) or becomes fluorescent (e.g., by adding a fluorescent dye which (in particular specifically) adheres to the nucleic acid, such as a fluorescent intercalating dye), the amount of the nucleic acid (especially RNA) can also be determined by measuring the fluorescence (FS) signal. Alternatively, the amount of nucleic acid (especially RNA) bound to particles can be determined by using particles which are labeled with a fluorescent dye. Any fluorescent dye can be used in the above approaches. Fluorescent dyes and procedures to covalently or non-covalently attach a fluorescent dye to a nucleic acid (especially RNA) or another substance (e.g., a substance constituting a particle as described herein, such as a lipid and/or polymer) are known to the skilled person; cf., e.g., “The Molecular Probes Handbook—A Guide to Fluorescent Probes and Labeling Technologies”, 11^{th} edt. (2010), I. Johnson and M. T. Z. Spence (editors), which is incorporated herein by reference. Furthermore, the amount of the nucleic acid (especially RNA) can also be determined by measuring the refractive index (RI) signal

B. Total Amount of Nucleic Acid (Especially RNA)

Generally, the amount of nucleic acid (especially RNA) may be determined or calculated based on at least one signal selected from the group consisting of the UV signal, the fluorescence signal, and the refractory index (RI) signal. In one embodiment, for this purpose a calibration curve is used, wherein said calibration curve is established on the basis of several control compositions containing different known amounts of control nucleic acid (especially RNA) and the at least one signal selected from the group consisting of the UV signal, the fluorescence signal, and the RI signal obtained from said control nucleic acid (especially RNA).

Nucleic acid (especially RNA) has a characteristic extinction coefficient in the UV range (e.g., at 260 nm or 280 nm). Thus, in an alternative and preferred embodiment, the amount of nucleic acid (especially RNA) is determined or calculated by measuring the UV signal (preferably at a wavelength in the range of 260 nm to 280 nm, such as at a wavelength of 260 nm or 280 nm) and using Lambert-Beer's law. For example, the nucleic acid (especially RNA) concentration of a sample or control composition can be calculated using the following equation:

$$c = \frac{A \cdot F}{ε \cdot d \cdot V}$$

wherein c is the nucleic acid (especially RNA) concentration (in mg/mL); A is the UV peak area (in AU min); F is the flow rate used in the field-flow fractionation (in mL/min); E is the specific extinction coefficient of the nucleic acid (e.g., 0.025 (mg/mL)⁻¹ cm⁻¹ for single-stranded RNA); d is the cell length (in cm); and V is the injected volume of the sample or control composition or of a part thereof.

The determination or calculation of the nucleic acid (especially RNA) using the extinction coefficient in the UV range (e.g., at 260 nm or 280 nm) is advantageous since it does not require the establishment of a calibration curve.

As indicated above, if a sample or control composition comprises nucleic acid (especially RNA) and particles, the nucleic acid (especially RNA) may be contained in the composition in free form (i.e., not bound/adhered to the particles) and/or in bound form (i.e., bound/adhered to the particles). The total amount of nucleic acid (especially RNA) is the sum of free nucleic acid (especially RNA) (i.e., unbound nucleic acid (such as unbound RNA)) and bound nucleic acid (especially RNA).

Thus, in order to determine or calculate the total amount of nucleic acid (especially RNA) contained in a sample or control composition of the present disclosure comprising nucleic acid (especially RNA) and particles, either (a) one has to determine or calculate both the amount of free nucleic acid (especially RNA) and the amount of bound nucleic acid (especially RNA) for said sample or control composition or (b) one has to transfer (preferably completely) the nucleic acid (especially RNA) of one form (e.g., the bound nucleic acid (especially the bound RNA)) into the other form (e.g., free nucleic acid (especially free RNA)) and determine or calculate the amount of the latter form. This transfer can be achieved, for example, by adding a release agent to the sample or control composition or a part thereof. The release agent is capable of releasing the nucleic acid (especially RNA) bound to the particles from the particles (thereby decreasing the amount of bound nucleic acid (especially bound RNA) to zero and increasing the amount of free nucleic acid (especially free RNA) to its maximum. Examples of release agents include, but are not limited to, (i) a surfactant, such as an anionic surfactant (e.g., sodium dodecylsulfate), a zwitterionic surfactant (e.g., n-tetradecyl-N,N-dimethyl-3-ammonio-1-propanesulfonate (Zwittergent® 3-14)), a cationic surfactant, a non-ionic surfactant, or a mixture thereof; (ii) an alcohol, such as an aliphatic alcohol (e.g., ethanol), or a mixture of alcohols; or (iii) a combination of (i) and (ii). Preferred release agents are an anionic surfactant (e.g., sodium dodecylsulfate), a zwitterionic surfactant (e.g., n-tetradecyl-N,N-dimethyl-3-ammonio-1-propanesulfonate (Zwittergent® 3-14)), or a combination thereof. In order to ensure that the nucleic acid (especially RNA) is not re-taken up into the particles during the field-flow-fractionation, in one embodiment, the sample or control composition for which the total amount of nucleic acid (especially RNA) contained therein is to be determined or calculated or a part of said sample or control composition is subjected to field-flow-fractionation using a liquid phase containing the release agent. However, in case Zwittergent® 3-14 is used as the release agent, it is not necessary to use a liquid phase containing the release agent.

C. Amount of Free Nucleic Acid (Especially RNA)

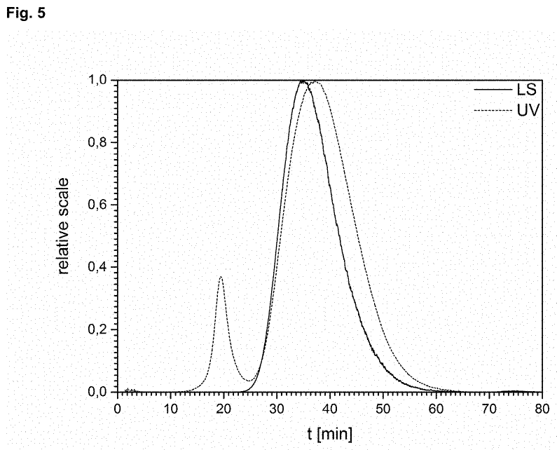

The free nucleic acid (especially RNA) is much smaller in size compared to particles as disclosed herein or at least has a much higher hydrodynamic mobility in the field-flow-fractionation compared to particles as disclosed herein. Thus, by using field-flow-fractionation it is possible to separate the free nucleic acid (especially RNA) from nucleic acid (especially RNA) bound to particles into two (preferably baseline separated) peaks, wherein one peak represents the free nucleic acid (especially RNA) and the other peak represents the nucleic acid (especially RNA) bound to particles. E.g., in case the field-flow-fractionation is performed using a the cross flow rate profile starting from one value (such as about 1 to about 4 mL/min) and then decreasing to a lower value (such as about 0 to about 0.1 mL/min), the peak at the earlier retention time represents the free nucleic acid (especially RNA) and the peak at the later retention time represents the nucleic acid (especially RNA) bound to particles. For example, FIG. 5 illustrates a representative fractogram obtained by subjecting a sample composition comprising RNA and particles to field-flow-fractionation, wherein the UV signal (recorded at 260 nm; dashed line) and the light scattering (LS) signal (solid line) are recorded over time. The light grey box indicates the peak for the free RNA, whereas the dark grey box indicates the RNA bound to particles (dashed line) and the particles (solid line).

Thus, the amount of free nucleic acid (especially RNA) contained in a sample or control composition of the present disclosure comprising nucleic acid (especially RNA) and particles may be determined or calculated in the same way as specified above for the determination or calculation of the total amount of nucleic acid (especially RNA) contained in a sample or control composition of the present disclosure comprising nucleic acid (especially RNA) and particles. Thus, in one embodiment, the amount of free nucleic acid (especially RNA) contained in a sample or control composition of the present disclosure comprising nucleic acid (especially RNA) and particles is determined or calculated based on at least one signal selected from the group consisting of the UV signal, the fluorescence signal, and the refractory index (RI) signal, wherein a calibration curve is used. In a preferred embodiment, the amount of free nucleic acid (especially RNA) is determined or calculated by using the extinction coefficient of nucleic acid (especially RNA) in the UV range (e.g., at 260 nm or 280 nm).

D. Amount of Nucleic Acid (Especially RNA) Bound to Particles

As indicated above, if a sample or control composition comprises nucleic acid (especially RNA) and particles, the nucleic acid (especially RNA) may be contained in the composition in free form (i.e., not bound/adhered to the particles) and/or in bound form (i.e., bound/adhered to the particles).

Thus, in one embodiment, the amount of bound nucleic acid (especially RNA) contained in a sample or control composition of the present disclosure comprising nucleic acid (especially RNA) and particles can be determined or calculated from the total amount of the nucleic acid (especially RNA) contained in the composition and the amount of free nucleic acid (especially free RNA) contained in the composition, in particular by subtracting the amount of free nucleic acid (especially free RNA) from the total amount of the nucleic acid (especially RNA). Both, the amount of bound and free nucleic acid (especially RNA) contained in the composition can be determined or calculated as specified above, e.g., by using a calibration curve based on at least one signal selected from the group consisting of the UV signal, the fluorescence signal, and the refractory index (RI) signal, or by using the extinction coefficient of nucleic acid (especially RNA) in the UV range (e.g., at 260 nm or 280 nm).

E. Amount of Surface Nucleic Acid (Such as the Amount of Surface RNA)

As indicated above, if a sample or control composition comprises nucleic acid (especially RNA) and particles, the nucleic acid (especially RNA) may be bound/adhered to the outer surface of the particles (“surface nucleic acid” (such as “surface RNA”)). This surface nucleic acid (such as surface RNA) can be detected by adding a dye, in particular a fluorescent dye, to the sample or control composition, wherein the dye (especially specifically) binds to the nucleic acid (especially RNA), in particular to the nucleic acid bound/adhered to the outer surface of the particles (i.e., the dye is preferably not able to bind to nucleic acid encapsulated by the particles). Dyes, in particular fluorescent dyes, suitable for this purpose are known to the skilled person; cf., e.g., “The Molecular Probes Handbook—A Guide to Fluorescent Probes and Labeling Technologies”, 11^{th} edt. (2010). Particular examples of such dyes which (in particular specifically) bind to the nucleic acid (especially RNA), in particular to the nucleic acid bound/adhered to the outer surface of the particles, include intercalating dyes, e.g., GelRED (5,5′-(6,22-dioxo-11,14,17-trioxa-7,21-diazaheptacosane-1,27-diyl)bis(3,8-diamino-6-phenylphenanthridin-5-ium)iodide), GelGreen (10,10′-(6,22-dioxo-11,14,17-trioxa-7,21-diazaheptacosane-1,27-diyl)bis(3,6-bis(dimethylamino)acridin-10-ium) iodide), berberine, ethidium (such as ethidium bromide), methylene blue, or proflavine, preferably GelRED.

Thus, in one embodiment, the amount of surface nucleic acid (especially surface RNA) contained in a sample or control composition of the present disclosure comprising nucleic acid (especially RNA) and particles can be determined or calculated from the signal of a dye, in particular the fluorescence signal of a fluorescent dye, such as an intercalating dye (e.g., GelRED (5,5′-(6,22-dioxo-11,14,17-trioxa-7,21-diazaheptacosane-1,27-diyl)bis(3,8-diamino-6-phenyphenanthridin-5-ium) iodide), GelGreen (10,10′-(6,22-dioxo-11,14,17-trioxa-7,21-diazaheptacosane-1,27-diyl)bis(3,6-bis(dimethylamino)acri-din-10-ium) iodide), berberine, ethidium (such as ethidium bromide), methylene blue, or proflavine, preferably GelRED) added to the sample or control composition, wherein the dye (especially specifically) binds to the nucleic acid (especially RNA), in particular to the nucleic acid (especially RNA) bound/adhered to the outer surface of the particles. Preferably, the light emission (e.g., the fluorescence emission) of the dye is enhanced by binding to (such as intercalation into) the surface nucleic acid (especially surface RNA).

In one embodiment, for this purpose a calibration curve is used, wherein said calibration curve is established on the basis of several control compositions containing a dye (e.g., a fluorescent dye, such as an intercalating dye, e.g., GelRED, GelGreen, berberine, ethidium (such as ethidium bromide), methylene blue, or proflavine, preferably GelRED) and different known amounts of control nucleic acid (especially RNA) and the light emission signal from the dye (e.g., the fluorescence signal from the fluorescent dye).

F. Amount of Encapsulated Nucleic Acid (Such as the Amount of Encapsulated RNA)

As indicated above, if a sample or control composition comprises nucleic acid (especially RNA) and particles, the nucleic acid (especially RNA) may be contained in the composition in bound form (i.e., bound/adhered to the particles), wherein the bound nucleic acid (especially RNA) is composed of nucleic acid (especially RNA) bound/adhered to the outer surface of the particles (i.e., surface nucleic acid (such as surface RNA)) and nucleic acid (especially RNA) contained/encapsulated within the particles (i.e., encapsulated nucleic acid (such as encapsulated RNA)).

Thus, in one embodiment, the amount of encapsulated nucleic acid (especially encapsulated RNA) contained in a sample or control composition of the present disclosure comprising nucleic acid (especially RNA) and particles can be determined or calculated from the amount of the bound nucleic acid (especially bound RNA) contained in the composition and the amount of surface nucleic acid (especially surface RNA) contained in the composition, in particular by subtracting the amount of surface nucleic acid (especially surface RNA) from the amount of bound nucleic acid (especially bound RNA). Both, the amount of bound and surface nucleic acid (especially RNA) contained in the composition can be determined or calculated as specified above. E.g., the amount of bound nucleic acid (especially RNA) contained in the composition can be determined or calculated from the total amount of the nucleic acid (especially RNA) contained in the composition and the amount of free nucleic acid (especially free RNA) contained in the composition as specified above (in particular by subtracting the amount of free nucleic acid (especially free RNA) from the total amount of the nucleic acid (especially RNA), wherein both, the amount of bound and free nucleic acid (especially RNA) contained in the composition can be determined or calculated as specified above, e.g., by using a calibration curve based on at least one signal selected from the group consisting of the UV signal, the fluorescence signal, and the refractory index (RI) signal, or by using the extinction coefficient of nucleic acid (especially RNA) in the UV range (e.g., at 260 nm or 280 nm)). Furthermore, the amount of surface nucleic acid (especially RNA) contained in the composition can be determined or calculated as described herein, e.g., from the light emission signal of a dye (e.g., the fluorescence signal of a fluorescent dye, such as an intercalating dye (e.g., GelRED (5,5′-(6,22-dioxo-11,14,17-trioxa-7,21-diazaheptacosane-1,27-diyl)bis(3,8-diamino-6-phenylphenanthridin-5-ium)iodide), GelGreen (10,10′-(6,22-dioxo-11,14,17-trioxa-7,21-diazaheptacosane-1,27-diyl)bis(3,6-bis(dimethylamino)acri-din-10-ium) iodide), berberine, ethidium (such as ethidium bromide), methylene blue, or proflavine, preferably GelRED) added to the composition, wherein the dye (especially specifically) binds to the nucleic acid (especially RNA) bound/adhered to the outer surface of the particles.

G. Amount of Accessible Nucleic Acid (Such as the Amount of Accessible RNA)

As indicated above (cf., e.g., FIG. 21), if a sample or control composition comprises nucleic acid (especially RNA) and particles, the accessible nucleic acid (especially RNA) is the sum of the surface nucleic acid (especially surface RNA) and the free nucleic acid (especially free RNA). Alternatively, the accessible nucleic acid (especially RNA) may be determined or calculated from the total amount of nucleic acid (especially total amount of RNA) and the encapsulated nucleic acid (especially encapsulated RNA) by subtracting the amount the encapsulated nucleic acid (especially encapsulated RNA) from the total amount of nucleic acid (especially total amount of RNA).

Thus, in one embodiment, the amount of accessible nucleic acid (especially the amount of accessible RNA) contained in a sample or control composition of the present disclosure comprising nucleic acid (especially RNA) and particles can be determined or calculated from the amount of the surface nucleic acid (especially surface RNA) contained in the composition and the amount of free nucleic acid (especially free RNA) contained in the composition, in particular by summating the amount of the surface nucleic acid (especially surface RNA) and the amount of the surface nucleic acid (especially surface RNA). In an alternative embodiment, the amount of accessible nucleic acid (especially the amount of accessible RNA) contained in a sample or control composition of the present disclosure comprising nucleic acid (especially RNA) and particles can be determined or calculated from the total amount of nucleic acid (especially total amount of RNA) contained in the composition and the encapsulated nucleic acid (especially encapsulated RNA) contained in the composition, in particular by subtracting the amount the encapsulated nucleic acid (especially encapsulated RNA) from the total amount of nucleic acid (especially total amount of RNA). The total amount of nucleic acid (especially total amount of RNA) contained in the composition, the amount of free nucleic acid (especially free RNA) contained in the composition, the amount of the surface nucleic acid (especially surface RNA) contained in the composition, and the encapsulated nucleic acid (especially encapsulated RNA) contained in the composition can be determined or calculated as specified above under B., C., E., and F., respectively.

H. Size, Size Distribution and Quantitative Size Distribution of Nucleic Acid (Especially RNA) Containing Particles

If a sample or control composition comprises nucleic acid (especially RNA) and particles, the size of the particles and the distribution of said particles can be determined or calculated from the light scattering (LS) signal of the one or more sample or control fractions obtained by subjecting the sample or control composition or at least a part thereof to field-flow fractionation. In one embodiment, the measured intensity of the scattered light at multiple angles is used, wherein each slice corresponds to a curve describing the angular dependence of the light scattered by the eluting particles. By fitting the curve with an appropriate formalism (e.g., Berry plot or Zimm plot or Debye plot) and extrapolating to zero angles the radius of gyration (R_{g}) values and/or hydrodynamic radius (Rₕ) values can be obtained, from which the size of the eluted particles can be determined or calculated. In another embodiment, an external calibration and regression analysis based on the retention times of different particle size standards can be utilized in order to determine or calculate the size of the eluted particles. In a third embodiment, the size of the eluted particles is determined by direct calculation (i.e., without calibration) from the retention time of the eluted species. If the dimensions of the fractionation channel are known and there is a constant cross-flow, the retention ratio can be determined empirically from the ratio of the measured void time and the retention time. The signal selected from the group consisting of the UV signal, the fluorescence signal, and the refractory index (RI) signal (from any of which the amount of nucleic acid (especially RNA) can be determined as described herein and also the amount of nucleic acid (especially RNA) containing particles can be determined) can be used for the determination or calculation of the particle size distribution and/or quantitative particle size distribution, whereby the signal selected from the group consisting of the UV signal, the fluorescence signal, and the RI signal can directly be translated into the amount of a particle having a specific size. The particle size distribution and/or quantitative particle size distribution can be given as the number of the particles, the molar amount of the particles, or the mass of the particles each as a function of their size.

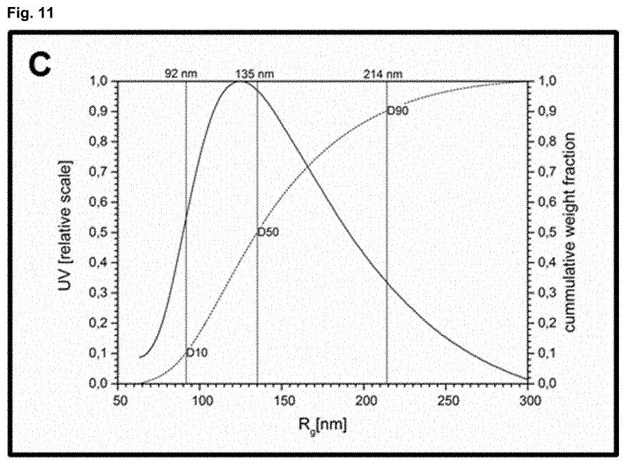

FIG. 11 illustrates the transformation of the data contained in the fractogram (FIG. 11A) obtained from subjecting a sample composition to AF4-UV-MALS into the size distribution (FIG. 11C, solid line) and quantitative size distribution (FIG. 11C, dashed line) of RNA containing particles. The radius of gyration (R_{g}) values (shown in FIGS. 11A and 11B as black dots) were determined from the MALS signals of the particle peak (elution time: 26-55 min; cf. FIG. 11A) using Berry plot. The experimentally determined R_{g} values were smoothed by fitting the R_{g} values to a polynomial function (cf. FIG. 11B, light gray line), recalculating the R_{g} values based on the polynomial fit, and plotting the recalculated R_{g} values as a function of the retention time. The UV signal was plotted as function of the recalculated R_{g} values thereby creating the size distribution curve (FIG. 11C, solid line). Transforming the UV signal into a cumulative weight fraction and plotting the cumulative weight fraction against the recalculated R_{g} values resulted in the quantitative size distribution curve (FIG. 11C, dashed line). From the quantitative size distribution curve characteristic values (in particular D10, D50, and D90) were determined.

Thus, in one embodiment, the size of the nucleic acid (especially RNA) containing particles is determined or calculated based on the LS signal by determining or calculating therefrom the radius of gyration (R_{g}) values. Preferably, the R_{g} values are determined or calculated for at least one particle peak. If the field-flow fractioning results in more than one particle peak, it is preferred that the R_{g} values are determined or calculated for each particle peak separately.

In one embodiment, the experimentally determined or calculated R_{g} values are smoothed, e.g., by fitting the experimentally determined or calculated R_{g} values to a polynomial function (e.g., f(t)=a+b₁x+b₂x²+b₃x³+b₄x⁴) or linear function (e.g., f(t)=a+a₁x) and recalculating the R_{g} values based on the polynomial or linear fit, and optionally plotting the recalculated R_{g} values as a function of the retention time. If the field-flow fractioning results in more than one particle peak, it is preferred that the experimentally determined or calculated R_{g} values are smoothed (e.g., recalculated as specified above) for each particle peak separately.

The LS signal may be obtained by any suitable detector and is preferably the dynamic light scattering (DLS) and/or the static light scattering (SLS), e.g., multi-angle light scattering (MALS), signal. A preferred MALS signal is the multi-angle laser light scattering (MALLS) signal.

In one embodiment, the size distribution of nucleic acid (especially RNA) containing particles is determined or calculated by plotting the signal selected from the group consisting of the UV signal, the fluorescence signal, and the RI signal (preferably the UV signal) against the (optionally recalculated) R_{g} values. Thus, in a preferred embodiment, the size distribution of RNA containing particles is determined or calculated by plotting the UV signal against the recalculated R_{g} values. The size distribution of nucleic acid (especially RNA) containing particles may be given as the number of the particles, the molar amount of the particles, or the mass of the particles each as a function of their size. If the field-flow fractioning results in more than one particle peak, it is preferred that the size distribution is determined or calculated for each particle peak separately.

In one embodiment, the quantitative size distribution of the nucleic acid (especially RNA) containing particles is determined or calculated from the size distribution of the nucleic acid (especially RNA) containing particles by transforming the signal selected from the group consisting of the UV signal, the fluorescence signal, and the RI signal (preferably the UV signal) into a cumulative weight fraction and plotting the cumulative weight fraction against the (optionally recalculated) R_{g} values. Thus, in a preferred embodiment, the quantitative size distribution of RNA containing particles is determined or calculated from the size distribution of the RNA containing particles by transforming the UV signal into a cumulative weight fraction and plotting the cumulative weight fraction against the recalculated R_{g} values. The quantitative size distribution of nucleic acid (especially RNA) containing particles may be given as the number of the particles, the molar amount of the particles, or the mass of the particles each as a function of their size. If the field-flow fractioning results in more than one particle peak, it is preferred that the quantitative size distribution is determined or calculated for each particle peak separately.

In one embodiment, the quantitative size distribution of the nucleic acid (especially RNA) containing particles includes D10, D50, D90, D95, D99, and/or D100 values (in particular based on R_{g} values). In one embodiment, the quantitative size distribution of the nucleic acid (especially RNA) containing particles includes D10, D50, and/or D90 values (in particular based on R_{g} values). If the field-flow fractioning results in more than one particle peak, it is preferred that D10, D50, D90, D95, D99, and/or D100 values (preferably D10, D50, and/or D90 values) (in particular based on R_{g} values) are determined or calculated for each particle peak separately.

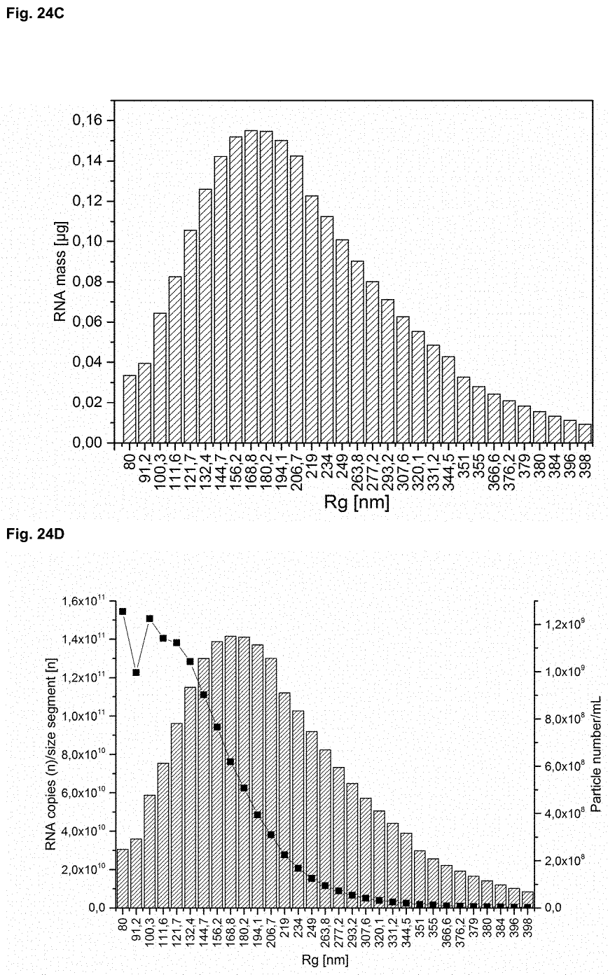

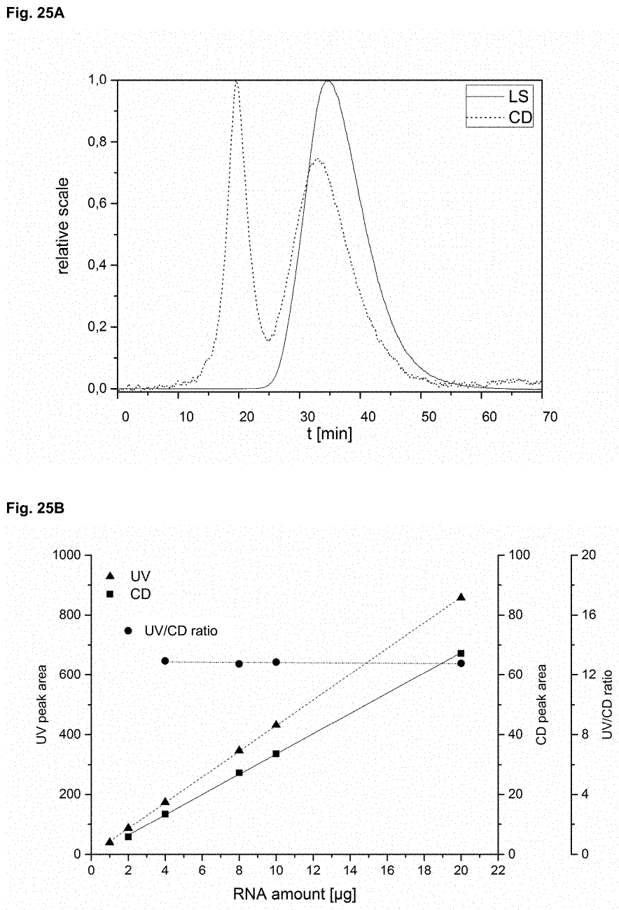

FIG. 24 illustrates the transformation of the data contained in the fractogram (FIG. 23A) obtained from subjecting a sample composition to AF4-UV-MALS into different types of quantitative size distribution of RNA containing particles: (a) a cumulative weight fraction (FIG. 24B, solid line); (b) RNA mass per particle fraction (Δt=1 min) (FIG. 24C); or (c) RNA copy number or particle number per particle fraction (Δt=1 min) (FIG. 24D). The radius of gyration (R_{g}) values (shown in FIG. 24A as bold line) were determined from the MALS signals of the particle peak (elution time: 24-55 min; cf., FIG. 24A) using Berry plot. The experimentally determined R_{g} values were smoothed by fitting the R_{g} values to a polynomial function, recalculating the R_{g} values based on the polynomial fit, and plotting the recalculated R_{g} values as a function of the retention time. Transforming the UV signal into a cumulative weight fraction and plotting the cumulative weight fraction against the recalculated R_{g} values resulted in the quantitative size distribution curve shown in FIG. 24B as solid line. Subdividing the particle peak (Δt=1 min) on the basis of the recalculated R_{g} values (thereby creating 31 R_{g} fractions), calculating the RNA mass from the UV signal for each R_{g} fraction, and plotting the RNA mass values against the R_{g} fractions resulted in the particular quantitative size distribution showing the RNA mass per R_{g} fraction; cf. FIG. 24C. Furthermore, transforming the RNA mass values into RNA copy numbers and plotting the latter against the R_{g} fractions resulted in the particular quantitative size distribution showing the RNA copy numbers per R_{g} fraction; cf., FIG. 24D, bars. In addition, transforming the UV and MALS signals into the number of particles and plotting the latter against the R_{g} fractions resulted in the particular quantitative size distribution showing the particle number per R_{g} fraction; cf., FIG. 24D, dot-line curve. For the above calculations and transformations, the following equations and information can be used:
Volume of particle:

$$V = \frac{4 π}{3} {r}^{3}$$

Volume of hard sphere as function of r_{g}:

$$V = \sqrt{\frac{5}{3}} {r}_{g}^{3}$$

Volume of lipoplex with one copy:
   length of the RNA used: 2000 nucleotides
   overall density: 1 g/mL=1 g/cm³=10⁻²¹ g/nm³
   molar mass per nucleotide (330 Da): 330 g/mol
   molar mass RNAₗᵢₚₒₚₗₑₓ/nucleotide (nucleotide+DOTMA+½ DOPE): 1370 Da
   molar mass RNAₗᵢₚₒₚₗₑₓ/copy: 1370×2000=2.74×10⁶ Da g/mol
   volume RNAₗᵢₚₒₚₗₑₓ/copy: 2.74×10⁶×10²¹/6×10²³=4.6×10³ nm³

Thus, in one embodiment, the size of the nucleic acid (especially RNA) containing particles is determined or calculated based on the LS signal by determining or calculating therefrom the radius of gyration (R_{g}) values and the R_{g} values are subdivided into at least two (such as at least 3, at least 4, at least 5, at least 6, at least 7, at least 8, at least 9, or at least 10) R_{g} fractions and/or up to 100 (such as up to 90, up to 80, up to 70, up to 60, up to 50, up to 40, up to 30, or up to 20) R_{g} fractions, wherein each R_{g} fraction has a R_{g} range (which preferably does not overlap with the R_{g} range of any other R_{g} fraction). Preferably, the R_{g} values and R_{g} fractions are determined or calculated for at least one particle peak. If the field-flow fractioning results in more than one particle peak, it is preferred that the R_{g} values and R_{g} fractions are determined or calculated for each particle peak separately.

In one embodiment, the experimentally determined or calculated R_{g} values are smoothed prior to subdividing them into R_{g} fractions, e.g., by fitting the experimentally determined or calculated R_{g} values to a polynomial function (e.g., f(t)=a+b₁x+b₂x²+b₃x³+b₄x⁴) or linear function (e.g., f(t)=a+a₁x) and recalculating the R_{g} values based on the polynomial or linear fit, and optionally plotting the recalculated R_{g} values as a function of the retention time. If the field-flow fractioning results in more than one particle peak, it is preferred that the experimentally determined or calculated R_{g} values are smoothed (e.g., recalculated as specified above) for each particle peak separately.

The LS signal may be obtained by any suitable detector and is preferably the dynamic light scattering (DLS) and/or the static light scattering (SLS), e.g., multi-angle light scattering (MALS), signal. A preferred MALS signal is the multi-angle laser light scattering (MALLS) signal.

In one embodiment, the size distribution of nucleic acid (especially RNA) containing particles is determined or calculated by plotting the signal selected from the group consisting of the UV signal, the fluorescence signal, and the RI signal (preferably the UV signal) against the R_{g} fractions (obtained by subdividing the (optionally recalculated) R_{g} values). Thus, in a preferred embodiment, the size distribution of RNA containing particles is determined or calculated by plotting the UV signal against the R_{g} fractions obtained by subdividing the recalculated R_{g} values. The size distribution of nucleic acid (especially RNA) containing particles may be given as the nucleic acid mass (especially RNA mass), the nucleic acid copy number (especially RNA copy number) or particle number each as a function of the R_{g} fractions. If the field-flow fractioning results in more than one particle peak, it is preferred that the size distribution is determined or calculated for each particle peak separately.

In one embodiment, the quantitative size distribution of the nucleic acid (especially RNA) containing particles is determined or calculated from the size distribution of the nucleic acid (especially RNA) containing particles by transforming the signal selected from the group consisting of the UV signal, the fluorescence signal, and the RI signal (preferably the UV signal) into a cumulative weight fraction and plotting the cumulative weight fraction against the R_{g} fractions (obtained by subdividing the (optionally recalculated) R_{g} values). Thus, in a preferred embodiment, the quantitative size distribution of RNA containing particles is determined or calculated from the size distribution of the RNA containing particles by transforming the UV signal into a cumulative weight fraction and plotting the cumulative weight fraction against the R_{g} fractions (obtained by subdividing the recalculated R_{g} values). The quantitative size distribution of nucleic acid (especially RNA) containing particles may be given as the nucleic acid mass (especially RNA mass) per R_{g} fraction, the nucleic acid copy number (especially RNA copy number) or particle number per R_{g} fraction. If the field-flow fractioning results in more than one particle peak, it is preferred that the quantitative size distribution is determined or calculated for each particle peak separately.

The above transformation approach (cf., e.g., FIG. 11 and FIG. 24) has been illustrated by using R_{g} values. However, the same approach can be utilized when using Rₕ values (not shown in FIG. 11 or FIG. 24). For example, the experimentally determined Rₕ values are smoothed by fitting the Rₕ values to a polynomial function, recalculating the Rₕ values based on the polynomial fit, and plotting the recalculated Rₕ values as a function of the retention time. Optionally, the Rₕ values are subdivided into at least two (such as at least 3, at least 4, at least 5, at least 6, at least 7, at least 8, at least 9, or at least 10) Rₕ fractions and/or up to 100 (such as up to 90, up to 80, up to 70, up to 60, up to 50, up to 40, up to 30, or up to 20) Rₕ fractions, wherein each Rₕ fraction has a Rₕ range (which preferably does not overlap with the Rₕ range of any other Rₕ fraction). The UV signal is plotted as function of the recalculated Rₕ values (or Rₕ fractions obtained from subdividing the recalculated Rₕ values) thereby creating a size distribution curve (based on Rₕ values or Rₕ fractions). Transforming the UV signal into a cumulative weight fraction and plotting the cumulative weight fraction against the recalculated Rₕ values results in a quantitative size distribution curve. From the quantitative size distribution curve characteristic values (in particular D10, D50, and D90), based on the Rₕ values, can be determined. Alternatively, transforming the UV signal into a cumulative weight fraction and plotting the cumulative weight fraction against the Rₕ fractions results in an alternative quantitative size distribution curve. From the alternative quantitative size distribution curve characteristic parameters, in particular the nucleic acid mass (especially RNA mass) per Rₕ fraction, the nucleic acid copy number (especially RNA copy number) or particle number per Rₕ fraction, can be determined.

Thus, in some embodiments, in particular those, where the one or more parameters to be determined or analyzed by the methods and/or uses of the present disclosure comprise the size, size distribution and/or quantitative size distribution of nucleic acid (especially RNA) containing particles, the methods and/or uses may comprise measuring the dynamic light scattering (DLS) signal of least one of the one or more sample fractions obtained from the field-flow fractionation. The hydrodynamic radius may be determined or calculated from the DLS signal in any conventional way, e.g., by using the Stokes-Einstein equation. Preferably, the Rₕ values are determined or calculated for at least one particle peak. If the field-flow fractioning results in more than one particle peak, it is preferred that the Rₕ values are determined or calculated for each particle peak separately.

Optionally, the Rₕ values are subdivided into at least two (such as at least 3, at least 4, at least 5, at least 6, at least 7, at least 8, at least 9, or at least 10) Rₕ fractions and/or up to 100 (such as up to 90, up to 80, up to 70, up to 60, up to 50, up to 40, up to 30, or up to 20) Rₕ fractions, wherein each Rₕ fraction has a Rₕ range (which preferably does not overlap with the Rₕ range of any other Rₕ fraction).

In one embodiment, the experimentally determined or calculated Rₕ values are smoothed (preferably prior to subdividing them into Rₕ fractions), e.g., by fitting the experimentally determined or calculated Rₕ values to a polynomial function (e.g., f(t)=a+b₁x+b2x²+b₃x³+b₄x⁴) or linear function (e.g., f(t)=a+a₁x) and recalculating the Rₕ values based on the polynomial or linear fit, and optionally plotting the recalculated Rₕ values as a function of the retention time. If the field-flow fractioning results in more than one particle peak, it is preferred that the experimentally determined or calculated Rₕ values are smoothed (e.g., recalculated as specified above) for each particle peak separately.

In one embodiment, the size distribution of nucleic acid (especially RNA) containing particles is determined or calculated by plotting the signal selected from the group consisting of the UV signal, the fluorescence signal, and the RI signal (preferably the UV signal) against the (optionally recalculated) Rₕ values (or the Rₕ fractions obtained from subdividing the (optionally recalculated) Rₕ values). Thus, in a preferred embodiment, the size distribution of RNA containing particles is determined or calculated by plotting the UV signal against the recalculated Rₕ values (or the Rₕ fractions obtained from subdividing the recalculated Rₕ values). The size distribution of nucleic acid (especially RNA) containing particles may be given as the number of the particles, the molar amount of the particles, or the mass of the particles each as a function of their size (e.g., as a function of the Rₕ values or Rₕ fractions obtained from subdividing the recalculated Rₕ values). If the field-flow fractioning results in more than one particle peak, it is preferred that the size distribution is determined or calculated for each particle peak separately.

In one embodiment, the quantitative size distribution of the nucleic acid (especially RNA) containing particles is determined or calculated from the size distribution of the nucleic acid (especially RNA) containing particles by transforming the signal selected from the group consisting of the UV signal, the fluorescence signal, and the RI signal (preferably the UV signal) into a cumulative weight fraction and plotting the cumulative weight fraction against the (optionally recalculated) Rₕ values (or the Rₕ fractions obtained from subdividing the (optionally recalculated) Rₕ values). Thus, in a preferred embodiment, the quantitative size distribution of RNA containing particles is determined or calculated from the size distribution of the RNA containing particles by transforming the UV signal into a cumulative weight fraction and plotting the cumulative weight fraction against the recalculated Rₕ values (or the Rₕ fractions obtained from subdividing the recalculated Rₕ values). The quantitative size distribution of nucleic acid (especially RNA) containing particles may be given as the number of the particles, the molar amount of the particles, or the mass of the particles each as a function of their size. Alternatively, the quantitative size distribution of nucleic acid (especially RNA) containing particles may be given as the nucleic acid mass (especially RNA mass) per Rₕ fraction, the nucleic acid copy number (especially RNA copy number) or particle number per Rₕ fraction. If the field-flow fractioning results in more than one particle peak, it is preferred that the quantitative size distribution is determined or calculated for each particle peak separately.

In one embodiment, the quantitative size distribution of the nucleic acid (especially RNA) containing particles includes D10, D50, D90, D95, D99, and/or D100 values (based on Rₕ values). In one embodiment, the quantitative size distribution of the nucleic acid (especially RNA) containing particles includes D10, D50, and/or D90 values (based on Rₕ values). If the field-flow fractioning results in more than one particle peak, it is preferred that D10, D50, D90, D95, D99, and/or D100 values (preferably D10, D50, and/or D90 values) (based on Rₕ values) are determined or calculated for each particle peak separately.

In some embodiments, in particular those, where the one or more parameters to be determined or analyzed by the methods and/or uses of the present disclosure comprise the size, size distribution and/or quantitative size distribution of nucleic acid (especially RNA) containing particles, the size, size distribution, and/or quantitative size distribution of nucleic acid (such as RNA) containing particles is/are calculated based on the R_{g} values of the nucleic acid (such as RNA) containing particles as described above and separately based on the Rₕ values of nucleic acid (such as RNA) containing particles as described above (i.e., these embodiments result in two data sets for the size, size distribution, and/or quantitative size distribution of nucleic acid (such as RNA) containing particles, one based on the R_{g} values and one based on the Rₕ values).

In some embodiments, in particular those, where the one or more parameters to be determined or analyzed by the methods and/or uses of the present disclosure comprise the size, size distribution and/or quantitative size distribution of nucleic acid (especially RNA) containing particles, the R_{g} values are subdivided into at least two R_{g} fractions as described above and the Rₕ values are subdivided into at least two Rₕ fractions as described above, the size, size distribution, and/or quantitative size distribution of nucleic acid (such as RNA) containing particles is/are calculated based on the R_{g} fractions of the nucleic acid (such as RNA) containing particles as described above and separately based on the Rₕ fractions of nucleic acid (such as RNA) containing particles as described above (i.e., these embodiments result in two data sets for the size, size distribution, and/or quantitative size distribution of nucleic acid (such as RNA) containing particles, one based on the R_{g} fractions and one based on the Rₕ fractions).

I. Size, Size Distribution and Quantitative Size Distribution of Nucleic Acid (Especially RNA)

When the nucleic acid (especially RNA) is in free form (i.e., not bound or adhered to particles contained in a sample or control composition comprising nucleic acid (especially RNA) and particles) or in unformulated form (i.e., in a composition lacking particles as specified herein, such as lacking components constituting liposomes (in particular cationic amphiphilic lipid(s) and/or cationic amphiphilic polymers) and/or virus-like particles) the size, the size distribution and/or the quantitative size distribution of the nucleic acid (especially RNA) (in particular, based on the radius of gyration (R_{g}) of nucleic acid (especially RNA) and/or the hydrodynamic radius (Rₕ) of nucleic acid (especially RNA)) can also be determined or analyzed.

Thus, in one embodiment, additional parameters to be analyzed or determined by the methods and/or uses of the present disclosure, in particular if the sample or control composition comprises nucleic acid (especially RNA) in free or unformulated form, include the size, the size distribution and/or the quantitative size distribution of the nucleic acid (especially RNA) (in particular, based on R_{g} and/or Rₕ values of nucleic acid (especially RNA) or on R_{g} and/or Rₕ fractions of nucleic acid (especially RNA), after subdividing the R_{g} and/or Rₕ values of nucleic acid (especially RNA) into R_{g} and/or Rₕ fractions of nucleic acid (especially RNA)). Generally, the size distribution and/or quantitative size distribution of nucleic acid (especially RNA) can be given as the number of the nucleic acid (especially RNA) molecules, the molar amount of the nucleic acid (especially RNA), or the mass of the nucleic acid (especially RNA) each as a function of their size. Alternatively, the size distribution and/or quantitative size distribution of nucleic acid (especially RNA) can be given as the nucleic acid mass (especially RNA mass) per R_{g} and/or Rₕ fraction or the nucleic acid copy number (especially RNA copy number) per R_{g} and/or Rₕ fraction.

These parameters can be determined or analyzed as specified above for nucleic acid (especially RNA) containing particles.

For example, in one embodiment, the size of the nucleic acid (especially RNA) is determined or calculated based on the LS signal by determining or calculating therefrom the radius of gyration (R_{g}) values and/or hydrodynamic radius (Rₕ) values. Preferably, the R_{g} (or Rₕ) values are determined or calculated for at least one nucleic acid (especially RNA) peak. If the field-flow fractioning results in more than one nucleic acid (especially RNA) peak, it is preferred that the R_{g} (or Rₕ) values are determined or calculated for each nucleic acid (especially RNA) peak separately.

Optionally, the R_{g} (or Rₕ) values are subdivided into at least two (such as at least 3, at least 4, at least 5, at least 6, at least 7, at least 8, at least 9, or at least 10) R_{g} (or Rₕ) fractions and/or up to 100 (such as up to 90, up to 80, up to 70, up to 60, up to 50, up to 40, up to 30, or up to 20) R_{g} (or Rₕ) fractions, wherein each R_{g} (or Rₕ) fraction has a R_{g} (or Rₕ) range (which preferably does not overlap with the R_{g} (or Rₕ) range of any other R_{g} (or Rₕ) fraction).

In one embodiment, the experimentally determined or calculated R_{g} (or Rₕ) values are smoothed (preferably prior to subdividing them into R_{g} (or Rₕ) fractions), e.g., by fitting the experimentally determined or calculated R_{g} (or Rₕ) values to a polynomial function (e.g., f(t)=a+b₁x+b₂x²+b₃x³+b₄x⁴) or linear function (e.g., f(t)=a+a₁x) and recalculating the R_{g} (or Rₕ) values based on the polynomial or linear fit, and optionally plotting the recalculated R_{g} (or Rₕ) values as a function of the retention time. If the field-flow fractioning results in more than one nucleic acid (especially RNA) peak, it is preferred that the experimentally determined or calculated R_{g} (or Rₕ) values are smoothed (e.g., recalculated as specified above) for each nucleic acid (especially RNA) peak separately.

The LS signal may be obtained by any suitable detector and is preferably the dynamic light scattering (DLS) and/or the static light scattering (SLS), e.g., multi-angle light scattering (MALS), signal. A preferred MALS signal is the multi-angle laser light scattering (MALLS) signal.

In one embodiment, the size distribution of the nucleic acid (especially RNA) is determined or calculated by plotting the signal selected from the group consisting of the UV signal, the fluorescence signal, and the RI signal (preferably the UV signal) against the (optionally recalculated) R_{g} (or Rₕ) values (or the R_{g} (or Rₕ) fractions obtained from subdividing the (optionally recalculated) R_{g} (or Rₕ) values). Thus, in a preferred embodiment, the size distribution of the RNA is determined or calculated by plotting the UV signal against the recalculated R_{g} (or Rₕ) values (or the R_{g} (or Rₕ) fractions obtained from subdividing the recalculated R_{g} (or Rₕ) values). The size distribution of nucleic acid (especially RNA) may be given as the number of nucleic acid (especially RNA) molecules, the molar amount of the nucleic acid (especially RNA), or the nucleic acid (especially RNA) of the particles each as a function of their size. Alternatively, the size distribution of nucleic acid (especially RNA) can be given as the nucleic acid mass (especially RNA mass) per R_{g} and/or Rₕ fraction or the nucleic acid copy number (especially RNA copy number) per R_{g} and/or Rₕ fraction. If the field-flow fractioning results in more than one nucleic acid (especially RNA) peak, it is preferred that the size distribution is determined or calculated for each nucleic acid (especially RNA) peak separately.

In one embodiment, the quantitative size distribution of the nucleic acid (especially RNA) is determined or calculated from the size distribution of the nucleic acid (especially RNA) by transforming the signal selected from the group consisting of the UV signal, the fluorescence signal, and the RI signal (preferably the UV signal) into a cumulative weight fraction and plotting the cumulative weight fraction against the (optionally recalculated) R_{g} (or Rₕ) values (or the R_{g} (or Rₕ) fractions obtained from subdividing the (optionally recalculated) R_{g} (or Rₕ) values). Thus, in a preferred embodiment, the quantitative size distribution of the RNA is determined or calculated from the size distribution of the RNA by transforming the UV signal into a cumulative weight fraction and plotting the cumulative weight fraction against the recalculated R_{g} (or Rₕ) values (or the R_{g} (or Rₕ) fractions obtained from subdividing the recalculated R_{g} (or Rₕ) values). The quantitative size distribution of nucleic acid (especially RNA) may be given as the number of nucleic acid (especially RNA) molecules, the molar amount of the nucleic acid (especially RNA), or the nucleic acid (especially RNA) of the particles each as a function of their size. Alternatively, the quantitative size distribution of nucleic acid (especially RNA) can be given as the nucleic acid mass (especially RNA mass) per R_{g} and/or Rₕ fraction or the nucleic acid copy number (especially RNA copy number) per R_{g} and/or Rₕ fraction. If the field-flow fractioning results in more than one nucleic acid (especially RNA) peak, it is preferred that the quantitative size distribution is determined or calculated for each nucleic acid (especially RNA) peak separately.

In one embodiment, the quantitative size distribution of the nucleic acid (especially RNA) includes D10, D50, D90, D95, D99, and/or D100 values (based on the R_{g} or Rₕ values). In one embodiment, the quantitative size distribution of the nucleic acid (especially RNA) includes D10, D50, and/or D90 values (based on the R_{g} or Rₕ values). If the field-flow fractioning results in more than one nucleic acid (especially RNA) peak, it is preferred that D10, D50, D90, D95, D99, and/or D100 values (preferably D10, D50, and/or D90 values) (based on the R_{g} or Rₕ values) are determined or calculated for each nucleic acid (especially RNA) peak separately.

In some embodiments, in particular those, where the one or more parameters to be determined or analyzed by the methods and/or uses of the present disclosure comprise the size, size distribution and/or quantitative size distribution of nucleic acid (especially RNA), the size, size distribution, and/or quantitative size distribution of nucleic acid (such as RNA) is/are calculated based on the R_{g} values of the nucleic acid (such as RNA) as described above and separately based on the Rₕ values of nucleic acid (such as RNA) as described above (i.e., these embodiments result in two data sets for the size, size distribution, and/or quantitative size distribution of nucleic acid (such as RNA), one based on the R_{g} values and one based on the Rₕ values).

In some embodiments, in particular those, where the one or more parameters to be determined or analyzed by the methods and/or uses of the present disclosure comprise the size, size distribution and/or quantitative size distribution of nucleic acid (especially RNA), the R_{g} values are subdivided into at least two R_{g} fractions as described above and the Rₕ values are subdivided into at least two Rₕ fractions as described above, the size, size distribution, and/or quantitative size distribution of nucleic acid (such as RNA) is/are calculated based on the R_{g} fractions of the nucleic acid (such as RNA) as described above and separately based on the Rₕ fractions of nucleic acid (such as RNA) as described above (i.e., these embodiments result in two data sets for the size, size distribution, and/or quantitative size distribution of nucleic acid (such as RNA), one based on the R_{g} fractions and one based on the Rₕ fractions).

J. Shape Factor/Form Factor

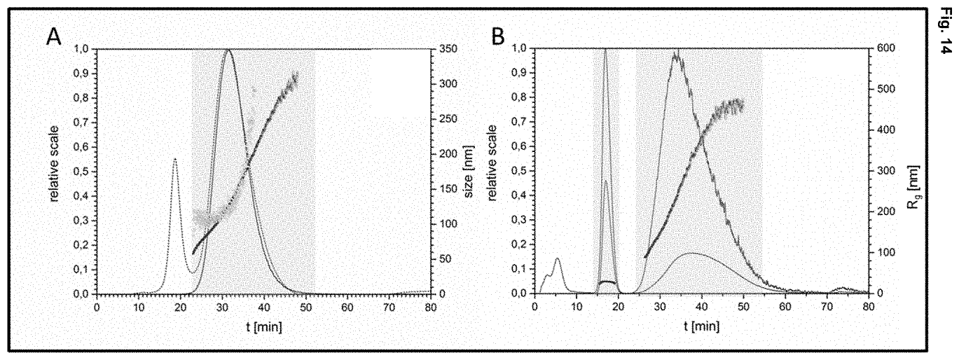

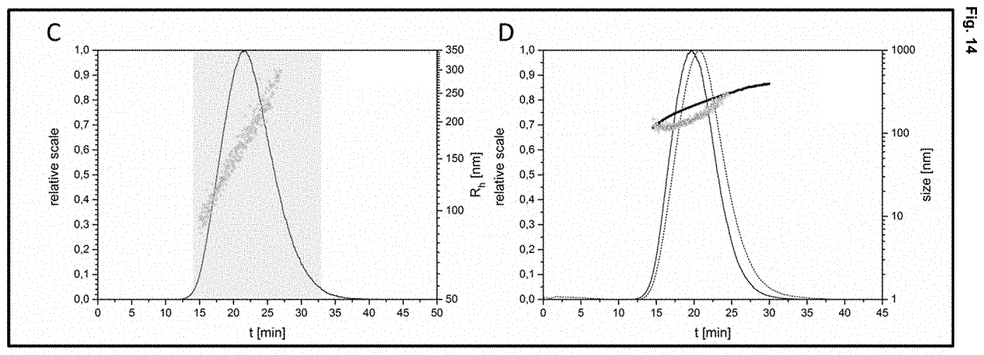

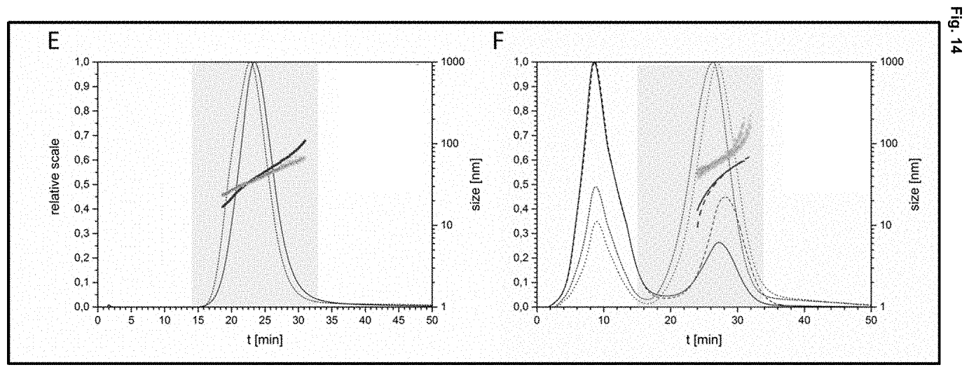

For some applications of nucleic acids (especially RNA) containing particles, such therapeutic or prophylactic application, the particles should be in a certain shape (e.g., a sphere-like shape). Parameters which provide information on the shape of particles are the shape factor and the form factor (cf., e.g., FIG. 13).

Thus, in some embodiments, the one or more parameters to be determined or analyzed by the methods and/or uses of the present disclosure comprise the shape factor and/or the form factor. The shape and form factors may be determined or calculated based on the R_{g} values (such as recalculated R_{g} values) and the hydrodynamic radius (Rₕ) values, preferably as determined or calculated in any one of sections H. to J., above. E.g., the shape factor may be determined or calculated by plotting the R_{g} values (such as recalculated R_{g} values) as determined or calculated above against the hydrodynamic radius (Rₕ) values as determined or calculated above and fitting the data points of this plot to a function (e.g. a linear function). For example, a slope of about 0.774 (such as 0.74) for the linear regression indicates a sphere-shaped form of the analyzed particles. A slope of about 0.816 for the linear regression would indicate a coil-shaped form of the analyzed particles, and a slope of about 1.732 for the linear regression would indicate a rod-shaped form of the analyzed particles. See, e.g., W. Burchard (1990) “Laser Light Scattering in Biochemistry”. Similarly, the form factor may be determined or calculated by plotting the hydrodynamic radius (Rₕ) values as determined or calculated above against the R_{g} values (such as recalculated R_{g} values) as determined or calculated above and fitting the data points of this plot to a function (e.g. a linear function).

K. Nucleic Acid (Especially RNA) Encapsulation Efficiency

For some applications of nucleic acids (especially RNA) containing particles, such therapeutic or prophylactic application, it is necessary to know how efficient nucleic acid (especially RNA) is encapsulated into particles.

Thus, in some embodiments, the one or more parameters to be determined or analyzed by the methods and/or uses of the present disclosure comprise the nucleic acid (especially RNA) encapsulation efficiency. The nucleic acid (especially RNA) encapsulation efficiency may be determined or calculated based on (i) the amount of encapsulated nucleic acid (especially RNA) contained in a sample or control composition comprising nucleic acid and particles and (ii) the total amount of nucleic acid (especially RNA) contained in the sample or control composition, wherein the total amount of nucleic acid (especially RNA) and the amount of encapsulated nucleic acid (especially RNA) are preferably determined or calculated as specified in sections B. and F. In one embodiment, nucleic acid (especially RNA) encapsulation efficiency is determined or calculated by dividing the amount of encapsulated nucleic acid (especially RNA) by the total amount of nucleic acid (especially RNA).

L. Molecular Weight of Nucleic Acid (Especially RNA)

The molecular weight of a nucleic acid (especially RNA) can be determined or calculated from the LS data and compared to its theoretical calculated molecular weight. The theoretical molecular weight of a nucleic acid (especially RNA) can be determined or calculated based on the nucleic acid (especially RNA) sequence and optional additional substances (e.g., one or more dyes, cap structure, etc.) covalently or non-covalently attached to the nucleic acid.

Thus, in some embodiments, the one or more parameters to be determined or analyzed by the methods and/or uses of the present disclosure comprise the molecular weight of nucleic acid (especially RNA). In these embodiments the methods and/or uses of the present disclosure comprise the step of measuring the LS signal of least one of the one or more sample fractions obtained, wherein the molecular weight of nucleic acid (especially RNA) may be determined or calculated based on the LS signal. Optionally, the molecular weight of nucleic acid (especially RNA) determined or calculated based on the LS signal is compared to the theoretical molecular weight of the nucleic acid (especially RNA), wherein the theoretical molecular weight of the nucleic acid (especially RNA) is determined or calculated as described herein or known to the skilled person (e.g., calculated or determined based on the nucleic acid (especially RNA) sequence and on optional additional substances (e.g., one or more dyes, cap structure, etc.) covalently or non-covalently attached to the nucleic acid (especially RNA)).

M. Ratio of the Amount of Nucleic Acid (Such as RNA) Bound to Particles to the Total Amount of Particle Forming Compounds

In some embodiments, the one or more parameters to be determined or analyzed by the methods and/or uses of the present disclosure comprise the ratio of the amount of nucleic acid (such as RNA) bound to particles to the total amount of particle forming compounds (in particular lipids and/or polymers) in the particles, wherein said ratio may be given as a function of the particle size.

The amount of bound nucleic acid (especially RNA) contained in a sample or control composition of the present disclosure comprising nucleic acid (especially RNA) and particles can be determined or calculated as described above, e.g., from the total amount of the nucleic acid (especially RNA) contained in the composition and the amount of free nucleic acid (especially free RNA) contained in the composition, in particular by subtracting the amount of free nucleic acid (especially free RNA) from the total amount of the nucleic acid (especially RNA). Both, the amount of bound and free nucleic acid (especially RNA) contained in the composition can be determined or calculated as specified above, e.g., by using a calibration curve based on at least one signal selected from the group consisting of the UV signal, the fluorescence signal, and the refractory index (RI) signal, or by using the extinction coefficient of nucleic acid (especially RNA) in the UV range (e.g., at 260 nm or 280 nm). The total amount of particle forming compounds (in particular lipids and/or polymers) in the particles can be determined or calculated from the amount of particle forming compounds (in particular lipids and/or polymers) used to make the particles. Alternatively, the amount of particle forming compounds (in particular lipids and/or polymers) in the particles can be determined by methods and/or techniques known to the skilled person, e.g., those based on HPLC (cf., e.g., Roces et al., Pharmaceutics. 8, 29 (2016)). The ratio of the amount of nucleic acid (such as RNA) bound to particles to the total amount of particle forming compounds (in particular lipids and/or polymers) in the particles can be determined or calculated by dividing the determined or calculated amount of nucleic acid (such as RNA) bound to particles by the determined or calculated total amount of particle forming compounds (in particular lipids and/or polymers) in the particles.

In those of the above embodiments where the ratio of the amount of nucleic acid (such as RNA) bound to particles to the total amount of particle forming compounds (in particular lipids and/or polymers) in the particles is given as a function of the particle size, the methods and/or uses of the present disclosure preferably comprise the step of measuring the LS signal of least one of the one or more sample fractions obtained by subjecting the sample or control composition or at least a part thereof to field-flow fractionation. Based on the LS signal the R_{g} values and/or Rₕ values can be obtained (preferably as described above) from which the size of the eluted particles can be determined or calculated (as described above).

N. Ratio of the Amount of Positively Charged Moieties of Particle Forming Compounds (in Particular Lipids and/or Polymers) in the Particles to the Amount of Nucleic Acid (Such as RNA) Bound to Particles

In some embodiments, the one or more parameters to be determined or analyzed by the methods and/or uses of the present disclosure comprise the ratio of the amount of positively charged moieties of particle forming compounds (in particular lipids and/or polymers) in the particles to the amount of nucleic acid (such as RNA) bound to particles, wherein said ratio may be given as a function of the particle size.

The amount of positively charged moieties of particle forming compounds (in particular lipids and/or polymers) in the particles can be determined or calculated from the amount of particle forming compounds (in particular lipids and/or polymers) used to make the particles and from the chemical composition of said particle forming compounds (e.g., from the number of positively charged moieties contained in the particle forming compounds). Alternatively, the amount of particle forming compounds (in particular lipids and/or polymers) in the particles can be determined by methods and/or techniques known to the skilled person, e.g., those based on HPLC (cf., e.g., Roces et al., Pharmaceutics. 8, 29 (2016)). The amount of bound nucleic acid (especially RNA) contained in a sample or control composition of the present disclosure comprising nucleic acid (especially RNA) and particles can be determined or calculated as described above, e.g., from the total amount of the nucleic acid (especially RNA) contained in the composition and the amount of free nucleic acid (especially free RNA) contained in the composition, in particular by subtracting the amount of free nucleic acid (especially free RNA) from the total amount of the nucleic acid (especially RNA). Both, the amount of bound and free nucleic acid (especially RNA) contained in the composition can be determined or calculated as specified above, e.g., by using a calibration curve based on at least one signal selected from the group consisting of the UV signal, the fluorescence signal, and the refractory index (RI) signal, or by using the extinction coefficient of nucleic acid (especially RNA) in the UV range (e.g., at 260 nm or 280 nm). The ratio of the amount of positively charged moieties of particle forming compounds (in particular lipids and/or polymers) in the particles to the amount of nucleic acid (such as RNA) bound to particles can be determined or calculated by dividing the determined or calculated amount of positively charged moieties of particle forming compounds (in particular lipids and/or polymers) in the particles by the determined or calculated amount of nucleic acid (such as RNA) bound to particles.

In those of the above embodiments where the ratio of the amount of positively charged moieties of particle forming compounds (in particular lipids and/or polymers) in the particles to the amount of nucleic acid (such as RNA) bound to particles is given as a function of the particle size, the methods and/or uses of the present disclosure preferably comprise the step of measuring the LS signal of least one of the one or more sample fractions obtained by subjecting the sample or control composition or at least a part thereof to field-flow fractionation. Based on the LS signal the R_{g} values and/or Rₕ values can be obtained (preferably as described above) from which the size of the eluted particles can be determined or calculated (as described above).

O. Charge Ratio of the Amount of Positively Charged Moieties of Particle Forming Compounds (in Particular Lipids and/or Polymers) in the Particles to the Amount of Negatively Charged Moieties of Nucleic Acid (Such as RNA) Bound to Particles

In some embodiments, the one or more parameters to be determined or analyzed by the methods and/or uses of the present disclosure comprise the charge ratio of the amount of positively charged moieties of particle forming compounds (in particular lipids and/or polymers) in the particles to the amount of negatively charged moieties of nucleic acid (such as RNA) bound to particles. Said charge ratio is usually denoted as N/P ratio and may be given as a function of the particle size.

The amount of positively charged moieties of particle forming compounds (in particular lipids and/or polymers) in the particles can be determined or calculated from the amount of particle forming compounds (in particular lipids and/or polymers) used to make the particles and from the chemical composition of said of particle forming compounds (e.g., from the number of positively charged moieties contained in the particle forming compounds). Alternatively, the amount of particle forming compounds (in particular lipids and/or polymers) in the particles can be determined by methods and/or techniques known to the skilled person, e.g., those based on HPLC (cf., e.g., Roces et al., Pharmaceutics. 8, 29 (2016)). The amount of negatively charged moieties of nucleic acid (such as RNA) bound to particles can be determined or calculated from the amount of nucleic acid (such as RNA) bound to particles and from the chemical composition of said nucleic acid (such as RNA), e.g. the number of negatively charged moieties (e.g., phosphate groups) contained in the nucleic acid. The amount of bound nucleic acid (especially RNA) contained in a sample or control composition of the present disclosure comprising nucleic acid (especially RNA) and particles can be determined or calculated as described above, e.g., from the total amount of the nucleic acid (especially RNA) contained in the composition and the amount of free nucleic acid (especially free RNA) contained in the composition, in particular by subtracting the amount of free nucleic acid (especially free RNA) from the total amount of the nucleic acid (especially RNA). Both, the amount of bound and free nucleic acid (especially RNA) contained in the composition can be determined or calculated as specified above, e.g., by using a calibration curve based on at least one signal selected from the group consisting of the UV signal, the fluorescence signal, and the refractory index (RI) signal, or by using the extinction coefficient of nucleic acid (especially RNA) in the UV range (e.g., at 260 nm or 280 nm). The charge ratio of the amount of positively charged moieties of particle forming compounds (in particular lipids and/or polymers) in the particles to the amount of negatively charged moieties of nucleic acid (such as RNA) bound to particles can be determined or calculated by dividing the determined or calculated amount of positively charged moieties of particle forming compounds (in particular lipids and/or polymers) in the particles by the determined or calculated amount of negatively charged moieties of nucleic acid (such as RNA) bound to particles.

In those of the above embodiments where the charge ratio of the amount of positively charged moieties of particle forming compounds (in particular lipids and/or polymers) in the particles to the amount of negatively charged moieties of nucleic acid (such as RNA) bound to particles is given as a function of the particle size, the methods and/or uses of the present disclosure preferably comprise the step of measuring the LS signal of least one of the one or more sample fractions obtained by subjecting the sample or control composition or at least a part thereof to field-flow fractionation. Based on the LS signal the R_{g} values and/or Rₕ values can be obtained (preferably as described above) from which the size of the eluted particles can be determined or calculated (as described above).

Field-Flow Fractionation

The field-flow fractionation a chromatography technique using a very thin flow against which a perpendicular force field is applied and achieving high-resolution separation. Examples of field-flow fractionation include asymmetric flow field-flow fractionation (AF4) and hollow fiber flow field-flow fractionation (HF5), such as the Eclipse™ systems (Dualtec™ or AF4™) marketed by Wyatt and are described, e.g., in WO 2018/165627 the entire disclosure of which is incorporated herein by reference. Thus, in one embodiment, the field-flow fractionation utilized in the methods and/or uses of the present disclosure is flow field-flow fractionation, such as asymmetric flow field-flow fractionation (AF4) or hollow fiber flow field-flow fractionation (HF5).

Typically, the asymmetric flow field-flow fractionation system (like the AF4 system) comprises a channel which is composed of two plates that are separated by a spacer foil (which, typically, has a thickness of 100 to 500 μm) and within which the flow and separation take place. The upper plate is impermeable, whereas the bottom plate is permeable (e.g., made of a porous frit material). Furthermore, the bottom plate is covered with a membrane having a molecular weight (MW) cut-off of suitable to prevent nucleic acid (especially RNA) and larger analytes (such as particles as disclosed herein) from permeating the membrane. In one embodiment, the membrane has a MW cut-off in the range of from 2 kDa to 30 kDa, e.g., a MW cut-off in the range of from 3 kDa to 25 kDa (like from 4 kDa to 20 kDa, from 5 kDa to 15 kDa or from 5 kDa to 12 kDa), such as a MW cut-off of 10 kDa. Any membrane suitable for the above purpose may be utilized. In one embodiment, the membrane is a polyethersulfon (PES) membrane, a regenerated cellulose membrane, or a polyvinylidene fluoride (PVDF) membrane (such any one of the known ultrafiltration membranes having a MW cut-off as specified above).

Typically, the asymmetric flow field-flow fractionation system (like the AF4 system) comprises an inlet port at one end of the channel, an outlet port at the other end of the channel, and an injection port which is positioned between the inlet and outlet ports, preferably closer to the inlet port.

Within the flow channel a parabolic flow profile is created because of the laminar flow of the liquid phase: the liquid phase moves slower closer to the boundary edges than it does at the center of the channel flow. When the perpendicular force field is applied to the laminar flow, the components of the liquid phase (including the analytes to be separated, in particular nucleic acids (especially RNA) and, if present, particles) are driven towards the boundary layer of the channel, preferably on the membrane side. A counteracting motion is created by diffusion associated with Brownian motion. Thus, smaller analytes having higher diffusion rates tend to reach an equilibrium position higher up in the channel, where the longitudinal flow is faster. Therefore, the velocity gradient flow within the channel is capable to separate analytes of different sizes. Since the smaller analytes are transported more rapidly along the channel than the larger particles, the smaller analytes elute before the larger ones which is orthogonal to, e.g., Size Exclusion Chromatography (SEC) where the large analytes elute first.

The principles described above with respect to the asymmetric flow field-flow fractionation system (like the AF4 system) also apply to HF5 system, with the exception that the HF5 system does not contain an upper plate, but rather the lower plate as well as the membrane have been rolled into tubes. This configuration can use very small channel volumes, resulting in high sensitivity and very fast run times.

Since the field-flow fractionation does not rely on the interaction of the analytes to be separated with a stationary phase and does not require a corresponding column filled with said stationary phase, it does not require high pressure for moving the liquid phase through the channel, thereby avoiding, inter alia, high shearing forces. Actually, the field-flow fractionation is gentle, rapid, and non-destructive.

Generally, the field-flow fractionation comprises two steps: injection and elution/fractionation. Optionally, after the injection step and before the elution/fractionation step, the field-flow fractionation may comprise a focusing step. Preferably, in case the field-flow fractionation comprises a focusing step, during the first two steps, the liquid phase is split, enters the channel from both ends (inlet port and outlet port) and is preferably balanced to meet under the injection port (e.g., the flows through the inlet and outlet ports (i.e., are adapted to each other in such a way that analytes injected through the injection port will not wander towards the inlet port or outlet port (preferably will not elute) but will be focused). During these first two steps, the liquid phase will only permeate through the membrane. When a sample or control composition or at least a part thereof is injected (preferably via the injection port), the analytes contained in said sample or control composition or at least a part thereof are optionally focused in a band (preferably as thin as possible) and preferably concentrated towards the membrane. After complete injection of the sample, the injection flow is stopped. Optionally, the focusing is continued for a certain period of time (e.g., for about 0.5 to about 2 min, such as about 1 min). Then, the flow is switched to the elution/fractionation mode, where the liquid phase enters only from the inlet port and exits at the outlet port which is connected to one or more detectors (e.g., UV detector (e.g., a UV detector which is able to monitor UV and CD signals, preferably simultaneously), fluorescence detector, refractive index detector, one or more LS detectors (such as MALS detector and/or DLS detector), and/or viscometer). The analytes elute separated according to size (or hydrodynamic mobility) and are detected and/or monitored by one or more detectors (e.g., an array of different detectors). This detection and/or monitoring is preferably done on-line, i.e., immediately, which avoids the need to store the fractions obtained from the field-flow fractionation. However, in one embodiment, at least one fraction is collected after the on-line detection and/or monitoring has been completed in order to allow for off-line analysis of the at least one fraction. In one embodiment, the calculation or determination of the one or more parameters is performed on-line.

Thus, in some embodiments, the expression “subjecting at least a part of the sample composition to field-flow fractionation” as used herein preferably comprises the steps of injecting at least a part of the sample composition into a field-flow fractionation device; optionally focusing the components (in particular nucleic acids (especially RNA) and, if present, particles) contained in the at least part of the sample composition within the field-flow fractionation device; and fractioning the components (in particular nucleic acids (especially RNA) and, if present, particles) according to their size or hydrodynamic mobility. Similarly, in some embodiments, the expression “subjecting at least a part of the control composition to field-flow fractionation” as used herein preferably comprises the steps of injecting at least a part of the control composition into a field-flow fractionation device; optionally focusing the components (in particular nucleic acids (especially RNA) and, if present, particles) contained in the at least part of the sample composition within the field-flow fractionation device; and fractioning the components (in particular nucleic acids (especially RNA) and, if present, particles) according to their size or hydrodynamic mobility. Irrespective of the type of the composition being subjected to field-flow fractionation (i.e., sample composition, control composition, at least a part of any of the two, etc.), the fractioning step produces at least one fraction, but may also produce at least two (such as at least 3, at least 4, at least 5, at least 6, at least 7, at least 8, at least 9, or at least 10) fractions and/or up to 100 (such as up to 90, up to 80, up to 70, up to 60, up to 50, up to 40, up to 30, or up to 20) fractions. Each of the fractions may represent (1) nucleic acid (especially RNA) of a certain size (such as nucleic acid (especially RNA) having a diameter in the range of about 10 to about 400 nm or 20 to 300 nm) or of a certain type (e.g., free nucleic acid (especially free RNA) or bound nucleic acid (especially bound RNA) or (2) nucleic acid (especially RNA) containing particles of a certain size (such as nucleic acid (especially RNA) containing particles having a diameter in the range of about 200 to 1200 nm) or of a certain type (e.g., nucleic acid (especially RNA) containing lipoplex particles or nucleic acid (especially RNA) containing virus-like particles).

Generally, the cross flow rate used in the field-flow fractionation (such as with an asymmetric flow field-flow fractionation system (like an AF4 system) or a hollow fiber system (like an HF5 system) may be up to about 10 mL/min. In one embodiment, the field-flow fractionation utilized in the methods and/or uses of the present disclosure is performed using a cross flow rate of up to 8 mL/min, preferably up to 4 mL/min, more preferably up to 2 mL/min. In a preferred embodiment, the field-flow fractionation utilized in the methods and/or uses of the present disclosure is performed using a cross flow profile, i.e., the cross flow rate is not constant during all phases (injection, optionally focusing and elution/fractionation) of the field-flow fractionation, but differs from phase to phase. For example, it is preferred that during the injection phase and, if present, the focusing phase, the cross flow is constant and is preferably at a rate at which the nucleic acid (especially RNA) and, if present, particles as disclosed herein are not eluted. Cross flow rates suitable for this purpose may be determined based on the teaching of the present disclosure.

In one embodiment, the cross flow rate profile preferably contains a fractioning phase which allows the components contained in the control or sample composition to fraction/separate by their size so as to produce one or more sample fractions. It is preferred that the cross flow rate changes during this fractioning phase (e.g., starting from one value (such as about 1 to about 4 mL/min) and then decreasing to a lower value (such as about 0 to about 0.1 mL/min) or starting from one value (such as about 0 to about 0.1 mL/min) and then increasing to a higher value (such as about 1 to about 4 mL/min), wherein the change can be by any means, e.g., a continuous (such as linear or exponential) change or a stepwise change. Preferably, the cross flow rate profile contains a fractioning phase, wherein the cross flow rate changes continuously (preferably exponentially) starting from one value (such as about 1 to about 4 mL/min) and then decreasing to a lower value (such as about 0 to about 0.1 mL/min). The fractioning phase may have any length suitable to fraction/separate the components contained in the sample composition by their size, e.g., about 5 min to about 60 min, such as about 10 min to about 50 min, about 15 min to about 45 min, about 20 min to about 40 min, or about 25 min to about 35 min, or about 30 min. The cross flow rate profile may contain additional phases (e.g., 1, 2, 3, or 4 phases) which may be before and/or after the fractioning phase (e.g., one before and 1, 2, or 3 after the fractioning phase) and which may serve to separate non-nucleic acid (especially non RNA) components contained in the sample composition (e.g., proteins, polypeptides, mononucleotides, etc.) from the nucleic acid (especially RNA) contained in the sample composition, to focus the nucleic acid (especially RNA) contained in the sample composition and/or to regenerate the field-flow fractionation device (e.g., to remove all components bound to the membrane of the device). Preferably, the cross flow rate of these additional phases is constant for each additional phase and the length of each of the additional phases is independently for each of the additional phases in the range of about 5 min to about 60 min (such as about 10 min to about 50 min, about 15 min to about 45 min, about 20 min to about 40 min, or about 25 min to about 35 min, or about 30 min). For example, the cross flow rate profile may contain (i) a first additional phase which is before the fractioning phase, wherein the cross flow rate of said first additional phase is constant and is the same cross low rate with which the fractioning phase starts (the length of the first additional phase may be in the range of about 5 min to about 60 min, such as about 10 min to about 50 min, about 15 min to about 45 min, about 20 min to about 40 min, or about 25 min to about 35 min, or about 10 min or about 20 min or about 30 min); (ii) a second additional phase which is after the fractioning phase, wherein the cross flow rate of said second additional phase is constant and is the same cross low rate with which the fractioning phase ends (the length of the second additional phase may be in the range of about 5 min to about 60 min, such as about 10 min to about 50 min, about 15 min to about 45 min, about 20 min to about 40 min, or about 25 min to about 35 min, or about 10 min or about 20 min or about 30 min); and optionally (iii) a third additional phase which is after the second additional phase, wherein the cross flow rate of said third additional phase is constant and different from that of the second additional phase (the length of the third additional phase may be in the range of about 5 min to about 60 min, such as about 10 min to about 50 min, about 15 min to about 45 min, about 20 min to about 40 min, or about 25 min to about 35 min, or about 10 min or about 20 min or about 30 min). In the embodiment, where the cross flow rate profile contains a fractioning phase, wherein the cross flow rate changes continuously (preferably exponentially) starting from one value (such as about 1 to about 4 mL/min) and then decreasing to a lower value (such as about 0 to about 0.1 mL/min), it is preferred that the cross flow rate profile further contains (i) a first additional phase which is before the fractioning phase, wherein the cross flow rate of said first additional phase is constant and is the same cross low rate with which the fractioning phase starts (such as about 1 to about 4 mL/min) (the length of the first additional phase may be in the range of about 5 min to about 30 min, such as about 6 min to about 25 min, about 7 min to about 20 min, or about 8 min to about 15 min, or about 10 min to about 12 min, or about 5 min or about 10 min or about 12 min); (ii) a second additional phase which is after the fractioning phase, wherein the cross flow rate of said second additional phase is constant and is the same cross low rate with which the fractioning phase ends (such as about 0.01 to 0.1 mL/min) (the length of the second additional phase may be in the range of about 5 min to about 60 min, such as about 10 min to about 50 min, about 15 min to about 45 min, about 20 min to about 40 min, or about 25 min to about 35 min, or about 30 min); and optionally (iii) a third additional phase which is after the second additional phase, wherein the cross flow rate of said third additional phase is constant and lower than that of the second additional phase (e.g., the cross flow rate of said third additional phase is 0) (the length of the third additional phase may be in the range of about 5 min to about 30 min, such as about 6 min to about 25 min, about 7 min to about 20 min, or about 8 min to about 15 min, or about 10 min to about 12 min, or about 5 min or about 10 min or about 12 min). A preferred example of such a cross flow rate profile is the following: 1.0 to 2.0 mL/min for 10 min, an exponential gradient from 1.0 to 2.0 mL/min to 0.01 to 0.07 mL/min within 30 min; 0.01 to 0.07 mL/min for 30 min; and 0 mL/min for 10 min.

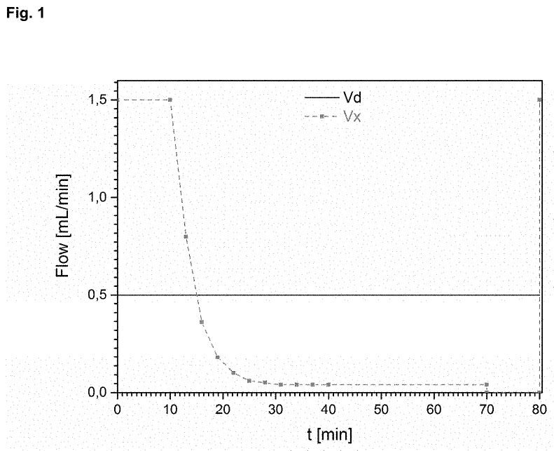

Thus, in one embodiment, the cross flow rates during the injection phase and, if present, the focusing phase are constant and in the range of at least about 1.0 (such as about 1.3 to about 3.0 mL/min, about 1.5 to about 2.5 mL/min, or about 1.8 to about 2.0 mL/min) over a period of time (e.g., 5 to 15 min). Furthermore, in one embodiment, the cross flow during the elution/fractionation phase gradually decreases to a very low rate (e.g., 0.01 to 0.07 mL/min) over a period of time (such as 20 to 40 min). Optionally, after the cross flow reached the very low rate, this rate is maintained over a period of time (such as 20 to 40 min, e.g., the same period of time used to decrease the cross low rate to the very low rate) and/or the cross flow is set to 0 mL/min for a period of time (such as 5 to 20 min). An exemplary cross flow profile for a complete cycle of injection, focusing and elution/fractionation phases is as follows: 1.0 to 2.0 mL/min for 10 min, an exponential gradient from 1.0 to 2.0 mL/min to 0.01 to 0.07 mL/min within 30 min; 0.01 to 0.07 mL/min for 30 min; and 0 mL/min for 10 min. A particular example of a cross flow profile used in the present disclosure is shown in FIG. 1.

In one embodiment, the field-flow fractionation utilized in the methods and/or uses of the present disclosure is performed using an inject flow rate in the range of 0.05 to 0.35 mL/min, preferably in the range of 0.10 to 0.30 mL/min, more preferably in the range of 0.15 to 0.25 mL/min.

In one embodiment, the field-flow fractionation utilized in the methods and/or uses of the present disclosure is performed using a detector flow rate in the range of 0.30 to 0.70 mL/min, preferably in the range of 0.40 to 0.60 mL/min, more preferably in the range of 0.45 to 0.55 mL/min. In one embodiment, detector flow rate is constant during all phases (injection, focusing and elution/fractionation) of the field-flow fractionation.

The liquid phase used in the field-flow fractionation for the inject flow may be any liquid compatible with the field-flow fractionation system and suitable to dissolve nucleic acid (especially RNA). A preferred liquid is an aqueous liquid, e.g., a liquid which is mainly composed of water (i.e., the water content of the liquid is more than 50% (v/v) or (w/w) (such as more than 60%, more than 70%, more than 80%, more than 90%, or more than 95% (v/v) or (w/w)). The liquid phase may contain a buffer, salt, and/or additional excipient(s) (such as a chelating agent).

In one embodiment, the field-flow fractionation utilized in the methods and/or uses of the present disclosure is performed using a UV detector which is able to monitor UV and CD signals, preferably simultaneously.

In case one of the parameters to be analyzed by methods and/or uses of the present disclosure is the total amount of nucleic acid (especially RNA), it is preferred that the liquid phase used in the field-flow fractionation contains a release agent which is capable of releasing the nucleic acid (especially RNA) bound to the particles from the particles (thereby decreasing the amount of bound nucleic acid (especially bound RNA) to zero and increasing the amount of free nucleic acid (especially free RNA) to its maximum. In contrast, in case one of the parameters to be analyzed by methods and/or uses of the present disclosure is the amount of free nucleic acid (especially free RNA), it is preferred that the liquid phase used in the field-flow fractionation does not contain a release agent.

In one embodiment, before subjecting at least a part of the sample or control composition to field-flow fractionation, the at least part of the sample or control composition is diluted, e.g., with the liquid phase or with a solvent or solvent mixture, said solvent or solvent mixture being able to prevent the formation of aggregates of the particles. In one embodiment, the solvent mixture is a mixture of water and an organic solvent, e.g., formamide.

### EXAMPLES

Abbreviations

The following abbreviations are used throughout description:

ivtRNA in vitro transcripted RNA

saRNA self-amplifying RNA

NP nanoparticle (LPX, LNPs, PLX, VLPs)

LNP lipid nanoparticle

LPX lipoplex particle

PLX polyplex particle

VLP virus-like particle

R_{g} radius of gyration

Rₕ hydrodynamic radius

MW molecular weight

Instruments

The field-flow fractionation was done using Eclipse® AF4 (Wyatt) for aqueous solutions together with the corresponding software. The membrane used in the fractionation was a PES membrane (Wyatt Technology Europe, Dernbach Germany) with a cut-off of 10 kDa. An Agilent 1260 Series quaternary pump with an in-line vacuum degasser delivered the carrier flow, and an Agilent 1260 Series Autosampler submitted sample or control compositions (corresponding to 4 μg of injected RNA) to the frit-inlet channel. The analytes (i.e., RNA and particles) were detected by using an Agilent 1260 Multiple Wavelength Detector (260-280 nm MWD; Agilent Technologies, Waldbronn, Germany) and a multi-angle light scattering (MALS) detector (DAWN HELEOS II, Wyatt Technology Corp. Santa Barbara, Calif., USA) with the laser having a wavelength 660 nm and a power of 60%. The MALS detector number 16 is connected to the QELS (DynaPro NanoStar, Wyatt Technology Cor. Santa Barbara, Calif., USA) via glass fiber.

Materials

Methods

AF4 Fractionation Method

The liquid phase for the inject flow, detector flow, and cross flow is 5 mM NaCl, 10 mM HEPES, 0.1 mM EDTA, pH 7.4, in water. The separation is performed by elution inject program with an inject flow rate Vi of 0.2 mL/min, a detector flow rate Vd of 0.5 mL/min and crossflow rate Vx of 1.5 mL/min for 10 min, followed by a Vx gradient exponentially decreasing from 1.5 mL/min to 0.04 mL/min within 30 min using a slope 3.5. Thereafter, Vx is kept constant at 0.04 mL/min over 30 min, followed by a period of 10 min with zero cross flow (cf. FIG. 1).

The eluted analytes were detected at multiple wavelengths (260-280 nm) and by using a multi-angle light scattering (MALS) detector (DAWN HELEOS II, Wyatt Technology Corp. Santa Barbara, Calif., USA) with the laser having a wavelength 660 nm and a laser power of 60%. The MALS detector number 16 is connected to the QELS (DynaPro NanoStar, Wyatt Technology Cor. Santa Barbara, Calif., USA) via glass fiber. For CD experiments, the detector CD-4095 (Jasco) was utilized.

Size distribution is calculated by ASTRA Software Version 7.1.3.25 (Wyatt Technology Europe, Dernbach Germany) using Berry plot by performing the first order fit to the data obtained at scattering detectors. The AF4 MALS size results are given as radius of gyration (R_{g}) values and were determined over the particle peak area. Coupled DLS provided the hydrodynamic radius (Rₕ) simultaneously. The UV signal is used for direct quantitative analysis of unbound (i.e., free) RNA in the sample or control composition, and the total amount of RNA in the sample or control composition is determined after having dissolved the particles using a release agent (detergent). The graph obtained by plotting the UV signal (e.g., at 260 nm or 280 nm) against the R_{g} values obtained from the MALS signal provides information on the size distribution of the particles contained in the sample or control composition, and the corresponding cumulative weight fraction analysis (obtained by transforming the UV signal into a cumulative weight fraction) provides information on the quantitative size distribution of the particles contained in the sample or control composition.

Determination of RNA Integrity

The determination of RNA integrity was performed with a large number of different heat-treated (degraded) RNAs specimens (ranging from 986 nt to 10000 nt). The RNAs (injected amount 4 μg per run) were separated with the AF4 fractionation method (see above) and RNA was detected on-line at 260 nm. A control composition comprising untreated (undegraded) RNA in the identical buffer was separated and analyzed in comparison to the treated RNA sample compositions. RNA sample compositions were diluted with formamide (60% (v/v)) and incubated 5 min at 60° C. immediately before the measurements. RNA with a low tendency to form higher molecular structures can be analyzed without formamide. For the calculation of the RNA integrity the RNA control composition was analyzed firstly. The elution time of the maximum peak height was determined and the peak area from the maximum peak height to the end of the run (baseline) was calculated, thereby obtaining A_{50%}(control) (cf. FIG. 2A). Secondly, the total peak area was calculated, thereby obtaining A_{100%}(control) (cf. FIG. 2B). Thirdly, the ratio (half peak area/total peak area=A_{50%}(control)/A_{100%}(control)) was determined and set to 100% thereby obtaining the integrity of the control RNA (I(control)). Fourthly, one of the treated RNA sample compositions was analyzed by calculating the peak area from the previously determined elution time point (control RNA) to the end of the run, thereby obtaining A_{50%}(sample) (cf. FIG. 2C). Fifthly, the total peak area was calculated, thereby obtaining A_{100%}(sample) (cf. FIG. 2D). Sixthly, the ratio between A_{50%}(sample) and A_{100%}(sample) was calculated, thereby obtaining I(sample), and the percentage integrity of the treated RNA sample was determined by normalizing I(sample) to I(control), thereby obtaining the integrity of the RNA contained in the sample composition

Determination of RNA Amount

For the determination of the RNA amount from AF4 fractograms, a control composition comprising a defined amount (4 μg) of RNA (0.5 mg/mL) was subjected to the AF4 fractionation method (see above) and the UV signal at 260 nm or 280 nm was detected. The UV peak areas were determined and used to calculate the RNA concentration directly from the peak area utilizing Lambert-Beer's law according to the following equation:

$$c = \frac{A \cdot F}{ε \cdot d \cdot V}$$

wherein c is the nucleic acid (especially RNA) concentration (in mg/mL); A is the UV peak area (in AU min); F is the flow rate used in the field-flow fractionation (in mL/min); ε is the specific extinction coefficient of the nucleic acid (e.g., 0.025 (mg/mL)⁻¹ cm⁻¹ for single-stranded RNA); d is the cell length (in cm); and V is the injected volume of the sample or control composition or of a part thereof.

Analyzing the Effect of a Treatment of Salt on RNA

The influence of different sodium chloride concentrations on different RNAs (IVT-RNA and saRNA) was systematically investigated using the AF4 fractionation method (see above) and by determining several characteristics of the RNAs (R_{g}, Rₕ, MW). Different RNAs were preincubated with different sodium chloride concentrations (e.g., 0-50 mM) and subjected to the AF4 fractionation method, wherein the amount of injected RNA per run was 30-100 μg and the AF4 fractionation method used corresponding liquid phases with varying NaCl concentrations (0-50 mM NaCl). The R_{g} values were determined for each RNA treated with different NaCl concentrations on the basis of the MALS signal using Zimm plot and were plotted as a function of the NaCl concentration. R_{g}(D50) and R_{g}(D90) values for each RNA composition treated with different NaCl concentrations were calculated by cumulative weight fraction analysis using the UV signal at 260 nm or 280 nm as described below.

Analyzing RNA Compositions Comprising Different Particles (LPX, LNP, or VLPs)

For the characterization (e.g. determination of the size distribution) of a broad set of diverse NPs (LPX, LNP, VLPs) the AF4 fractionation method (see above) was applied. The injection amounts for each NP were adjusted to total RNA quantity (LPX and LNP 4 μg; VLPs: 20 μg). The on-line detection of the particles was achieved by (i) coupling the AF4 system directly to an UV-detector (MWD Agilent) and an MALS detector (HELEOS II, Wyatt Technology; for the determination of R_{g} values), and (ii) externally connecting DLS to one angle at the MALS detector (number 16) via glass fiber for the simultaneous determination of Rₕ values. For some samples also an RI detector (Optilab T-rEX, Wyatt) was used to simultaneously detect the RI signal.

Analyzing RNA Compositions Comprising Two Different Particles (VLPs and LPX)

Lipoplex particles comprising short RNA (40 bp; used as adjuvants to enhance the immune response of protein based vaccine) and F12 liposomes (DOTMA/DOPE 2/1) with an access of RNA with a lipid/RNA ratio of 1.3/2 were prepared. The resulting short RNA lipoplex particles were mixed in a second step with a VLP sample composition in a LPX/VLP ratio of 1/1, and 4 μg of total RNA were subjected to the AF4 fractionation method (see above) to determine the size distribution of the particles contained in said short RNA-LPX VLP sample composition.

Quantitative Size Distribution (e.g. D90) of Diverse RNA-NPs

For analyzing RNA-lipid based particles (LPX or LNP) 4 μg of total RNA were subjected to the AF4 fractionation method (see above), whereas for analyzing RNA-polymer based nanoparticles 10 μg of total RNA were subjected to the AF4 fractionation method. The on-line detection of the particles was achieved by directly coupling the AF4 system to an UV-detector (MWD Agilent) and a MALS detector (HELEOS II, Wyatt Technology; for the determination of R_{g} values). For the simultaneous determination of Rₕ values DLS was connected externally to MALS via glass fiber. To provide additional information on the RNA (free and bound) on-line UV detection at 260 nm or 280 nm was applied to AF4-MALS-DLS as well. For the quantitative size distribution the experimentally obtained R_{g} values were directly plotted against the UV signal of the particle peak fraction. R_{g} values for, e.g., larger particles can be plotted as a function of the retention time, the data points can be fitted to a polynomial equation (e.g., f(t)=a+b₁x+b₂x²+b₃x³+b₄x⁴) or linear equation (e.g., f(t)=a+a₁x), and the R_{g} values can be recalculated based on the polynomial or linear fit. In the next step the UV signal of the particle fraction is plotted as a function of recalculated R_{g} values. The UV signal is directly proportional to the RNA quantity bound to the corresponding particle fraction and equivalent to the weight fraction. In the final step the recorded UV signals as well as the values of corresponding cumulative weight fraction analysis including (D10, D50, and D90 values) were plotted as a function of the R_{g} values. The plot of UV signal traces to particle sizes (R_{g} values) directly provides the quantitative information on particle amount.

Determination of the Amount of Unbound RNA (Free RNA)

For the determination of unbound RNA (free RNA) in RNA-LPX, 4 μg of total RNA in LPX particles was subjected to the AF4 fractionation method as described above (cf., e.g., FIG. 1). The amount of the unbound/free RNA preferably requires baseline separation of the unbound/free RNA from particles (e.g., LPX) using UV-absorption at 260 nm or 280 nm. For the determination of the unbound/free RNA two approaches can be applied:

1) Approach using a calibration curve: The relative amount (%) of the unbound/free RNA in the RNA-LPX particles is determined by correlating the UV peak area of unbound/free RNA to the UV peak area of a control RNA (calibration curve).

2) Direct approach: The UV absorption can directly be translated in concentration using Lambert-Beer's law and the RNA extinction coefficient as described above).

The quantification of unbound/free RNA at different ratios of lipid to RNA (“NP ratio”) can also be determined or calculated using the AF4 fractionation method. Sample compositions were prepared by mixing a mixture of lipids (DOTMA/DOPE 2/1) with RNA at different charge ratios (0.1-0.9) without or with NaCl (100 mM), wherein the RNA concentration was kept constant and the amount of lipids varied. For the determination of unbound/free RNA in these sample compositions 40 μL of the formed nanoparticles (4 μg total RNA) were subjected to the AF4 fractionation method. The analysis was performed according to the approaches described above.

Determination of Total Amount of RNA Content in RNA-LPX Sample Compositions

Prior to the quantitative determination of the total amount of RNA using the AF4 fractionation method, the nanoparticles have to be disrupted by the addition of a release agent (e.g. 0.5% SDS or 0.1% Zwittergent (ZW)) to release the RNA from the particles. 40 μL of sample composition (4 μg total RNA) were subjected to the AF4 fractionation method as described above with the variation that the liquid phase contained the release agent (e.g., 0.05% (w/v) SDS) to prevent the re-formation of nanoparticles during the separation. The measured UV-peak area under the curve can directly be translated into the RNA concentration (and therefrom into the total amount of RNA contained the sample composition) using Lambert-Beer's law and the RNA extinction coefficient. In addition, the completeness of the NP disruption can be monitored by the MALS signal.

### Example 1—Determination of the RNA Using the AF4 Fractionation Method

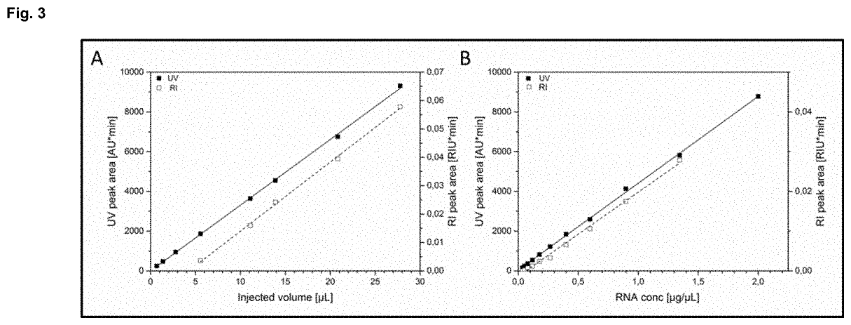

Different injection volumes of a RNA stock solution were analyzed by the AF4 fractionation method using a UV detector and an RI detector (AF4-UV-RI). The peak areas under the curve (UV full line; RI dashed line) were plotted against the injected volumes and a linear regression was fitted (cf. FIG. 3A). Serial dilutions of a RNA were measured with the identical injection volumes by AF4-UV-RI and analyzed as before (cf. FIG. 3B).

The data shown in FIGS. 3A and B demonstrate a direct linear correlation between the signals (RI and UV) and RNA amount. Thus, these data prove that a direct determination of RNA (i.e., without using a calibration curve) is feasible. Furthermore, no sample dilution is necessary (compared to the determination of the RNA amount by measuring the UV signal of an RNA solution in a cuvette). Thus, a wide concentration range of sample RNA compositions can be used (injection volume can be adapted). Further advantages of the AF4 fractionation method are the following:
low standard deviation (<2%);
low salt effects (because the sample is “washed” during the AF4 fractionation procedure);
changes in the extinction coefficient of RNAs can be analyzed and determined.

### Example 2—Determination of RNA Integrity

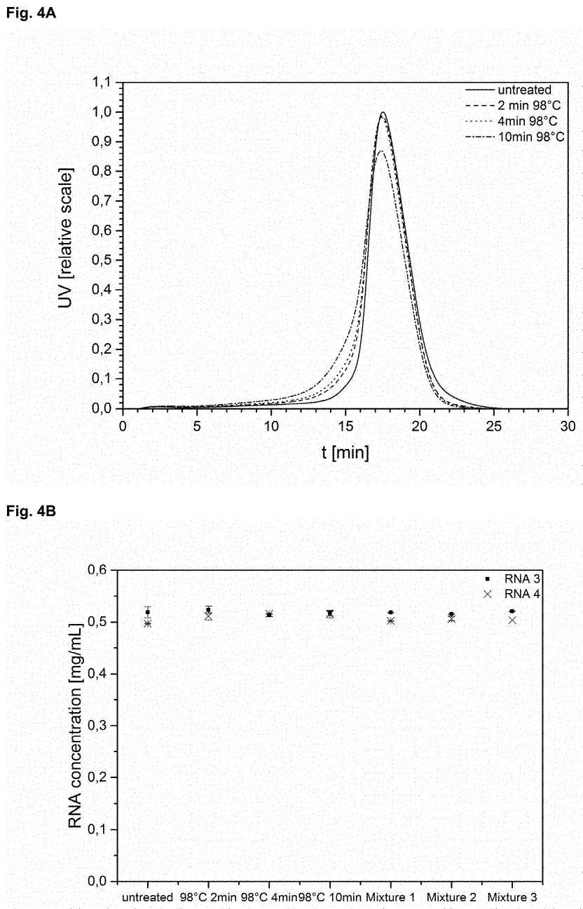

RNAs were heat-treated (98° C. for 2 min, 4 min, or 10 min) to degrade the RNAs in varying degree. Sample compositions comprising either untreated RNA, treated RNA (2 min, 4 min, or 10 min at 98° C.) or a defined mixture of heat-degraded and untreated RNAs were analyzed by the AF4 fractionation method (AF4-UV-RI) without using a standard. Representative AF4 fractograms of the different sample compositions (n=3) are depicted in FIG. 4A. From these fractograms the mean area under the curve was directly transformed to RNA concentration applying Lambert-Beer's law and the resulting concentration was plotted as a function of degradation time of RNA (cf. FIG. 4B).

As can be seen from FIG. 4B, different degrees of RNA degradation (in the range of 0-50% degradation) have a minor impact (<2%) on the quantification of the RNA using the AF4 fractionation method. In contrast, other quantification methods (agarose gel, fragment analyzer) show a strong dependency of signal intensity vs. degradation.

### Example 3—Separation of Complex Mixtures

Sample particle compositions (containing lipid and RNA in a molar ratio of 1.3/2) were prepared and subjected to the AF4 method disclosed herein, wherein the UV and light scattering (LS) signal were detected. A representative fractogram obtained from the AF4 method is shown in FIG. 5, wherein the solid line represents the LS signal at an angle of 90° and indicates the particle peak (t=˜35 min), whereas the dashed line represents the UV signal (recorded at 260 nm) and reflects bound (t=˜38 min) and unbound RNA (t=˜20 min).

FIG. 5 demonstrates that the AF4 method is capable of separating a complex mixture of components (free RNA and LPX particles), whereby the components eluted as a function of their hydrodynamic radius (Rₕ). The UV trace (dashed line) shows two distinct peaks, at retention time of 18 to 25 min and between 25 to 60 min. The first peak (light grey box) represents free, unbound RNA in the solution due to the molar access of RNA in the formulation, and the second peak represents the LPX particles (dark grey box).

Thus, according to the data presented in FIG. 5, the AF4 method is applicable to sample compositions over a wide size range (from nm to μm) and separates efficiently different components (RNA and NP) of a complex mixture of RNA and nanoparticles. In addition, the method is able to separate the polydisperse nanoparticles fraction (LNPs, LPX, VLPs, RNA) in lager size ranges, which cannot be accomplished by common techniques like SEC. Thus, the AF4 method fulfills the requirement for size separation of compositions comprising complex mixtures of particles.

### Example 4—Determination of RNA Integrity

Sample compositions comprising different heat-degraded RNAs differing in their lengths (RNA #1-4; size: 986 to 1688 nt) and a control composition comprising untreated RNA were prepared and subjected to the AF4 fractionation method (cf. FIG. 6A). Similarly, sample compositions comprising RNA #2 using different ratios (untreated (control), completely heat-degraded and a 50:50 mixture of untreated with completely heat-degraded) were prepared and subjected to the AF4 fractionation method (cf. FIG. 6C). The RNA integrity for each sample composition was determined on the basis of the UV signal as specified above (using the ratio of half peak area/total peak area for both sample and control compositions; measured at least in triplicates) and compared to the theoretical calculated values. The RNA integrity percentages of the sample compositions (dark, middle and light gray bars) and of the theoretical calculated values (black bars) are depicted in FIGS. 6B and 6D.

As can be seen from FIGS. 6A and C, the different heat-degraded RNAs can be separated and detected with the AF4 method. The calculated RNA integrities showed a heat-time dependent degradation-kinetic (FIG. 6B) with integrity of ˜95% for 2 min, ˜90% for 4 min and ˜70% for 10 min heat-treatment. To verify the approach, defined mixture of degraded and non-degraded RNAs were combined in a controlled manner and analyzed (FIG. 6D). The measured RNA integrity values are in excellent accordance with the theoretical calculated values (FIG. 6D).

One major important quality parameter for RNA is the integrity. The AF4 method described herein is suitable for the determination of the RNA integrity from different, non-formulated RNA specimens, ranging from small 40 nt to very large 10000 nt RNAs. The method is capable to detect very small variation in the RNA integrity and is independent of quantification problems with intercalating dyes.

### Example 5—Comparison of RNA Quantification Using the AF4 Method and a Method Based on Fluorescence

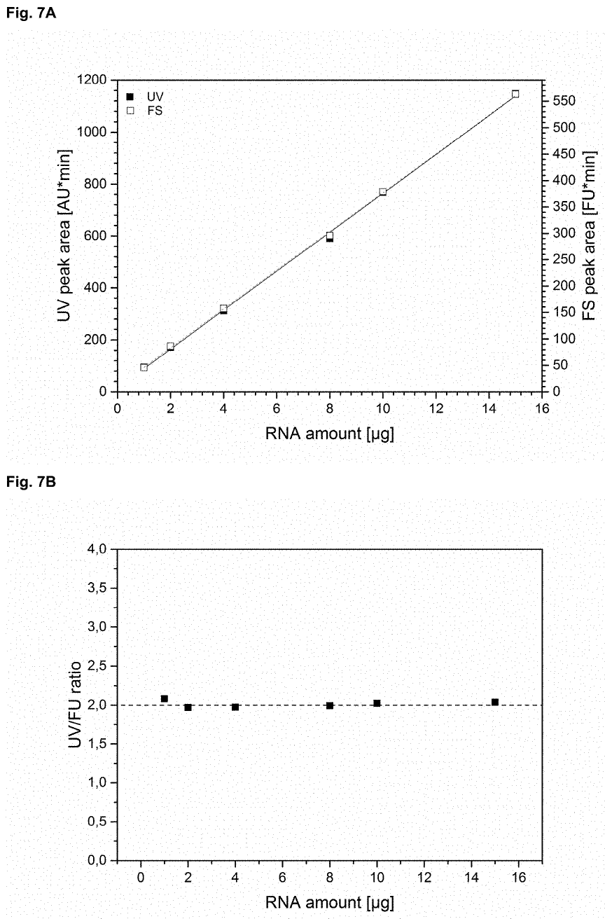

Sample compositions comprising RNA and fluorescently labeled particles were prepared and subjected to the AF4 method described herein, wherein increased volumes were injected and the UV signal and the fluorescence (FS) signal were detected. The UV and FS particle peak area for each of the sample compositions were determined and plotted against the RNA amount injected (cf. FIG. 7A). Furthermore, the ratio of UV to FS particle peak area of the sample compositions were calculated and plotted against the RNA amount injected (cf. FIG. 7B).

FIG. 7 demonstrates AUCs of both detection systems increased linearly with increasing concentrations of injected RNA and the resulting plots provided comparable results over the broad concentration range. The linear behavior of both signals indicates that the UV signal is not affected by scattering due to the predominant UV absorption of high RNA concentration bound to liposomes, i.e., there is no significant scatter impact. Thus, FIG. 7 demonstrates the suitability of the UV signal for quantifying RNA bound to particles.

### Example 6—Determination of the Ratio of the UV Signals of Free RNA and RNA Bound to Particles

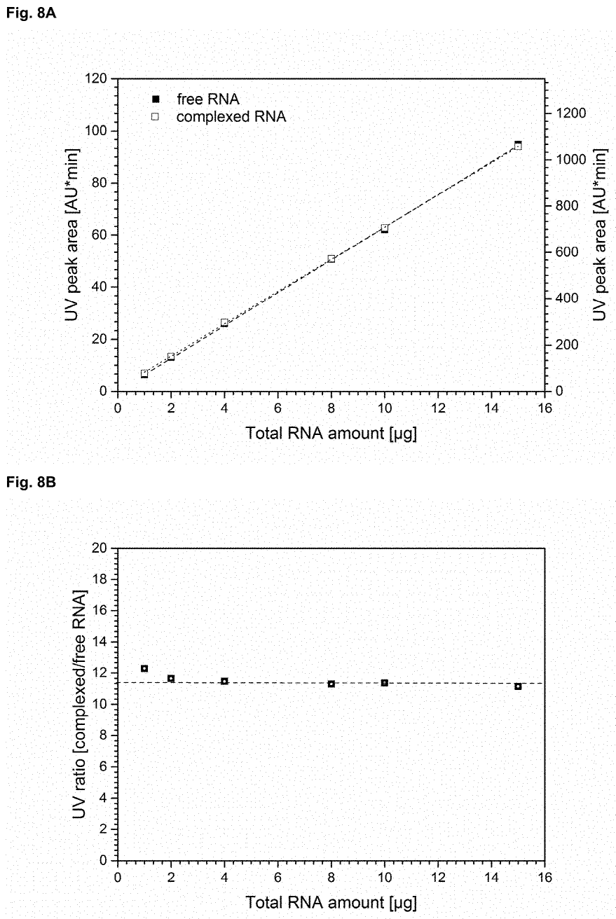

Sample compositions comprising RNA in varying amounts and lipoplex particles were prepared and subjected to the AF4 method described herein, wherein the UV signal was detected. From the UV signal, the peak area for both the free RNA and RNA bound to the particles were determined and plotted against the total amount of RNA in the respective sample composition; cf., FIG. 8A. Furthermore, the ratio of the peak area for RNA bound to the particles to the peak area for free RNA was determined for each sample composition and plotted against the total amount of RNA in the respective sample composition; cf., FIG. 8B.

As can be seen from FIG. 8A, there is a linear relationship between the peak for free RNA and the LPX peak over a broad total amount of RNA. Furthermore, the determined ratios of the peak area for RNA bound to the particles to the peak area for free RNA as well as the extinction coefficient were found to be constant over a broad LPX concentration range (cf. FIG. 8B). Such ratio may be an additional quality parameter for particle formulations.

### Example 7—Determination of the Size Distribution of Particles—Comparison of Results Obtained by UV or Fluorescence Signal

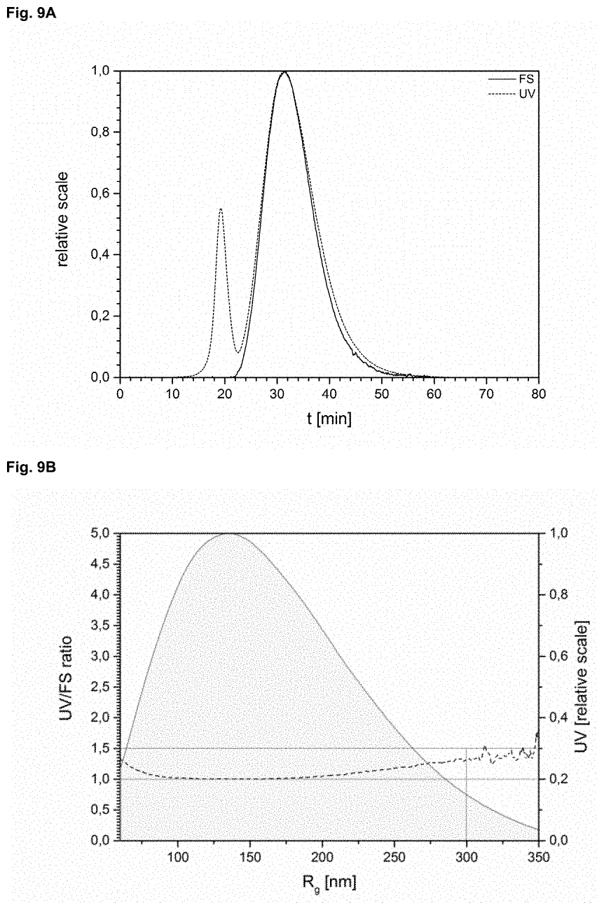

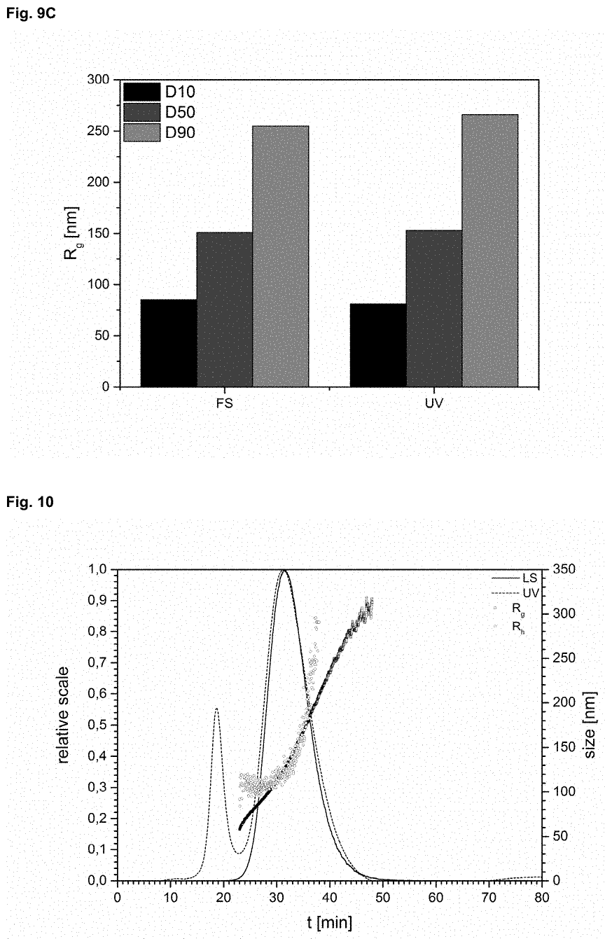

Sample compositions comprising RNA and Atto594-labeled particles were prepared and subjected to the AF4 method described herein, wherein the UV signal (at 260 nm), the MALS signal, and the fluorescence signal (FS) (emission at 624 nm) were detected. A representative fractogram is shown in FIG. 9A. The UV/FS ratio was calculated and the UV signal from the particle peak fraction (elution time: 22-60 min) as well as the UV/FS ratio were plotted against the R_{g} values (determined on the basis of MALS signal); cf. FIG. 9B. The R_{g} area which has a variation below 50% of the UV/FS ratio is highlighted in FIG. 9B (boxes). In the R_{g} range between 50 and 300 nm the variation of the UV/FS ratio is small and gives reliable size values. Smaller R_{g} values are affected by the RNA signal. Lager R_{g} values are affected by scattering. In total these affected R_{g} values are below 10% of the total signal quantities. D10, D50, and D90 values were calculated based on a cumulative weight fraction analysis using fluorescence emission at 624 nm (black bars) and UV signal at 260 nm (grey bars); cf. FIG. 9C.

The fractogram obtained with the fluorescence detector (cf. FIG. 9A) showed only one peak, which is attributed to lipoplex particles (LPX) due to the use of fluorescently labeled helper lipid, which allows detection of nanoparticles only. The traces of UV and FS were quite similar at the whole elution range with a minor deviation at higher retention times, indicating a minor impact of scattering with increasing size. To further prove the feasibility of using UV to obtain the quantitative information on particle size distribution, the ratio of the overall UV absorption values of LPX (fractionated by the AF4 method described herein) to the FS signal (recorded simultaneously at 620 nm) was calculated and plotted against the corresponding R_{g} values (cf. FIG. 9B). The resulting UV/FU-ratio was found to be constant over a wide size range with increasing deviation at larger sizes. The cumulative weight fractions were analyzed using both signals providing quantitative D10, D50, and D90 values; cf. FIG. 9C. When comparing these D10, D50, and D90 values determined on the basis of the UV signal with those determined on the basis of the FS signal, no significant differences for the particle sizes D10 and D50 were observed and only a minor difference is detected at larger sizes (D90). Thus, these data indicate that nanoparticles only contribute a negligible amount of light extinction and that the UV signal is not strongly affected by scattering.

Therefore, these results provide the proof for the feasibility of using on-line UV detection for quantitative size measuring without the need of a correcting factor for scattering. The AF4 method described herein provides the opportunity to separate the particles as a function of their diffusion coefficient (e.g., unbound/free RNA from RNA containing LPX) and to determine quantitatively the amount of free RNA as well as the size distribution of RNA containing LPX in one run, which is not possible by conventional methods like DLS. Other methods like NTA (nanoparticles tracking analysis) may also provide information on particle size distribution, but have other drawbacks (cf., e.g., the section “Background”, above). For example, for NTA the samples have to be diluted by a factor of 10-1000-fold which can cause problems, especially with concentration depending aggregation or disassembly of particles, which may result in incorrect information on particle size distribution.

### Example 8—Determination of Several Parameters of Particles

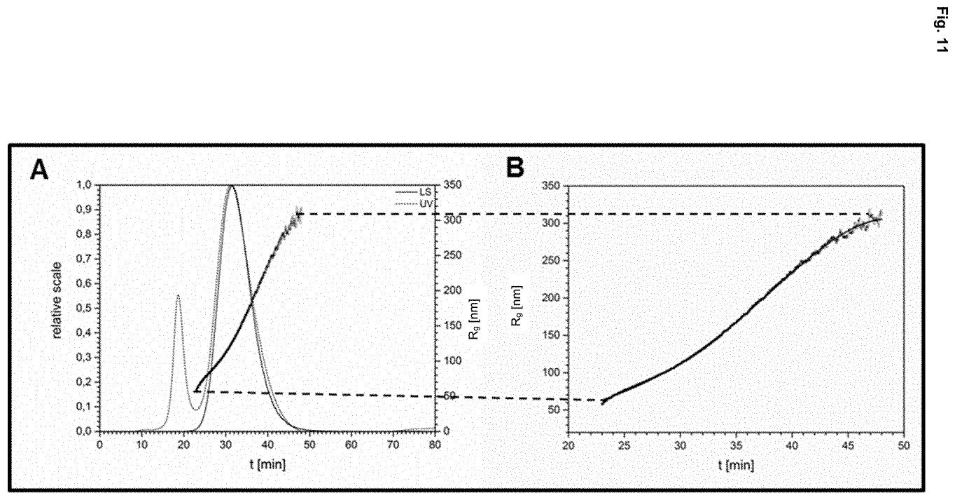

Sample compositions comprising RNA and particles were prepared and subjected to the AF4 method described herein, wherein the UV signal (at 260 nm), the MALS signal (at 90°), and the DLS signal were detected. A representative fractogram is shown in FIG. 10 (the DLS signal is not shown in FIG. 10).

The separation profiles shown in FIG. 10 include the UV signal (dashed line) as well as the MALS signal at 90° (solid line). The R_{g} values (gray squares) were determined on the basis of the MALS signal for the LPX peak (25 to 60 min retention time) using Berry plot, and were in the range of from 80 nm to 400 nm. The hydrodynamic radius (Rₕ) values (gray circles) were determined on the basis of the DLS signal and were in the range of from 130 nm and 300 nm.

The size and size distribution are two of the key parameters of drug delivery vehicles (e.g. FDA's “Liposome Drug Products Guidance” 2018). As demonstrated by this Example, the AF4 method is not only capable of efficiently separating the components of complex nanoparticles (RNA from nanoparticle) but also allows the on-line determination of size and size distribution of nanoparticles over a wide size range (nm-μm).

### Example 9—Determination of the Quantitative Size Distribution of Particles

The experimental data obtained with the sample compositions prepared and analyzed in Example 8 were further analyzed in order to determine the quantitative size distribution of the particles. The fractogram shown in FIG. 10 is again shown in FIG. 11A. In a first step for the determination of the quantitative size distribution, the experimentally determined R_{g} values of the particle peak (elution time: 26-55 min) contained in the fractogram shown in FIG. 11A were extracted and fitted to a polynomial equation (light gray line); cf. FIG. 11B. Then, the R_{g} values were recalculated based on the polynomial fit. In the next step the UV signal of the particle fraction was plotted as a function of recalculated R_{g} values (cf. FIG. 11C, solid line). The UV signal is directly proportional to the particle quantity and equivalent to the weight fraction. In the final step, the recorded UV signals were transformed into the corresponding cumulative weight fraction values (including D10, D50, and D90 values) were plotted as a function of the recalculated R_{g} values(cf. FIG. 11C, dashed line). The plot of the UV signal to particle sizes (R_{g} values) directly provides the quantitative information on particle amount.

As demonstrated in this example and other examples (cf., e.g., Examples 5 and 7), the UV signal and the corresponding cumulative weight fraction distribution allow the determination and analysis of quantitative particle size distribution profiles. The AF4 method described herein was robust, reproducible and provides in-depth characterization of separated samples and thus allows the detection of changes within sample compositions. The results illustrate that the AF4 method provides simultaneous information on qualitative and quantitative information on size and size distributions, i.e., for the characterization of particles such as NPs.

### Example 10—Analyzing the Effect of Different Lipid/RNA Ratios on Parameters of Particles

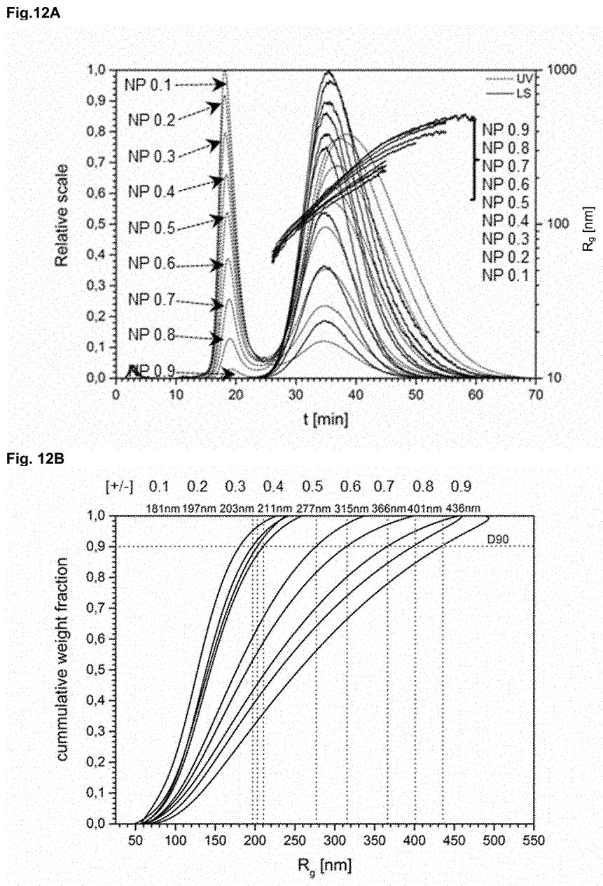

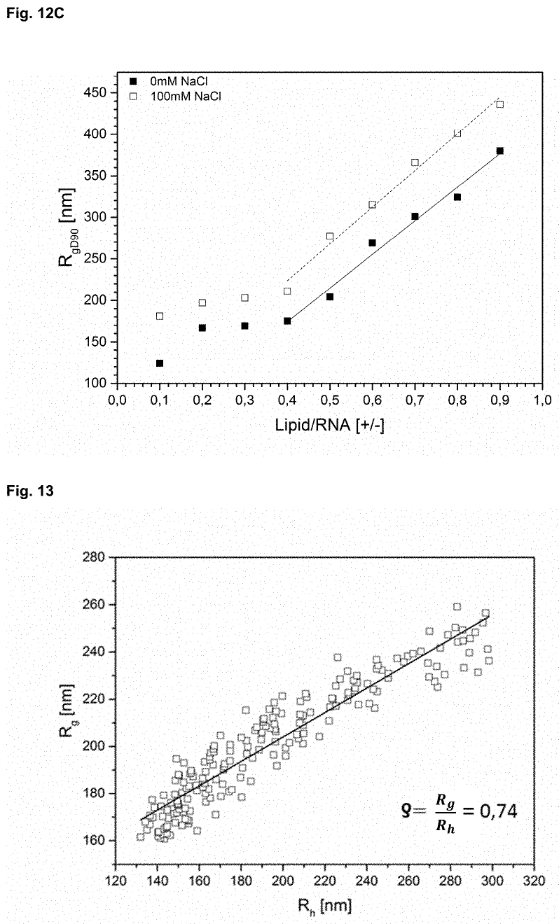

Different sample compositions were prepared by mixing lipid and RNA at different lipid/RNA ratios (0.1-0.9) with or without 100 mM NaCl and subjected to the AF4 method described herein. For each of the different sample compositions, the UV signal (at 260 nm), the light scattering signal (at 90°), and the corresponding R_{g} values (calculated using Berry plot) were determined. FIG. 12A shows an overlay of the fractograms for the together with the corresponding R_{g} data points. The cumulative weight fraction values were determined, the R_{g} values were plotted against the cumulative weight fraction values, and the D90 value for each of the nine sample compositions were determined (cf. FIG. 12B). These R_{g}(D90) values were plotted as a function of lipid/RNA ratio with 100 mM NaCl (black dots) or without NaCl (open dots))

FIG. 12A shows that by using the AF4 method free RNA can be can efficiently separated from physicochemical heterogeneous nanoparticles (LPX) and quantified. In addition, FIG. 12A illustrates the effect of different lipid/RNA ratios during synthesis of sample compositions on the physicochemical properties/parameters (e.g., R_{g}) of the components of the sample composition (i.e., free RNA and particles). According to FIGS. 12B and 12C, the size of particles did not significantly change at with particles (lipid/RNA ratio of between 0.1 and 0.4). The bigger particles were formed at higher ratios (>0.4). The size increases linearly with an increasing amount of liposome for LPX samples, which does not appear to be affected by ionic strength. The data indicates that the increased access of liposomes results in increased sizes of the resulting particles. The absence of salt led to a decrease in size at the indicated charge ratios.

This Example shows that the AF4 method allows the separation and quantification of free RNA and particles as well as the determination of the quantitative size distribution and characterization of particles at various charge ratios. Thus, it has been demonstrated that the method is a useful analytical tool for analyzing RNA-LPX interaction and can give, in a single run, quantitative and qualitative information on different nanoparticles.

### Example 11—Estimation of the Form of Particles

Further information on particle shape can be received by plotting the calculated R_{g} values (e.g., from Example 8) versus the Rₕ values (determined on the basis of the DLS signal) and fitting the data to a linear equation. The slope of the linear regression provides information on the particle shape. For example, a slope of 0.74 indicates a sphere-like shape for the analyzed nanoparticles. The ratio of R_{g} to Rₕ values is also called shape factor.

### Example 12—Separation and Characterization of Different Types of Particles

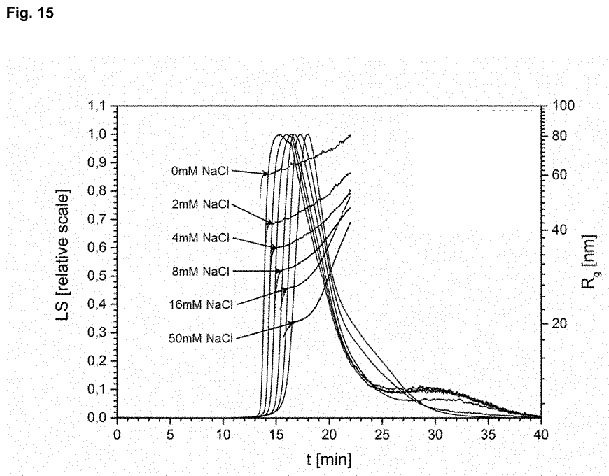

Sample compositions comprising different types of particles LPX, LNP, PLX, liposomes, VLPs+LPX) were prepared and analyzed using the AF4 method described herein. FIG. 14 shows the AF4-UV-MALS-DLS separation/detection. LS at 90° angle is depicted as solid lines and indicates the particle peaks. Dashed lines represent the UV signal (for the RNA detection) recorded at 260 nm. Radius of gyration (R_{g}) values (dark dots) are derived from multi angle light scattering (MALS) signals using Zimm plot (RNA and VLPs) and Berry plot (LNPs). Dynamic light scattering (DLS; gray dots) provides hydrodynamic radius (Rₕ). The individual particle peak fractions are highlighted by gray bars. FIG. 14A shows a representative fractogram of an LPX sample containing lipid and RNA in a molar ratio of 1.3/2 after AF4-UV-MALS-DLS separation/detection. FIG. 14B depicts a representative fractogram of a composition comprising two types of particles (short RNA-LPX:VLP, 1:1 mixture). FIG. 14C shows a representative fractogram of a liposome sample (positively charged liposomes, composed of DOTMA and DOPE in a molar ratio of 2/1). FIG. 14D depicts a representative fractogram of a LPX sample (positively charged LPX, containing DOTMA and cholesterol, and RNA in a molar ratio of 4/1). FIG. 14E shows a representative fractogram of lipid nanoparticle (LNPs) samples, containing DODMA, cholesterol, DOPE, PEG (in a molar ratio of 1.2/1.44/0.3/0.06) and RNA in a molar ratio of 3/1. FIG. 14F depicts a representative fractogram of particles, containing JetPEI polymer and IVT-RNA or saRNA in a particle to RNA ratio of 12/1.

FIG. 14 demonstrates that the AF4 method can be applied to broad specimens of particles. The elution profile allows, e.g., the determination of the size distribution of particles. Furthermore, aggregates in the samples can be detected (e.g. FIG. 14B) and the different types of particles can be efficiently separated from unbound, free RNA (unmarked UV peaks in FIG. 14A/B/F).

### Example 13—Characterization of Unformulated RNA after Treatment with Salt

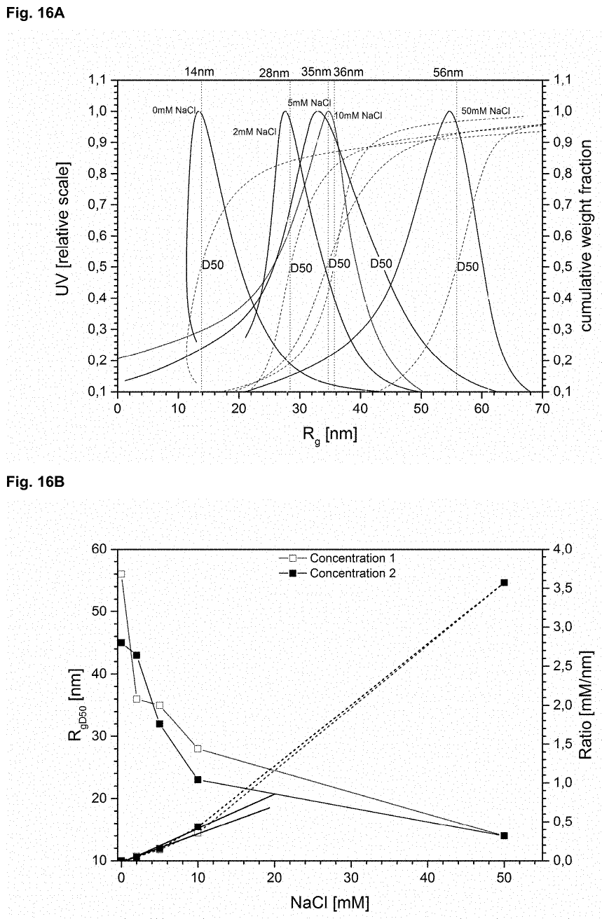

The AF4 method was used to analyze the RNA behavior in the presence of ions (sodium chloride). Sample compositions were prepared by pre-incubating various RNAs (IVT-RNA) with different sodium chloride concentrations (0-50 mM). Exemplary AF4 fractograms (light scattering signals at 90° are shown) from non-formulated RNA in different sodium chloride concentrations (0-50 mM) are depicted in FIG. 15. R_{g} values were derived from the MALS signal using Zimm plot.

As can be seen in FIG. 15, the differently treated RNAs can be separated and detected with the AF4 method. Only very minor amounts of higher molecular weight order aggregates could be detected. Interestingly, the RNA R_{g} value is decreasing as a function of increasing sodium chloride concentrations and, thus, is inversely correlated with the ion concentration (from ˜80 nm without NaCl to 20 nm with 50 mM NaCl). Furthermore, the retention time shifted to longer time points with increasing salt concentration (from ˜15 min without NaCl to 18 min with 50 mM NaCl). This shift is indicative for a change in the Rₕ of the RNA (from smaller to bigger Rₕ values). A form factor (Rₕ/R_{g}) can be calculated and indicate a compaction of the RNA in the present of salt.

The above data were subjected to cumulative weight fraction analysis in order to determine the qualitative size distribution as well as the R_{g}(D50) values for each of the sample compositions treated with different sodium chloride concentrations (0-50 mM); cf. FIG. 16A. The RNA R_{g}(D50) values (from FIG. 16A) were plotted against the sodium chloride concentration and the ratios (mM sodium chloride vs. nm R_{g}) were calculated. Linear fitting of the ratio from 0 to 10 mM NaCl values are represented by bold lines, whereas dotted lines represent the fitting from 10 to 50 mM NaCl. Gray and black lines represent examples of measurements with two different RNA concentrations.

As can be seen from FIG. 16, there is a strong reduction of the R_{g} values (˜30%) if salt is present at a low concentration (0-5 mM NaCl). At higher salt concentrations (10 mM NaCl) the progression on the R_{g} reduction decreases. According to FIG. 16B, there is a linear correlation at lower NaCl concentrations (0-10 mM), whereas at high NaCl concentration (50 mM) a non-linear correlation is visible. This can be explained by a strong compaction of the RNA in the presence of ions at low concentration (30% R_{g} reduction with 5 mM NaCl), whereas a further compaction (˜30%) of the RNA can still occur to a certain extent, which, however, requires a much higher ion concentration (50 mM NaCl).

Ions are one key factor which drives the RNA folding/compaction, which has an impact on the RNA loading capability of nanoparticles. The AF4 protocol described herein is suitable for the analysis of changes in the R_{g} values of sodium chloride treated RNAs (such as IVT-RNA and saRNA).

### Example 14—Separation and Quantification of Free RNA in Complex Sample Compositions

This Example illustrates the quantification of the free/unbound RNA in complex sample compositions. To show the suitability of the AF4 method for the determination of free RNA in sample compositions comprising RNA and particles a calibration curve of naked RNA was performed using UV detection at 260 nm.

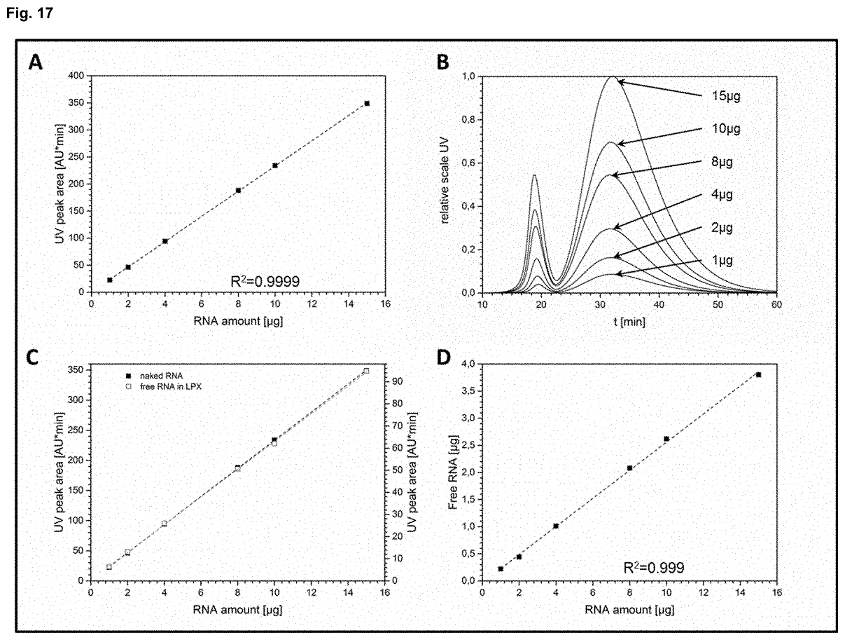

Using the AF4 method disclosed herein different amounts of free RNA (1-15 μg) were detected by the UV absorption at 260 nm in composition without particles. The RNA amounts were plotted versus the respective UV peak area under the curve (AUC*min) to generate a linear calibration curve (cf. FIG. 17A). Varying amounts of sample compositions (containing 1-15 μs total RNA) were analyzed by the AF4 method. Overlaid AF4 fractograms show UV signals at 260 nm (cf. FIG. 17B). The first peak (elution time: ˜20 min) corresponds to the free RNA, whereas the second peak (elution time: ˜38 min) corresponds to the particles (bound RNA). The amount of free, unbound RNA in particle compositions can be calculated in the relation to the reference RNA (=100%) (see FIG. 17A). To show linearity of the method, the UV peak integrals of the free RNA (see FIG. 17B) as well as the reference, naked RNA (see FIG. 17A) were plotted as a function of different RNA amounts (1-15 μs) (cf. FIG. 17C). As a second, preferred procedure (direct method) for the quantification of the free RNA, the unbound RNA peak is defined and the RNA amount can be directly calculated using the specific extinction coefficient of RNA (Lambert-Beer' law) (cf. FIG. 17D).

As can be seen from FIG. 17, the UV signal areas were found to be proportional to the sample concentration at the indicated range in a reproducible manner FIG. 17A shows the AUCs of UV signal as a function of different amount of RNA indicating a linear behavior for quantifying RNA using UV signals. Furthermore, according to FIG. 17B, no change in the elution behavior of unbound RNA was observed. In FIG. 17C UV signal integrals of naked RNA as well as of the free RNA of the nanoparticles are shown as a function of different amounts of RNA. Both plots were linear fitted and show a direct correlation. This indicates the feasibility that the UV signal (AUC*min) can be directly utilized to quantify the free RNA in NP samples without performing a calibration curve with naked RNA. Thus, the free RNA can directly be quantified with respect to the same amount of appropriate naked RNA at the indicated linear range. The results give the percentage (%) of free RNA in colloidal formulations.

Thus, this Example shows that the AF4 method can be used as a standard-less method for the direct quantification of free RNA in samples compositions comprising particles, without the need of a reference sample or normalization. Furthermore, the ratio of free RNA to NP can be determined as an additional quality indicator of sample compositions comprising particles.

### Example 15—Separation and Quantification of Free RNA in Different Sample Compositions

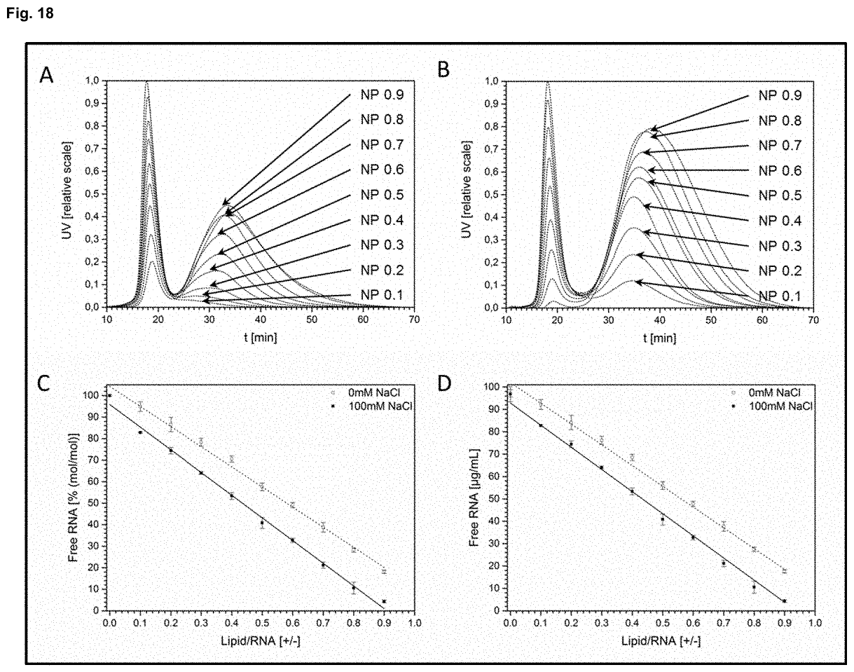

This Example shows the analysis of the free RNA amount in sample compositions with different physicochemical behavior. Sample particle compositions ((DOTMA/DOPE 2/1)/RNA complexes mixed at variable charge ratios (0.1-0.9)) were prepared without NaCl (cf. FIG. 18A) or with 100 mM NaCl (cf. FIG. 18B) and analyzed using the AF4 method described herein. All mixtures were prepared in duplicates and measured at least in duplicates. The percentage of the calculated, unbound RNA with 100 mM NaCl (black circles) and without NaCl (open circles) was plotted against the charge ratio.

FIGS. 18A and B show that the AF4 method can efficiently separate and quantify the free RNA from physicochemically heterogeneous NP (LPX) samples (lipid/RNA charge ratios) and the different LPXs can be further separated. The relative amount of the free RNA was calculated as a function of the lipid/RNA charge ratio, where the RNA concentration was kept constant (0.1 mg/mL) and the liposome amount varied. The ionic strength of the mixture (0 vs. 100 mM NaCl) was also varied. Clear changes in the amount of free RNA are visible depending on the lipid/RNA ratio and the ionic strength (0-100 mM NaCl). The retention time of the free RNA for all sample compositions was similar for all samples (FIG. 18A/B). The amount of free RNA decreased linearly with an increasing amount of liposome for LPX samples with and without NaCl (FIG. 18C). The presence of salt caused a decrease (up to 15%) in the amount of detectable, free RNA. From these data one can conclude that the addition of salt can increase the amount of LPX bound RNA by ˜15%. FIG. 18D depicting the concentration of unbound RNA (μg/mL) with 100 mM NaCl (black circles) and without NaCl (open circles) shows similar results.

This Example demonstrates that the AF4 method allows the separation of unbound RNA as well as on-line quantification of free drug (RNA) in heterogeneous LPX samples. The method is a useful analytical tool for determining RNA-LPX interactions and can give, in a single run, quantitative information on the particles.

### Example 16—Quantification of Total RNA in Sample Compositions

This Example illustrates the quantification of total RNA in particle compositions using the AF4 method described herein.

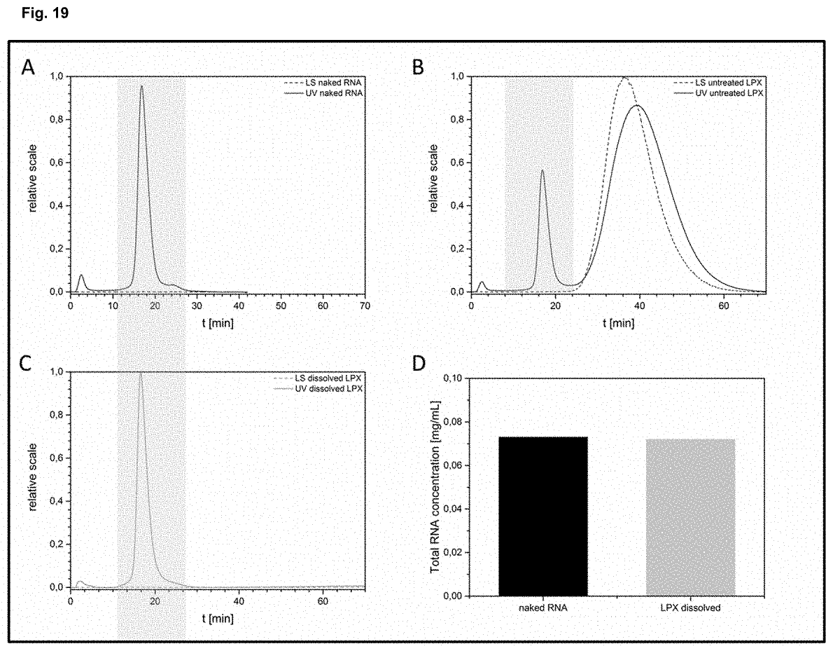

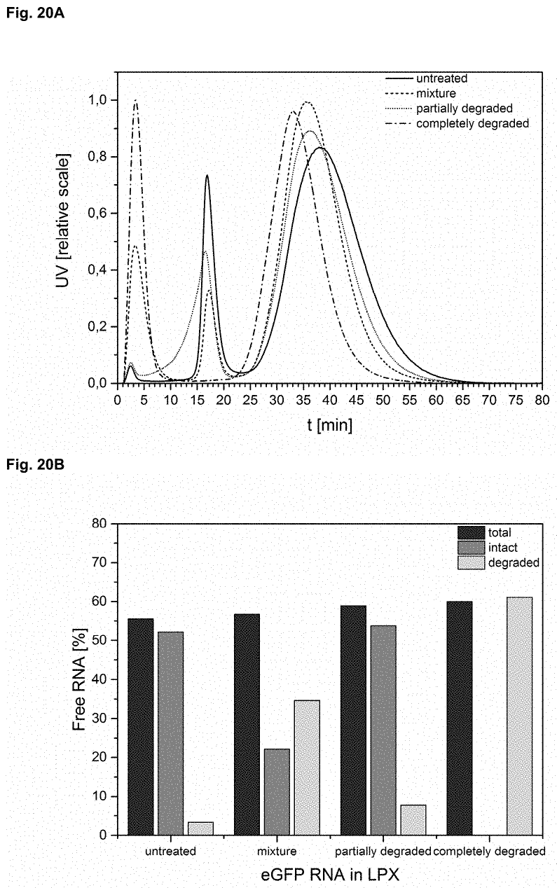

FIG. 19A shows a fractogram of Zwittergent treated, naked RNA separated by the AF4 method. The UV signal at 260 nm is represented by the black line and the LS signal at 90° is represented by the dashed line. FIG. 19B depicts representative fractograms of particle compositions with UV detection (solid line), with free RNA (highlighted in grey) and bound RNA (second peak), LS signal at 90° angle (dashed line). FIG. 19C shows a corresponding fractogram of an RNA composition, in which the particles have been dissolved using a release agent (the liquid phase contained 0.1% Zwittergent), with UV detection (solid line) and light scattering at 90° (dashed line). FIG. 19D depicts the direct quantification of the naked RNA and total RNA after treatment with the release agent (Zwittergent).

Parameters which are considered important quality parameters in the FDA guidance are the free, bound and total RNA concentrations in the sample composition. The challenge of using the UV detection for quantifying the total RNA in lipid based formulations lays in the differences in extinction coefficient of free and bound RNA. In order to use the UV detection at 260 nm for the quantification of total RNA concentration in the LPX these differences have to be eliminated. To address these tasks two different approaches can be applied. The first approach is based on the determination of the extinction coefficient of complexed RNA, which is more complicated due the need of high amount of RNA for the determination. The second approach is based on releasing bound RNA from the formulation. Prior to the quantitative determination of total RNA, nanoparticles have to be disrupted by addition of a release agent (e.g., a surfactant, such as 0.5% SDS or 0.1% Zwittergent (ZW)) to release the RNA from the particle. The separation of dissolved LPX was performed with the liquid phase containing, e.g., 0.05% (w/v) SDS or 0.05% (w/v) ZW to prevent the re-formation of nanoparticle during the separation. The separation of dissolved LPX resulted in a decrease of the LS peak with an increase of the UV signal in the fractogram (FIG. 19C). The UV signal of naked control RNA (FIG. 19A) were comparable with the recorded UV signal of the RNA released from the particles (FIG. 19C).

Thus, the obtained UV peak area of dissolved LPX can directly be translated into the total RNA concentration (mg/mL) in the particle formulation. The concentration calculated in mg/mL using the same extinction coefficient for both RNAs shows comparable results for naked control as well as RNA released from LPX (FIG. 19D).

The results indicate that the AF4 method allows the determination of the amount of free RNA as well as the quantification the total amount of RNA in compositions comprising RNA and particles.

### Example 17—Determination of the Integrity of Free RNA and Total RNA in Sample Compositions

This Example illustrates the determination of the integrity of free RNA and total RNA in sample compositions containing RNA and particles using the AF4 method disclosed herein.

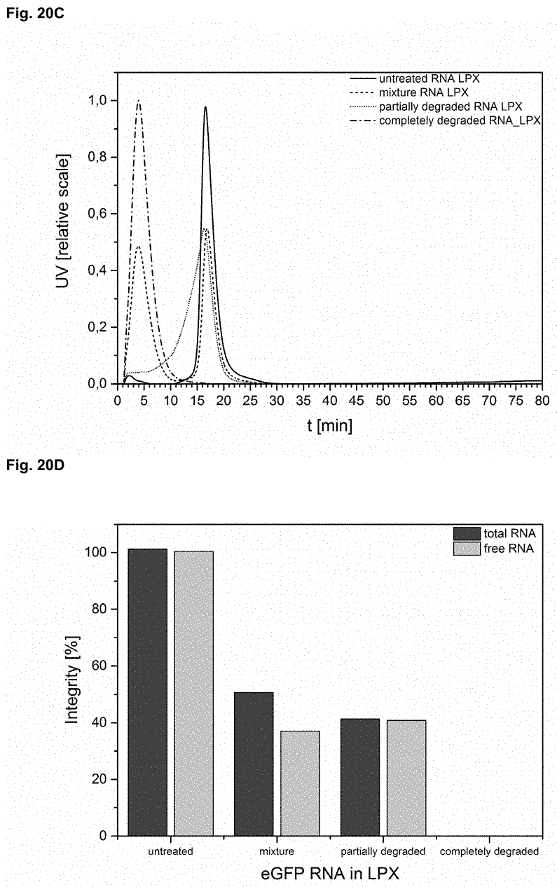

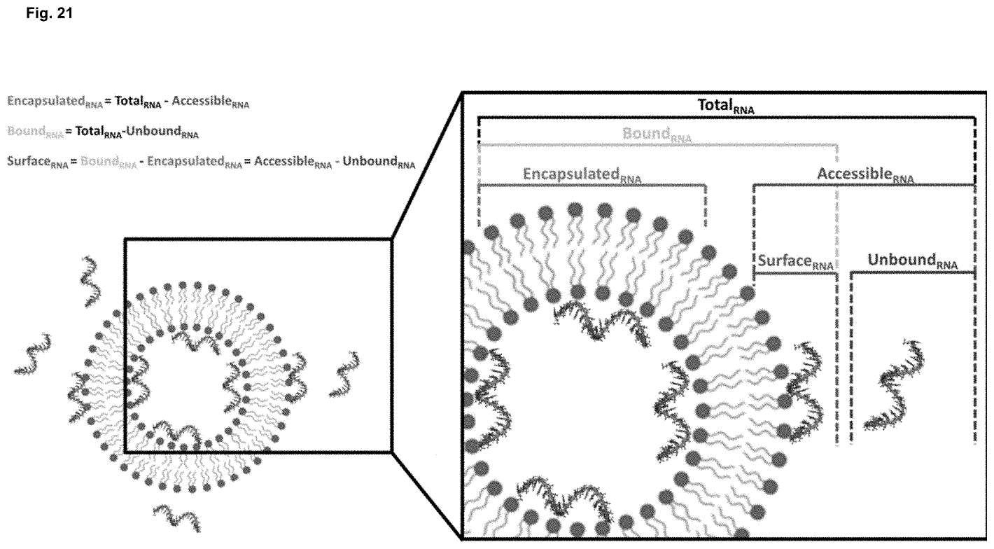

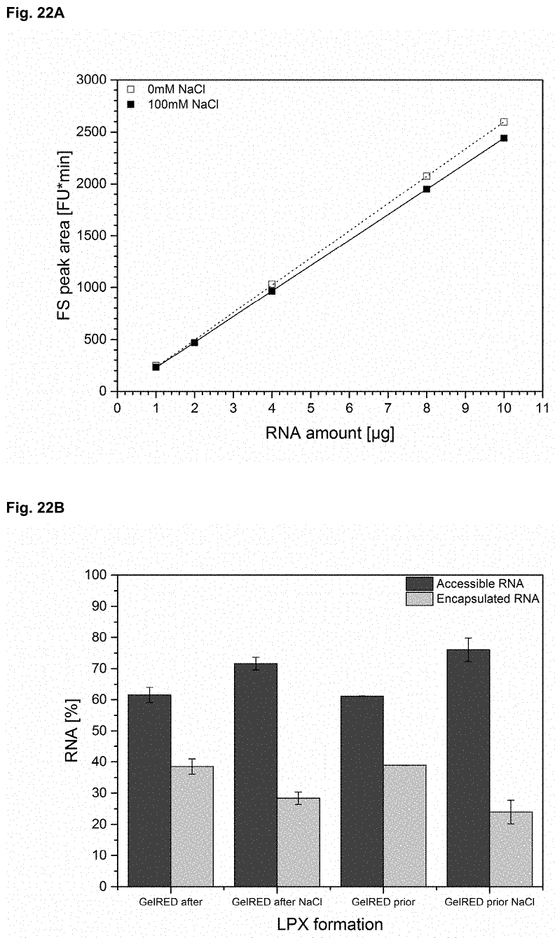

FIG. 20A shows UV traces of separated particles with RNAs differing in the RNA integrity using the AF4 method (untreated RNA: black solid line; partially heat-degraded RNA: dotted line; mixture (mixed in a defined manner 50% of untreated and 50% of completely degraded): dashed line; completely degraded RNA in particles: solid grey line). FIG. 20B depicts the quantification of intact free RNA (dark grey) as well as of total (black) and completely degraded (light gray) free RNA in particles. FIG. 20C shows UV traces of dissolved particles after AF4 separation (using a release agent in the liquid phase). FIG. 20D depicts determined integrities analyzed by AF4-UV measurements of free and total RNA in particles. Bar diagrams represent the relative RNA integrities of free RNA (gray bars) in comparison to the determined integrities of total RNA values in particles (black bars).

The RNA integrity is an important quality parameter as mentioned above. This Example demonstrates that the AF4 method allows the determination of the integrity of naked RNA and total RNA which, however, cannot be achieved by other methods (e.g., capillary electrophoresis).

FIG. 20A shows overlaid UV fractograms of LPXs prepared with different degraded RNAs (non-degraded to heat-degraded). Intact untreated RNA gave 2 distinct peaks eluting at 13-25 min (free RNA) and 25-60 min (nanoparticle). Completely degraded RNA (98° C., 16h) is shown as solid grey line with 2 distinct peaks at 0-10 min (free degraded RNA) and 22-50 min. The mixture of untreated and completely degraded RNA (prepared by mixing 50% of untreated RNA with 50% of completely degraded RNA) is shown as dotted line with 3 distinct peaks at 0-10 min (free degraded RNA), 13-25 min (free intact RNA), and 25-55 min (nanoparticle). A further sample composition comprised partially degraded RNA (RNA heat treated at 98° C. for 15 min) and LPX. These sample compositions were separated by the AF4 method and analyzed using UV detection. The UV signals of separated LPX are shown as black dotted-line, and two distinct peaks appeared at 5-25 (free RNA, partially degraded) and 25-55 min (LPX). The differences in the quantity of free intact RNA are shown in FIG. 20B, corresponding to the degradation degree of RNA. For the LPX composition comprising the completely degraded RNA no intact free RNA was detectible, whereas the sample composition comprising the mixture contained 22% of free intact RNA and the sample composition comprising untreated RNA contained 52% of free intact RNA. Looking at the total amount of free RNA nearly comparable results were observed. A slight increase of free RNA (from 55-60%) was observed with increasing RNA degradation. However, the integrity of free RNA in the sample composition comprising the mixture is lower (37%) as expected (50%), indicating preferable interaction of intact RNA to cationic lipid in comparison to completely degraded RNA. The integrity of completely degraded RNA affects the integrity of free RNA due to the higher amount of free degraded RNA in the formulation (12%, FIG. 20). These findings (higher total RNA integrity values, lower free RNA integrity in the mixture of intact and degraded RNA) indicates the preferred binding of the intact RNA to cationic lipid, while the integrity as well as the content of free RNA in the sample composition comprising the mixture appear to be comparable.

FIG. 20C shows the overlaid UV fractograms of corresponding LPX sample compositions comprising a release agent. The UV peaks at higher elution time for all LPX particles disappeared and the elution time of the bounded RNA shifted to the elution time of the free RNA.

Thus, this Example demonstrates that the AF4 method described herein is able to separate the different fractions of RNA (free, bound, total) in LPX and to determine the integrity of the fractionated RNAs. In addition, the AF4 method allows to simultaneously calculate the RNA integrity and RNA quantity (based on UV detection) of particles in a single run. The simultaneous analysis of these parameters cannot be achieved with other conventional techniques.

### Example 18—Determination of Free, Accessible, and Encapsulated RNA in Sample Compositions

This Example illustrates the determination of free, accessible, and encapsulated RNA in sample compositions using the AF4 method disclosed herein.

The linearity of fluorescence detection of the AF4 method is shown in FIG. 22A: different amounts of RNA (0 mM vs. 100 mM NaCl) were injected and separated by the AF4 method described herein. Prior to the injection an intercalating dye (GelRED) was added to the RNA for the fluorescence detection (600 nm). FIG. 22B depicts bar diagrams showing the relative amounts of accessible (black bars) and encapsulated (grey bars) RNA in LPX compositions without and with NaCl (100 mM). For the detection of the fluorescence emission signal, the intercalating dye (GelRED; 600 nm) was added prior or after the LPX formation. FIG. 22C shows a comparison of the relative amounts of free RNA in particle compositions (LPX) using the AF4 method disclosed herein and the scheme depicted in FIG. 21, wherein the amounts have been determined using different RNA detections: UV absorption at 260 nm (black bars) and fluorescence emission signal at 600 nm (FS) (grey bars).

### Example 19—Analyzing RNA Integrity without Using a Reference RNA

This Example provides an overview of the procedure for estimating the (relative) integrity of RNA, in particular long saRNA, using the AF4 method disclosed herein and without using a reference RNA.

saRNA having a length of 11,917 nt was subjected to the AF4 method disclosed herein. FIG. 23A shows an exemplary AF4 fractogram of the saRNA with the LS signal at 90° (dotted line) and UV signal at 260 nm (solid line). The bold dark line represents the molecular weight curve derived from the MALS signal. In FIG. 23B, for better overview, only the molecular weight curve from FIG. 23A is shown as solid line in the upper panel of FIG. 23B. The limits for the total RNA peak (peak 1) were set based on the total UV peak signal (i.e., from t=10 min to t=40 min). Here, the limits for the “intact” RNA peak (peak 2) were set by the first derivative from the molecular weight curve (derived form MALS) as follows. The first derivative from the molecular weight curve was calculated (dotted line in the lower panel of FIG. 23B). The nearly horizontal part of the molecular weight curve reflects the retention time, where the fraction of undegraded RNA is present. On this basis, integration limits were selected, and the amount of undegraded RNA in the sample was calculated.

### Example 20—Quantitative Analysis of Free and Bound RNA Using UV for the Determination of the Particle Size Distribution, the Cumulative RNA Weight Fraction, the RNA Mass in the LPX Fractions, and the RNA Copies Per LPX Fraction

An RNA lipoplex (LPX) sample composition was subjected to the AF4 method disclosed herein. FIG. 24A shows a representative AF4 fractogram for said RNA LPX sample composition with the LS signal at 90° (solid line) and the UV signal at 260 nm (dashed line). The UV signal shows two peaks, wherein the first peak represents the amount of free, unbound RNA and the second peak results from the LPX nanoparticles comprising RNA. The UV signal is directly representative for the RNA amount in the different fractions, as a function of elution time. The radius of gyration (R_{g}; bold line) was derived from the MALS signal.

FIG. 24B shows the UV signal at 260 nm (dashed line) from FIG. 24A and, as solid line, the cumulative weight fraction based on the area under the UV signal. For the absolute quantification of unbound RNA, the first peak area under the curve was used together with the specific RNA extinction coefficient to calculate the amount of the unbound RNA fraction. Thus, the first peak can quantitatively be translated into the absolute amount of unbound RNA (here: 1.4 μg; 36 μg/mL). The relative amount of the unbound RNA fraction (36%) can be obtained by correlating the absolute amount (μg) of the unbound RNA in the RNA LPX sample composition in relation to the total RNA (solid line). The plausibility of this value was confirmed by two additional, orthogonal methods (agarose gel electrophoresis assay and centrifugation assay). By confirming the unbound RNA value of 36%, it is concluded that the remaining amount of RNA (3.66 μg; 64 μg/mL) is bound in the LPX fraction. This indicates that also the direct UV data from the AF4 fractogram quantitatively correspond to the RNA in the particles with close to 100% recovery. In case stronger scattering from the particles plays a role, the quantitatively determined free RNA, together with data from the fraction of free RNA from other measurements, can be taken for scaling of the UV peak for the particles.

FIG. 24C shows the RNA amount bound in the RNA LPX sample composition by using the absorption at 260 nm in the different size fractions (Δt=1 min). The nanoparticles were separated according to their diffusions coefficient, and the radius of gyration (R_{g}) was derived from MALS using Barry plot. For the calculation of the RNA amount of different R_{g} fractions, only the LPX peak (i.e., the second peak of FIGS. 24A and B starting at t=˜24 min and ending at t=˜60 min) was used. FIG. 24D shows the number of calculated RNA copies per R_{g} fraction (bars, left y-axis) calculated from the results presented in FIG. 24C. The calculated particle number per R_{g} fraction is represented by a corresponding dot-line curve.

This Example demonstrates that the AF4 method described herein is able to simultaneously determine the cumulative RNA weight fraction of RNA LPX sample compositions (cf., FIG. 24B), the RNA mass in LPX fractions (cf., FIG. 23C), the RNA copies per LPX fraction (cf., FIG. 23D, bars) and the particle number per LPX fraction (cf., FIG. 23D, dot-line curve) in a single run. The simultaneous determination of these parameters cannot be achieved with other conventional techniques.

### Example 21—Using Circular Dichroism (CD) Spectroscopy in the AF4 Method

This Example demonstrates that also CD spectroscopy can be used in the AF4 method disclosed herein for measuring the UV signal.

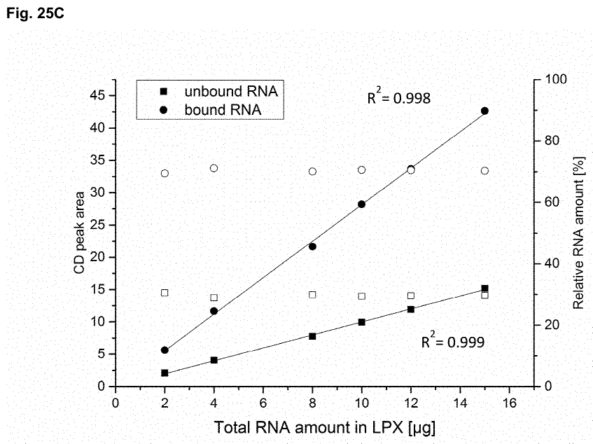

An RNA lipoplex (LPX) sample composition was subjected to the AF4 method disclosed herein using CD spectroscopy as means for measuring the UV signal. FIG. 25A shows a representative AF4 fractogram for the RNA LPX sample composition with the LS signal at 90° angle (solid line) and the CD signal recorded at 260 nm (dotted line), wherein the latter represents the unbound RNA (first peak; t=18 min) and the bound RNA (second peak; t=35 min).

FIG. 25B shows the suitability of the CD detection in the AF4 method disclosed herein for the quantification of free and bound RNA in nanoparticle formulations. Calibration curves of naked RNA were generated using UV as well as CD detection at 260 nm in parallel. The peak areas under the curve (CD: filled squares and solid line; UV: filled triangles and dashed line) were plotted against the injected RNA amount. The ratio of the peak areas of CD and UV signals is shown as dots (second right y-axis). The values of the CD signal areas fit with a good linearity (R²=0.999) and are found to be directly proportional to the amount of RNA (and UV signal). The ratio of the peak areas of CD and UV signal indicates a constant behavior over the wide calibration rage (4 to 20 μg). Therefore, this Example demonstrates that CD can also be used for quantifying the amount of RNA (free and bound) in nanoparticles.

FIG. 25C shows the quantification of free and bound RNA using CD detection in the AF4 method disclosed herein. The area under the curve (AUC) of the CD signal from the appropriate naked RNA was correlated to the appropriate total AUC CD signal. Different amounts of RNA LPX sample composition (2 to 15 μg) were subjected to the AF4 method and plotted against the respective CD peak AUC and the values were linearly fitted (R²=0.998). The CD signal areas were found to be direct proportional to the amount of free as well as bound RNA. The relative amount (%) of unbound RNA (unfilled squares) and bound RNA (unfilled circles) in the RNA LPX sample composition was determined by correlating the amount of unbound RNA and bound RNA with respect to the total RNA amount. The relative proportion of the bound to unbound RNA fraction is constant over the shown calibration range.

1. A method for determining one or more parameters of a sample composition, wherein the sample composition comprises RNA and optionally particles, the method comprising:
(a) subjecting at least a part of the sample composition to field-flow fractionation, thereby fractioning the components contained in the sample composition by their size so as to produce one or more sample fractions;
(b) measuring at least the UV signal, and optionally the light scattering (LS) signal, of least one of the one or more sample fractions obtained from step (a); and
(c) calculating from the UV signal, and optionally from the LS signal, the one or more parameters,
wherein the one or more parameters comprise the RNA integrity, the total amount of RNA, the amount of free RNA, the amount of RNA bound to particles, the size of RNA containing particles, the size distribution of RNA containing particles, and the quantitative size distribution of RNA containing particles.

2. The method of claim 1, wherein the field-flow fractionation is flow field-flow fractionation, such as asymmetric flow field-flow fractionation (AF4) or hollow fiber flow field-flow fractionation (HF5).

3. The method of claim 1 or 2, wherein step (a) is performed using a membrane having a molecular weight (MW) cut-off suitable to prevent RNA from permeating the membrane, preferably a membrane having a MW cut-off in the range of from 2 kDa to 30 kDa, such as a MW cut-off of 10 kDa.

4. The method of any one of claims 1 to 3, wherein step (a) is performed using a polyethersulfon (PES) or regenerated cellulose membrane.

5. The method of any one of claims 1 to 4, wherein step (a) is performed using a cross flow rate of up to 8 mL/min, preferably up to 4 mL/min, more preferably up to 2 mL/min.

6. The method of any one of claims 1 to 5, wherein step (a) is performed using the following cross flow rate profile: 1.0 to 2.0 mL/min for 10 min, an exponential gradient from 1.0 to 2.0 mL/min to 0.01 to 0.07 mL/min within 30 min; 0.01 to 0.07 mL/min for 30 min; and 0 mL/min for 10 min.

7. The method of any one of claims 1 to 6, wherein step (a) is performed using an inject flow in the range of 0.05 to 0.35 mL/min, preferably in the range of 0.10 to 0.30 mL/min, more preferably in the range of 0.15 to 0.25 mL/min.

8. The method of any one of claims 1 to 7, wherein step (a) is performed using a detector flow in the range of 0.30 to 0.70 mL/min, preferably in the range of 0.40 to 0.60 mL/min, more preferably in the range of 0.45 to 0.55 mL/min.

9. The method of any one of claims 1 to 8, wherein the integrity of the RNA contained in the sample composition is calculated using the integrity of a control RNA.

10. The method of claim 9, wherein the integrity of a control RNA is determined by the following steps:
(a′) subjecting at least a part of a control composition containing control RNA to field-flow fractionation, in particular AF4 or HF5, thereby fractioning the components contained in the control composition by their size so as to produce one or more control fractions;
(b′) measuring at least the UV signal of least one of the one or more control fractions obtained from step (a′);
(c′1) calculating from the UV signal obtained in step (b′) the area from the maximum height of one UV peak to the end of the UV peak, thereby obtaining A_{50%}(control);
(c′2) calculating from the UV signal obtained in step (b′) the total area of the one peak used in step (c′1), thereby obtaining A_{100%}(control); and
(c′3) determining the ratio between A_{50%}(control) and A_{100%}(control), thereby obtaining the integrity of the control RNA (I(control)).

11. The method of claim 10, wherein the integrity of the RNA contained in the sample composition is calculated by the following steps:
(c1) calculating from the sample UV signal obtained from step (b) the area from the maximum height of the sample UV peak corresponding to the control UV peak used in step (c′1) to the end of the sample UV peak, thereby obtaining A_{50%}(sample);
(c2) calculating from the sample UV signal obtained from step (b) the total area of the sample UV peak used in step (c1), thereby obtaining A_{100%}(sample);
(c3) determining the ratio between A_{50%}(sample) and A_{100%}(sample), thereby obtaining I(sample); and
(c4) determining the ratio between I(sample) and I(control), thereby obtaining the integrity of the RNA contained in the sample composition.

12. The method of claim 9, wherein calculating the integrity of a control RNA is determined by the following steps:
(a″) subjecting at least a part of a control composition containing control RNA to field-flow fractionation, in particular AF4 or HF5, thereby fractioning the components contained in the control composition by their size so as to produce one or more control fractions;
(b″) measuring at least the UV signal of least one of the one or more control fractions obtained from step (a″); and
(c″) determining from the UV signal obtained in step (b″) the height of one UV peak (H(control)), thereby obtaining the integrity of the control RNA.

13. The method of claim 12, wherein the integrity of the RNA contained in the sample composition is calculated by the following steps:
(c1′) determining from the UV signal obtained in step (b) the height of the sample UV peak corresponding to the control UV peak used in step (c″) (H(sample)); and
(c2′) determining the ratio between H(sample) and H(control), thereby obtaining the integrity of the RNA contained in the sample composition.

14. The method of any one of claims 1 to 13, wherein the amount of RNA is determined by using (i) an RNA extinction coefficient or (ii) an RNA calibration curve.

15. The method of any one of claims 1 to 14, wherein the sample composition comprises RNA and particles, such as lipoplex particles and/or lipid nanoparticles and/or polyplex particles and/or lipopolyplex particles and/or virus-like particles, to which RNA is bound.

16. The method of claim 15, wherein the amount of total RNA is determined by (i) treating at least a part of the sample composition with a release agent; (ii) performing steps (a) to (c) with at least the part obtained from step (i); and (iii) determining the amount of RNA as specified in claim 14.

17. The method of claim 16, wherein in step (a) the field-flow-fractionation is performed using a liquid phase containing the release agent.

18. The method of claim 16 or 17, wherein the release agent is (i) a surfactant, such as an anionic surfactant (e.g., sodium dodecylsulfate), a zwitterionic surfactant (e.g., n-tetradecyl-N,N-dimethyl-3-ammonio-1-propanesulfonate (Zwittergent® 3-14)), a cationic surfactant, a non-ionic surfactant, or a mixture thereof; (ii) an alcohol, such as an aliphatic alcohol (e.g., ethanol), or a mixture of alcohols; or (iii) a combination of (i) and (ii).

19. The method of any one of claims 15 to 18, wherein the amount of free RNA is determined by performing steps (a) to (c) without the addition of a release agent, in particular in the absence of any release agent; and determining the amount of RNA as specified in claim 14.

20. The method of any one of claims 15 to 19, wherein the amount of RNA bound to particles is determined by subtracting the amount of free RNA as determined by claim 19 from the amount of total RNA as determined by any one of claims 16 to 18.

21. The method of any one of claims 15 to 20, wherein step (b) further comprises measuring the LS signal, such as the dynamic light scattering (DLS) signal and/or the static light scattering (SLS), e.g., multi-angle light scattering (MALS), signal, of least one of the one or more sample fractions obtained from step (a).

22. The method of claim 21, wherein the size of RNA containing particles is determined by calculating from the LS signal obtained from step (b) the radius of gyration (R_{g}) values and/or the hydrodynamic radius (Rₕ) values.

23. The method of claim 21, wherein the experimentally determined R_{g} and/or Rₕ values are smoothed, preferably by fitting the experimentally determined or calculated R_{g} or Rₕ values to a polynomial or linear function and recalculating the R_{g} or Rₕ values based on the polynomial or linear fit.

24. The method of any one of claims 21 to 23, wherein the size distribution of RNA containing particles is determined by plotting the UV signal obtained from step (b) against the R_{g} or Rₕ values determined as specified in claim 22.

25. The method of any one of claims 21 to 24, wherein the quantitative size distribution of RNA containing particles is calculated from the plot showing the UV signal as function of the R_{g} or Rₕ values by transforming the UV signal into a cumulative weight fraction and plotting the cumulative weight fraction against the R_{g} or Rₕ values.

26. The method of claim 25, wherein the quantitative size distribution includes D10, D50, and/or D90 values.

27. The method of any one of claims 22 to 26, wherein step (b) comprises measuring the dynamic light scattering (DLS) signal of least one of the one or more sample fractions obtained from step (a) and step (c) comprises calculating the Rₕ values from the DLS signal.

28. The method of any one of claims 15 to 27, wherein the one or more parameters comprise (or are) at least two, preferably at least three, parameters selected from the group consisting of: the amount of free RNA, the amount of RNA bound to particles, the size distribution of RNA containing particles, and the quantitative size distribution of RNA containing particles.

29. The method of any one of claims 15 to 28, wherein the amount of RNA, in particular free RNA, is determined by measuring the UV signal at 260 nm and using the RNA extinction coefficient at 260 nm or by measuring the UV signal at 280 nm and using the RNA extinction coefficient at 280 nm.

30. The method of any one of claims 1 to 29, wherein the size distribution of RNA containing particles and/or the quantitative size distribution of RNA containing particles is/are within the range of 10 to 2000 nm, preferably within the range of 20 to 1500 nm, such as 30 to 1200 nm, 40 to 1100 nm, 50 to 1000, 60 to 900 nm, 70 to 800 nm, 80 to 700 nm, 90 to 600 nm, or 100 to 500 nm, such as within the range of 10 to 1000 nm, 15 to 500 nm, 20 to 450 nm, 25 to 400 nm, 30 to 350 nm, 40 to 300 nm, or 50 to 250 nm.

31. The method of any one of claims 1 to 30, wherein the RNA has a length of 10 to 15,000 nucleotides, such as 40 to 15,000 nucleotides, 100 to 12,000 nucleotides or 200 to 10,000 nucleotides.

32. The method of any one of claims 1 to 31, wherein the RNA is in vitro transcribed RNA, in particular in vitro transcribed mRNA.

33. The method of any one of claims 1 to 32, wherein measuring the UV signal, optionally the LS signal, such as the SLS, e.g., MALS, signal and/or the DLS signal, is performed on-line and/or step (c) is performed on-line.

34. The method of any one of claims 15 to 33, wherein before subjecting at least a part of the sample composition to field-flow fractionation, the at least part of the sample composition is diluted with a solvent or solvent mixture, said solvent or solvent mixture being able to prevent the formation of aggregates of the particles.

35. The method of claim 36, wherein the solvent mixture is a mixture of water and an organic solvent, e.g., formamide.

36. The method of any one of claims 1 to 35, wherein measuring the UV signal is performed by using circular dichroism (CD) spectroscopy.

37. A method of analyzing the effect of altering one or more reaction conditions when providing a composition comprising RNA and optionally particles, the method comprising:
(A) providing a first composition comprising RNA and optionally particles;
(B) providing a second composition comprising RNA and optionally particles, wherein the provision of the second composition differs from the provision of the first composition only in the one or more reaction conditions;
(C) subjecting a part of the first composition to a method of any one of claims 1 to 36, thereby determining one or more parameters of the first composition;
(D) subjecting a corresponding part of the second composition to the method used in step (C), thereby determining one or more parameters of the second composition; and
(E) comparing the one or more parameters of the first composition obtained in step (C) with the corresponding one or more parameters of the second composition obtained in step (D).

38. The method of claim 37, wherein the one or more reaction conditions comprise any of the following: salt concentration/ionic strength (e.g., 2 mM NaCl or 100 mM NaCl); temperature (e.g., low temperature (such as −20° C.) or high temperature (such as 50° C.)); pH or buffer concentration; light/radiation; oxygen; shear force; pressure; freezing/thawing cycle; drying/reconstitution cycle; addition of excipient(s) (e.g., stabilizer and/or chelating agent); type and/or source of particle forming compounds (in particular lipids and/or polymers, e.g., cationic lipid vs. zwitterionic lipid, or pegylated lipid vs. unpegylated lipid); charge ratio; physical state; and ratio of RNA to particle forming compounds of (in particular lipids and/or polymers).

39. Use of field-flow-fractionation for determining one or more parameters of a sample composition comprising RNA and optionally particles, wherein the one or more parameters comprise the RNA integrity, the total amount of RNA, the amount of free RNA, the amount of RNA bound to particles, the size of RNA containing particles (such as the hydrodynamic radius of RNA containing particles), the size distribution of RNA containing particles, and the quantitative size distribution of RNA containing particles.

40. The use of claim 39, wherein the field-flow fractionation comprises:
(a) subjecting at least a part of the sample composition to field-flow fractionation, thereby fractioning the components contained in the sample composition by their size so as to produce one or more sample fractions;
(b) measuring at least the UV signal, and optionally the light scattering (LS) signal, of least one of the one or more sample fractions obtained from step (a); and
(c) calculating from the UV signal, and optionally from the LS signal, the one or more parameters.

41. The use of claim 39 or 40, wherein the field-flow fractionation is flow field-flow fractionation, such as asymmetric flow field-flow fractionation (AF4) or hollow fiber flow field-flow fractionation (HF5).

42. The use of any one of claims 39 to 41, wherein the field-flow-fractionation uses a membrane having a molecular weight (MW) cut-off suitable to prevent RNA from permeating the membrane, preferably a membrane having a MW cut-off in the range of from 2 kDa to 30 kDa, such as a MW cut-off of 10 kDa.

43. The use of any one of claims 39 to 42, wherein the field-flow-fractionation uses a polyethersulfon (PES) or regenerated cellulose membrane.

44. The use of any one of claims 40 to 43, wherein step (a) is performed using
(I) a cross flow rate of up 0 to 8 mL/min, preferably up to 4 mL/min, more preferably up to 2 mL/min, such as the following cross flow rate profile: 1.0 to 2.0 mL/min for 10 min, an exponential gradient from 1.0 to 2.0 mL/min to 0.01 to 0.07 mL/min within 30 min; 0.01 to 0.07 mL/min for 30 min; and 0 mL/min for 10 min; and/or
(II) an inject flow in the range of 0.05 to 0.35 mL/min, preferably in the range of 0.10 to 0.30 mL/min, more preferably in the range of 0.15 to 0.25 mL/min; and/or
(III) a detector flow in the range of 0.30 to 0.70 mL/min, preferably in the range of 0.40 to 0.60 mL/min, more preferably in the range of 0.45 to 0.55 mL/min.

45. The use of any one of claims 39 to 44, wherein the integrity of the RNA contained in the sample composition is determined using the integrity of a control RNA.

46. The use of claim 45, wherein the integrity of a control RNA is determined by the following steps:
(a′) subjecting at least a part of a control composition containing control RNA to field-flow fractionation, in particular AF4 or HF5, thereby fractioning the components contained in the control composition by their size so as to produce one or more control fractions;
(b′) measuring at least the UV signal of least one of the one or more control fractions obtained from step (a′);
(c′1) calculating from the UV signal obtained in step (b′) the area from the maximum height of one UV peak to the end of the UV peak, thereby obtaining A_{50%}(control);
(c′2) calculating from the UV signal obtained in step (b′) the total area of the one peak used in step (c′1), thereby obtaining A_{100%}(control); and
(c′3) determining the ratio between A_{50%}(control) and A_{50%}(control), thereby obtaining the integrity of the control RNA (I(control)).

47. The use of claim 46, wherein the integrity of the RNA contained in the sample composition is calculated by the following steps:
(c1) calculating from the sample UV signal obtained from step (b) the area from the maximum height of the sample UV peak corresponding to the control UV peak used in step (c′1) to the end of the sample UV peak, thereby obtaining A_{50%}(sample);
(c2) calculating from the sample UV signal obtained from step (b) the total area of the sample UV peak used in step (c1), thereby obtaining A_{100%}(sample);
(c3) determining the ratio between A_{50%}(sample) and A_{100%}(sample), thereby obtaining I(sample); and
(c4) determining the ratio between I(sample) and I(control), thereby obtaining the integrity of the RNA contained in the sample composition.

48. The use of claim 45, wherein calculating the integrity of a control RNA is determined by the following steps:
(a″) subjecting at least a part of a control composition containing control RNA to field-flow fractionation, in particular AF4 or HF5, thereby fractioning the components contained in the control composition by their size so as to produce one or more control fractions;
(b″) measuring at least the UV signal of least one of the one or more control fractions obtained from step (a″); and
(c″) determining from the UV signal obtained in step (b″) the height of one UV peak (H(control)), thereby obtaining the integrity of the control RNA.

49. The use of claim 48, wherein the integrity of the RNA contained in the sample composition is calculated by the following steps:
(c1′) determining from the UV signal obtained in step (b) the height of the sample UV peak corresponding to the control UV peak used in step (c″) (H(sample)); and
(c2′) determining the ratio between H(sample) and H(control), thereby obtaining the integrity of the RNA contained in the sample composition.

50. The use of any one of claims 39 to 49, wherein the amount of RNA is determined by using (i) an RNA extinction coefficient or (ii) an RNA calibration curve.

51. The use of any one of claims 40 to 50, wherein the sample composition comprises RNA and particles, such as lipoplex particles and/or lipid nanoparticles and/or polyplex particles and/or lipopolyplex particles and/or virus-like particles, to which RNA is bound.

52. The use of claim 51, wherein the amount of total RNA is determined by (i) treating at least a part of the sample composition with a release agent; (ii) performing steps (a) to (c) with at least the part obtained from step (i); and (iii) determining the amount of RNA as specified in claim 50.

53. The use of claim 52, wherein in step (a) the field-flow-fractionation is performed using a liquid phase containing the release agent.

54. The use of claim 52 or 53, wherein the release agent is (i) a surfactant, such as an anionic surfactant (e.g., sodium dodecylsulfate), a zwitterionic surfactant (e.g., n-tetradecyl-N,N-dimethyl-3-ammonio-1-propanesulfonate (Zwittergent® 3-14)), a cationic surfactant, a non-ionic surfactant, or a mixture thereof; (ii) an alcohol, such as an aliphatic alcohol (e.g., ethanol), or a mixture of alcohols; or (iii) a combination of (i) and (ii).

55. The use of any one of claims 51 to 54, wherein the amount of free RNA is determined by performing steps (a) to (c) without the addition of a release agent, in particular in the absence of any release agent; and determining the amount of RNA as specified in claim 50.

56. The use of any one of claims 51 to 55, wherein the amount of RNA bound to particles is determined by subtracting the amount of free RNA as determined by claim 55 from the amount of total RNA as determined by any one of claims 52 to 54.

57. The use of any one of claims 51 to 56, wherein step (b) further comprises measuring the LS signal, such as the dynamic light scattering (DLS) signal and/or the static light scattering (SLS), e.g., multi-angle light scattering (MALS), signal, of least one of the one or more sample fractions obtained from step (a).

58. The use of claim 57, wherein the size of RNA containing particles is determined by calculating from the LS signal obtained from step (b) the radius of gyration (R_{g}) values and/or the hydrodynamic radius (Rₕ) values.

59. The use of claim 58, wherein the experimentally determined R_{g} and/or Rₕ values are smoothed, preferably by fitting the experimentally determined or calculated R_{g} or Rₕ values to a polynomial or linear function and recalculating the R_{g} or Rₕ values based on the polynomial or linear fit.

60. The use of any one of claims 57 to 59, wherein the size distribution of RNA containing particles is determined by plotting the UV signal obtained from step (b) against the R_{g} or Rₕ values determined as specified in claim 58.

61. The use of any one of claims 57 to 60, wherein the quantitative size distribution of RNA containing particles is calculated from the plot showing the UV signal as function of the R_{g} or Rₕ values by transforming the UV signal into a cumulative weight fraction and plotting the cumulative weight fraction against the R_{g} or Rₕ values.

62. The use of claim 61, wherein the quantitative size distribution includes D10, D50, and/or D90 values.

63. The use of any one of claims 58 to 62, wherein step (b) comprises measuring the dynamic light scattering (DLS) signal of least one of the one or more sample fractions obtained from step (a) and step (c) comprises calculating the Rₕ values from the DLS signal.

64. The use of any one of claims 51 to 63, wherein the one or more parameters comprise (or are) at least two, preferably at least three, parameters selected from the group consisting of: the amount of free RNA, the amount of RNA bound to particles, the size distribution of RNA containing particles, and the quantitative size distribution of RNA containing particles.

65. The use of any one of claims 51 to 64, wherein the amount of RNA, in particular free RNA, is determined by measuring the UV signal at 260 nm and using the RNA extinction coefficient at 260 nm or by measuring the UV signal at 280 nm and using the RNA extinction coefficient at 280 nm.

66. The use of any one of claims 39 to 65, wherein the size distribution of RNA containing particles and/or the quantitative size distribution of RNA containing particles is/are within the range of 10 to 2000 nm, preferably within the range of 20 to 1500 nm, such as 30 to 1200 nm, 40 to 1100 nm, 50 to 1000, 60 to 900 nm, 70 to 800 nm, 80 to 700 nm, 90 to 600 nm, or 100 to 500 nm, such as within the range of 10 to 1000 nm, 15 to 500 nm, 20 to 450 nm, 25 to 400 nm, 30 to 350 nm, 40 to 300 nm, or 50 to 250 nm.

67. The use of any one of claims 39 to 66, wherein the RNA has a length of 10 to 15,000 nucleotides, such as 40 to 15,000 nucleotides, 100 to 12,000 nucleotides or 200 to 10,000 nucleotides.

68. The use of any one of claims 39 to 67, wherein the RNA is in vitro transcribed RNA, in particular in vitro transcribed mRNA.

69. The use of any one of claims 40 to 68, wherein measuring the UV signal, optionally the LS signal, such as the SLS, e.g., MALS, signal and/or the DLS signal, is performed on-line and/or step (c) is performed on-line.

70. The use of any one of claims 40 to 69, wherein before subjecting at least a part of the sample composition to field-flow fractionation, the at least part of the sample composition is diluted with a solvent or solvent mixture, said solvent or solvent mixture being able to prevent the formation of aggregates of the particles.

71. The use of claim 70, wherein the solvent mixture is a mixture of water and an organic solvent, e.g., formamide.

72. The use of any one of claims 40 to 71, wherein measuring the UV signal is performed by using CD spectroscopy.
